(19) United States
(12) Patent Application Publication
(10) Pub. No.: US 2006/0110691 A9
(43) Pub. Date: May 25, 2006

(54) Photothermographic material

(76) Inventors: Tomoyuki Ohzeki, Kanagawa (JP); Hiroyuki Mifune, Kanagawa (JP); Katsuyuki Watanabe, Kanagawa (JP); Eiichi Okutsu, Kanagawa (JP)

Correspondence Address: TAIYO CORPORATION, 401 HOLLAND LANE, #407, ALEXANDRIA, VA, 22314, US

(21) Appl. No.: 10/760,496

(22) Filed: Jan. 21, 2004

Related U.S. Application Data
(63) Continuation-in-part of application No. 10/285,644, filed on Nov. 1, 2002.
(63) Continuation-in-part of application No. 10/736,334, filed on Dec. 16, 2003.
(63) Continuation-in-part of application No. 10/633,253, filed on Aug. 4, 2003, now Pat. No. 7,026,109.

(30) Foreign Application Priority Data
Jan. 24, 2003 (JP) 2003-15600
Feb. 5, 2003 (JP) 2003-28210
Feb. 13, 2003 (JP) 2003-35057
Nov. 5, 2001 (JP) 2001-339636
Nov. 8, 2001 (JP) 2001-342983
Nov. 9, 2001 (JP) 2001-344727
Nov. 29, 2001 (JP) 2001-364512
Mar. 29, 2002 (JP) 2002-96660
Mar. 29, 2002 (JP) 2002-97920
Dec. 20, 2002 (JP) 2002-370299
Sep. 18, 2003 (JP) 2003-325985
Aug. 16, 2002 (JP) 2002-237328
Dec. 27, 2002 (JP) 2002-378994

(51) Int. Cl. G03C 5/16

(52) U.S. Cl. 430/348

(57) ABSTRACT

A photothermographic material including an image forming layer containing at least a photosensitive silver halide, a non-photosensitive organic silver salt, a reducing agent and a binder on the same surface of a support, wherein the photothermographic material contains a compound having an adsorption group to silver halide and a reducing group, or a precursor of the compound, and satisfies one of the following conditions: 1) the photothermographic material contains a development accelerator; 2) the non-photosensitive organic silver contains silver behenate in an amount of not less than 80% by mole, and the binder has a glass transition temperature (Tg) of 45° C. or less; or 3) the photothermographic material contains at least one compound represented by the following formula (H);
Q-(Y)ₙ—C(Z₁)(Z₂)X
wherein, in formula (H), Q represents an alkyl group, an aryl group or a heterocyclic group; Y represents a divalent linking group; n represents 0 or 1; Z₁ and Z₂ each independently represent a halogen atom; and X represents a hydrogen atom or an electron attracting group.

### CROSS-REFERENCE TO RELATED APPLICATION

This application claims priority under 35 USC 119 from Japanese Patent Application Nos. 2003-015600, 2003-028210 and 2003-035057, the disclosures of which are incorporated by reference herein.

### BACKGROUND OF THE INVENTION

1. Field of the Invention

The present invention relates to a photothermographic material, and more particularly, to a photothermographic material that has a high sensitivity with a low degree of fogging and is excellent in raw stock storability and image stability such as print-out resistance.

2. Description of the Related Art

In the medical imaging field and the graphic arts field, there has been, in recent years, a strong desire for a dry photographic process from the viewpoints of environmental conservation and economy of space. Further, the development of digitization in these fields has resulted in the rapid development of systems in which image information is captured and stored in a computer, whereafter the image information is processed, if necessary, by the computer which outputs the image information through communication to a desired location, and the image information is further output, at the site, onto a photosensitive material using a laser image setter or a laser imager, followed by development thereof to form an image on the photosensitive material. It is required that the photosensitive material be able to record an image under exposure to a laser with a high intensity and that a clear black-tone image with a high resolution and sharpness can be formed. While various kinds of hard copy systems using a pigment or a dye such as an ink-jet printer or an electrophotographic system have been distributed as a general image forming system using such a digital imaging recording material, images in the digital imaging recording material obtained by such a general image forming system are insufficient in terms of image qualities required for medical images. To facilitate diagnosis, image qualities such as sharpness, granularity, gradation, tone and high recording speed (sensitivity) are required. However, digital imaging recording materials have not reached a level at which they can replace medical silver salt film processed by conventional wet development.

A thermographic system using an organic silver salt is well known. Generally, a photothermographic material, in particular, comprises an image forming layer in which a photocatalyst (for example, a silver halide) of a catalytically active amount, a reducing agent, a reducible silver salt (for example, an organic silver salt) and if necessary, a toner controlling a color tone of developed silver are dispersed in a binder matrix.

A black-toned silver image is formed in a photothermographic material by heating the photothermographic material to a high temperature (for example, 80° C. or higher) after imagewise exposure to cause an oxidation-reduction reaction between a silver halide or a reducible silver salt (functioning as an oxidizing agent) and a reducing agent. The oxidation-reduction reaction is accelerated by a catalytic action of a latent image generated on the silver halide by exposure. As a result, a black-toned silver image is formed in an exposed region. Fuji medical dry imager FM-DP L is an example of a practical medical image forming system that has been marketed.

There has been a demand for higher sensitivity in a photothermographic material using an organic silver salt, in order to increase an image recording speed, and there has also been a demand for reduced fogging to improve the capacity for medical diagnosis. Further, it is extremely important to improve image stability and raw stock storability of a photothermographic material in order for it to replace medical silver salt film processed by conventional wet development.

On the other hand, a gas laser (Ar⁺, He—Ne, or He—Cd), a YAG laser, a dye laser, a laser diode or the like is generally used as a laser beam. A laser diode and a second harmonic generation element and the like can also be used. With regard to an emitting wavelength, lasers in a wide wavelength range from the blue region to the infrared region are used. Among these, an infrared laser diode is particularly suitable for design of a laser image output system which is inexpensive and can obtain stable light emission, and which, in particular, is compact, excellent in operability, and not restrict with respect to an installation location. For this reason, the photothermographic material is required to have infrared sensitivity. Various efforts have been made for enhancing infrared sensitivity. However, infrared spectrum sensitization has a problem in that it is generally unstable and decomposes during storage of the photosensitive material, leading to decrease in sensitivity, and there is increasing demand for improvement in preservation stability, together with increased sensitivity.

Recently, a blue laser diode has been developed, enabling image recording with high precision with increased recording density and long life. Therefore, demand for the blue laser diode is expanding and a photothermographic recording material compatible with the blue laser diode is required.

Since the above-described thermographic system using an organic silver salt has no fixing step, there has been a considerable problem in image stability after development, particularly with respect to worsening of print-out when exposed to light. As means for improving the print-out, a method in which silver iodide formed through conversion of an organic silver salt is employed is disclosed in U.S. Pat. No. 6,143,488 and European Patent (EP) No. 0922995. In a method, such as described therein, in which an organic silver salt is converted with iodine, however, a sufficient sensitivity cannot be obtained, which has led to difficulty in incorporation into an actual system. As to other photosensitive materials using silver iodide, description thereof is given in International Publication (WO) Nos. 97-48014 and 97-48015, U.S. Pat. No. 6,165,705, Japanese Patent Application Laid-Open (JP-A) No. 8-297345, and Japanese Patent No. 2785129. However, in all of these, neither a sufficient sensitivity nor a sufficient fogging level is achieved, leading to a poor laser exposure photosensitive material which is not suitable for practical use.

Sensitivity of a silver iodide photographic emulsion has been enhanced by soaking the emulsion in an aqueous solution of halogen acceptors such as sodium nitrite, pyrogallol or hydroquinone, and by sensitizing with sulfur at pAg 7.5 according to sensitization methods described in the literature. However, the sensitizing effects of these halogen acceptors are quite small and insufficient for a photothermographic material which is the object of the present invention. Accordingly, development of technologies enabling the sensitivity to be greatly increased in a photothermographic material using a silver halide rich in silver iodide content has been eagerly desired.

Sensitization methods using compounds that generate two electrons from one photon in silver halide photosensitive materials processed with liquid developer have been reported in U.S. Pat. Nos. 5,747,235, 5,747,236, 6,054,260 and 5,994,051.

However, a silver halide photosensitive material processed with liquid developer is used for forming silver images by reducing silver halide with a developing agent (reducing agent) usually contained in the liquid developer, or for forming color images by taking advantage of an oxidized compound as a by-product of a developing agent. The basic reaction for imaging is a reduction reaction of silver halide with a developing agent. On the other hand, in the photothermographic material, silver halide only forms a latent image by exposure. Silver halide itself is not reduced by a reducing agent, and silver ions supplied from non-photosensitive organic silver salts are reduced. While the reducing agent in liquid developer processing is an ionic reducing agent such as hydroquinone or p-phenylenediamine, the reducing agent in a photothermographic material is a hindered phenol derivative usually known as a radical reagent.

The mechanisms of the development reactions (reducing reactions) are quite different between the photosensitive material processed with liquid developer and the photothermographic material, and the compounds used therein are of completely different systems. Accordingly, it cannot at all be said that a compound that is effective in liquid developer processing will also be effective for a photothermographic material. With respect to the compounds described in the aforementioned U.S. patents, it cannot at all be anticipated whether the compounds might display the same effect or whether quite different effects might be expected upon applying them to a photothermographic material. Application of the compounds to a photothermographic material using silver halide rich in silver iodide content was even less anticipated, and it was impossible to presume the effect of the compounds.

### SUMMARY OF THE INVENTION

The present invention intends to provide a photothermographic material that has a high sensitivity with a low degree of fogging and is excellent in raw stock storability and print-out resistance of images.

<1> A first aspect of the invention provides a photothermographic material comprising an image forming layer containing at least a photosensitive silver halide, a non-photosensitive organic silver salt, a reducing agent and a binder on the same surface of a support, wherein the photothermographic material contains: a compound having an adsorption group to silver halide and a reducing group, or a precursor of the compound; and a development accelerator.

<2> A second aspect of the invention provides a photothermographic material comprising, on a support, at least a photosensitive silver halide, a non-photosensitive organic silver salt, a reducing agent and a binder, wherein: 1) the photothermographic material contains a compound having an adsorption group to silver halide and a reducing group, or a precursor of the compound; 2) the non-photosensitive organic silver salt contains silver behenate in an amount of not less than 80% by mole; and 3) the binder has a glass transition temperature (Tg) of 45° C. or less.

<3> A third aspect of the invention provides a photothermographic material comprising at least a photosensitive silver halide, a non-photosensitive organic silver salt, a reducing agent and a binder, wherein the photothermographic material contains: a compound having an adsorption group to silver halide and a reducing group, or a precursor of the compound; and at least one compound represented by the following formula (H):
Q-(Y)ₙ—C(Z₁)(Z₂)X
wherein, in formula (H), Q represents an alkyl group, an aryl group or a heterocyclic group; Y represents a divalent linking group; n represents 0 or 1; Z₁ and Z₂ each independently represent a halogen atom; and X represents a hydrogen atom or an electron attracting group.

### DETAILED DESCRIPTION OF THE INVENTION

The present invention will be described in detail below.

(Photothermographic Material)

The photothermographic material of the invention has an image forming layer containing at least a photosensitive silver halide, a non-photosensitive organic silver salt, a reducing agent and a binder, on at least one surface of a support. The image forming layer may be a single layer or may be constituted of a plurality of layers. Further, the image forming layer may carry thereon a intermediate layer or a surface protective layer, or may carry a back layer, a back protective layer and the like on the opposite surface.

The constitutions and preferable components of these layers will be illustrated in detail below.

(Compound having Adsorption Group and Reducing Group)

The photothermographic material of the present invention contains the compound having an adsorption group and a reducing group.

It is preferred that the compound having an adsorption group and a reducing group used in the invention is represented by the following formula (I).
Formula (I) A-(W)n-B

In formula (I), A represents a group capable of adsorption to a silver halide (hereafter, it is called an adsorption group) and W represents a divalent connecting group and n represents 0 or 1 and B represents a reducing group.

Next, formula (I) is explained in more detail.

In formula (I), the adsorption group represented by A is a group to adsorp directly to a silver halide or a group to promote adsorption to a silver halide. As typical examples, a mercapto group (or the salt thereof), a thione group (—C(═S)—), a nitrogen atom, a heterocyclic ring containing at least one atom selected from a nitrogen atom, a sulfur atom, a selenium atom and a tellurium atom, a sulfide group, a disulfide group, a cationic group, an ethynyl group and the like are described.

The mercapto group as an adsorption group means a mercapto group (and the salt thereof) itself and simultaneously more preferably represents a heterocyclic ring group or an aryl group or an alkyl group substituted by at least one mercapto group (or the salt thereof). Herein, as the heterocyclic ring group, a monocyclic or a condensed aromatic or nonaromatic heterocyclic ring group having at least a 5 to 7 membered ring, e.g., an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group and the like are described. A heterocyclic ring having quarternalized nitrogen atom may also be adopted, wherein a mercapto group as a substituent may dissociate to form a mesoion. As examples of such heterocyclic ring group, an imidazolium ring group, a pyrazolium ring group, a thiazolium ring group, a triazolium ring group, a tetrazolium ring group, a thiadiazolium ring group, a pyridinium ring group, a pyrimidinium ring group, a triazinium ring group and the like are described and among them, a triazolium ring group (e.g., a 1,2,4-triazolium-3-thiolate ring group) is preferable. As an aryl group, a phenyl group or a naphthyl group is described. As an alkyl group, a straight chain, branched chain or cyclic alkyl group having 1 to 30 carbon atoms is described. As a counter ion, whereby a mercapto group forms the salt thereof, a cation such as an alkali metal, an alkali earth metal, a heavy metal and the like (Li⁺, Na⁺, K⁺, Mg²⁺, Ag⁺, Zn²⁺ and the like), an ammonium ion, a heterocyclic ring group having quaternalized nitrogen atom, a phosphonium ion and the like are described. Further, the mercapto group as an adsorption group may become a thione group by a tautomerization. For example, a thioamide group (herein —C(═S)—NH— group) and the group containing the said thioaminde group as a partial structure, namely a chain or a cyclic thioamide, thioureide, thiourethane or dithiocarbanic ester group and the like are described. Herein, as cyclic examples, a thiazolidine-2-thione group, an oxazolidine-2-thione group, a 2-thiohydantoin group, a rhodanine group, an isorhodanine group, a thiobarbituric acid group, a 2-thioxo-oxazolidine-4-one group and the like are described.

The thione group as an adsorption group may also contain a chain or a cyclic thioamide group, a thioureido group, a thiouretane group or a thioester group which can not tautomerize to a mercapto group (having no hydrogen atom on the α-position of a thione group) with containing a mercapto group capable to become a thion group by tautomerization.

The heterocyclic ring group containing at least one atom selected from a nitrogen atom, a sulfur atom, a selenium atom and a tellurium atom represents a nitrogen atom containing heterocyclic ring group having —NH-group, as a partial structure of hetero ring, capable to form a silver iminate (>NAg) or a heterocyclic ring group, having —S— group, —Se— group, —Te— group or ═N-group as a partial structure of hetero ring, and capable to coordinate to a silver ion by a chelate bonding. As the former examples, a benzotriazole group, a triazole group, an indazole group, a pyrazole group, a tetrazole group, a benzimidazole group, a purine group and the like are described. As the latter examples, a thiophene group, a thiazole group, a benzoxazole group, a thiadiazole group, an oxadiazole group, a triazine group, a selenoazole group, a benzoselenazole group, a tellurazole group, a benzotellurazole group and the like are described. The former is preferable.

The sulfide group or disulfide group as an adsorption group contains all groups having “—S—” or “—S—S—” as a partial structure, but the group having “alkyl (or an alkylene)-X-alkyl (or alkylene)”, “aryl (or arylene)-X-alkyl (or alkylene)”, and “aryl (or arylene)-X-aryl (or arylene)” as a partial structure are preferably, wherein X represents “—S— group” or “—S—S— group”. Further, these sulfide groups or disulfide groups may form a cyclic structure. As typical examples of a cyclic structure formation, the group containing a thiorane ring, a 1,3-dithiorane ring, a 1,2-dithiorane ring, a thiane ring, a dithiane ring, a thiomorphorine ring and the like are described. As a sulfide group, the group having “alkyl (or alkylene)-S-alkyl (or alkylene)” as a partial structure and as a disulfide group, a 1,2-dithiorane ring group are particularly preferably described.

The cationic group as an adsorption group means the group containing a quaternalized nitrogen atom, such as an ammonio group or a nitrogen containing heterocyclic ring group containing a quaternalized nitrogen atom. Herein, an ammonio group means a trialkylammonio group, a dialkylarylammonio group, an alkyldiarylammonio group, such as a benzyldimethylammonio group, a trihexylammonio group, a phenyldiethylammonio group and the like are described. As examples of the heterocyclic ring group containing a quaternalized nitrogen atom, a pyridinio group, a quinolinio group, an isoquinolinio group, an imidazolio group and the like are described. A pyridinio group and an imidazolio group are preferable and a pyridinio group is particularly preferable. These nitrogen containing heterocyclic ring groups containing a quaternalized nitrogen atom may have any substituent, but in the case of a pyridinio group and an imidazolio group, an alkyl group, an aryl group, an acylamino group, a chlorine atom, an alkoxycarbonyl group, a carbamoyl group and the like are preferably as a substituent and in a pyridinio group, a phenyl group is particularly preferable as a substituent.

The ethynyl group as an adsorption group means —C≡CH group and the said hydrogen atom may be substituted.

The adsorption group described above may have any substituent. As examples of a substituent, a halogen atom (a fluorine atom, a chlorine atom, a bromine atom or an iodine atom), an alkyl group (a straight chain alkyl group, a branched chain alkyl group, a cyclic alkyl group and a bicyclic alkyl group and an active methine group are contained), an alkenyl group, an alkynyl group, an aryl group, a heterocyclic ring group (irrelevant to a substituting position), an acyl group, an alkoxycarbonyl group, an aryloxycarbonyl group, a heterocyclic oxycarbonyl ring group, a carbamoyl group, a N-hydroxycarbamoyl group, a N-acylcarbamoyl group, a N-sulfonylcarbamoyl group, a N-carbamoylcarbamoyl group, a thiocarbamoyl group, a N-sulfamoylcarbamoyl group, a carbazoyl group, a carboxy group or a salt thereof, an oxalyl group, an oxamoyl group, a cyano group, a carbonimidoyl group, a formyl group, a hydroxy group, an alkoxy group (a group containing an ethyleneoxy group or a propyleneoxy group as repeating unit is contained), an aryloxy group, an oxy group substituted to heterocyclic ring, an acyloxy group, (an alkoxy or an aryloxy)carbonyloxy group, a carbamoyloxy group, a sulfonyloxy group, an amino group, (an alkyl, an aryl or a heterocyclic ring)amino group, an acylamino group, a sulfonamide group, an ureido group, a thioureido group, a N-hydroxyureido group, an imide group, (an alkoxy or aryloxy)carbonylamino group, a sulfamoylamino group, a semicarbazide group, a thiosemicarbazide group, a hydrazino group, an ammonio group, an oxamoylamino group, a N-(alkyl or aryl)sulfonylureido group, a N-acylureido group, a N-acylsulfamoylamino group, a hydroxyamino group, a nitro group, a heterocyclic ring group containing quaternalized nitrogen atom (e.g., a pyridinio group, an imidazolio group, a quinolinio group, an isoquinolinio group), an isocyano group, an imino group, a mercapto group, (an alkyl, an aryl or a heterocyclic ring)thio group, (an alkyl, an aryl or a heterocyclic ring)dithio group, (an alkyl, or an aryl)sulfonyl group, (an alkyl or an aryl)sulfinyl group, a sulfo group and the salt thereof, a sulfamoyl group, a N-acylsulfamoyl group, a N-sulfonylsulfamoyl group and a salt thereof, a phosphino group, a phosphinyl group, a phosphinyloxy group, a phosphinylamino group, a silyl group and the like are described. Herein, the active methine group means a mathine group subsutituted by two electron-withdrawing group, wherein the electron-withdrawing group means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group and a carbonimidoyl group. Herein, two electron-withdrawing groups may bind each other to form a cyclic structure. The salt means a cation such as from an alkali metal, an alkali earth metal and a heavy metal and an organic cation such as an ammonium ion, a phosphonium ion and the like.

Further, as typical examples of an adsorption group, the compounds described in pages 4 to 7 in the specification of JP-A No. 11-95355 are described.

As an adsorption group represented by A in formula (I), a heterocyclic ring group substituted by a mercapto group (e.g., a 2-mercaptothiadiazole group, a 3-mercapto-1,2,4-triazole group, a 5-mercaptotetrazole group, a 2-mercapto-1,3,4-oxadiazole group, a 2-mercaptobenzothiazole group, a 2-mercaptobenzimidazole group, a 1,5-dimethyl-1,2,4-triazorium-3-thiolate group and the like), a heterocyclic ring group substituted by two mercapto groups (e.g., a 2,4-dimercaptopyrimidine group, a 2,4-dimercatotriazine group, a 3,5-dimercapto-1,2,4-triazole group, a 2,5-dimercapto-1,3-thiazole group and the like) or a nitrogen atom containing heterocyclic ring group having a —NH— group capable to form an imino-silver (>NAg) as a partial structure of heterocyclic ring (e.g., a benzotriazole group, a benzimidazole group, an indazole group and the like) are more preferably and a heterocyclic ring group substituted by two mercapto groups is particularly preferable.

In formula (I), W represents a divalent connection group. The said connection group may be any divalent connection group, as far as it does not give a bad effect toward a photographic property. For example, a divalent connection group composed of a carbon atom, a hydrogen atom, an oxygen atom a nitrogen atom and a sulfur atom can be used. As typical examples, an alkylene group having 1 to 20 carbon atoms (e.g., a methylene group, an ethylene group, a trimethylene group, a tetramethylene group, a hexamethylene group and the like), an arylene group having 6 to 20 carbon atoms (e.g., a phenylene group, a nephthylene group and the like), —CONR₁—, —SO₂NR₂—, —O—, —S—, —NR₃—, —NR₄CO—, —NR₅SO₂—, —NR₆CONR₇—, —COO—, —OCO— and the combination of these connecting groups are described. Herein, R₁, R₂, R₃, R₄, R₅, R₆ and R₇ independently represent a hydrogen atom, an aliphatic group and an aryl group. As preferred aliphatic group represented by R₁, R₂, R₃, R₄, R₅, R₆ and R₇, a straight chain, branched chain or cyclic alkyl group, an alkenyl group, an alkynyl group, an aralkyl group having 1 to 30 carbon atoms, particularly 1 to 20 carbon atoms (e.g., a methyl group, an ethyl group, an isopropyl group, a t-butyl group, a n-octyl group, a n-decyl group, a n-hexadecyl group, a cyclopropyl group, a cyclopentyl group, a cyclohexyl group, an aryl group, a 2-butenyl group, a 3-pentenyl group, a propargyl group, a 3-pentynyl group, a benzyl group and the like) are described. In formula (I), as an aryl group represented by R₁, R₂, R₃, R₄, R₅, R₆ and R₇, a monocyclic or condensed ring aryl group having 6 to 30 carbon atoms is preferable and that having 6 to 20 carbon atoms is more preferable. For example, a phenyl group and a naphthyl group and the like are described. The above substituent represented by R₁, R₂, R₃, R₄, R₅, R₆ and R₇ may have still more any substituent, whereby the substituent defined as similar to the substituent for an adsorption group described above.

In formula (I), a reducing group represented by B represents the group capable to reduce a silver ion. As the examples, a formyl group, an amino group, a triple bond group such as an acetylene group, a propargyl group and the like, an alkylmercapto group or an arylmercapto group, hydroxylamines, hydroxamic acids, hydroxyureas, hydroxyurethanes, hydroxysemicarbazides, reductones (reductone derivatives are contained), anilines, phenols (chroman-6-ols, 2,3-dihydrobenzofuran-5-ols, aminophenols, sulfonamidophenols and polyphenols such as hydroquinones, catechols, resorcinols, benzenetriols, bisphenols are contained), hydrazines, hydrazides and phenidones can be described.

In formula (I), a preferable reducing group represented by B is the residue derived from the compound represented by general fomula (B₁) to (B₁₃)

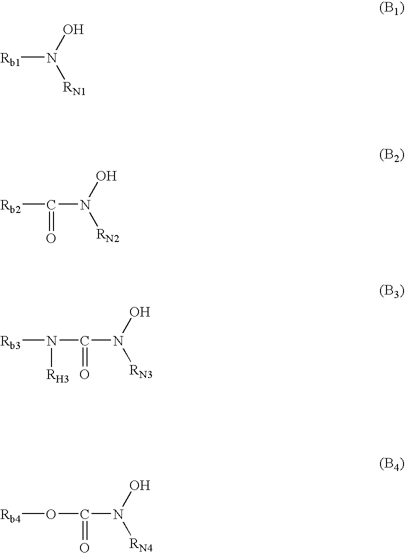

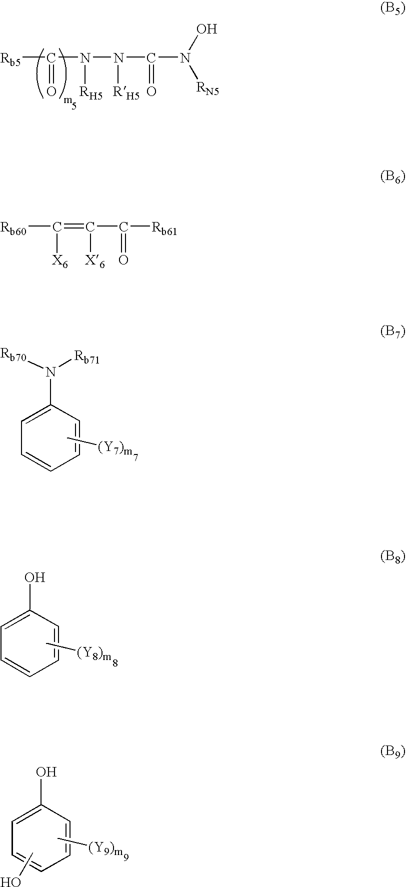

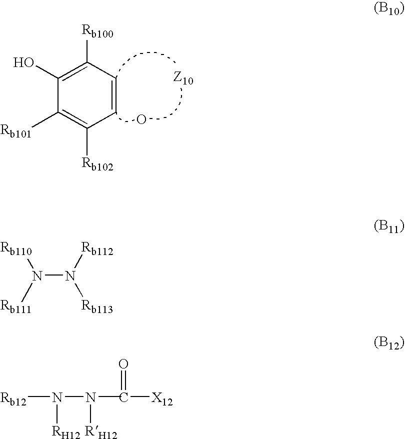

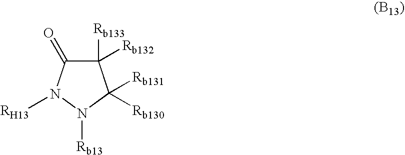

In formulae (B₁) to (B₁₃), R_{b1}, R_{b2}, R_{b3}, R_{b4}, R_{b5}, R_{b70}, R_{b71}, R_{b110}, R_{b111}, R_{b112}, R_{b113}, R_{b12}, R_{b13}, R_{N1}, R_{N2}, R_{N3}, R_{N4}, and R_{N5} represent a hydrogen atom, an alkyl group, an aryl group or a heterocyclic ring group; and R_{H3}, R_{H5}, R′_{H5}, R_{H12}, R′_{H12}, and R_{H13} represent a hydrogen atom, an alkyl group, an aryl group, an acyl group, an alkylsulfonyl group or an arylsulfonyl group; and among them, R_{H3} may still more represent a hydroxy group. R_{b100}, R_{b101}, R′_{b102}, and R_{b130} to R_{b133} represent a hydrogen atom or a substituent. Y₇ and Y₈ represent a substituent except for a hydroxy group and Y₉ represents a substituent and m₅ represents 0 or 1 and m₇ represents an integer from 0 to 5 and m₈ represents an integer from 1 to 5 and m₉ represents an integer from 0 to 4. Y₇, Y₈ and Y₉ may still more represent an aryl group condensed to a benzene ring (e.g., a benzene condensed ring) and further more may have a substituent. Z₁₀ represents a non-metal atomic group capable to form a ring and X12 represents a hydrogen atom, an alkyl group, an aryl group, a heterocyclic ring group, an alkoxy group, an amino group (an alkylamino group, an arylamino group, an amino group substituted to a heterocyclic ring or a cyclic amino group are contained) and a carbamoyl group.

In formula (B₆), X₆ and X′₆ each represent a hydroxy group, an alkoxy group, a mercapto group, an alkylthio group, an amino group (an alkylamino group, an arylamino group, an amino group substituted to a heterocyclic ring group or a cyclic amino group are contained), an acylamino group, a sulfonamide group, an alkoxycarbonylamino group, an ureido group, an acyloxy group, an acylthio group, an alkylaminocarbonyloxy group or an arylaminocarbonyloxy group. R_{b60} and R_{b61} represent an alkyl group, an aryl group, an amino group, an alkoxy group and an aryloxy group and R_{b60} and R_{b61} may bind each other to form a cyclic structure.

In the explanation of each group in above formula (B₁) to (B₁₃), an alkyl group means a straight chain, branched chain or cyclic and a substituted or unsubstituted alkyl group having 1 to 30 carbon atoms and an aryl group means a monocyclic or condensed and a substituted or unsubstituted aromatic alicyclic ring such as a phenyl group and a naphthyl group and a heterocyclic ring group means an aromatic or nonaromatic and a monocyclic or condensed and a substituted or unsubstituted heterocyclic ring group having at least one hetero atom.

And the substituent described in the explanation of each substituent in formula (B₁) to (B₁₃) means the same as the substituent for an adsorption group described above. These substituents may be more substituted by these substituents.

In formula (B₁) to (B₅), R_{N1}, R_{N2}, R_{N3}, R_{N4} and R_{N5} are preferably a hydrogen atom or an alkyl group and herein, an alkyl group is preferably a straight, branched or cyclic and a substituted or unsubstituted alkyl group having 1 to 12 carbon atoms and more preferably a straight, branched or cyclic and a substituted or unsubstituted alkyl group having 1 to 6 carbon atoms such as a methyl group, an ethyl group, a propyl group, a benzyl group and the like.

In formula (B₁), R_{b1} is preferably an alkyl group and a heterocyclic ring group and herein, an alkyl group means a straight, branched or cyclic and a substituted or unsubstituted alkyl group and is preferably an alkyl group having 1 to 30 carbon atoms and more preferably an alkyl group having 1 to 8 carbon atoms. A heterocyclic ring group means a 5 or 6 membered monocyclic or condensed ring and an aromatic or nonaromatic heterocyclic ring group and may have a substituent. As a heterocyclic ring group, an aromatic heterocyclic ring group is preferable, for examples, a pyridine ring group, a pyrimidine ring group, a triazine ring group, a thiazole ring group, a benzothiazole ring group, an oxazole ring group, a benzoxazole ring group, an imidazole ring group, a benzimidazole ring group, a pyrazole ring group, an indazole ring group, an indole ring group, a purine ring group, a quinoline ring group, an isoquinoline ring group, a quinazoline ring group and the like are described. Especially, a triazine ring group and a benzothiazole ring group are preferable. The case, wherein an alkyl group or a heterocyclic ring group represented by R_{b1} further has one or two or more of —NH(R_{N1})OH group as its substituent is one of preferred embodiments of the compound represented by formula (B₁).

In formula (B₂), R_{b2} is preferably an alkyl group, an aryl group or a heterocyclic ring group and more preferably is an alkyl group or an aryl group. Preferred range of alkyl group is similar to that in the explanation of R_{b1}. As an aryl group, a phenyl group or a naphthyl group is preferable and a phenyl group is particularly preferable and may have a substituent. The case, wherein the group represented by R_{b2} further has one or two or more of —NH(R_{N2})OH group as its substituent is one of preferred embodiments of the compound represented by formula (B₂).

In formula (B₃), R_{b3} is preferably an alkyl group or an aryl group, wherein a preferred range thereof is similar to that in the explanation of R_{b1} and R_{b2}. R_{H3} is preferably a hydrogen atom, an alkyl group or a hydroxy group and more preferably a hydrogen atom. The case, wherein the group represented by R_{b3} further has one or two or more of —NH(R_{N3})CON(R_{N3})OH group as its substituent is one of preferred embodiments of the compound represented by formula (B₃). And R_{b3} and R_{N3} may bind each other to form a cyclic structure (preferably a 5 or 6 membered saturated heterocyclic ring).

In formula (B₄), R_{b4} is preferably an alkyl group, wherein a preferred range thereof is similar to that in the explanation of R_{b1}. The case where the group represented by R_{b4} further has one or two or more of —OCON(R_{N4})OH group as its substituent is one of preferred embodiments of the compound represented by formula (B₄).

In formula (B₅), R_{b5} preferably is an alkyl group or an aryl group and more preferably is an aryl group, wherein a preferred range is similar to that in the explanation of R_{b1} and R_{b2}. R_{H5} and R′_{H5} are preferably a hydrogen atom or an alkyl group and more preferably a hydrogen atom.

In formula (B₆), it is preferred that R_{b60} and R_{b61} bind each other to form a cyclic structure. The cyclic structure formed herein is 5 to 7 membered nonaromatic carbon ring or a heterocyclic ring and may be monocyclic or condensed ring. As typical examples of preferred cyclic structure, a 2-cyclopentene-1-one ring, a 2,5-dihydrofurane-2-one ring, a 3-pyrroline-2-one ring, a 4-pyrazoline-3-one ring, a 2-cyclohexene-1-one ring, a 4-pyrazoline-3-one ring, a 2-cyclohexene-1-one ring, a 5,6-dihydro-2H-pyrane-2-one ring, a 5,6-dihydro-2-pyridone ring, a 1,2-dihydronaphthalene-2-one ring, a cumarin ring (a benzo-α-pyrane-2-one ring), a 2-quinolone ring, a 1,4-dihydronaphthalene-1-one ring, a chromone ring (a benzo-γ-pyrane-4-one ring), a 4-quinolone ring, an indene-1-one ring, a 3-pyrroline-2,4-dione ring, an uracil ring, a thiouracil ring, a dithiouracil ring and the like are described and a 2-cycolopentene-1-one ring, a 2,5-dihydrofurane-2-one ring, 3-pyrroline-2-one ring, a 4-pyrazoline-3-one ring, a 1,2-dihydronaphthalene-2-one ring, a cumarin ring (a benzo-α-pyrane-2-one ring), a 2-quinolone ring, a 1,4-dihydronaphthalene-1-one ring, a chromone ring (a benzo-γ-pyrane-4-one ring), a 4-quinolone ring, an indene-1-one ring, a dithiouracil ring and the like are more preferably and a 2-cycolopentene-1-one ring, a 2,5-dihydrofurane-2-one ring, a 3-pyrroline-2-one ring, an indene-1-one ring and a 4-pyrazoline-3-one ring are still more preferable.

When X₆ and X′₆ represent a cyclic amino group, a cyclic amino group means a nonaromatic nitrogen atom containing heterocyclic ring group bound at a nitrogen atom, e.g., a pyrrolidino group, a pyperidino group, a pyperadino group, a morphorino group, a 1,4-thiazine-4-yl group, a 2,3,5,6-tetrahydro-1,4-thiazine-4-yl group, an indolyl group and the like are included.

As X₆ and X′_{6.} a hydroxy group, a mercapto group, an amino group (an alkylamino group, an arylamino group or a cyclic amino group are contained), an acylamino group, a sulfonamide group, or an acyloxy group and an acylthio group are preferable and a hydroxy group, a mercapto group, an amino group, an alkylamino group, a cyclic amino group, a sulfonamide group, an acylamino group or an acyloxy group are more preferable and a hydroxy group, an amino group, an alkylamino group and a cyclic amino group are particularly preferable. Further, it is preferred that at least one of X₆ and X′₆ is a hydroxy group.

In formula (B₇), R_{b70} and R_{b71} preferably are a hydrogen atom, an alkyl group or an aryl group and more preferably an alkyl group. The preferred range of alkyl group is similar to that in the explanation of R_{b1}. R_{b70} and R_{b71} may bind each other to form a cyclic structure (e.g., a pyrrolidine ring, a pyperidine ring, a morphorino ring, a thiomorphorino ring and the like). As the substituent represented by Y₇, an alkyl group (that preferred range is the same as the explanation of R_{b1}), an alkoxy group, an amino group, an acylamino group, a sulfonamide group, an ureido group, an acyl group, an alkoxycarbonyl group, a carbamoyl group, a sulfamoyl group, a chlorine atom, a sulfo group or the salt thereof, a carboxy group or the salt thereof and the like are preferable and m₇ represents preferably integer from 0 to 2.

In formula (B₈), m₈ is preferably integer from 1 to 4 and the plural Y₈ may be same or different. Y₈ in the case wherein m₈ is 1, or at least one of the plural Y₈ in the case wherein m₈ is 2 or more, is preferably an amino group (an alkylamino group and an arylamino group are contained), a sulfonamide group or an acylamino group. In the case, wherein m₈ is 2 or more, remaining Y₈ is preferably a sulfonamide group, an acylamino group, an ureido group, an alkyl group, an alkylthio group, an acyl group, an alkoxycarbonyl group a carbamoyl group, a sulfo group or the salt thereof, a carboxy group or the salt thereof, a chlorine atom and the like. Herein, in the case, wherein o′-(or p′-)hydroxyphenylmethyl group (may have more substituents) is substituted at the ortho or para position toward a hydroxy group as the substituent represented by Y₈, these compounds represent a compound group generally called as a bisphenol. The said compound is one of the preferred examples represented by formula (B₈) too. Further, the case, wherein B₈ represent a benzene condensed ring and results to represent naphthols for formula (B₈) is very preferable. It is also probable that formula (B₈) represents naphthols, wherein Y₈ is a benzene condensed ring.

In formula (B₉), the substitution position of two hydroxy groups may be each other an ortho position (catechols), a meta position (resorcinols) or a para position (hydroquinones). m₉ is preferably 1 or 2 and the plural Y₉ may be the same or different. As preferred substituents represented by Y₉, a chlorine atom, an acylamino group, an ureido group, a sulfonamide group, an alkyl group, an alkylthio group, an alkoxy group, an acyl group, an alkoxycarbonyl group, a carbamoyl group, a sulfo group or the salt thereof, a carboxy group or the salt thereof, a hydroxy group, an alkylsulfonyl group, an arylsulfonyl group and the like are described. The case where Y₉ represents a benzene condensed ring and results to represent 1,4-naphthohydroquinones for formula (B₉) is also preferable. When formula (B₉) represents catechols, Y₉ is particularly preferably a sulfo group or the salt thereof and a hydroxy group.

In formula (B₁₀), when R_{b100}, R_{b101} and R_{b102} represent substituents, preferred examples of substituent are similar to that in preferred examples of Y₉. Among them, an alkyl group (particularly a methyl group) is preferable. As preferred examples of a cyclic structure to form Z₁₀, are a chroman ring and a 2,3-dihydrobenzofurane ring are described and these cyclic structures may have a substituent and may form a spiro ring.

In formula (B₁₁), as preferred examples of R_{b111}, R_{b112} and R_{b113} are an alkyl group, an aryl group or a heterocyclic ring group and their preferred ranges are similar to that in the explanation of R_{b1} and R_{b2}. Among them, an alkyl group is preferable and two alkyl groups in R_{b110} to R_{b113} may bind to form a cyclic structure. Herein, a cyclic structure means 5 to 7 membered nonaromatic heterocyclic ring, e.g., a pyrrolidine ring, a pyperidine ring, a morphorino group, a thiomorphorino group, a hexahydropyridazine ring and the like.

In formula (B₁₂), R_{b12} preferably is an alkyl group, an aryl group or a heterocyclic ring group and their preferred ranges are similar to that in the explanation of R_{b1} and R_{b2}. X₁₂ preferably is an alkyl group, an aryl group (particularly a phenyl group), a heterocyclic ring group, an alkoxy group, an amino group (an alkylamino group, an arylamino group, an amino group sunstitiuted to a heterocyclic ring or a cyclic amino group are contained), and a carbamoyl group and more preferably is an alkyl group (particularly, an alkyl group having 1 to 8 carbon atoms is preferable), an aryl group (particularly, a phenyl group is preferable), an amino group (an alkylamino group, an arylamino group or a cyclic amino group are contained). R_{H12} and R′_{H12}, preferably are a hydrogen atom or an alkyl group and more preferably are a hydrogen atom.

In formula (B₁₃), R_{b13} preferably is an alkyl group or an aryl group and their preferred ranges are similar to that in the explanation of R_{b1} and R_{b2}. R_{b130}, R_{b130}, R_{b132} and R_{b133} preferably are a hydrogen atom, an alkyl group (particularly, an alkyl group having 1 to 8 carbon atoms are preferable) and an aryl group (particularly, a phenyl group is preferable). R_{H13} preferably is a hydrogen atom or an acyl group and more preferably is a hydrogen atom.

In formula (I), a reducing group represented by B preferably is hydroxylamines, hydroxamic acids, hydroxyureas, hydroxysemicarbazides, phenols, hydrazines, hydrazides and phenidones and more preferably is hydroxyureas, hydroxysemicarbazides, phenols, hydrazides and phenidones.

The oxidation potential of a reducing group represented by B in formula (I), can be measured by using the measuring method described in Akira Fujishima, “DENKIKAGAKU SOKUTEIHO”, pages 150 to 208, GIHODO SHUPPAN and NIHON KAGAKUKAI, “ZIKKEN KAGAKUKOUZA”, 4th ed., vol. 9, pages 282 to 344, MARUZEN. For example, the method of rotating disc voltammetry can be used; namely the sample is dissolved in the solution (methanol:pH 6.5 Britton-Robinson buffer=10%:90% (% by volume)) and after bubbling with nitrogen gas during 10 minutes the voltamograph can be measured under the condition of 1000 rotations/minute, the sweep rate 20 mV/second, at 25° C. by using a rotating disc electrode (RDE) made by glassy carbon as a working electrode, a platinum electrode as a counter electrode and a saturated calomel electrode as a reference electrode. The half wave potential (E1/2) can be calculated by that obtained voltamograph.

When a reducing group represented by B in the present invention is measured by the method described above, an oxidation potential preferably is in the range of about −0.3 V to about 1.0 V, more preferably about −0.1 V to about 0.8 V, and most preferably about 0 V to about 0.7 V.

Most of the reducing groups represented by B in the present invention are known in the photographic industry and those examples are described in the following patents. For example, JP-A Nos. 2001-42466, 8-114884, 8-314051, 8-333325, 9-133983, 11-282117, 10-246931, 10-90819, 9-54384, 10-171060 and 7-77783 can be described. And as an example of phenols, the compound described in U.S. Pat. No. 6,054,260 is described too.

The compound of formula (I) in the present invention may have the ballasted group or polymer chain in it generally used in the nonmoving photographic additives as a coupler. And as a polymer, for example, the polymer described in JP-A No. 1-100530 can be described.

The compound of formula (I) in the present invention may be bis or tris type of compound. The molecular weight of the compound represented by formula (I) in the present invention is preferably 100 to 10000 and more preferably 120 to 1000 and particularly preferably 150 to 500.

The examples of the compound represented by formula (I) in the present invention are shown below, but the present invention is not limited in these. The compounds shown in JP-A Nos. 2000-330247 and 2001-42446 are also preferable examples.

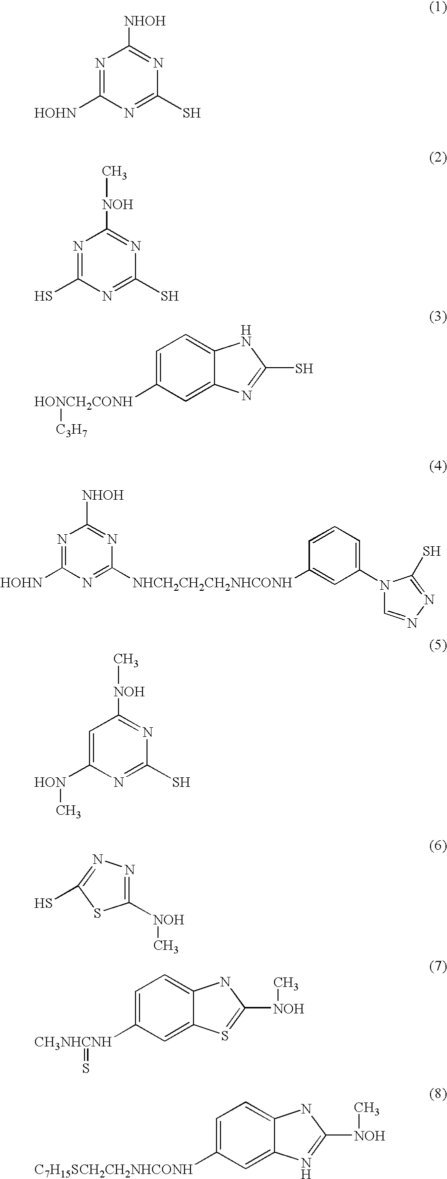

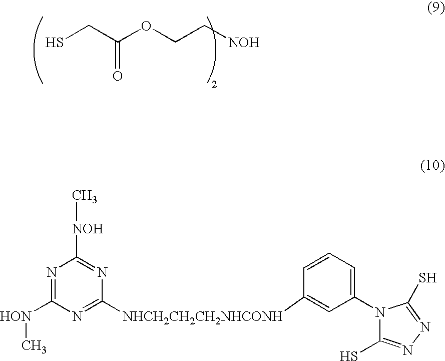

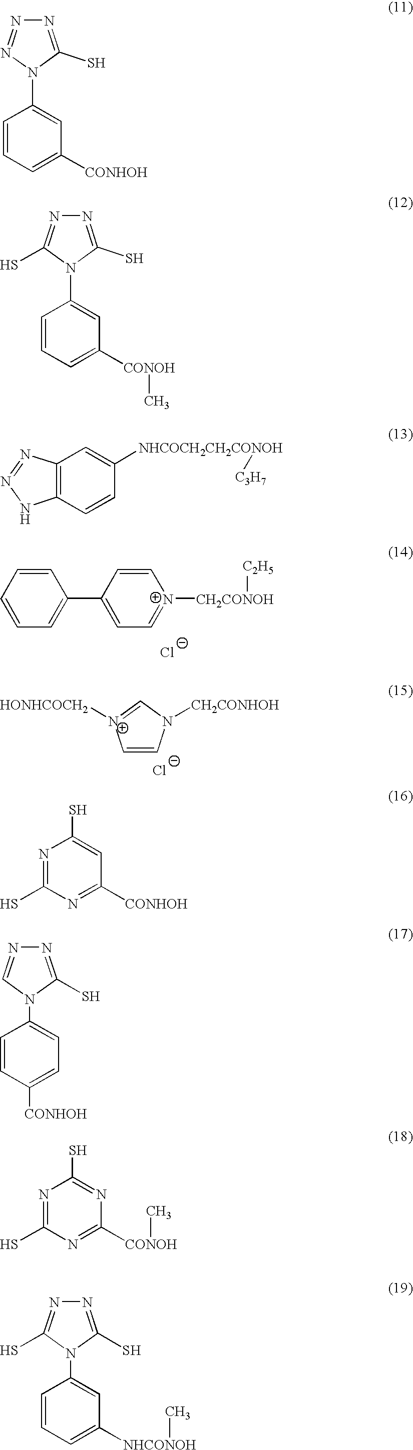

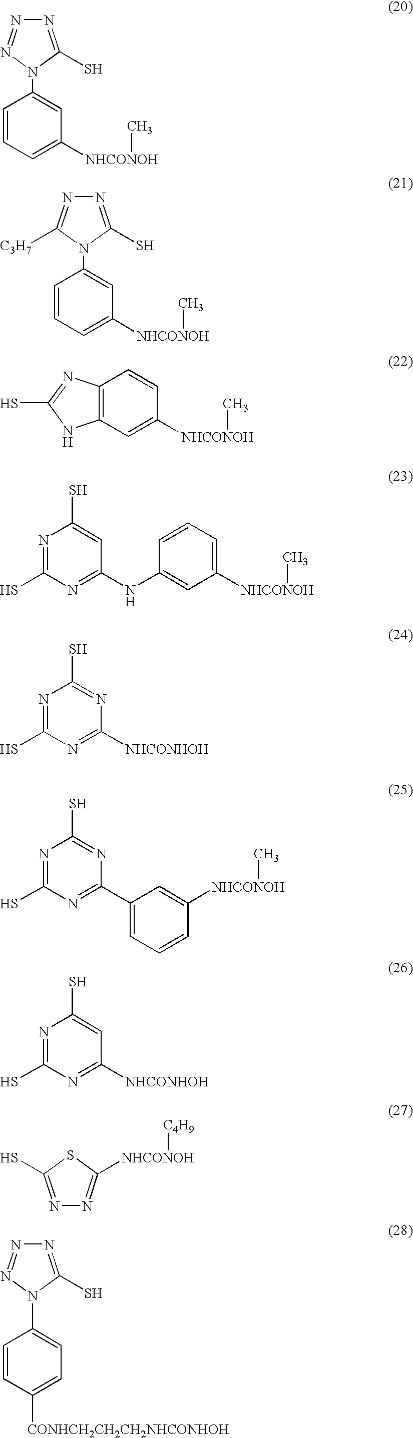

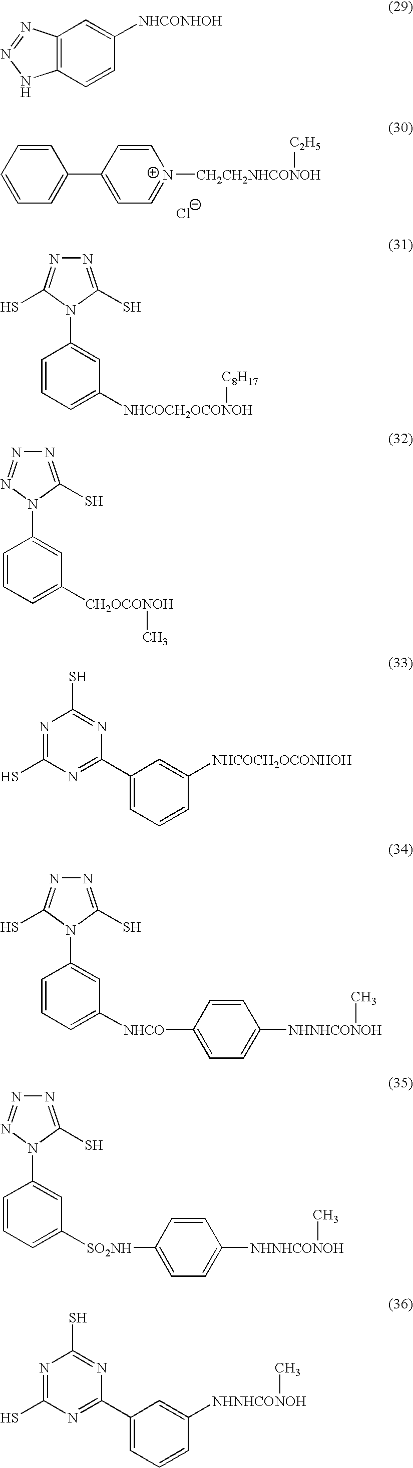

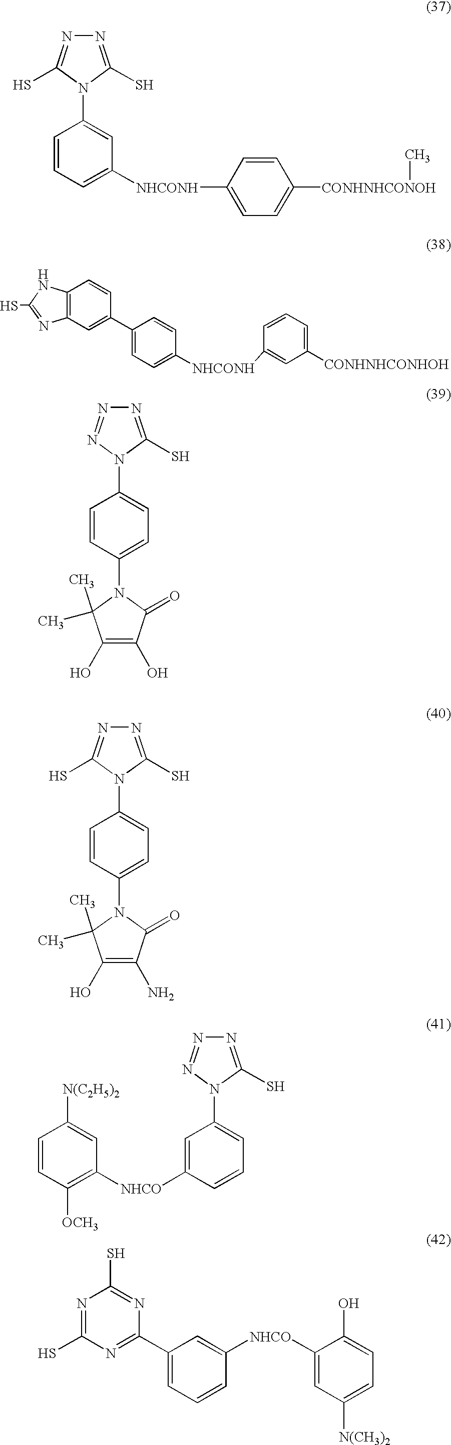

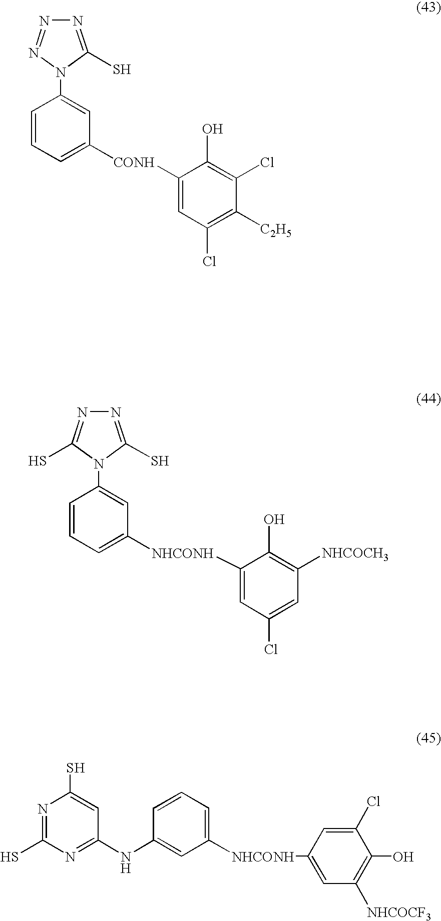

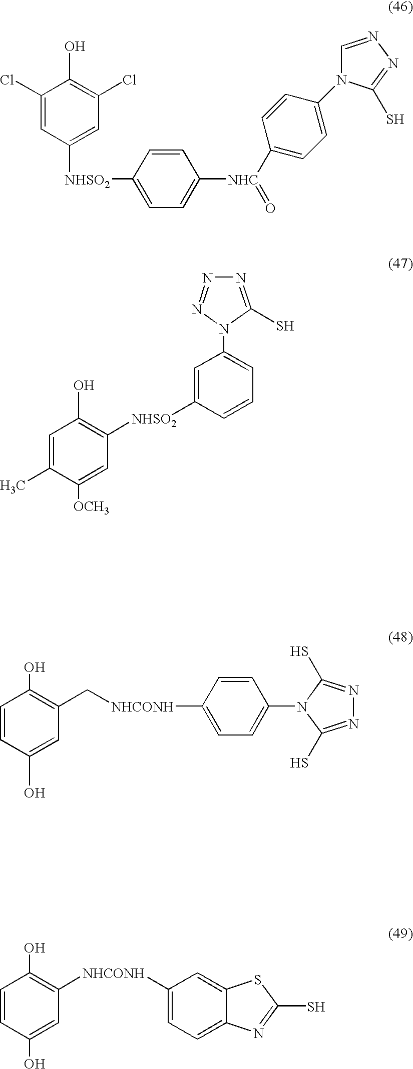

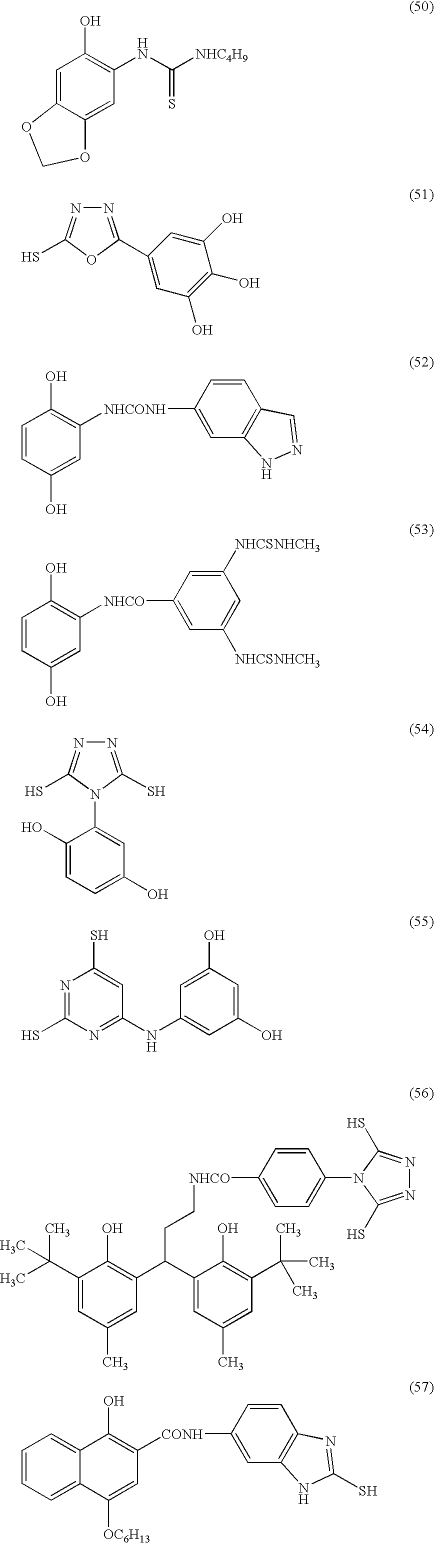

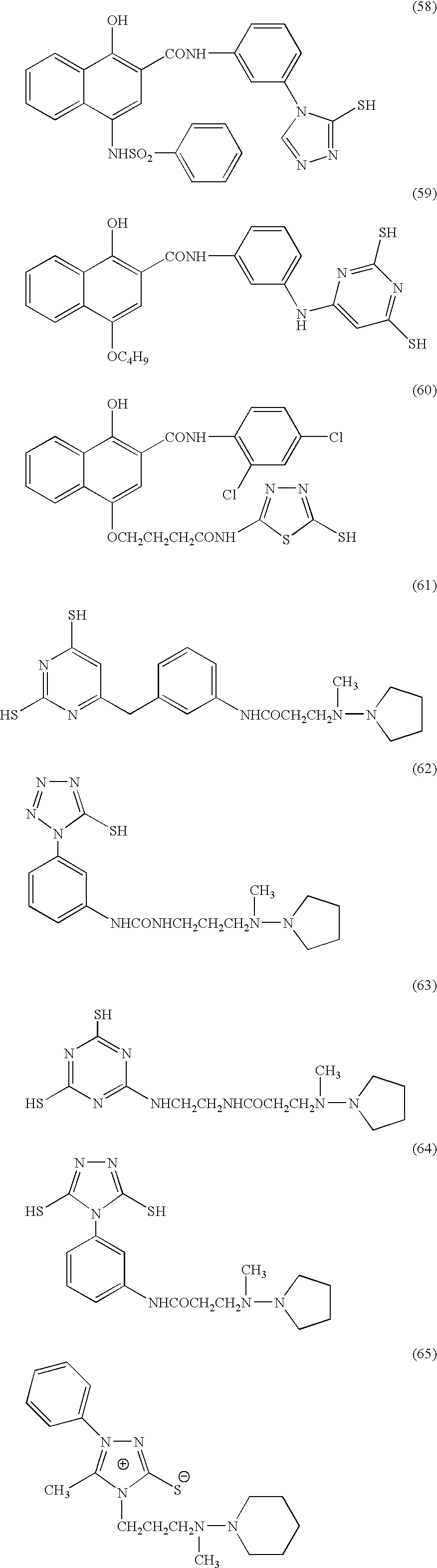

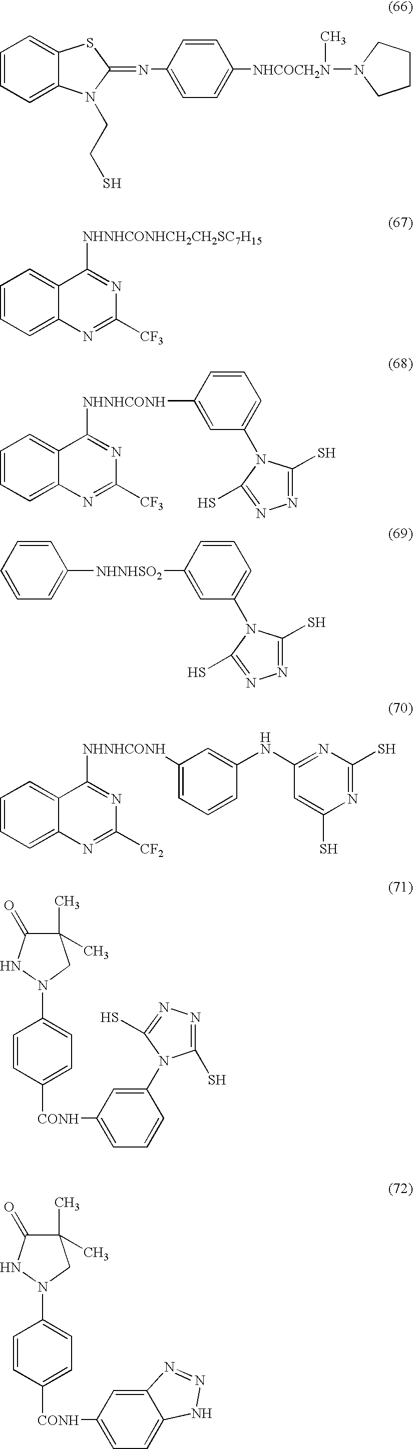

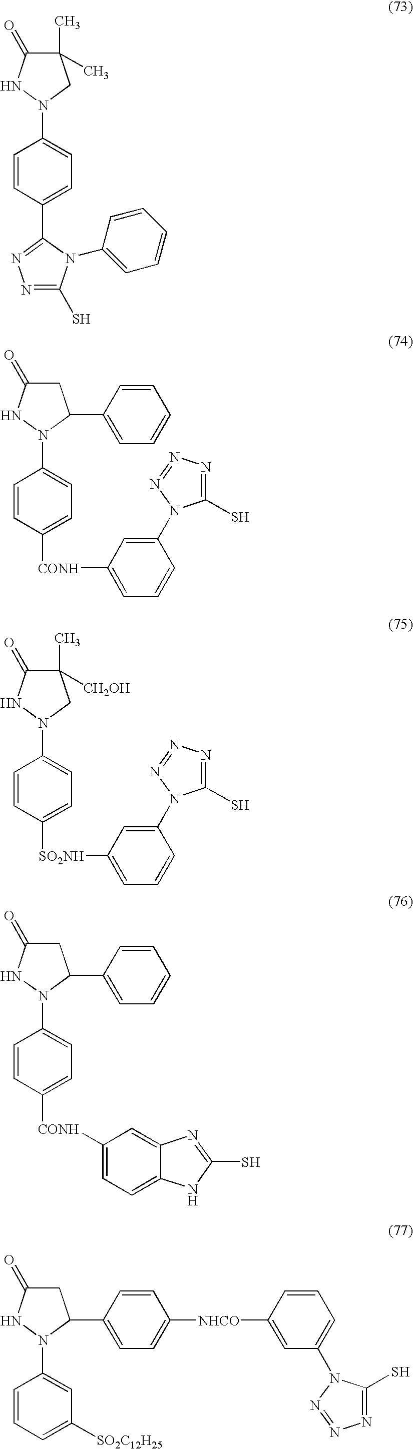

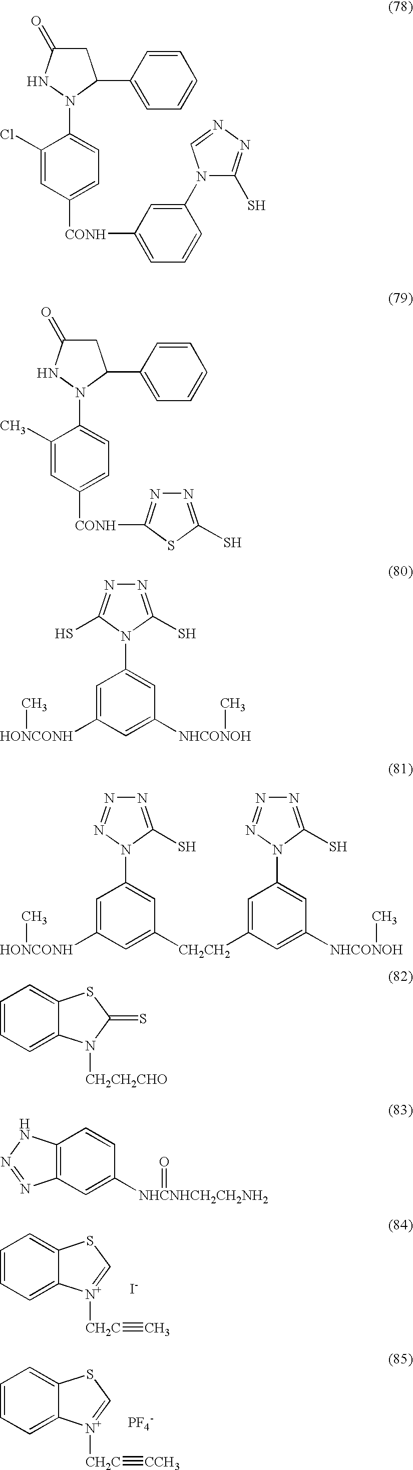

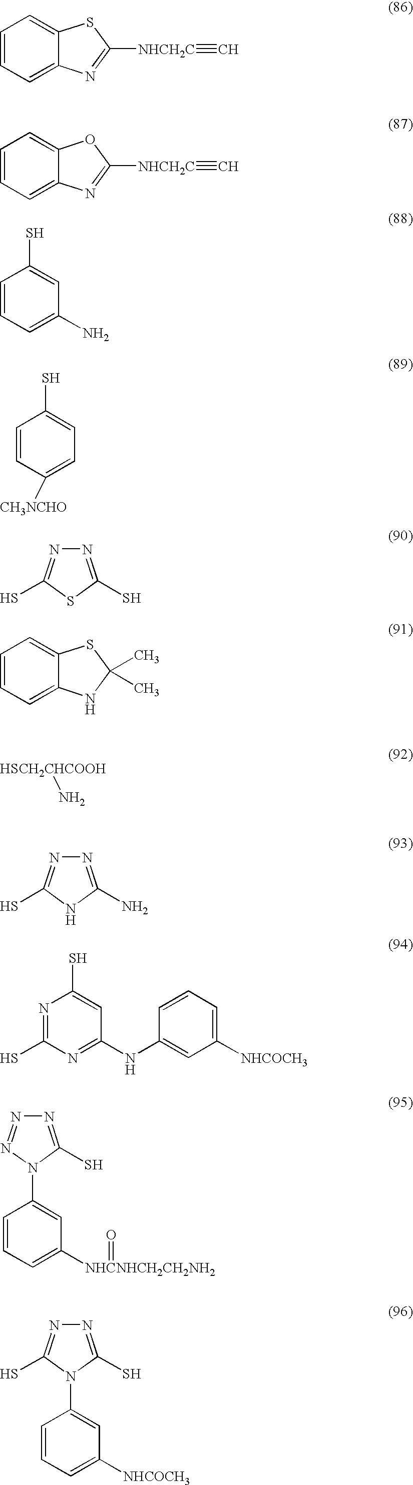

These compounds can be easily synthesized by the known method.

The compound of formula (I) in the present invention can be used independently as only one compound, but it is preferred to use two compounds or more in combination. When two or more types of compounds are used in combination, those may be added to the same layer or the different layers, whereby addition methods may be different from each other.

The compound represented by formula (I) in the present invention preferably is added to a image forming layer and more preferably is to be added at an emulsion making process. In the case, wherein these compounds are added at an emulsion making process, these compounds may be added at any step in the process. For example, the silver halide grain forming step, a step before starting of salt washing-out step, the salt washing-out step, the step before chemical ripening, the chemical ripening step, the step before prepraring a final emulsion and the like are described. Also, the addition can be performed in the plural divided steps in the process. It is preferred to be added in an image forming layer, but also to be diffused at a coating step from a protective layer or an intermediate layer adjacent to the image forming layer, wherein these compounds are added in the protective layer or the intermediate layer in combination with their addition to the image forming layer.

The preferred addition amount is largely depend on the addition method or the type of compound described above, but generally 1×10⁻⁶ mol to 1 mol, preferably 1×10⁻⁵ mol to 5×10⁻¹ mol, and more preferably 1×10⁻⁴ mol to 1×10⁻¹ mol, per one mol of photosensitive silver halide.

The compound represented by formula (I) in the present invention can be added by dissolving in water or water-soluble solvent such as methanol, ethanol and the like or a mixed solution thereof. At this time, pH may be arranged suitably by an acid or an alkaline and a surfactant can be coexisted. Further, these compounds may be added by dissolving in an organic solvent having high boiling point as an emulsified dispersion and also may be added as a solid dispersion.

(Development Accelerator)

The development accelerator used in the invention will be described in detail.

Reducing agents (named as principal reducing agents hereinafter) are substituted with development accelerators of the invention in the photothermographic material having at least one image forming layer comprising a photosensitive silver halide, a non-photosensitive organic silver salt, reducing agents and a binder. By substitution with development accelerators in a proportion of 10% by mole, the photothermographic material exhibits 0.05 or more of increment of sensitivity at an optical density of 1.0 as compared with using the non-substituted reducing agents.

The development accelerator is preferably a compound capable of exhibiting sensitivity increment of 0.05 or more at a substitution ratio of 5% by mole, and more preferably at a substitution ratio of 2% by mole.

Any compounds may be used for the development accelerator, so long as the compound is able to increase sensitivity when the principal reducing agents are substituted with the compound in thermal development. The preferably used compound is a so-called reducing agent. Examples of the reducing agent available include aminophenols, p-phenylenediamines, sulfonamide phenols, carbonamide phenols, 1-phenyl-5-pyrrazolidones, ascorbic acids, hydrazines, phenols and naphthols, and the like. Among them, sulfonamide phenols (for example, the compounds represented by formula (1) in Japanese Patent Application Laid-Open (JP-A) No. 10-221806 and the compounds represented by formula (A) in JP-A No. 2000-267222) and hydrazines are preferable.

The particularly preferable compounds include those represented by the following formulae (1) to (3):
Q¹-NHNH—R¹ Formula (1)

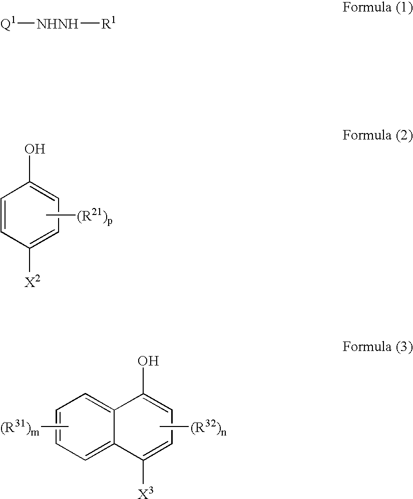

(In formula (1), Q¹ represents 5 to 7 membered unsaturated ring bonded to NHNH—R¹ through a carbon atom, and R¹ represents a carbamoyl group, an acyl group, an alkoxycarbonyl group, an aryloxycarbonyl group, a sulfonyl group or a sulfamoyl group. In formulae (2) and (3), X² and X³ each independently represent a hydrogen atom or a substituent, and R²¹, R³¹ and R³² each independently represent a hydrogen atom or a substituent. m and p each independently represent an integer from 0 to 4, and n represents an integer from 0 to 2.)

The most preferable compound as the development accelerator of the invention is the compound (hydrazine derivatives) represented by formula (1). The photothermographic material of the invention preferably contains the reducing compound represented by formula (1) in the same surface containing a photosensitive silver halide and a non-photosensitive silver salt on a support.

The compound represented by formula (1) is a developing agent generically called as hydrazine developing agent. In the formula, Q¹ represents a 5 to 7 membered unsaturated ring bonded to NHNH—R¹ through a carbon atom. R¹ represents a carbamoyl group, an acyl group, an alkoxycarbonyl group, an aryloxycarbonyl group, a sulfonyl group or a sulfamoyl group.

Preferable examples of the 5 to 7 membered unsaturated ring represented by Q¹ in formula (1) include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiazole ring, a 1,2,4-thiazole ring, a 1,2,5-thiazole ring, a 1,3,4-oxadiazole ring, a 1,2,4-oxadiazole ring, a 1,2,5-oxadiazole ring, a thiazole ring, an oxazole ring, an isothiazole ring, an isooxazole ring and a thiophene ring, and the like. A condensed ring formed by condensation of these rings is also preferable.

These rings may have a substituent, and in the case these rings have at least two substituents, the substituents may be the same or different from each other. Examples of the substituent include a halogen atom, an alkyl group, an aryl group, a carbonamide group, an alkylsulfonamide group, an arylsulfonamide group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group and an acyl group.

These substituents may have additional substituent when they are substitutable. Examples of such substituent include a halogen atom, an alkyl group, aryl group, a carbonamide group, an alkylsulfonamide group, an arylsulfonamide group, an alkoxy group, an aryloxy group, an alkylthio group, an arylthio group, an acyl group, an alkoxycarbonyl group, an aryloxycarmonyl group, a carbamoyl group, a cyano group, a sulfamoyl group, an alkylsulfonyl group, an arylsulfonyl group and an acyloxy group.

The carbamoyl group represented by R¹ in formula (1) preferably has 1 to 50 carbon atoms, and more preferably 6 to 40 carbon atoms. Examples of the carbamoyl group include a non-substituted carbamoyl group, a methylcarbamoyl group, an N-ethylcarbamoyl group, an N-propylcarbamoyl group, an N-sec-butylcarbamoyl group, an N-octylcarbamoyl group, an N-cyclohexylcarbamoyl group, an N-tert-butylcarbamoyl group, an N-dodecylcarbamoyl group, an N-(3-dodecyloxypropyl) carbamoyl group, an N-octadecylcarbamoyl group, an N-[3-(2,4-tert-pentylphenoxy)propyl]carbamoyl group, an N-(2-hexyldeyl)carbamoyl group, an N-phenylcarbamoyl group, an N-(4-dodecyloxyphenyl)carbamoyl group, an N-(2-chloro-5-dodecyloxycarbonylphenyl)carbamoyl group, an N-naphthylcarbamoyl group, an N-3-pyridylcarbamoyl group, and an N-benzylcarbamoyl group.

The acyl group represented by R¹ in formula (1) preferably has 1 to 50 carbon atoms, and more preferably 6 to 40 carbon atoms. Examples of the acyl group include a formyl group, an acetyl group, a 2-methylpropanoyl group, a cyclohexylcarbonyl group, an octanoyl group, a 2-hexyldecanoyl group, a dodecanoyl group, a chloroacetyl group, a trifluoroacetyl group, a benzoyl group, a 4-dodecyloxybenzoyl group and a 2-hydroxymethylbenzoyl group.

The alkoxycarbonyl group represented by R¹ in formula (1) preferably has 2 to 50 carbon atoms, and more preferably 6 to 40 carbon atoms. Examples of the alkoxycarbonyl group include a methoxycarbonyl group, ethoxycarbonyl group, an isobutyloxy carbonyl group, a cyclohexyloxycarbonyl group, a dodecyloxycarbonyl group, and a benzyloxycarbonyl group.

The aryloxycarbonyl group represented by R¹ in formula (1) preferably has 7 to 50 carbon atoms, and more preferably 7 to 40 carbon atoms. Examples of the aryloxycarbonyl group include a phenoxycarbonyl group, a 4-octylphenoxycarbonyl group, a 2-hydroxymethylphenoxycarbonyl group, and a 4-dodecyloxyhenoxycarbonyl group.

The sulfonyl group represented by R¹ in formula (1) preferably has 1 to 50 carbon atoms, and more preferably 6 to 40 carbon atoms. Examples of the sulfonyl group include a methylsulfonyl group, a butylsulfonyl group, an octylsulfonyl group, a 2-hexadecylsulfonyl group, a 3-dodecyloxypropylsulfonyl group, a 2-octyloxy-5-tert-octylphenylsulfonyl group, and a 4-dodeyloxyphenylsulfonyl group.

The sulfamoyl group represented by R¹ in formula (1) preferably has 0 to 50 carbon atoms, and more preferably 6 to 40 carbon atoms. Examples of the sulfamoyl group include a non-substituted sulfamoyl group, an N-ethylsulfamoyl group, an N-(2-ethylhexyl)sulfamoyl group, an N-decylsulfamoyl group, an N-hexadecylsulfamoyl group, an N-[3-(2 -ethylhexyloxy)propyl]sulfamoyl group, an N-(2-chloro-5-dodecyloxycarbonylphenyl)sulfamoyl group, and an N-(2-tetradecyloxyphenyl)sulfamoyl group.

The group represented by R¹ in formula (1) may have the group as the examples of the substituent of the 5 to 7 membered unsaturated ring represented by Q¹ at a substitutable position. When the group has at least two substituents, these substituents may be the same or different from each other.

Among the compound represented by formula (1), Q¹ is preferably a 5- or 6-membered unsaturated ring, more preferably, a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isooxazole ring, or a ring formed by condensation of any one of these rings with a benzene ring or an unsaturated heterocyclic ring, and particularly preferably, a quinazoline ring. Preferably, Q¹ has at least one electron attracting substituent. Examples of the preferable substituent include a fluoroalkyl group (for example a trifluoromethyl group, a pentafluoroethyl group, a 1,1-difluoroethyl group, a difluoromethyl group, a fluoromethyl group, a heptafluoropropyl group, and a pentafluorophenyl group), a cyano group, a halogen atom (fluorine, chlorine, bromine and iodine), an acyl group, an alkoxycarbonyl group, a carbamoyl group, an alkylsulfonyl group, and an arylsulfonyl group. The trifluoromethyl group is particularly preferable.

R¹ in formula (1) is preferably a carbamoyl group, more preferably, a substituted carbamoyl group represented by —CO—NH—R¹, and particularly preferably, R¹ represents an alkyl group or an aryl group having 1 to 10 carbon atoms.

While examples of the compound represented by formula (1) are shown below, the compound used for the invention is not restricted to these examples.

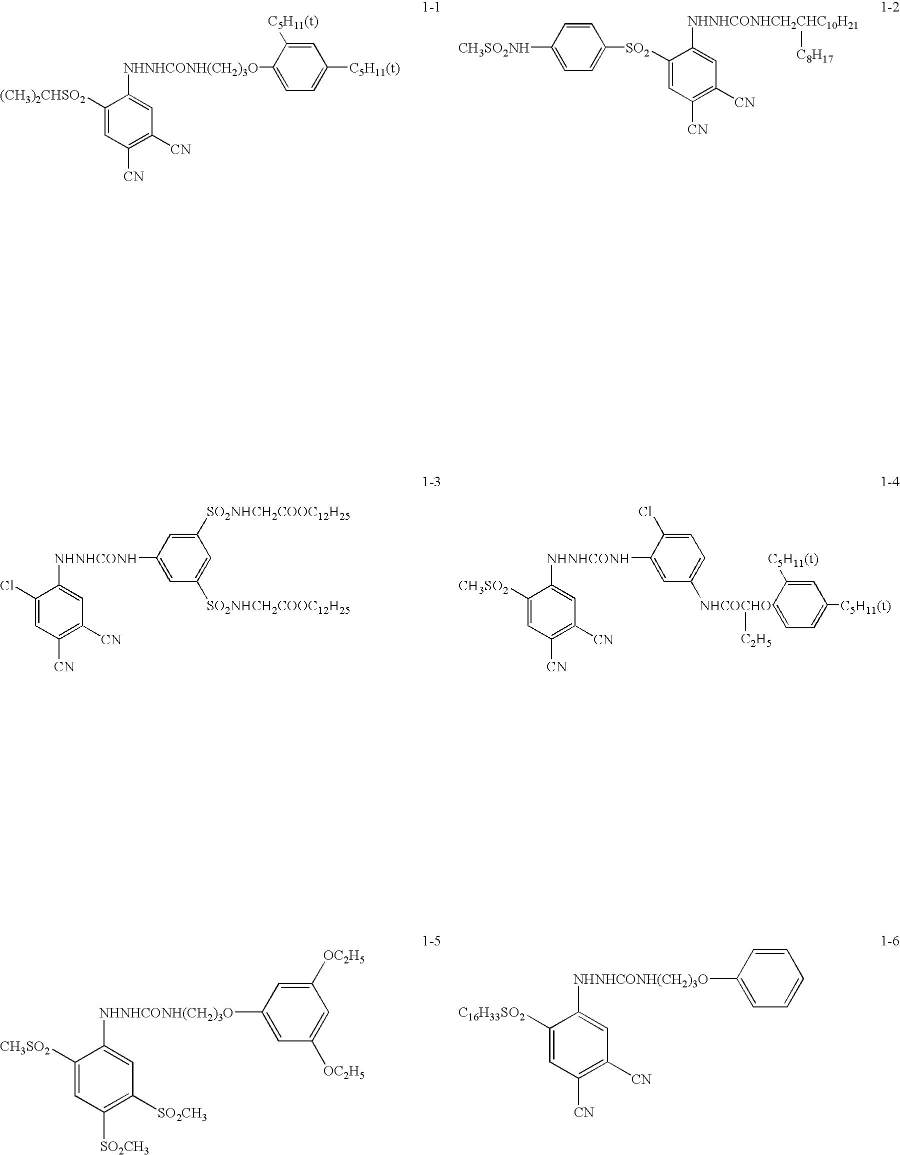

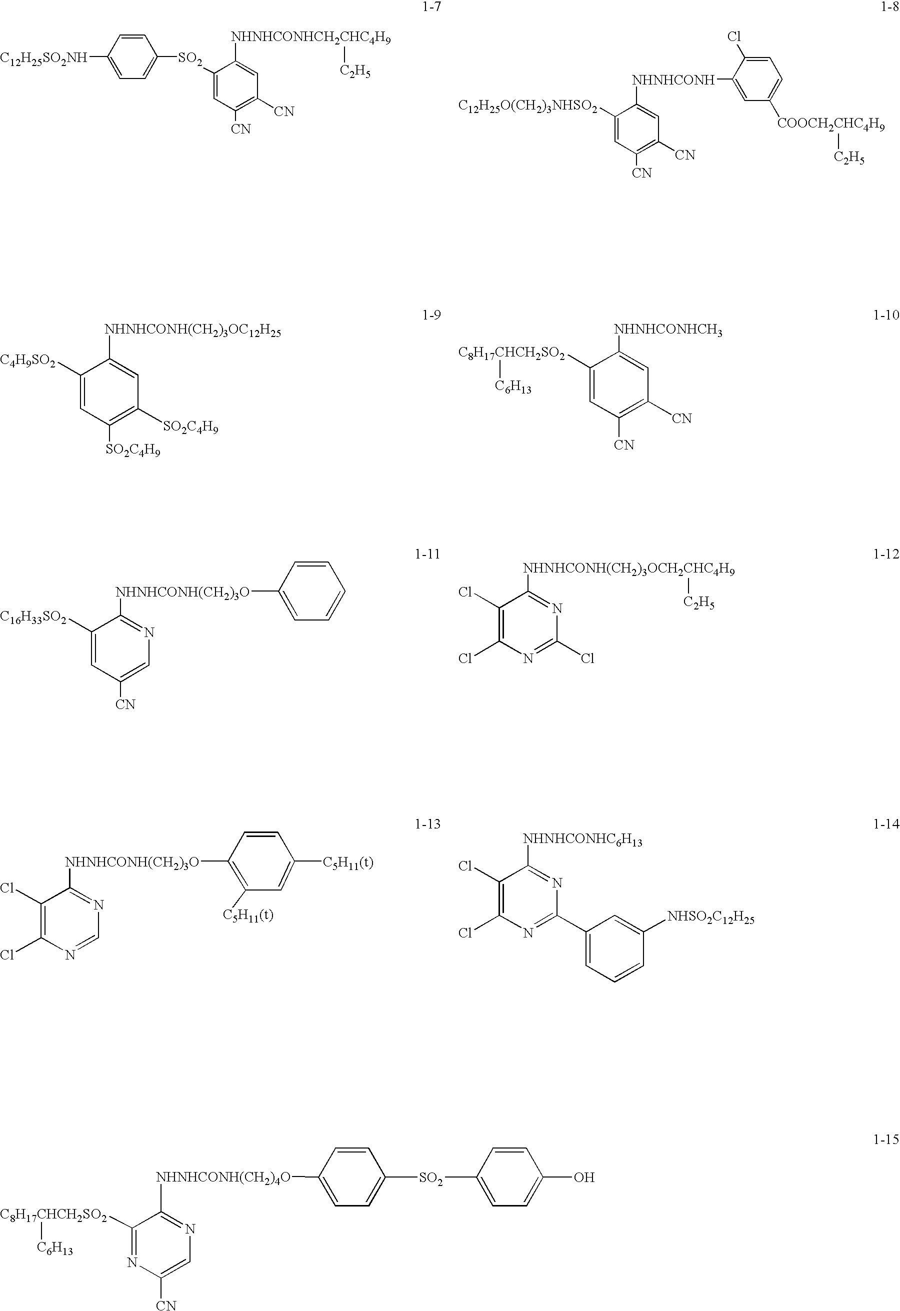

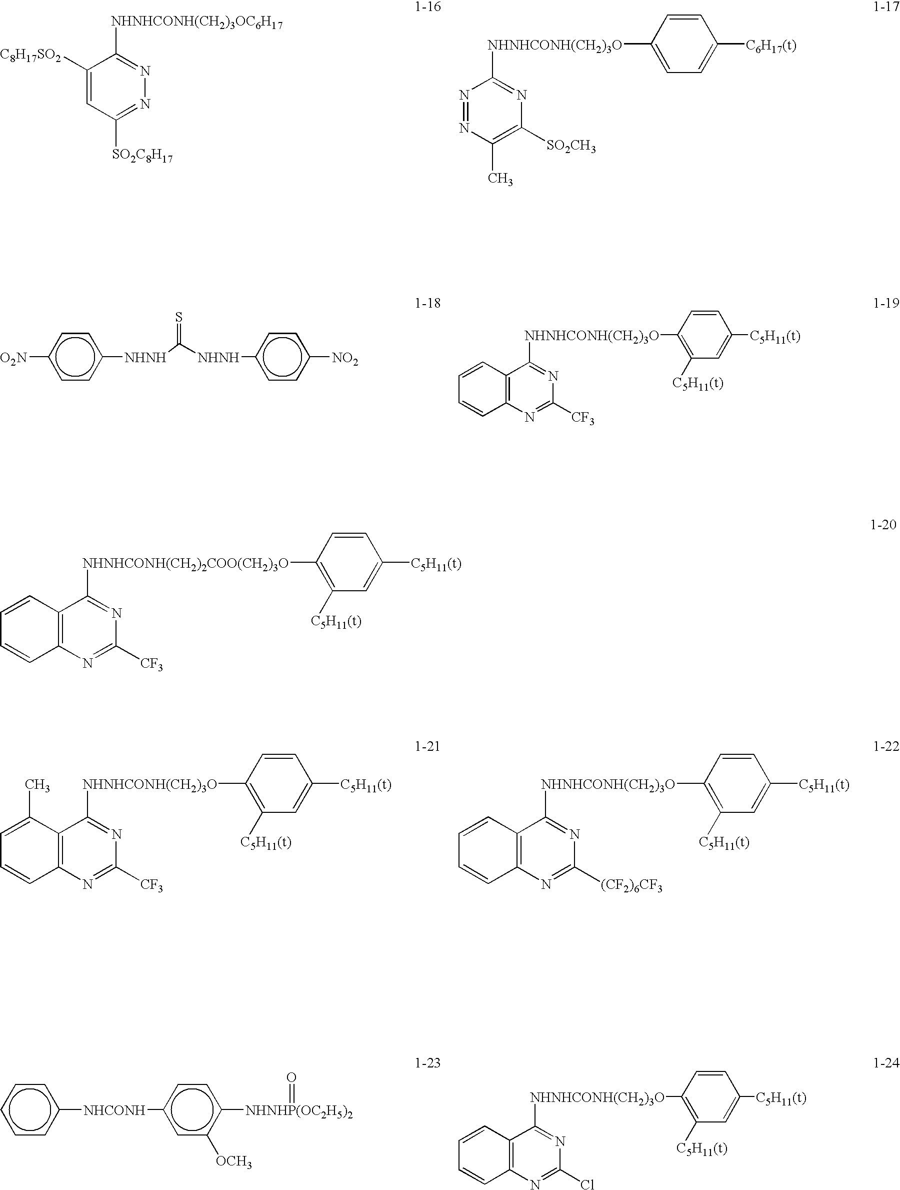

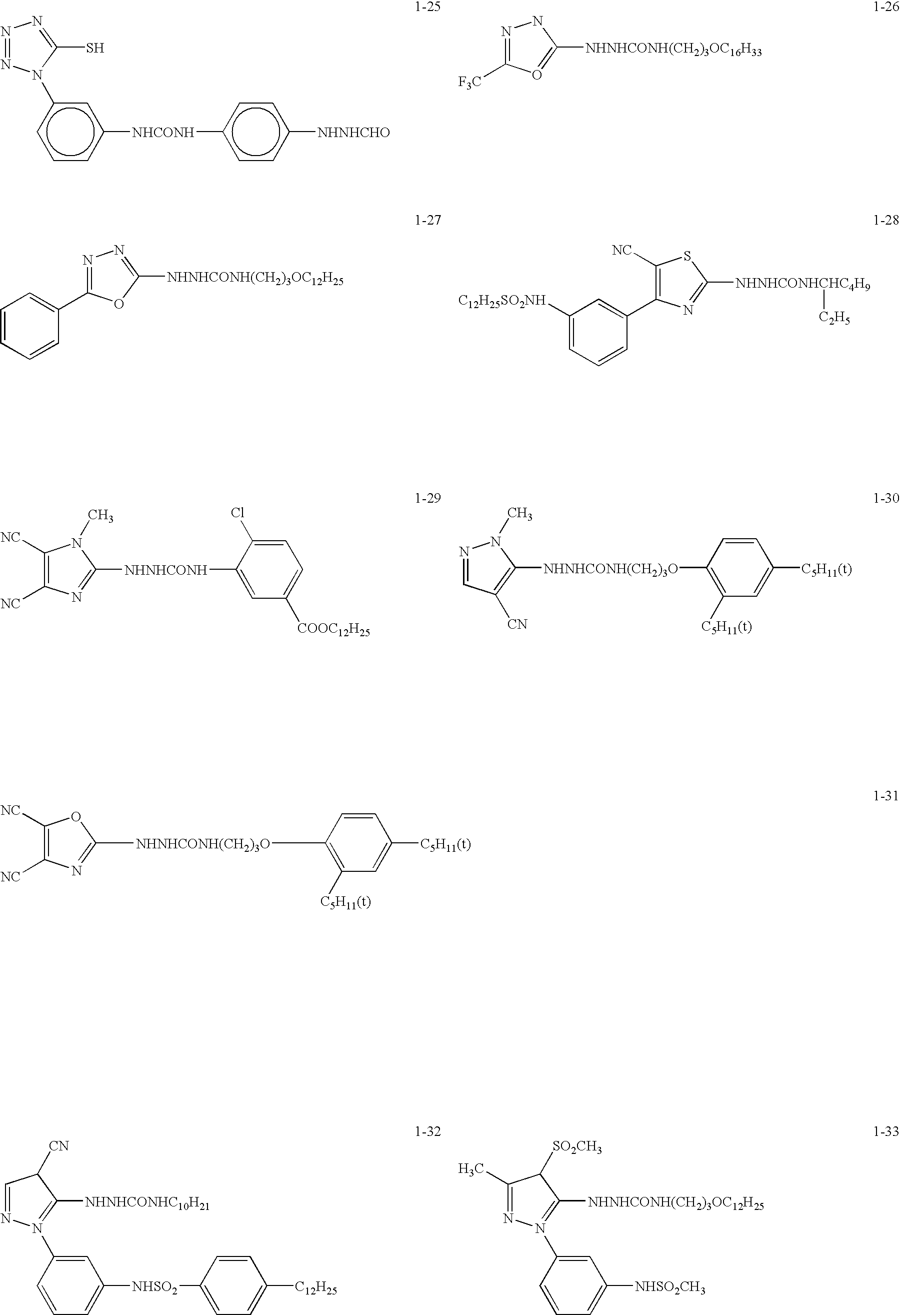

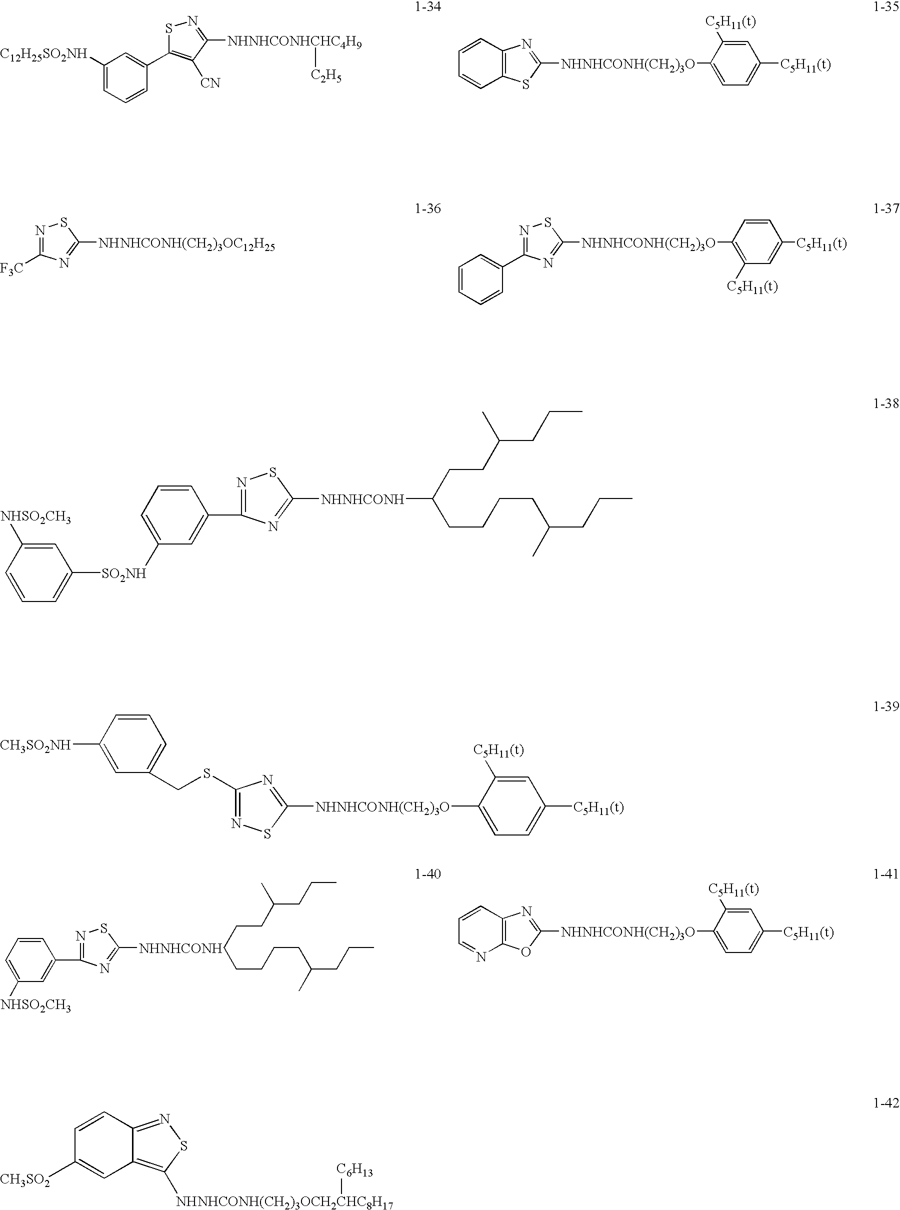

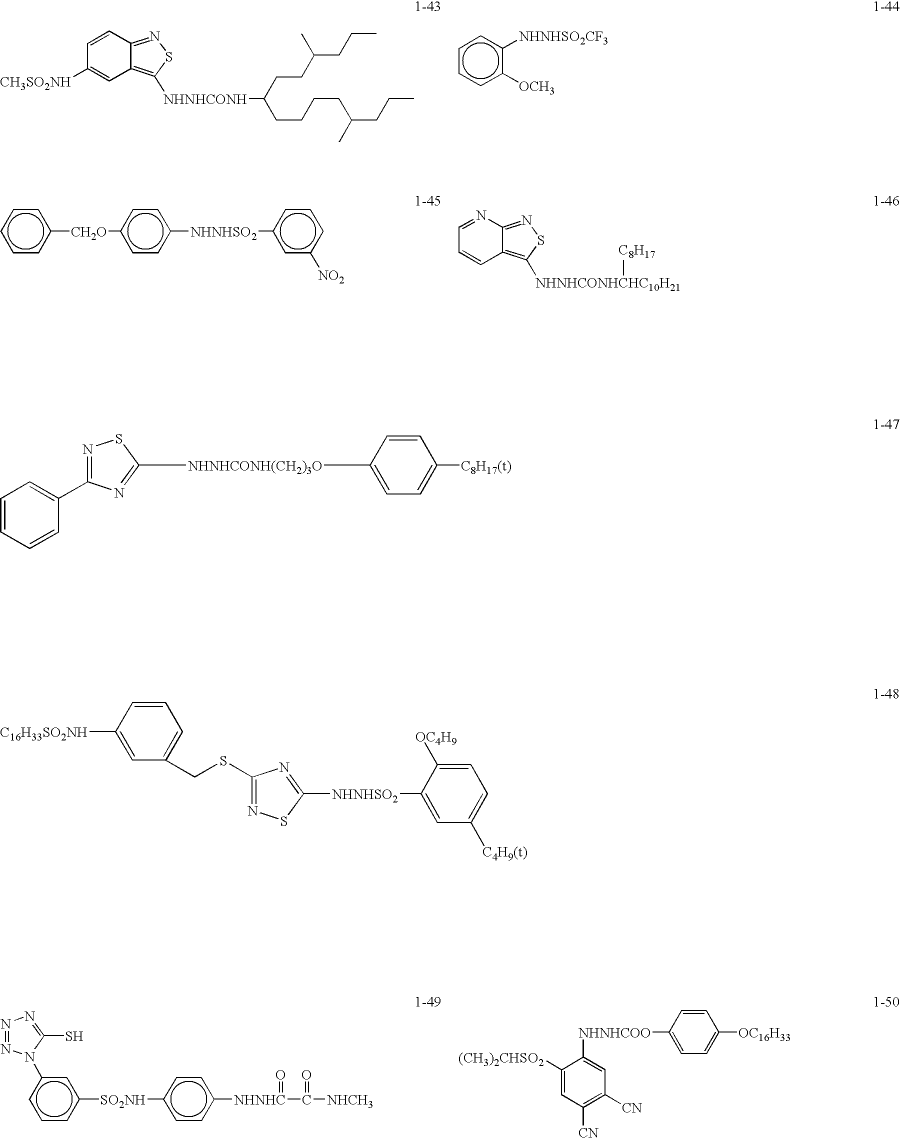

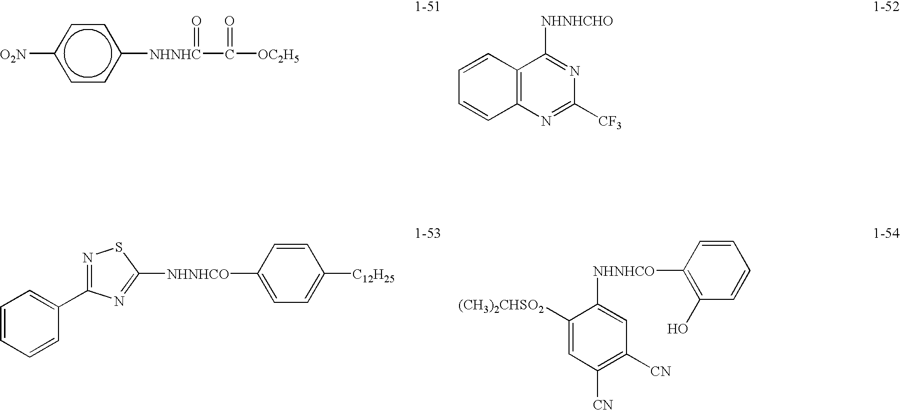

TABLE 1

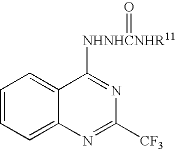

| Compound No. | R¹¹ |
|---|---|
| 1-55 | CH₃ |
| 1-56 | C₂H₅ |
| 1-57 | (n)C₃H₇ |
| 1-58 | (i)C₃H₇ |
| 1-59 | (n)C₄H₉ |
| 1-60 | (i)C₄H₉ |
| 1-61 | sec-C₄H₉ |
| 1-62 | (t)C₄H₉ |
| 1-63 | (n)C₅H₁₁ |
| 1-64 | (t)C₅H₁₁ |
| 1-65 | (n)C₆H₁₃ |
| 1-66 | 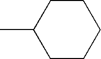 |
| 1-67 | (n)C₈H₁₇ |
| 1-68 | (t)C₈H₇ |
| 1-69 | 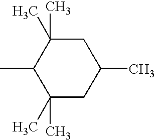 |
| 1-70 | 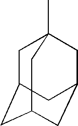 |

TABLE 2

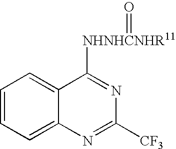

| Compound No. | R¹¹ |
|---|---|
| 1-71 | 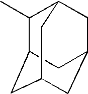 |
| 1-72 | 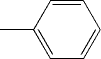 |
| 1-73 | 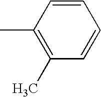 |
| 1-74 | 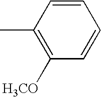 |
| 1-75 | 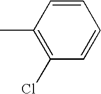 |
| 1-76 | 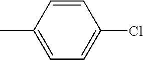 |
| 1-77 | 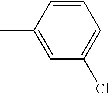 |
| 1-78 | 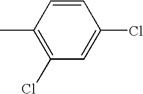 |

TABLE 3

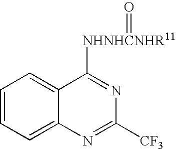

| Compound No. | R¹¹ |
|---|---|
| 1-79 | 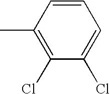 |
| 1-80 | 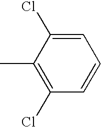 |
| 1-81 | 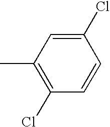 |
| 1-82 | 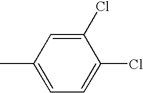 |
| 1-83 | 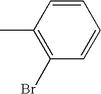 |
| 1-84 | 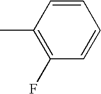 |
| 1-85 | 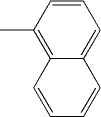 |

TABLE 4

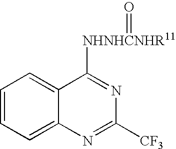

| Compound No. | R¹¹ |
|---|---|
| 1-86 | 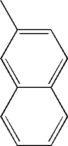 |
| 1-87 | 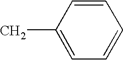 |
| 1-88 | 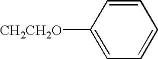 |
| 1-89 | CH₂CH₂OCH₂CH₃ |
| 1-90 | CH₂CH₂OCH₃ |

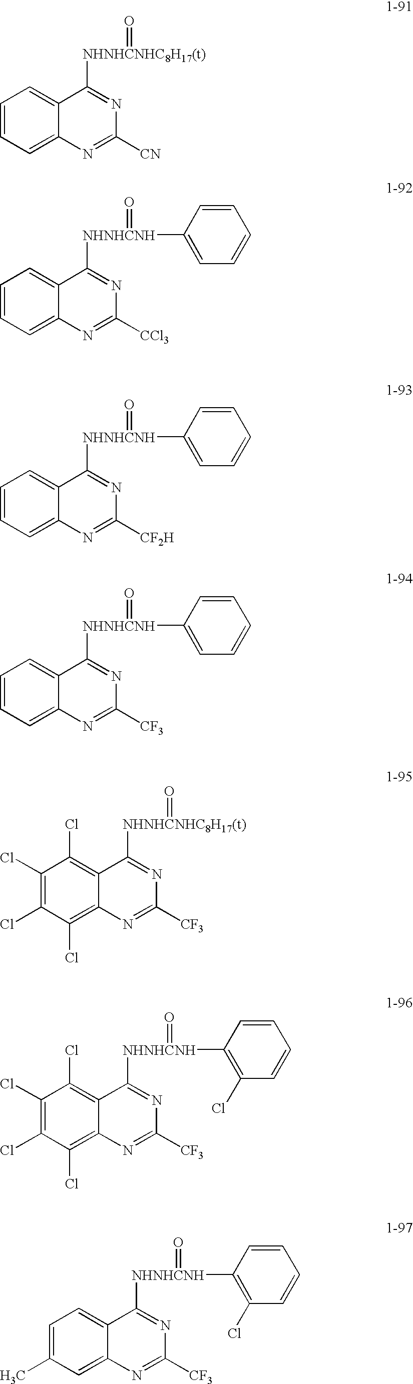

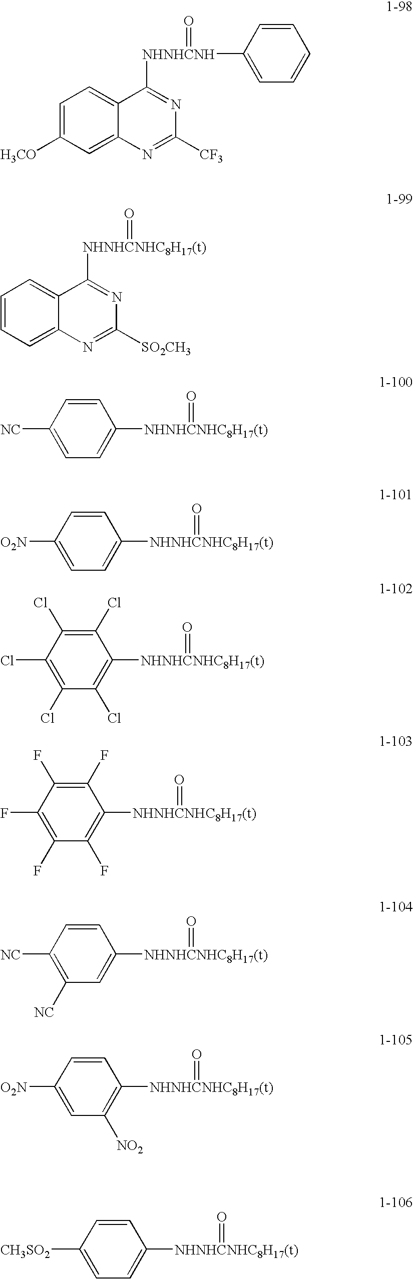

The compound represented by formula (1) can be synthesized according to the methods described in JP-A Nos. 9-152702, 8-286340, 9-152700, 9-152701, 9-152703 and 9-152704.

While the compound represented by formula (1) may be added in wide ranges, it is preferably in the range of 0.01 mol to 100 mol, more preferably 0.1 mol to 10 mol, per one mol of silver ion.

The compound represented by formula (1) may be added into the coating solution by any methods including adding in the form of a solution, powder, solid fine particle dispersion, emulsion and oil protect dispersion, and the like. Adding in the form of solid fine particles is particularly preferable when the compound is used together with the latex of the invention. The solid fine particles may be dispersed by the pulverizing methods known in the art (for example a ball mill, a vibrating ball mill, a sand mill, a colloid mill, a jet mill and a roller mill, and the like). A dispersion aid may be used for dispersing the solid fine particles.

The compounds represented by the following formulae (2) and (3) will be described hereinafter.

In formulae (2) and (3), X² and X³ each independently represent a hydrogen atom or a substituent. Examples of the substituents represented by X² and X³ include a halogen atom (for example a fluorine atom, a chlorine atom, a bromine atom and an iodine atom), an aryl group (having preferably 6 to 30 carbon atoms, more preferably 6 to 20 carbon atoms, and further preferably 6 to 12 carbon atoms; for example a phenyl group, a p-methylphenyl group and a naphthyl group), an alkoxy group (having preferably 1 to 20 carbon atoms, more preferably 1 to 12 carbon atoms, and further preferably 1 to 8 carbon atoms; for example a methoxy group, an ethoxy group and a butoxy group), an aryloxy group (having preferably 6 to 30 carbon atoms, more preferably 6 to 16 carbon atoms, and further preferably 6 to 12 carbon atoms; for example a phenyloxy group and a 2-naphthyloxy group), an alkylthio group (having preferably 1 to 20 carbon atoms, more preferably 1 to 16 carbon atoms, and further preferably 1 to 12 carbon atoms; for example a methylthio group, an ethylthio group and a butylthio group), an arylthio group (having preferably 6 to 30 carbon atoms, more preferably 6 to 16 carbon atoms, and further preferably 6 to 12 carbon atoms; for example a phenyltio group and a naphthylthio group), an acyloxy group (having preferably 1 to 20 carbon atoms, more preferably 2 to 16 carbon atoms, and further preferably 2 to 10 carbon atoms; for example an acetoxy group and a benzoyloxy group), an acylamino group (having preferably 2 to 20 carbon atoms, more preferably 2 to 16 carbon atoms, and further preferably 2 to 10 carbon atoms; for example a N-methyl acetylamino group and a benzoylamino group), a sulfonylamino group (having preferably 1 to 20 carbon atoms, more preferably 1 to 16 carbon atoms, and further preferably 1 to 12 carbon atoms; for example a methanesulfonyl group and a benzenesulfonyl group), a carbamoyl group (having preferably 1 to 20 carbon atoms, more preferably 1 to 16 carbon atoms, and further preferably 1 to 12 carbon atoms; for example a carbamoyl group, an N,N-diethylcarbamoyl group and an N-phenylcarbamoyl group), an acyl group (having preferably 2 to 20 carbon atoms, more preferably 2 to 16 carbon atoms, and further preferably 2 to 12 carbon atoms; for example an acetyl group, a benzoyl group, a formyl group and a pivaloyl group), an alkoxycarbonyl group (having preferably 2 to 20 carbon atoms, more preferably 2 to 16 carbon atoms, and further preferably 2 to 12 carbon atoms; for example a methoxycarbonyl group), a sulfo or sulfonyl group (having preferably 1 to 20 carbon atoms, more preferably 1 to 16 carbon atoms, and further preferably 1 to 12 carbon atoms; for example a mesyl or a tosyl group), a sulfonyloxy group (having preferably 1 to 20 carbon atoms, more preferably 1 to 16 carbon atoms, and further preferably 1 to 12 carbon atoms; for example a methanesulfonyloxy group and a benzenesulfonyloxy group), an azo group, a heterocyclic group, a heterocyclic mercapto group and a cyano group. The heterocyclic group as used herein represents a saturated or unsaturated heterocyclic group, and include, for example, a pyridyl group, a quinolyl group, quinoxanyl group, a pyrazinyl group, a benzotriazolyl group, a pyrazolyl group, an imidazolyl group, a benzoimidazolyl group, a tetrazolyl group, a hydantoin-1-yl group, a succinimide group and a phthalimide group.

The substituents represented by X² and X³ in formulae (2) and (3) are more preferably an alkoxy group and an aryloxy group. The substituents represented by X² and X³ may be further substituted with other substituents, which may be any substituents known in the art so long as they do not deteriorate photographic performance.

In the formulae (2) and (3), R²¹, R³¹ and R³² each independently represent a hydrogen atom or a substituent, m and p each independently represent an integer from 0 to 4, and n represents an integer from 0 to 2. Any substituents may be used as the substituents represented by R²¹, R³¹ and R³² so long as they do not adversely affect the photographic property. For example, they are halogen atoms (for example fluorine, chlorine, bromine and iodine atoms), linear, branched or cyclic alkyl groups, or a combination thereof (having preferably 1 to 20 carbon atoms, more preferably 1 to 16 carbon atoms, and further preferably 1 to 13 carbon atoms; for example methyl, ethyl, n-propyl, isopropyl, sec-butyl, tert-butyl, tert-octyl, n-amyl, tert-amyl, n-dodecyl, n-tridecyl and cyclohexyl groups), alkenyl groups (having preferably 2 to 20 carbon atoms, more preferably 2 to 16 carbon atoms, and further preferably 2 to 12 carbon atoms; for example vinyl, allyl, 2-butenyl and 3-pentenyl groups), aryl groups (having preferably 6 to 30 carbon atoms, more preferably 6 to 20 carbon atoms, and further preferably 6 to 12 carbon atoms; for example phenyl, p-methylphenyl, and naphthyl groups), alkoxy groups (having preferably 1 to 20 carbon atoms, more preferably 1 to 16 carbon atoms, and further preferably 1 to 12 carbon atoms; for example methoxy, ethoxy, propoxy and butoxy groups), aryloxy groups (having preferably 6 to 30 carbon atoms, more preferably 6 to 20 carbon atoms, and further preferably 6 to 12 carbon atoms; for example phenyloxy and 2-naphthyloxy groups), acyloxy groups (having preferably 2 to 20 carbon atoms, more preferably 2 to 16 carbon atoms, and further preferably 2 to 12 carbon atoms; for example acetoxy and benzoyloxy groups), amino groups (having preferably 0 to 20 carbon atoms, more preferably 1 to 16 carbon atoms, and further preferably 1 to 12 carbon atoms; for example dimethylamino, diethylamino, dibutylamino and anilino groups), acylamino groups (having preferably 2 to 20 carbon atoms, more preferably 2 to 16 carbon atoms, and further preferably 2 to 13 carbon atoms; for example acetylamino, tridecanoylamino and benzoylamino groups), sulfonylamino groups (having preferably 1 to 20 carbon atoms, more preferably 1 to 16 carbon atoms, and further preferably 1 to 12 carbon atoms; for example methanesulfonylamino, butanesulfonylmino and benzenesulfonylamino groups), ureido groups (having preferably 1 to 20 carbon atoms, more preferably 1 to 16 carbon atoms, and further preferably 1 to 12 carbon atoms; for example ureido, methylureido and phenylureido groups), carbamate groups (having preferably 2 to 20 carbon atoms, more preferably 2 to 16 carbon atoms, and further preferably 2 to 12 carbon atoms; for example methoxycarbonylamino and phenyloxycarbonylamino groups), carboxyl or carbamoyl groups (having preferably 1 to 20 carbon atoms, more preferably 1 to 16 carbon atoms, and further preferably 1 to 12 carbon atoms; for example carbamoyl, N,N-diethylcarbamoyl, N-dodecylcarbamoyl and N-phenylcarbamoyl groups), alkoxtcarbonyl groups (having preferably 2 to 20 carbon atoms, more preferably 2 to 16 carbon atoms, and further preferably 2 to 12 carbon atoms; for example methoxycarbonyl, ethoxycarbonyl and butoxycarbonyl groups), acyl groups (having preferably 2 to 20 carbon atoms, more preferably 2 to 16 carbon atoms, and further preferably 2 to 12 carbon atoms; for example acetyl, benzoyl, formyl and pivaloyl groups), sulfo or sulfonyl groups (having preferably 1 to 20 carbon atoms, more preferably 1 to 16 carbon atoms, and further preferably 1 to 12 carbon atoms; for example mesyl and tosyl groups), sulfamoyl groups (having preferably 1 to 20 carbon atoms, more preferably 0 to 16 carbon atoms, and further preferably 0 to 12 carbon atoms; for example sulfamoyl, methylsulfamoyl, dimethylsulfamoyl and phenylsulfamoyl groups), cyano group, hydroxyl group, mercapto group, alkylthio groups (having preferably 1 to 20 carbon atoms, more preferably 1 to 16 carbon atoms, and further preferably 1 to 12 carbon atoms; for example methylthio and butylthio groups), and heterocyclic groups (having preferably 2 to 20 carbon atoms, more preferably 2 to 16 carbon atoms, and further preferably 2 to 12 carbon atoms; for example pyridyl, imidazolyl and pyrrolidyl groups). These substituents may be further substituted with other substituents.

The preferable substituents represented by R²¹, R³¹ and R³² in formula (2) are, among the substituents described above, a halogen atom, an alkyl group, an aryl group, an alkoxy group, an aryloxy group, an acyloxy group, an anilino group, an acylamino group, a sulfonylamino group, a carboxyl group, a carbamoyl group, an acyl group, a sulfonyl group, a sulfamoyl group, a cyano group, a hydroxyl group, a mercapto group, an alkylthio group and a heterocyclic group.

The compounds represented by formula (2) preferably have carbamoyl groups (having preferably 1 to 20 carbon atoms, more preferably 1 to 16 carbon atoms, and further preferably 1 to 12 carbon atoms; for example carbamoyl, N,N-diethylcarbamoyl, N-dodecylcarbamoyl, N-phenylcarbamoyl, N-(2-chlorophenyl)carbamoyl, N-(4-chlorophenyl)carbamoyl, N-(2,4-dichlorophenyl)carbamoyl, N-(3,4-dichlorophenyl) carbamoyl groups) at position 2. It is particularly preferable that the compounds have arylcarbamoyl groups (having preferably 7 to 20 carbon atoms, more preferably 7 to 16 carbon atoms, and further preferably 7 to 12 carbon atoms; for example N-phenylcarbamoyl, N-(2-chlorophenyl)carbamoyl, N-(4-chlorophenyl)carbamoyl, N-(2,4-dichlorophenyl)carbamoyl and N-(3,4-dichlorophenyl)carbamoyl groups) at position 2.

While examples of the compounds represented by formula (3) are listed below, the compounds used in the invention are not restricted thereto.

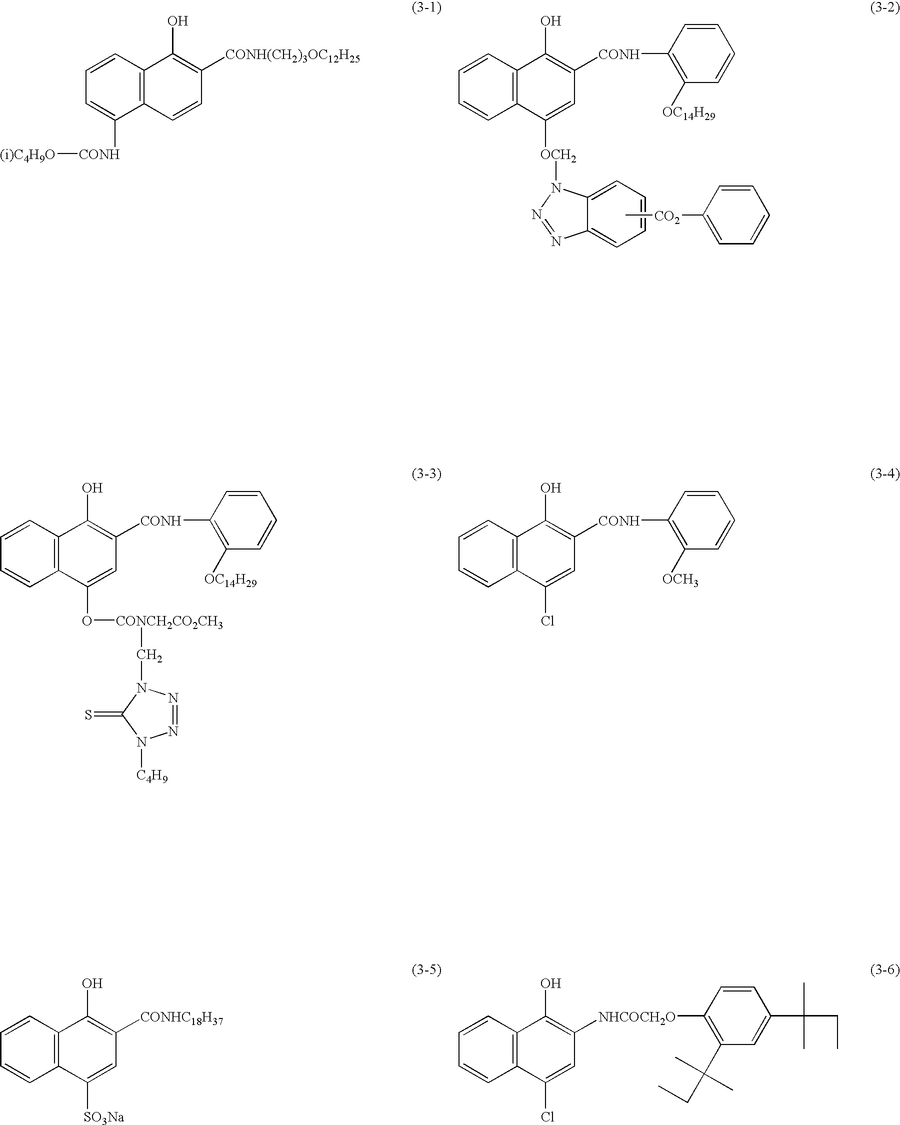

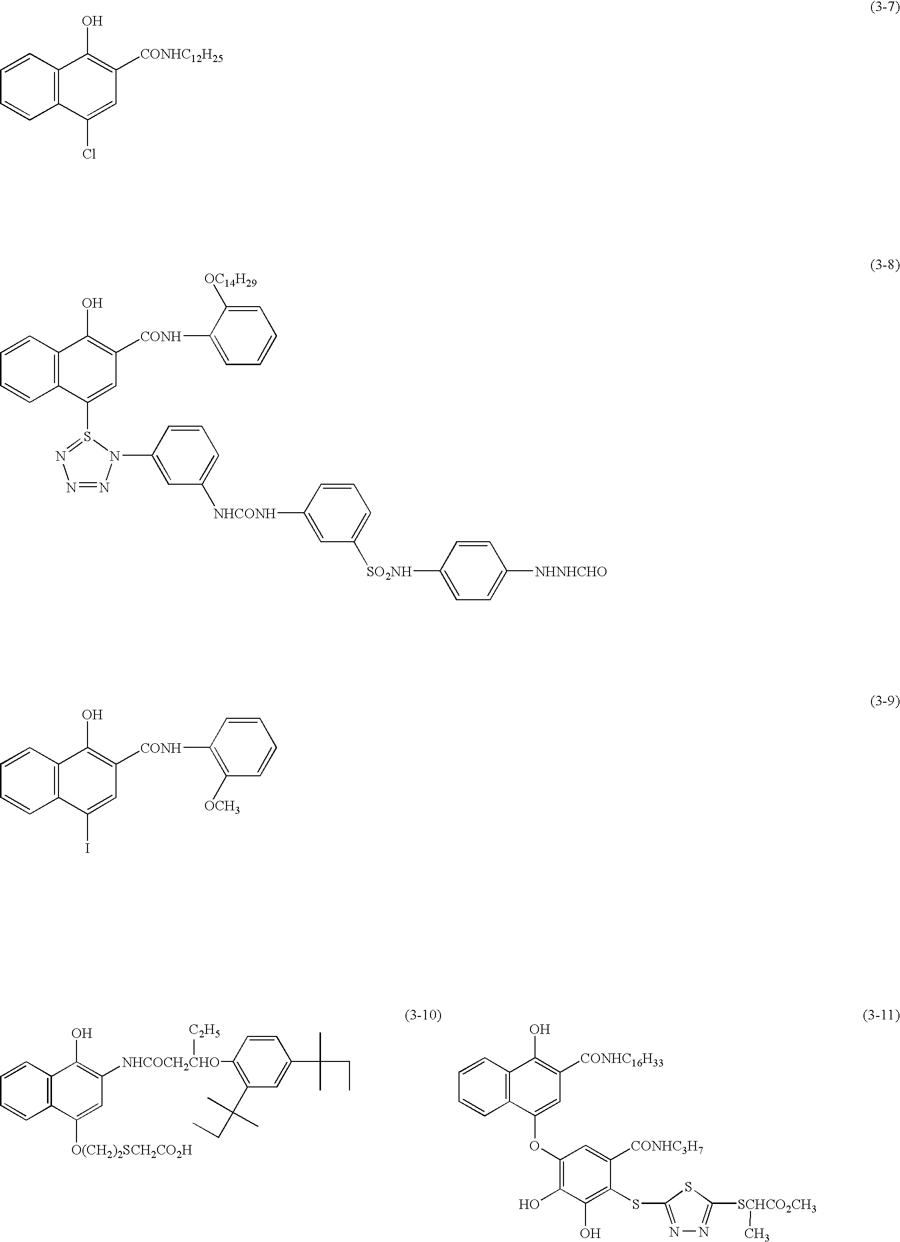

The compounds represented by formulae (2) and (3) can be readily synthesized by the methods well known in the art of photography.

The compounds represented by formulae (2) and (3) may be used by dissolving in water or appropriate organic solvents, for example alcohols (methanol, ethanol, propanol and fluorinated alcohols), ketone (asetone, methyl ethyl ketone), dimethylformamide, dimethylsulfoxide and methyl cellosolve.

Otherwise, the compounds may be used by mechanically preparing an emulsified dispersion by a emulsifying dispersion method known in the art after dissolving the compounds in oils such as dibutyl phthalate, trichlesyl phosphate, glyceryl triacetate and diethyl phthalate, and in auxiliary solvents such as ethyl acetate and cyclohexanone. The compounds may be used by dispersing the powder of the compound according to a solid dispersion method known in the art using a ball mill, a colloid mill, a sand grinder mill, a Manton-Golin mill, a microfluidizer or an ultrasonic wave.

While the compounds represented by formulae (2) and (3) may be added in any layer on the support so long as the layer is on the same surface as the surface containing a photosensitive silver halide and a silver salt that can be reduced, the compound is preferably added in the layer containing a silver halide or in the layer adjacent thereto.

The addition amount of the compound represented by formulae (2) and (3) is preferably 0.2 mmol to 200 mmol, more preferably 0.3 mmol to 100 mmol, and further preferably 0.5 mmol to 30 mmol. One of the compounds represented by formulae (2) and (3) may be used, or may be used as a mixture of at least two of them.

It is particularly preferable to use the compounds represented by formulae (1) and (3) together.

The compound represented by formula (2) is preferably any one of the compounds represented by formula (4) or (5).

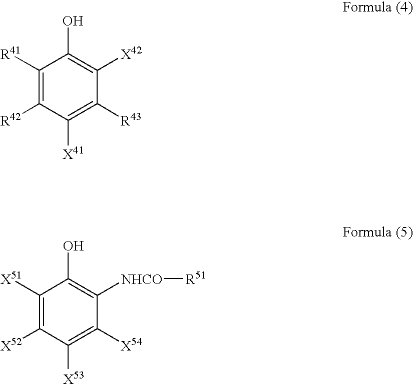

In formula (4), R⁴¹, R⁴², R⁴³, X⁴¹ and X⁴² each independently represent a hydrogen atom, a halogen atom, a carbon atom, a nitrogen atom, a sulfur atom or a phosphor atom, which is a substituent bonded to the benzene ring. However, at least one of X⁴¹ and X⁴² is a group represented by —NR⁴⁴R⁴⁵. R⁴⁴ and R⁴⁵ each independently represent a hydrogen atom, an alkyl group, an alkenyl group, an alkynyl group, an aryl group or a heterocyclic group, or a group represented by —C(═O)—R, —C(═O)—C(═O)—R, —SO₂R, —SO—R, —P(═O)(R)₂ or —C(═NR′)—R. R and R′ each independently represent a group selected from a hydrogen atom, an alkyl group, an aryl group, a heterocyclic group, an amino group, an alkoxy group and an aryloxy group. These substituents may form a ring by forming bonds between adjacent groups.

In formula (5), X⁵¹ represents a substituent, and X⁵² to X⁵⁴ each independently represent a hydrogen atom or a substituent. However, X⁵¹ to X⁵⁴ are not hydroxyl groups, and X⁵³ is not a sulfonamide. The substituents represented by X⁵¹ to X⁵⁴ may form a ring by joining with each other. R⁵¹ represents a hydrogen atom, an alkyl group, an aryl group, a heterocyclic group, an amino group or an alkoxy group.

The development accelerator represented by formula (4) will be described below.

In formula (4), R⁴¹ to R⁴³ each independently represent a hydrogen atom, a carbon atom, an oxygen atom, a nitrogen atom, a sulfur atom or a sulfur atom, which is substituent bonded to a benzene ring. Examples of the carbon atom bonded to the benzene ring include linear, branched or cyclic alkyl groups (for example a methyl, ethyl, iso-propyl, tert-butyl, n-octyl, tert-amyl, 1,3-tetramethylbutyl and cyclohexyl groups), alkenyl groups (for example vinyl, allyl, 2-nutenyl and 3-pentenyl groups), alkynyl groups (for example propargyl and 3-pentynyl groups), aryl groups (for example phenyl, p-methylphenyl and naphthyl groups), acyl groups (for example acetyl, benzoyl, formyl and pyvaloyl groups), alkoxycarbonyl groups (for example methoxycarbonyl and ethoxycarbonyl groups), aryloxycarbonyl groups (for example phenoxycarbonyl group), carbamoyl groups (for example carbamoyl, diethylcarbamoyl and phenylcarbamoyl groups), a cyano group, a carboxyl group, and heterocyclic groups (for example 3-pyrazolyl group).

Examples of the substituent bonded to the benzene ring through an oxygen atom include a hydroxyl group, alkoxy groups (for example methoxy, ethoxy and butoxy groups), aryloxy groups (for example phenyloxy and 2-naphthyloxy groups), heterocyclic oxy groups (for example 4-pyridyloxy group), and acyloxy groups (for example acetoxy and benzoyloxy groups). Non-restrictive examples of the substituents bonded to the benzene ring through the nitrogen atom include amino groups (for example amino, methylamino, dimethylamino, diethylamino and dibenzylamino groups), a nitro group, a hydrazino group, heterocyclic groups (for example 1-imidazolyl and morphoryl groups), acylamino groups (for example acetylamino and benzoylamino groups), alkoxycarbonylamino groups (for example methoxycarbonylamino group), aryloxycarbonylamino groups (for example a phenyloxycarbonylamino group), sulfonylamino groups (for example methanesulfonyl and benzenesulfonylamino groups), sulfamoyl groups (for example sulfamoyl, methylsulfamoyl, dimethylsulfamoyl and phenylsulfamoyl groups), ureido groups (for example ureido, methylureido and phenylureido groups), phosphorylamino groups (for example a diethylphosphorylamino group), and imide groups (for example succimide, phthalimide and trifluoromethane sulfonimide groups). Non-restrictive examples of the substituent bonded to the benzene ring through the sulfur atom include a mercapto group, a disulfide group, a sulfo group, a sulfino group, a sulfonylthio group, alkylthio groups (for example methylthio and ethylthio groups) arylthio groups (for example a phenylthio group), sulfonyl groups (for example mesyl, tosyl and phenylsulfonyl groups), sulfinyl groups (for example methanesulfinyl and benzenesulfinyl groups), and heterocyclic thio groups (for example a 2-imidazolylthio group). Non-restrictive examples of the substituent bonded to the benzene ring through a phosphor atom include phosphoric acid ester groups (for example diethyl phosphate and diphenylphosphate groups).

Preferable examples of R⁴¹ to R⁴³ in formula (4) include a hydrogen atom, a halogen atom, a linear, branched or cyclic alkyl group, an aryl group, an acyl group, an alkoxycarbonyl group, an aryloxycarbonyl group, a cyano group, carboxyl group, a heterocyclic group, a hydroxyl group, an alkoxy group, an aryloxy group, a heterocyclic oxy group, an acyloxy group, an amino group, a nitro group, a heterocyclic group, an acylamino group, an alkoxycarbonylamino group, an aryloxycarbonylamino group, a sulfonylamino group, an imide group, a sulfamoyl group, a carbamoyl group, an udeido group, a mercapto group, a disulfide group, a sufo group, a sulfino group, an alkylthio group, an arylthio group, a sulfonyl group, a sulfinyl group and a heterocyclic thio group.

More preferable examples of R⁴¹ to R⁴³ in formula (4) include a hydrogen atom, a halogen atom, linear, a branched or cyclic alkyl group, an aryl group, an acyl group, an alkoxycarbonyl group, an aryloxycarbonyl group, a cyano group, a carboxyl group, a heterocyclic group, a hydroxyl group, an alkoxy group, an aryloxy group, an acyloxy group, an amino group, a nitro group, a heterocyclic group, an acylamino group, an alkoxycarbonylamino group, an aryloxycarbonylamino group, a sulfonylamino group, an imide group, a carbamoyl group, a mercapto group, a sulfo group, an alkylthio group, an arylthio group and a sulfonyl group.

Particularly preferable examples of R⁴¹ to R⁴³ in formula (4) include a hydrogen atom, a halogen atom, a linear, branched or cyclic alkyl group, an aryl group, an acyl group, an alkoxycarbonyl group, an aryloxycarbonyl group, a cyano group, a carboxyl group, an acyloxy group, an acylamino group, an alkoxycarbonylamino group, an aryloxycarbonylamino group, a sulfonylamino group, a carbamoyl group, a sulfo group, an alkylsulfonyl group, and an arylsulfonyl group.

In formula (4), X⁴¹ and X⁴² represent a hydrogen atom or a halogen atom, or substituents bonded to the benzene ring through a carbon atom, an oxygen atom, a nitrogen atom, a sulfur atom and a phosphor atom. Examples of the substituent bonded to the benzene ring through a carbon atom include linear, branched or cyclic alkyl groups (for example methyl, ethyl, iso-propyl, tert-butyl, n-octyl, tert-amyl, 1,3-tetramethylbutyl and cyclohexyl groups), alkenyl groups (for example viny, allyl, 2-butenyl, 3-pentenyl groups), alkynyl groups (for example propargyl, 3-pentinyl groups), aryl groups (for example phenyl, p-methylphenyl and naphthyl groups), acyl groups (for example acetyl, benzoyl, formyl and pivaloyl groups), alkoxycarbonyl groups (for example methoxycarbonyl and ethoxyarbonyl groups), aryloxycarbonyl groups (for example a phenoxycarbonyl group), a cyano group, a carboxyl group, heterocyclic groups (for example a 3-pyrazolyl group), and carbamoyl groups (for example carbamoyl, diethylcarbamoyl and phenylcarbamoyl groups).

Non-restrictive examples of the substituent bonded to the benzene ring through an oxygen atom in formula (4) include a hydroxyl group, an alkoxy group (for example methoxy, ethoxy and butoxy group), an aryloxy group (for example phenyloxy and 2-naphthyloxy group), a heterocyclic oxy group (for example a 4-pyridyloxy group), and an acyloxy group (for example acetoxy and benzoyloxy group).

Examples of the substituent bonded to the benzene ring through a nitrogen atom in formula (4) include amino groups (for example amino, methylamino, dimethylamino, diethylamino and dibenzylamino group), a nitro group, a hydroxame group, a hydrazino group, a heterocyclic group (for example 1-imidazolyl and morphoryl group), an acylamino group (for example acetylamino and benzoylamino group), an alkoxycarbonylamino group (for example methoxycarbonylamino group), an aryloxycarbonylamino group (for example phenyloxycarbonylamino group), sulfonylamino groups (for example methanesulfonylamino and benzenesulfonylamino group), sulfamoyl groups (for example sulfamoyl, methylsulfamoyl, dimethylsulfamoyl and pehnylsulfamoyl group), and phosphorylamino groups (for example a diethylphosphorylamino group).

Examples of the substituent bonded to the benzene ring through a sulfur atom in formula (4) include a mercapto group, a disulfide group, a sulfo group, a sulfino group, a sulfonylthio group, a thiosulfonyl group, an alkylthio group (for example methylthio and ethylthio group), arylthio groups (for example phenylthio group), sulfonyl groups (for example mesyl, tosyl and phenylsolfonyl groups), sulfinyl groups (for example mathanesulfinyl and benzenesulfinyl groups), and heterocyclic thio groups (for example a 2-imidazolylthio group).

Non-restrictive examples of the substituent bonded to the benzene ring through a phosphor atom include phosphoric acid ester groups (for example diethyl phosphate and diphenyl phosphate groups).

Preferable X⁴¹ and X⁴² in formula (4) are hydrogen atoms, halogen atoms, linear, branched or cyclic alkyl groups, aryl groups, acyl groups, alkoxycarbonyl groups, aryloxycarbonyl groups, cyano groups, carboxyl groups, heterocyclic groups, hydroxyl groups, alkoxy groups, aryloxy groups, heterocyclic oxy groups, acyloxy groups, amino groups, nitro groups, heterocyclic groups, acylamino groups, alkoxycarbonylamino groups, aryloxycarbonylamino groups, sulfonylamino groups, imide groups, sulfamoyl groups, carbamoyl groups, ureido groups, mercapto groups, disulfide groups, alkylthio groups, arylthio groups, sulfonyl groups and heterocyclic thio groups.

More preferable X⁴¹ and X⁴² in formula (4) are hydrogen atoms, halogen atoms, linear, branched or cyclic alkyl groups, aryl groups, acyl groups, alkoxycarbonyl groups, aryloxycarbonyl groups, cyano groups, carboxyl groups, hydroxyl groups, alkoxy groups, aryloxy groups, acyloxy groups, amino groups, acylamino-groups, alkoxycarbonylamino groups, aryloxycarbonylamino groups, sulfonylamino groups, imide groups, carbamoyl groups, sulfo groups and arylsulfonyl groups.

Particularly preferable X⁴¹ and X⁴² in formula (4) are hydrogen atoms, halogen atoms, linear, branched or cyclic alkyl groups, aryl groups, acyl groups, alkoxycarbonyl groups, aryloxycarbonyl groups, cyano groups, carboxyl groups, alkoxy groups, aryloxy groups, acyloxy groups, acylamino groups, alkoxycarbonylamino groups, aryloxycarbonylamino groups, sulfonylamino groups, carbamoyl groups, mercapto groups and alkylthio groups.

At least one of X⁴¹ and X⁴² is a group represented by —NR⁴⁴R⁴⁵. R⁴⁴ and R⁴⁵ each independently represent a hydrogen atom, an alkyl group, an alkenyl group, an alkynyl group, an aryl group and a heterocyclic group, or the groups represented by —C(═O)—R, —C(C═O)—C(C═O)—R, —SO₂—R, —SO—R, —P(═O)(R)₂ and —C(═NR′)—R. R and R′ each independently are selected from a hydrogen atom, an alkyl group, an aryl group, a heterocyclic group, an amino group, an alkoxy group and an aryloxy group.

When R⁴⁴ and R⁴⁵ represent hydrogen atoms, alkyl groups, alkenyl groups, alkynyl groups, aryl groups or heterocyclic groups, they may represent, for example, linear, branched or cyclic alkyl groups (for example methyl, ethyl, iso-propyl, tert-butyl, n-octyl, tert-amyl, 1,3-tetramethylbutyl and cyclohexyl groups), alkenyl groups (for example vinyl, aryl, 2-butenyl and 3-pentenyl groups), alkynyl groups (for example paropargyl and 3-pentenyl groups), aryl groups (for example phenyl, p-methylphenyl and naphthyl groups), and heterocyclic groups (for example 2-imidazolyl and 1-pyrrazolyl groups).

When R⁴⁴ and R⁴⁵ represent —C(═O)—R, —C(C═O)—C(C═O)—R, —SO₂—R, —SO—R, —P(═O)(R)₂ and —C(═NR′)-R groups, R and R′ each independently represent a hydrogen atom, an alkyl group (for example methyl, ethyl, iso-propyl, tert-butyl, n-octyl, tert-amyl, 1,3-tetramethylbutyl and cyclohexyl groups), aryl groups (for example phenyl, p-methylphenyl and naphthyl groups), heterocyclic groups (for example 4-pyridyl, 2-thienyl and 1-methyl-2-pyrrolyl groups), amino groups (for example amino, dimethylamino, phenylamino and 2-pyridylamino groups), alkoxy groups (for example methoxy, ethoxy and cyclohexyloxy groups), and aryloxy groups (for example phenoxy and 2-naphthoxy groups).

Preferable groups represented by R⁴⁴ and R⁴⁵ in formula (4) are hydrogen atoms, linear, branched or cyclic alkyl groups, aryl groups, acyl groups, alkoxycarbonyl groups, aryloxycarbonyl groups, sulfamoyl groups, carbamoyl groups, sulfonyl groups and sulfinyl groups. More preferable groups represented by R⁴⁴ and R⁴⁵ are hydrogen atoms, linear, branched or cyclic alkyl groups, aryl groups, acyl groups and sulfonyl groups. A particularly preferable combination comprises a hydrogen atom as any one of R⁴⁴ and R⁴⁵, and the other is an alkylsulfonyl group or an arylsulfonyl group. These substituents may be further substituted with the substituents as described above. These substituents may form salts by dissociating their protons when the substituents have highly acidic hydrogen atoms. Counter-cations thereof may be metal ions, ammonium ions and sulfonium ions. Such dissociation state in which active hydrogens are dissociated may be effective countermeasures when evaporation of the compound in the development process is of problem. R⁴¹, R⁴², R⁴³, X⁴¹ and X⁴² may form a ring by forming bonds among the adjoining groups. While examples of the compound represented by formula (4) are listed below, the invention is not restricted to these examples.

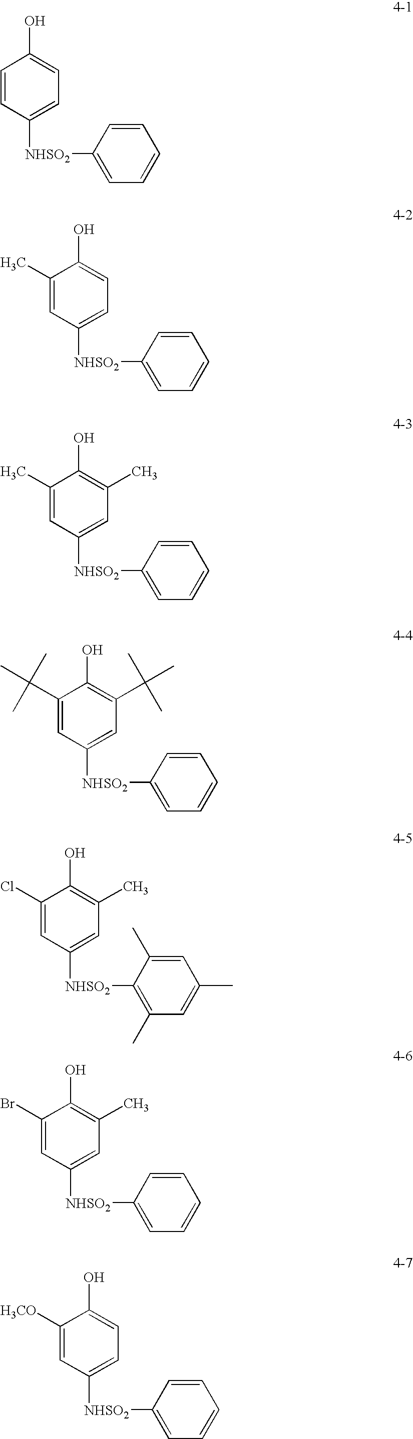

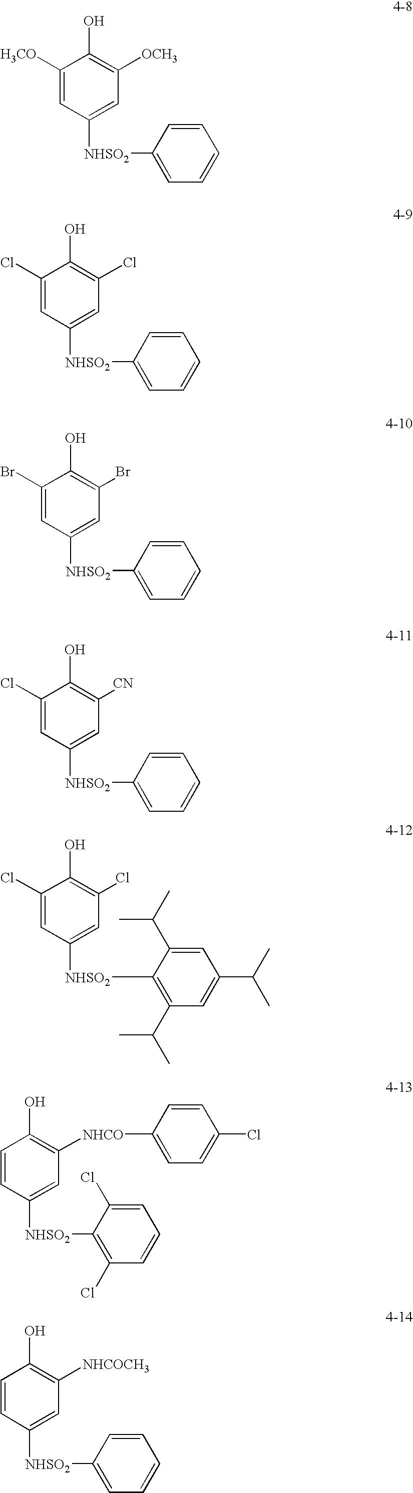

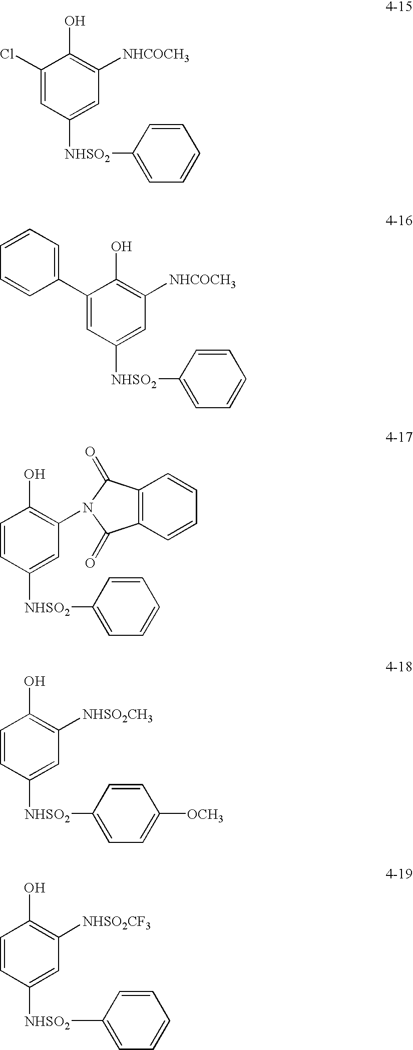

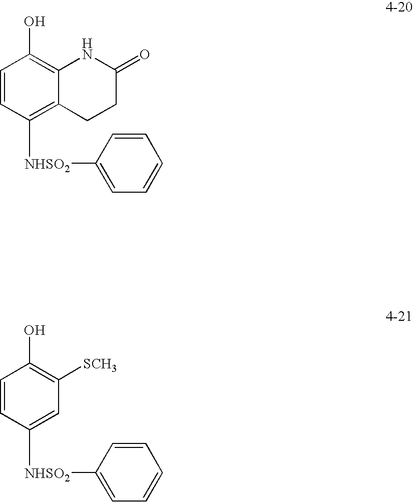

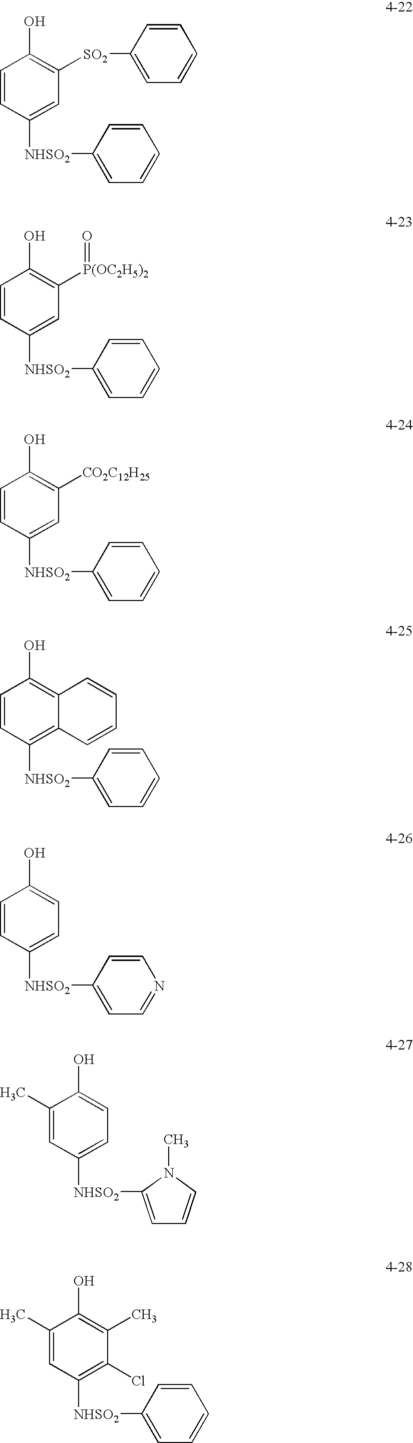

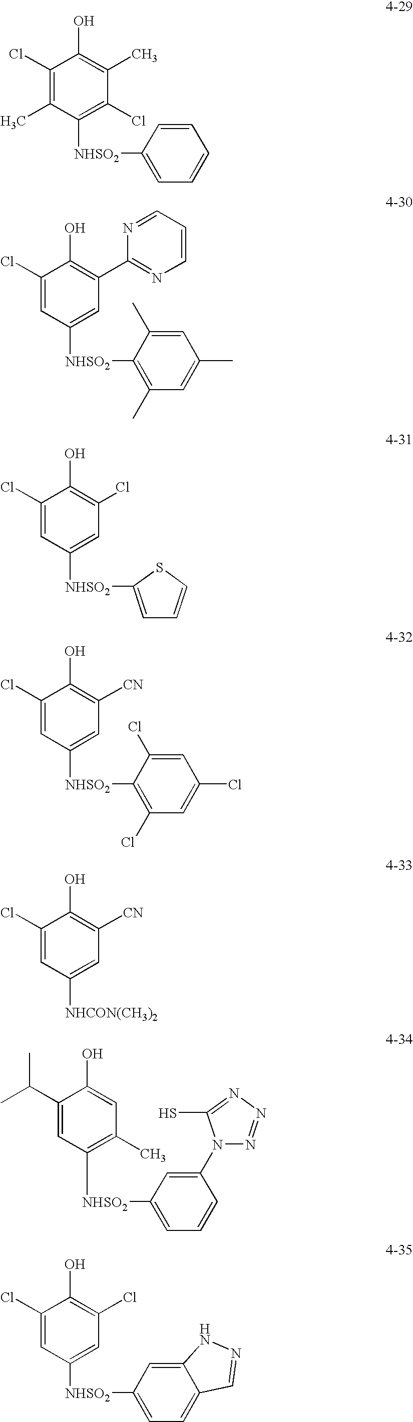

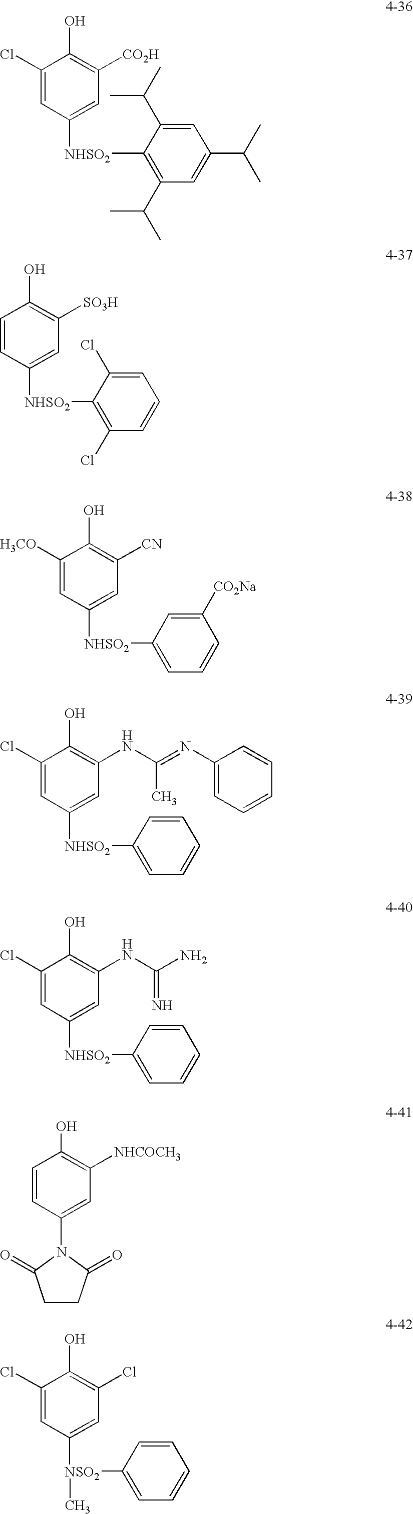

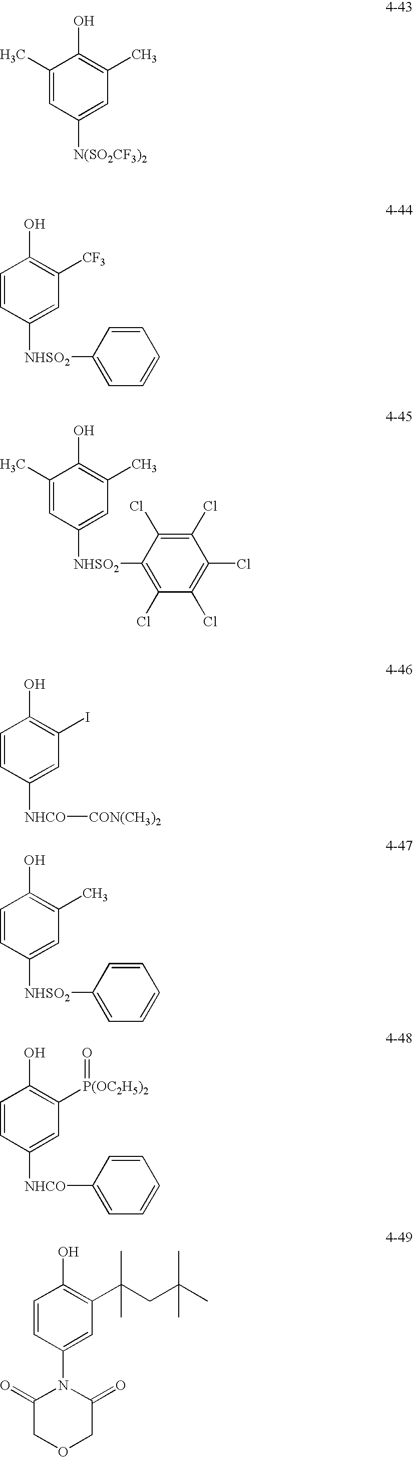

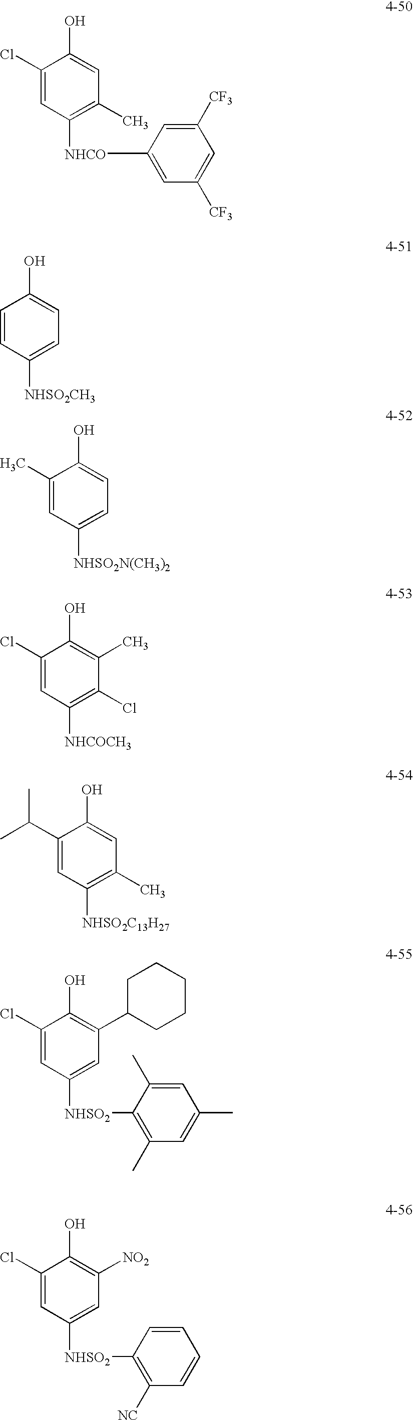

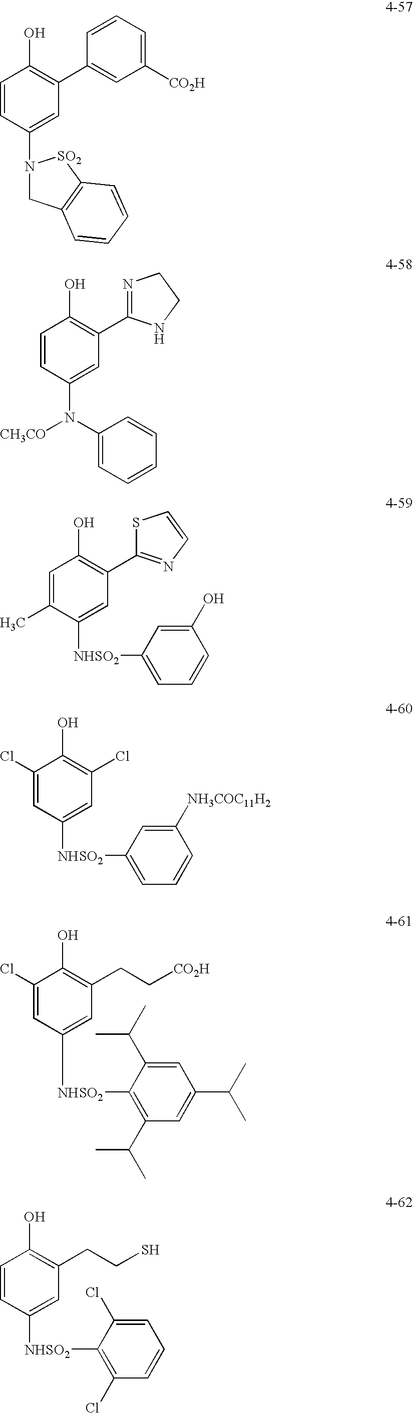

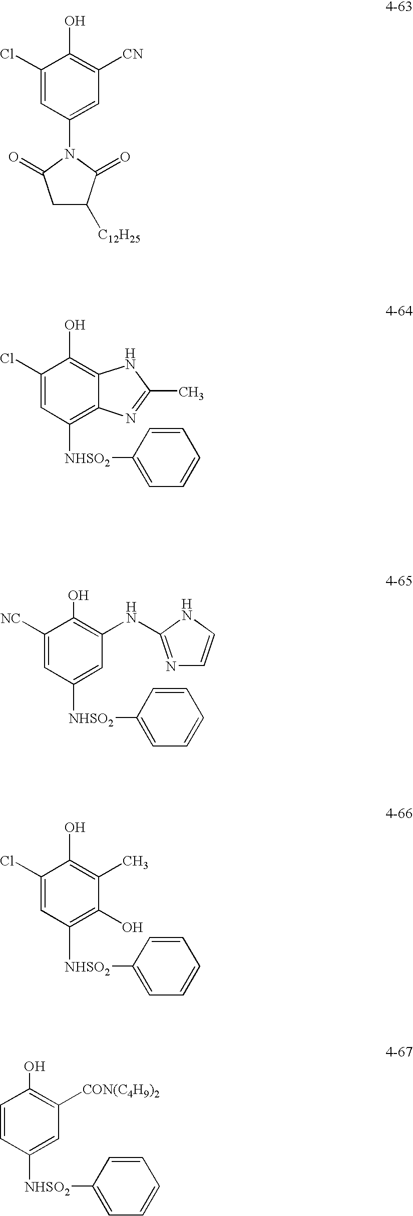

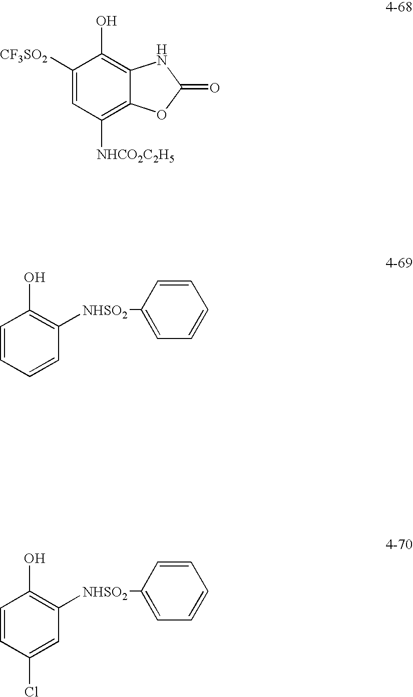

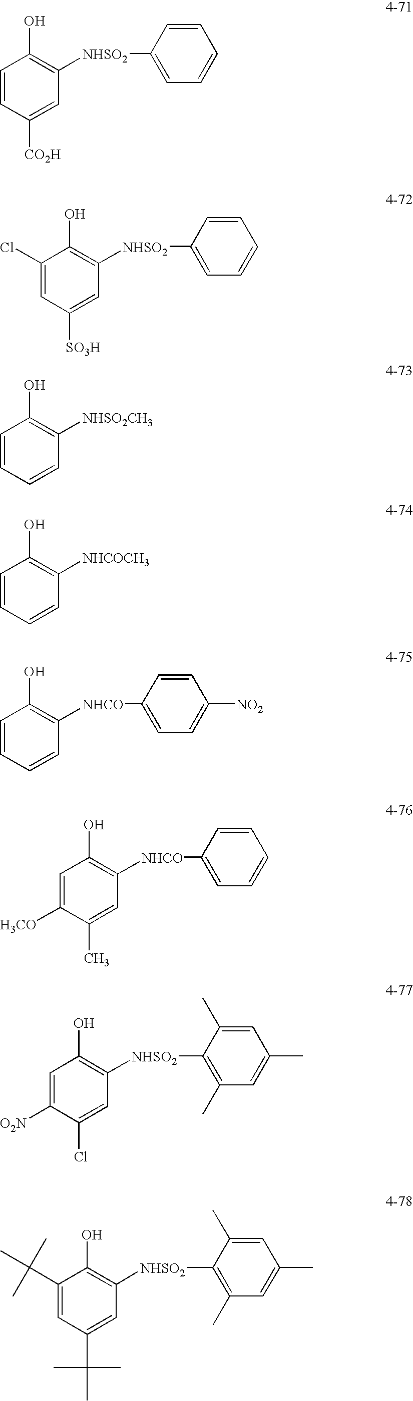

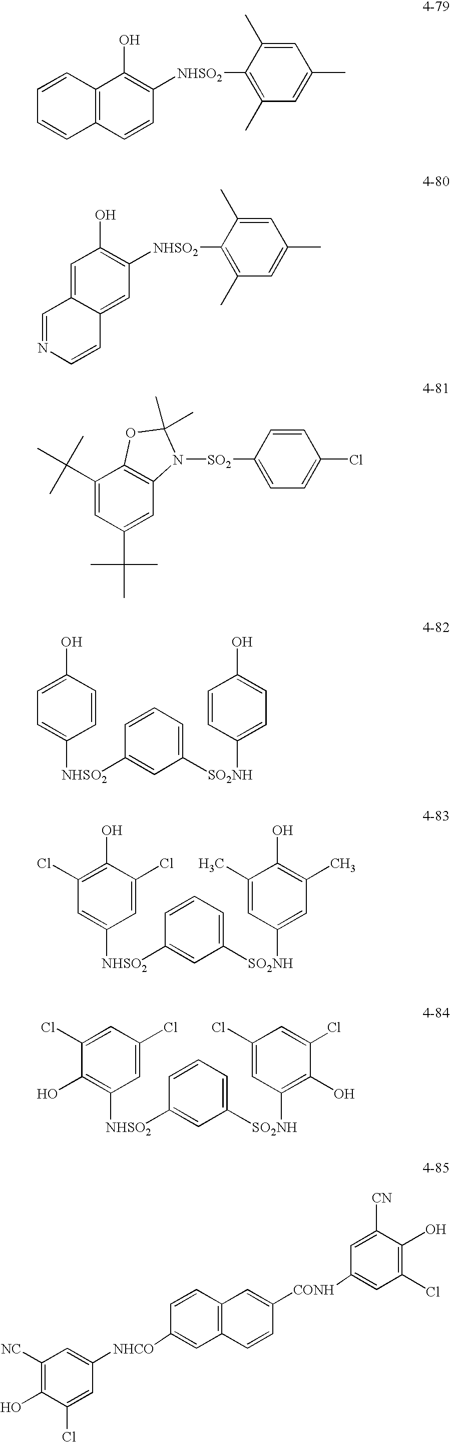

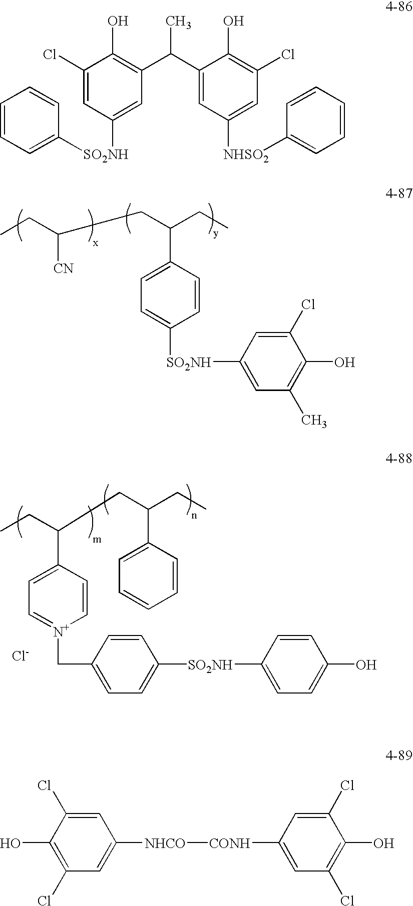

The development accelerator represented by formula (5) will be described below.

In formula (5), X⁵¹ represents a substituent (X⁵¹ is a substituent capable of substituting for a hydrogen atom on the benzene ring, and is not a hydrogen atom.). However, X⁵¹ is not a hydroxyl group. Examples of the substituent include halogen atoms, alkyl groups (including cycloalkyl and bicycloalkyl groups), alkenyl groups (including cycloalkenyl groups and bicycloalkenyl groups), alkynyl groups, aryl groups, heterocyclic groups, cyano groups, nitro groups, carboxyl groups, alkoxy groups, aryloxy groups, silyloxy groups, heterocyclic groups, acyloxy groups, carbamoyloxy groups, alkoxycarbonyloxy groups, aryloxycarbonyloxy groups, acylamino groups, aminocarbonylamino groups, alkoxycarbonylamino groups, aryloxycarbonylamino groups, sulfamoylamino groups, alkyl and arylsulfonylamino groups, mercapto groups, alkylthio groups, arylthio groups, heterocyclic thio groups, sulfamoyl groups, sulfo groups, alkyl and arylsulfinyl groups, alkyl and arylsulfonyl groups, acyl groups, aryloxycarbonyl groups, alkoxycarbonyl groups, carbamoyl groups, aryl and heterocyclic azo groups, imide groups, phosphino groups, phosphinyl groups, phosphinyloxy groups, phosphinylamino groups and silyl groups.

In more detail, X⁵¹ represents a halogen atom (a fluorine, a chlorine, a bromine or an iodine atom), or a linear, branched, cyclic, substituted or non-substituted alkyl group. These groups are alkyl groups (preferably alkyl groups having 1 to 30 carbon atoms; for example methyl, ethyl, n-propyl, isopropyl, tert-butyl, n-octyl, eicosyl, 2-chloroethyl, 2-cyanoethyl or 2-ethylhexyl group), cycloalkyl groups (preferably substituted or non-substituted cycloalkyl groups having 3 to 30 carbon atoms; for example cyclohexyl, cyclopentyl or 4-n-dodecylcyclohexyl groups), and bicycloalkyl groups (preferably a substituted or non-substituted bicycloalkyl group having 5 to 30 carbon atoms, that is a monovalent group after eliminating one hydrogen atom from a bicycloalkane having 5 to 30 carbon atoms). For example, they include a bicyclo[1,2,2]heptne-2-yl group, a bicyclo[2,2,2]octane-3-yl group, a octane-3-yl group, and tricyclo structures having a larger number of cyclic structures. The alkyl groups in the substituents described below (for example the alkyl group in the alkylthio group) also represent alkyl groups in this category. The alkenyl groups represent substituted or non-substituted linear, branched or cyclic alkenyl groups. They are alkenyl groups (preferably substituted or non-substituted alkenyl groups having 2 to 30 carbon atoms; for example vinyl, aryl, prenyl, geranyl or oleyl groups) or cycloalkenyl groups (preferably substituted or non-substituted cycloalkenyl groups having 3 to 30 carbon atoms, those are monovalent groups after eliminating one hydrogen atom from a cycloalkene having 3 to 30 carbon atoms). They are, for example, a 2-cyclopentene-1-yl group, a 2-cyclohexene-1-yl group, a bicycloalkenyl group (a substituted or non-substituted bicycloalkenyl group, preferably a substituted or non-substituted bicycloalkenyl group having 5 to 30 carbon atoms, that is a monovalent group after eliminating one hydrogen atom from a bicycloalkene group having one double bond). They include, for example, a bicyclo[2,2,1]hepto-2-ene-1-yl group, a bicyclo[2,2,2]octo-2-ene-4-yl group, and alkynyl groups (preferably substituted or non-substituted alkynyl groups having 2 to 30 carbon atoms; for example ethynyl, propargyl and trimethylsilylethynyl groups), aryl groups (preferably a substituted or non-substituted aryl group having 6 to 30 carbon atoms; for example phenyl, p-tolyl, naphthyl, m-chlorophenyl, and o-hexadecanoyl aminophenol groups), and heterocyclic groups (preferably monovalent groups obtained by eliminating one hydrogen atom from substituted or non-substituted, aromatic or non-aromatic heterocyclic groups having 3 to 30 carbon atoms, more preferably 5- or 6-membered aromatic heterocyclic groups having 3 to 30 carbon atoms). Examples of the group include a 2-furyl group, a 2-thienyl group, a 2-pyrimidinyl group, a 2-benzothiazolyl group, a cyano group, a nitro group, a carboxyl group, an alkoxy group (preferably a substituted or non-substituted alkoxy group having 1 to 30 carbon atoms; for example methoxy, ethoxy, isopropoxy, tert-butoxy, n-octyloxy, and 2-methoxyethoxy groups), aryloxy groups (preferably a substituted or non-substituted aryloxy group having 6 to 30 carbon atoms; for example phenoxy, 2-methylphenoxy, 4-tert-butylohenoxy, 3-nitrophenoxy, and 2-tetradecanoylaminophenoxy groups), silyloxy groups (preferably a silyloxy group having 3 to 20 carbon atoms; for example trimethylsilyloxy and tert-butyldimethylsilyloxy groups), heterocyclic oxy groups (preferably a substituted or non-substituted heterocyclic oxy group having 2 to 30 carbon atoms, for example 1-phenylnatorazole-5-oxy and 2-tetrahydropyranyloxy groups), acyloxy group (preferably a formyloxy group, a substituted or non-substituted alkoxycarbonyloxy group having 2 to 30 carbon atoms and a substituted or non-substituted arylcarbonyloxy group having 6 to 30 carbon atoms; for example formyloxy, acetyloxy, pyvaloyloxy, stearoyloxy, benzoyloxy and p-methoxyphenylcarbonyloxy groups), carbamoyloxy groups (preferably a substituted or non-substituted carbamoyloxy group having 1 to 30 carbon atoms, for example N,N-dimethylcarbamoyloxy, N,N-diethylcarbamoyloxy, morphorinocarbonyloxy, N,N-di-n-octylaminocarbonyloxy, and N-n-octylcarbamoyloxy groups), alkoxycarbonyloxy groups (preferably a substituted or non-substituted alkoxycarbonyloxy group having 2 to 30 carbon atoms; for example methoxycarbonyloxy, ethoxycarbonyloxy, tert-butoxycarbonyloxy, and n-octylcarbonyloxy groups), aryloxycarbonyloxy groups (preferably a substituted or non-substituted alkoxycarbonyloxy group having 7 to 30 carbon atoms; for example phenoxycarbonyloxy, p-methoxyphenoxycarbonyloxy, and p-n-hexadecyloxyphenoxycarbonyloxy groups), acylamino groups (preferably a formylamino group, a substituted or non-substituted arkylcarbonylamino group having 1 to 30 carbon atoms, a substituted or non-substituted arylcarbonylamino group having 6 to 30 carbon atoms; for example formylamino, acetylamino, pyvaloylamino, lauroylamino, benzoylamino, and 3,4,5-tri-n-octyloxyphenylcarbonylamino groups), aminocarbonylamino groups (preferably a substituted or non-substituted aminocarbonylamino group having 1 to 30 carbon atoms; for example carbamoylamino, N,N-diethylaminocarbonylamino, N,N-diethylaminocarbonylamino, and morpholinocarbonylamino groups), alkoxycarbonylamino groups (preferably a substituted or non-substituted alkoxycarbonylamino group having 2 to 30 carbon atoms; for example methoxycarbonylamino, ethoxycarbonylamino, tert-butoxycarbonylamino, n-octadecyloxycarbonylamino, and N-methyl-methoxycarbonylamino groups), aryloxycarbonylamino groups (preferably a substituted or non-substituted aryloxycarbonylamino group having 7 to 30 carbon atoms; for example phenoxycarbonylamino, p-chlorophenoxycarbonylamino, and m-n-octyloxyphenoxycarbonylamino groups), sulfamoylamino groups (preferably a substituted or non-substituted sulfamoylamino group having 0 to 30 carbon atoms; for example sulfamoylamino, N,N-dimethylaminosulfonylamino, and N-n-octylaminosulfonylamino groups), alkyl and arylsulfonylamino groups (preferably a substituted or non-substituted alkylsulfonylamino group having 1 to 30 carbon atoms, and a substituted or non-substituted arylsulfonylamino group having 6 to 30 carbon atoms; for example methylsulfonylamino, butylsulfonylamino, phenylsulfonylamino, 2,3,5-trichlorophenylsulfonylamino, and p-methylphenylsulfonylamino groups), a mercapto group, alkylthio groups (preferably a substituted or non-substituted alkylthio group having 1 to 30 carbon atoms; for example methylthio, ethylthio, and n-hexadecylthio groups), arylthio groups (preferably a substituted or non-substituted arylthio group having 6 to 30 carbon atoms; for example phenylthio, p-chlorophenylthio, and m-methoxyphenylthio groups), heterocyclic thio groups (preferably a substituted or non-substituted heterocyclic thio group having 2 to 30 carbon atoms; for example 2-benzothiazolyl, and 1-phenyltetrazole-5-yl thio groups), sulfamoyl groups (preferably a substituted or non-substituted sulfamoyl group having 0 to 30 carbon atoms; for example N-ethylsulfamoyl, N-(3-dodecyloxypropyl)sulfamoyl, N,N-dimethylsulfamoyl, N-acetylsulfamoyl, N-benzoylsulfamoyl, and N—(N′-phenylcarbamoyl)sulfamoyl groups), a sulfo group, alkyl and arylsulfinyl groups (preferably a saturated or non-saturated alkylsulfinyl group having 1 to 30 carbon atoms, and a saturated or non-saturated arylsulfinyl group having 6 to 30 carbon atoms; for example, methylsulfinyl, ethylsulfinyl, phenylsulfinyl, and p-methylphenylsulfinyl groups), alkyl and aryl sulfonyl groups (preferably a substituted or non-substituted alkylsulfonyl group having 1 to 30 carbon atoms, and a substituted or non-substituted arylsulfonyl group having 6 to 30 carbon atoms; for example methylsulfonyl, ethylsulfonyl, phenylsulfonyl, and p-methylphenylsulfonyl groups), acyl groups (preferably a formyl group, a substituted or non-substituted alkylcarbonyl group having 2 to 30 carbon atoms, a substituted or non-substituted arylcarbonyl group having 7 to 30 carbon atoms, and a heterocyclic carbonyl group bonded to a substituted or non-substituted carbonyl group having 4 to 30 carbon atoms; for example acetyl, pyvaloyl, 2-chloroacetyl, stearoyl, benzoyl, p-n-octylphenoxyphenylcarbonyl, 2-pyridylcarbonyl and 2-furylcarbonyl groups), aryloxycarbonyl groups (preferably a substituted or non-substituted aryloxycarbonyl group having 7 to 30 carbon atoms; for example phenoxycarbonyl, o-chlorophenoxycarbonyl, m-nitro phenoxycarbonyl, and p-tert-butylphenoxycarbonyl groups), alkoxycarbonyl groups (preferably a substituted or non-substituted alkoxycarbonyl group having 2 to 30 carbon atoms; for example methoxycarbonyl, ethoxycarbonyl, tert-butoxycarbonyl, and n-octadecyloxycarbonyl groups,), carbamoyl groups (preferably a substituted or non-substituted carbamoyl group having 5 to 30 carbon atoms; for example a carbamoyl group, an N-methylcarbamoyl group, an N,N-dimethylcarbamoyl group, an N,N-di-n-octylcarbamoyl group, and an N-(methylsulfonyl)carbamoyl group), aryl and heterocyclic azo groups (preferably a substituted or non-substituted arylazo group having 6 to 30 carbon atoms, and a substituted or non-substituted heterocyclic azo group having 3 to 30 carbon atoms; for example phenyazo, p-chlorophenylazo, and 5-ethylthio-1,3,4-thiadiazole-2-yl azo groups), imide groups (preferably an N-succimide group and an N-phthalimide group), phosphino groups (preferably a substituted or non-substituted phosphino group having 2 to 30 carbon atoms; for example dimethylphosphino, diethylphosphino, and methylphenoxyphosphino groups,), phosphinyl groups (preferably a substituted or non-substituted phosphinyl group having 2 to 30 carbon atoms; for example phosphinyl, dioctyloxyphosphinyl, and diethoxyphosphinyl groups), phosphinyloxy groups (preferably a substituted or non-substituted phosphinyloxy group having 2 to 30 carbon atoms; for example diphenoxyphosphinyloxy, and dioctylphosphinyloxy groups), phosphinylamino groups (preferably a substituted or non-substituted phosphinylamino group having 2 to 30 carbon atoms; for example dimethoxyphosphinylamino, and dimethylaminophosphinylamino groups), and silyl groups (preferably a substituted or non-substituted silyl group having 3 to 30 carbon atoms; for example trimethylsilyl group, tert-butyldimethylsilyl and phenyldimethylsilyl groups).

Preferable substituent represented by X⁵¹ in formula (5) is a halogen atom (fluorine, chlorine, bromine and iodine atom, preferably chlorine and bromine atom), an acylamino group (preferably having 1 to 20 carbon atoms, more preferably having 1 to 14 carbon atoms, and particularly preferably having 1 to 8 carbon atoms; for example formylamino, acetylamino and benzoylamino group), an alkyl group (having preferably 1 to 20 carbon atoms, more preferably 1 to 14 carbon atoms, and particularly preferably 1 to 8 carbon atoms; for example methyl, ethyl, isopropyl, and cyclohexyl group), an aryl group (having preferably 6 to 20 carbon atoms, more preferably 6 to 14 carbon atoms, and particularly preferably 6 to 8 carbon atoms; for example phenyl, naphthyl, and p-methylphenyl group), an alkoxy group (having preferably 1 to 20 carbon atoms, more preferably 1 to 14 carbon atoms, and particularly preferably 1 to 8 carbon atoms; for example methoxy and ethoxy group), an aryloxy group (having preferably 6 to 20 carbon atoms, more preferably 6 to 14 carbon atoms, and particularly preferably 6 to 8 carbon atoms; for example phenoxy and 2-naphthyloxy group), an acyloxy group (having preferably 1 to 20 carbon atoms, more preferably 1 to 14 carbon atoms, and particularly preferably 1 to 8 carbon atoms; for example acetoxy and benzoyloxy group), a sulfonylamino group (having preferably 1 to 20 carbon atoms, more preferably 1 to 14 carbon atoms, and particularly preferably 1 to 8 carbon atoms; for example methanesulfonylamino and benzenesulfonylamino group), a carbamoyl group (having preferably 1 to 20 carbon atoms, more preferably 1 to 14 carbon atoms, and particularly preferably 1 to 8 carbon atoms; for example carbamoyl, N,N-dimethylcarbamoyl, and N-phenylcarbamoyl group), an acyl group (having preferably 1 to 20 carbon atoms, more preferably 1 to 14 carbon atoms, and particularly preferably 1 to 8 carbon atoms; for example formyl, acetyl and benzoyl group), an alkoxycarbonyl group (having preferably 2 to 20 carbon atoms, more preferably 2 to 16 carbon atoms, and particularly preferably 2 to 12 carbon atoms; for example methoxycarbonyl, ethoxycarbonyl and butoxycarbonyl group), an aryloxycarbonyl group (having preferably 6 to 20 carbon atoms, more preferably 6 to 16 carbon atoms, and particularly preferably 6 to 12 carbon atoms; for example phenoxycarbonyl, and 2-naphthyloxycarbonyl group), a cyano group and a nitro group. More preferable substituent is a halogen atom and an acylamino group, and particularly preferable, a chlorine atom and a bromine atom.

X⁵³ represents a hydrogen atom or a substituent in formula (5). However, X⁵³ is neither the hydroxyl group nor the sulfonamide group. Examples of the substituent represented by X⁵³ are the same as the examples of the substituent X⁵¹ in formula (5) except the sulfonamide group. Preferable examples of X⁵³ include a hydrogen atom, halogen atoms (fluorine, chlorine, bromine and iodine atom preferably chlorine and bromine atoms), an acylamino group (having preferably 1 to 20 carbon atoms, more preferably 1 to 14 carbon atoms, and particularly preferably 1 to 8 carbon atoms; for example formylamino, acetylamino and benzoylamino group), an alkyl group (having preferably 1 to 20 carbon atoms, more preferably 1 to 14 carbon atoms, and particularly preferably 1 to 8 carbon atoms; for example methyl, ethyl, isopropyl and cyclohexyl groups), an aryl group (having preferably 6 to 20 carbon atoms, more preferably 6 to 14 carbon atoms, and particularly preferably 6 to 8 carbon atoms; for example phenyl, naphthyl and p-methylphenyl group), an alkoxy group (having preferably 1 to 20 carbon atoms, more preferably 1 to 14 carbon atoms, and particularly preferably 1 to 8 carbon atoms; for example methoxy and ethoxy group), an aryloxy group (having preferably 6 to 20 carbon atoms, more preferably 6 to 14 carbon atoms, and particularly preferably 6 to 8 carbon atoms; for example phenoxy and 2-naphthyloxy group), an acyloxy group (having preferably 1 to 20 carbon atoms, more preferably 1 to 14 carbon atoms, and particularly preferably 1 to 8 carbon atoms; for example acetoxy and benzoyloxy group), carbamoyl group (having preferably 1 to 20 carbon atoms, more preferably 1 to 14 carbon atoms, and particularly preferably 1 to 8 carbon atoms; for example carbamoyl, N,N-dimethylcarbamoyl and N-phenylcarbamoyl group), an acyl group (having preferably 1 to 20 carbon atoms, more preferably 1 to 14 carbon atoms, and particularly preferably 1 to 8 carbon atoms; for example formyl, acetyl and benzoyl group), an alkoxycarbonyl group (having preferably 2 to 20 carbon atoms, more preferably 2 to 16 carbon atoms, and particularly preferably 2 to 12 carbon atoms; for example methoxycarbonyl, ethoxycarbonyl and butoxycarbonyl group), an aryloxycarbonyl group (having preferably 6 to 20 carbon atoms, more preferably 6 to 16 carbon atoms, and particularly preferably 6 to 12 carbon atoms; for example phenoxycarbonyl and 2-naphthyloxycarbonyl group), a cyano group and a nitro group. Among these, halogen atoms, an acylamino group or an alkyl group is more preferable, and particularly preferable is chlorine atom or bromine atom.

At least one of the substituents represented by X⁵¹ and X⁵¹ in formula (5) is preferably electron attractive. The electron attractive group has a positive Hammett's substituent constant σρ, and examples thereof include a halogen atom, a cyano group, a nitro group, an alkoxycarbonyl group, an aryloxycarbonyl group, an imino group, an imino group substituted with Nitrogen atom, a chiocarbonyl group, a perfluoroalkyl group, a sulfonamide group, a formyl group, a phosphoryl group, a carboxyl group, a carbamoyl group, an acyl group, a sulfo group (or salts thereof), an alkylsulfonyl group, an arylsulfonyl group, a sulfamoyl group, an acyloxy group, an acylthio group, a sulfonyloxy group, a heterocyclic group, and an aryl group substituted with these electron attractive groups. More preferably, both of X⁵¹ and X⁵¹ are electron attractive groups, further preferably halogen atoms, and particularly preferably chlorine atoms or bromine atoms.

X⁵² and X⁵⁴ in formula (5) each represent a hydrogen atom or a substituent. However, X⁵² and X⁵⁴ are not hydroxyl groups. Examples of these substituents are the same as the examples of X⁵¹. Preferable examples of X⁵² and X⁵⁴ include a hydrogen atom, halogen atoms (fluorine, chlorine, bromine and iodine atoms, preferably chlorine and bromine atoms), acylamino groups (having preferably 1 to 20 carbon atoms, more preferably 1 to 14 carbon atoms and particularly preferably 1 to 8 carbon atoms; for example formylamino, acetylamino, and benzoylamino groups), alkyl groups (having preferably 1 to 20 carbon atoms, more preferably 1 to 14 carbon atoms and particularly preferably 1 to 8 carbon atoms; for example methyl, ethyl, isopropyl and cyclohexyl groups), aryl groups (having preferably 6 to 20 carbon atoms, more preferably 6 to 14 carbon atoms and particularly preferably 6 to 8 carbon atoms; for example phenyl, naphthyl and p-methylphenyl groups), alkoxy groups (having preferably 1 to 20 carbon atoms, more preferably 1 to 14 carbon atoms and particularly preferably 1 to 8 carbon atoms; for example methoxy and ethoxy groups), aryloxy groups (having preferably 6 to 20 carbon atoms, more preferably 6 to 14 carbon atoms and particularly preferably 6 to 8 carbon atoms; for example phenoxy and 2-naphthyloxy groups), acyloxy groups (having preferably 1 to 20 carbon atoms, more preferably 1 to 14 carbon atoms and particularly preferably 1 to 8 carbon atoms; for example acetoxy and benzoyloxy groups), sulfonylamino groups (having preferably 1 to 20 carbon atoms, more preferably 1 to 14 carbon atoms and particularly preferably 1 to 8 carbon atoms; for example methanesulfonyl group and benzenesulfonylamino group), carbamoyl groups (having preferably 1 to 20 carbon atoms, more preferably 1 to 14 carbon atoms and particularly preferably 1 to 8 carbon atoms; for example carbamoyl, N,N-dimethylcarbamoyl and N-phenylcarbamoyl groups), acyl group (having preferably 1 to 20 carbon atoms, more preferably 1 to 14 carbon atoms and particularly preferably 1 to 8 carbon atoms; for example formyl, acetyl and benzoyl groups), alkoxycarbonyl groups (having preferably 2 to 20 carbon atoms, more preferably 2 to 16 carbon atoms and particularly preferably 2 to 12 carbon atoms; for example methoxycarbonyl, ethoxycarbonyl and butoxycarbonyl groups), aryloxycarbonyl groups (having preferably 6 to 20 carbon atoms, more preferably 6 to 16 carbon atoms and particularly preferably 6 to 12 carbon atoms; for example phenoxycarbonyl and 2-naphthyloxycarbonyl groups), a cyano group and a nitro group. More preferable are hydrogen atoms, alkyl groups, aryl groups, halogen atoms and acylamino groups, particularly preferable are hydrogen atoms, methyl groups and ethyl groups.

X⁵¹ to X⁵⁴ in formula (5) may be substituted, and examples of the substituents include those in X⁵¹ in formula (5). X⁵¹ to X⁵⁴ may be linked with each other to form a ring.

R⁵¹ in formula (5) represents a hydrogen atom, an alkyl group (having preferably 1 to 20 carbon atoms, more preferably 1 to 14 carbon atoms, and particularly preferably 1 to 7 carbon atoms; for example methyl, ethyl, isopropyl and cyclohexyl group), an aryl group (having preferably 6 to 20 carbon atoms, more preferably 6 to 14 carbon atoms, and particularly preferably 6 to 8 carbon atoms; for example phenyl, naphthyl and p-methylphenyl group), a heterocyclic group (for example pyrimidyl, imidazoly and pyrrolidyl group), an amino group (having preferably 0 to 20 carbon atoms, more preferably 0 to 14 carbon atoms, and particularly preferably 0 to 8 carbon atoms; for example amino, methylamino, N,N-dimethylamino and N-phenylamino group), and an alkoxy group (having preferably 1 to 20 carbon atoms, more preferably 1 to 14 carbon atoms, and particularly preferably 1 to 8 carbon atoms; for example methoxy and ethoxy group). The substituent is preferably a hydrogen atom, an aryl group, a heterocyclic group, an amino group, an alkoxy group and an alkyl group having 1 to 7 carbon atoms, more preferably an aryl group and an alkyl group having 1 to 7 carbon atoms, and particularly preferably an aryl group. R⁵¹ may be substituted, and examples of the substituent are the same as described for the substituents in X⁵¹ in formula (5).

In a preferable combination of X⁵¹ to X⁵⁴ and R⁵¹ in formula (5), any least one of X⁵′ and X⁵³ is a halogen atom, X⁵² and X⁵⁴ are hydrogen atoms or alkyl groups, and R⁵¹ is an aryl group or alkyl group having 1 to 7 carbon atoms. In a more preferable combination, both X⁵¹ and X⁵³ are chlorine atoms or bromine atoms, X⁵² is a hydrogen atom or an alkyl group, X⁵⁴ is a hydrogen atom, and R⁵¹ is an aryl group.

The total molecular weight of the compound represented by formula (5) is preferably in the range of 170 to 800, more preferably 220 to 650, and particularly preferably 220 to 500.

While examples of the compound represented by formula (5) are listed below, the invention is not restricted to these examples.

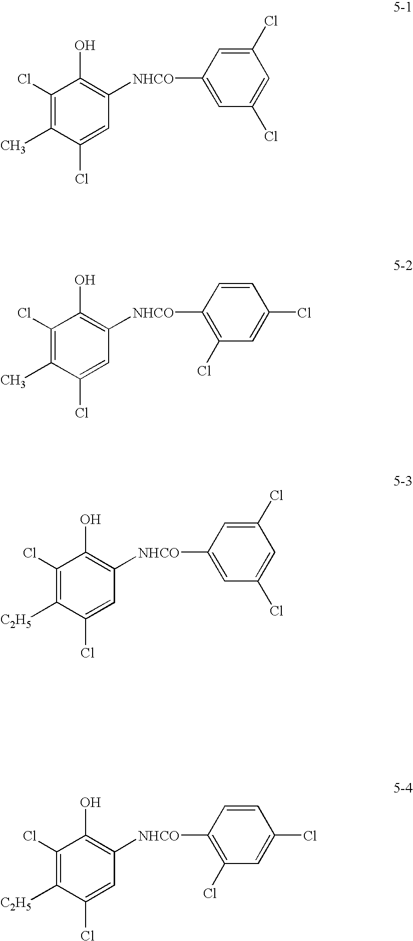

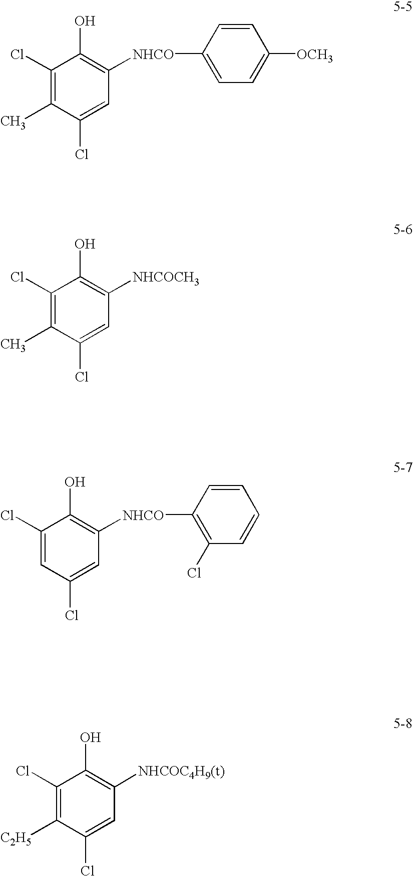

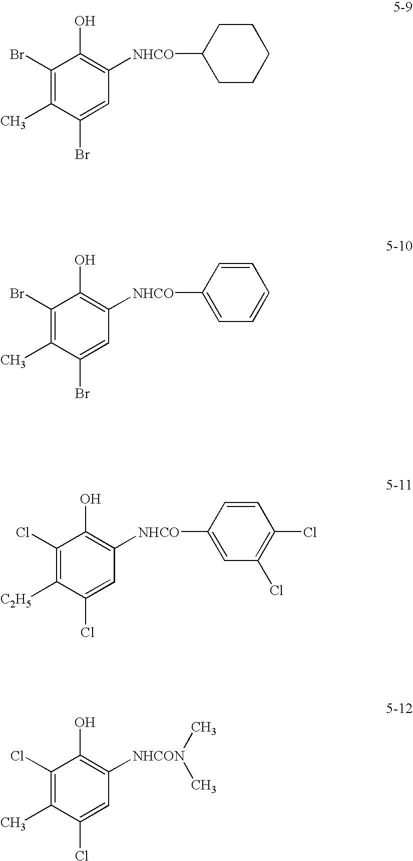

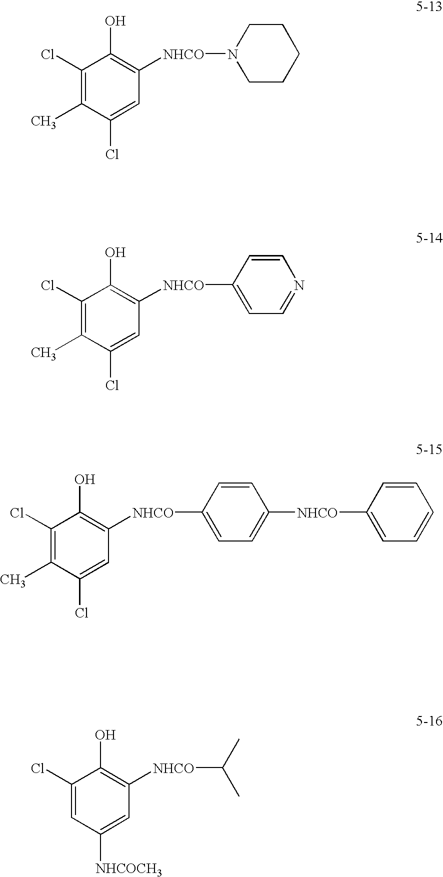

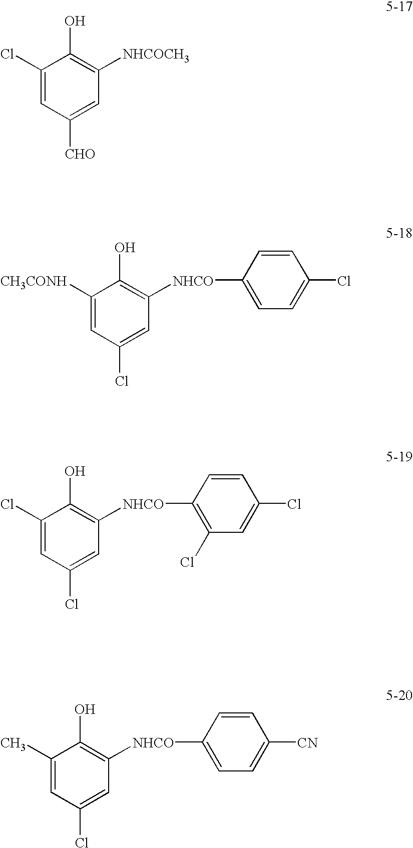

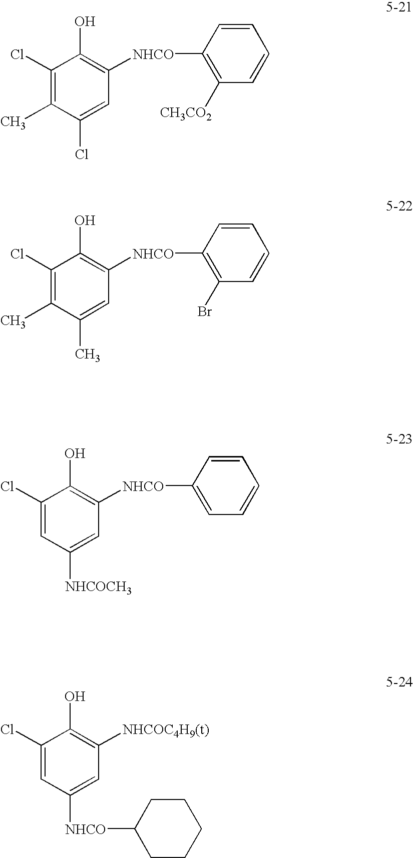

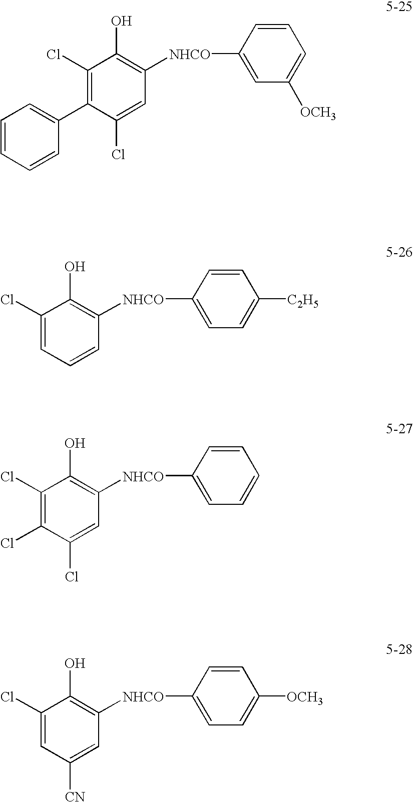

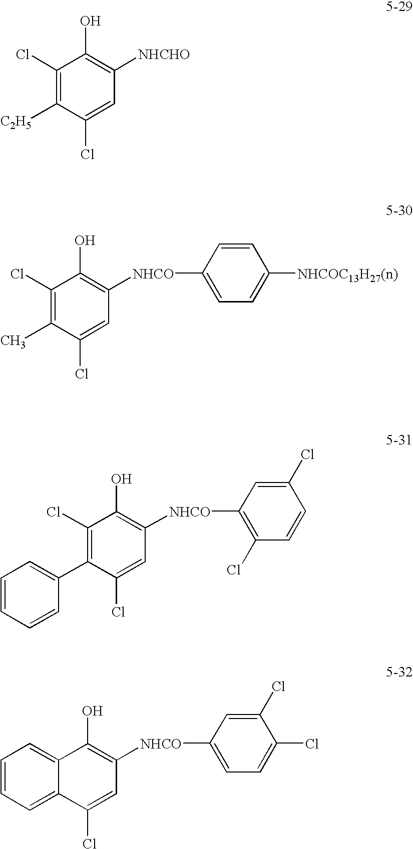

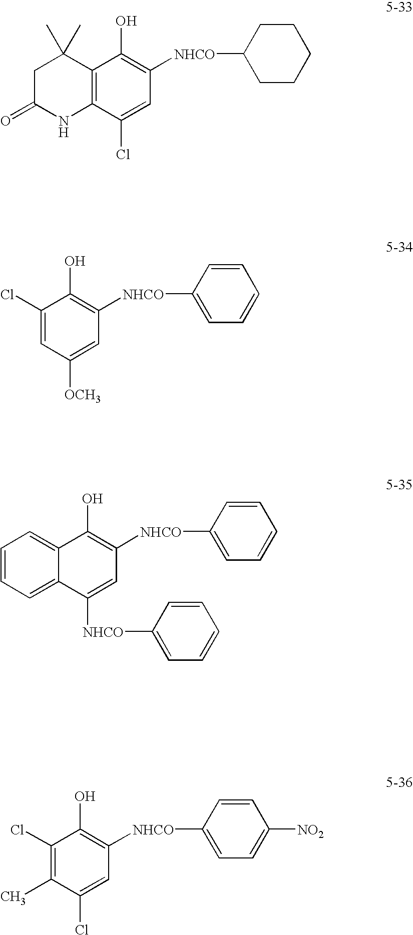

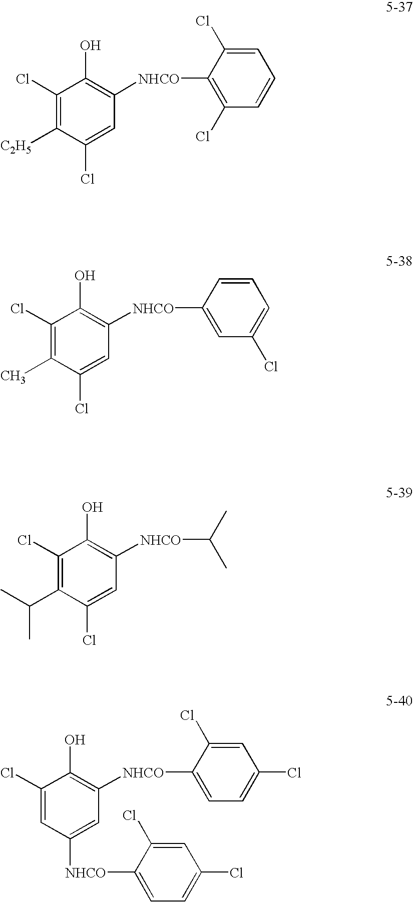

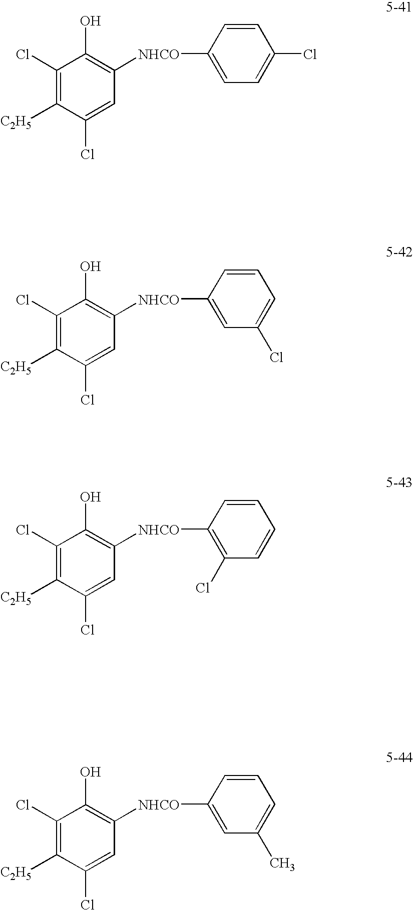

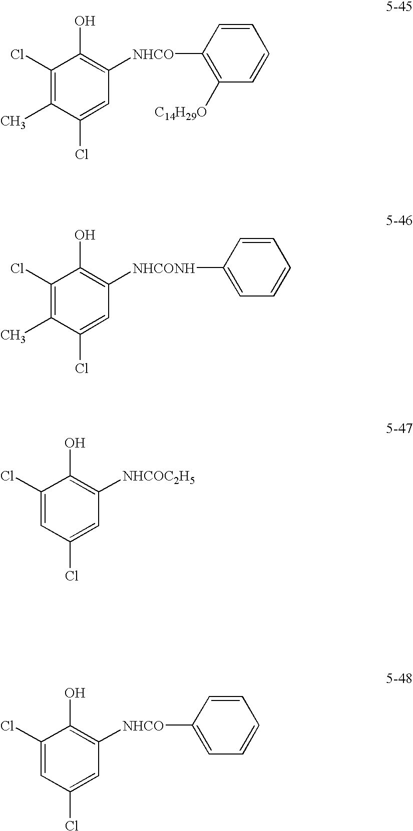

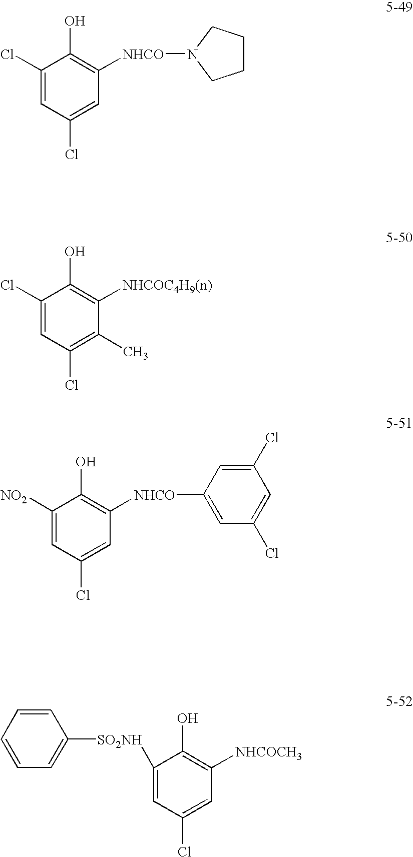

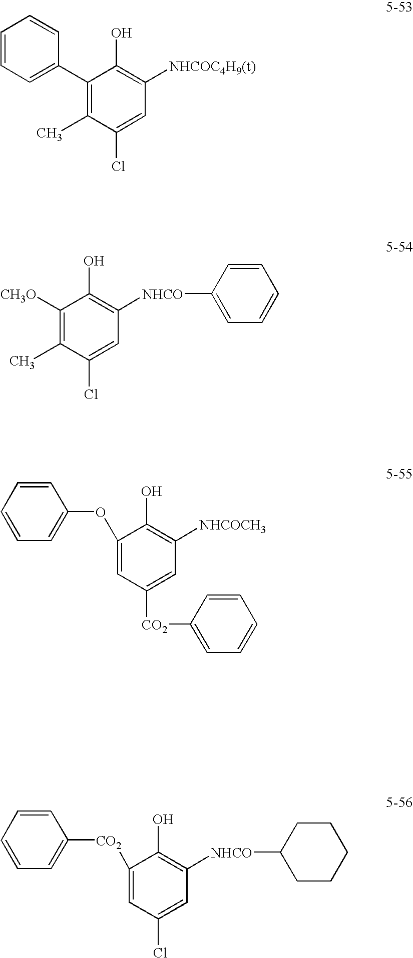

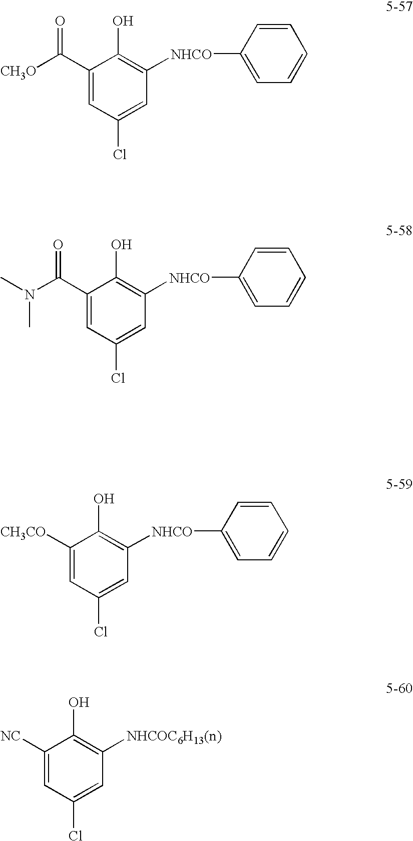

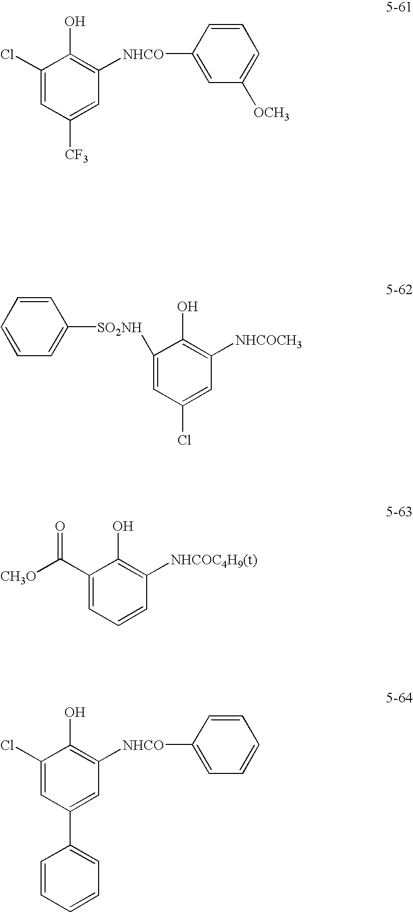

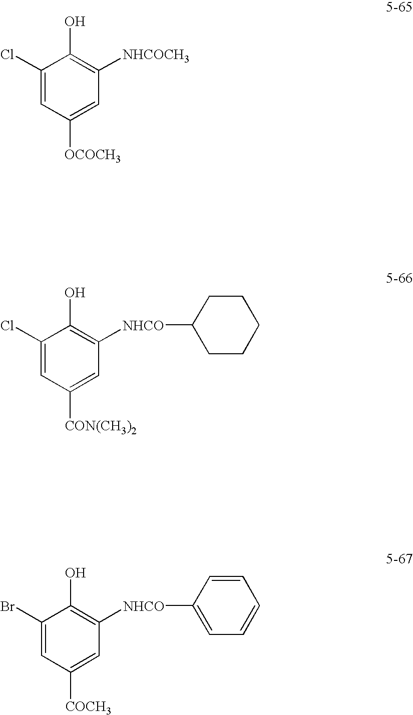

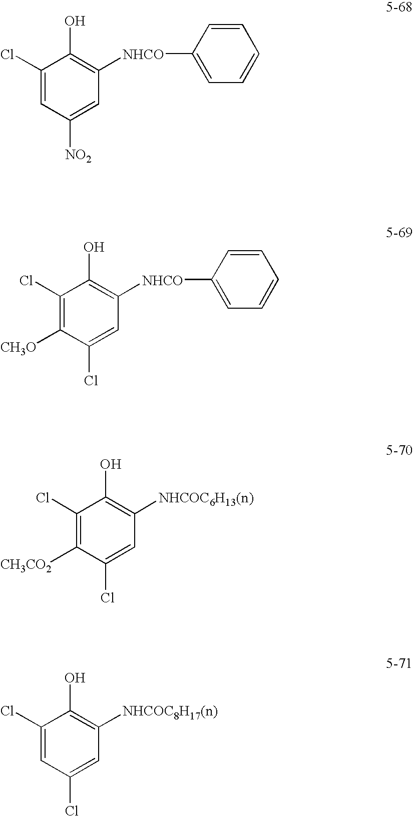

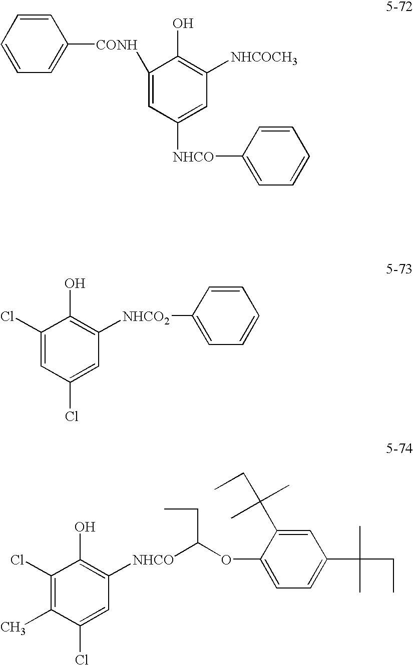

The compound represented by formula (3) is more preferably a compound represented by formula (6).

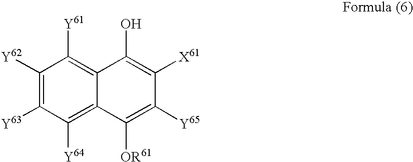

The compound represented by formula (6) will be described below.

In formula (6), R⁶¹ represents an alkoxy group, an aryl group, an alkenyl group and an alkynyl group, and X⁶¹ represents an acyl group, an alkoxycarbonyl group, a carbamoyl group, a sulfonyl group and a sulfamoyl group. Y⁶¹ to Y⁶¹ each independently represent a hydrogen atom or a substituent.

The alkyl group represented by R⁶¹ in formula (6) preferably is a linear, branched or cyclic alkyl group or a combination thereof having 1 to 30 carbon atoms, more preferably 1 to 16 carbon atoms, and particularly preferably 1 to 13 carbon atoms. Examples thereof are a methyl group, an ethyl group, an n-propyl group, an iso-propyl group, an n-butyl group, a sec-butyl group, a t-butyl group, an n-hexyl group, a cyclohexyl group, an n-octyl group, a t-octyl group, an n-amyl group, a t-amyl group, an n-decyl group, an n-dodecyl group, an n-tridecyl group, a benzyl group and a phenethyl group.

The aryl group represented by R⁶¹ in formula (6) preferably has 6 to 30 carbon atoms, more preferably 6 to 20 carbon atoms, and particularly preferably 6 to 12 carbon atoms. Examples of the substituent include a phenyl group, a 4-methylphenyl group, a 2-chlorophenyl group, a 4-chlorophenyl group, a 2,4-dichlorophenyl group, a 3,4-dichlorophenyl group, a 2-methoxyphenyl group, a 4-methoxyphenyl group, a 4-hexylphenyl group, a 2-dodecylphenyl group and an naphthyl group.

The alkenyl group represented by R⁶¹ in formula (6) has 2 to 30 carbon atoms, more preferably 2 to 20 carbon atoms, and particularly preferably 2 to 12 carbon atoms. Examples of the substituents include a vinyl group, an aryl group, isopropenyl group, a butenyl group and a hexenyl group.

The alkynyl group represented by R⁶¹ in formula (6) has 2 to 30 carbon atoms, more preferably 2 to 20 carbon atoms, and particularly 2 to 12 carbon atoms. Examples of the substituent include an ethynyl group and a propynyl group.

R⁶¹ in formula (6) may further has substituents, and examples of the preferable substituent include the substituents represented by Y⁶¹ to Y⁶⁵ in the compound to be described hereinafter represented by formula (6).

R⁶¹ in formula (6) further preferably represents an alkyl group or an aryl group, particularly preferably an alkyl group.

X⁶¹ in formula (6) represents an acyl group, an alkoxycarbonyl group, a carbamoyl group, a sulfonyl group or a sulfamoyl group.

The acyl group represented by X⁶¹ in formula (6) preferably has 2 to 20 carbon atoms, more preferably 2 to 16 carbon atoms, and particularly preferably 2 to 12 carbon atoms. Examples thereof include an acetyl group, a propionyl group, a butyryl group, a valeryl group, a hexanoyl group, a myristyl group, a palmitoyl group, a stearyl group, an oleyl group, an acryloyl group, a cyclohexanecarbonyl group, a benzoyl group, a formyl group and a pivaloyl group.

The alkoxycarbonyl group represented by X⁶¹ in formula (6) preferably has 2 to 20 carbon atoms, more preferably 2 to 16 carbon atoms, and particularly preferably 2 to 12 carbon atoms. Examples thereof include a methoxycarbonyl group, an ethoxycarbonyl group, a butoxycarbonyl group and a phenoxycarbonyl group.

The carbamoyl group represented by X⁶¹ in formula (6) preferably has 1 to 20 carbon atoms, more preferably 1 to 16 carbon atoms, and particularly preferably 1 to 12 carbon atoms. Examples thereof include a carbamoyl group, an N,N-diethylcarbamoyl group, an N-dodecylcarbamoyl group, an N-decylcarbamoyl group, an N-hexadecylcarbamoyl group, an N-phenylcarbamoyl group, an N-(2-chlorophenyl)carbamoyl group, an N-(4-chlorophenyl)carbamoyl group, an N-(2,4-dichlorophenyl)carbamoyl group, an N-(3,4-dichlorophenyl)carbamoyl group, an N-pentachlorophneylcarbamoyl group, an N-(2-methoxyphenyl)carbamoyl group, an N-(4-mehtoxyphenyl)carbamoyl group, an N-(2,4-dimethoxyphenyl)carbamoyl group, an didecyloxyphenyl)carbamoyl group, and an N-(4-dodecyloxyphenyl)carbamoyl group.

The sulfonyl group represented by X⁶¹ in formula (6) preferably has 1 to 20 carbon atoms, more preferably 1 to 16 carbon atoms, and particularly preferably 1 to 12 carbon atoms. Examples thereof include a mesyl group, an ethanesulfonyl group, a cyclohexanesulfonyl group, a benzenesulfonyl group, a tosyl group and a 4-chlotobenzenesulfonyl group.

The sulfamoyl group represented by X⁶¹ in formula (6) preferably has 0 to 20 carbon atoms, more preferably 0 to 16 carbon atoms, and particularly preferably 0 to 12 carbon atoms. Examples thereof include a sulfamoyl group, a methylsulfamoyl group and a dimethylsulfamoyl group.

X⁶¹ in formula (6) may have further substituents, and examples of the preferable substituent are those represented by Y⁶¹ to Y⁶¹ in the compound to be described hereinafter in formula (6).

X⁶¹ in formula (6) preferably represents carbamoyl groups, more preferably alkylcarbamoyl or aryl carbamoyl groups, and particularly preferably an arylcarbamoyl group.

Y⁶¹ to Y⁶⁵ in formula (6) each independently represent a hydrogen atom or a substituent. Any substituents may be used as the substituents represented by Y⁶¹ to Y⁶⁵, so long as they do not adversely affect photographic properties. Examples thereof include halogen atoms (fluorine, chlorine, bromine and iodine atoms), linear, branched or cyclic alkyl groups, or a combination thereof (having preferably 1 to 20 carbon atoms, more preferably 1 to 16 carbon atoms, and particularly preferably 1 to 13 carbon atoms; for example methyl, ethyl, n-propyl, isopropyl, sec-butyl, t-butyl, t-octyl, n-amyl, t-amyl, n-dodecyl, n-tridecyl and cyclohexyl groups), alkenyl groups (having preferably 2 to 20 carbon atoms, more preferably 2 to 16 carbon atoms, and particularly preferably 2 to 12 carbon atoms; for example vinyl, aryl, 2-butenyl and 3-pentenyl groups), aryl groups (having preferably 6 to 30 carbon atoms, more preferably 6 to 20 carbon atoms, and particularly preferably 6 to 12 carbon atoms; for example phenyl, p-methylphenyl and naphthyl groups), alkoxy groups (having preferably 1 to 20 carbon atoms, more preferably 1 to 16 carbon atoms, and particularly preferably 1 to 12 carbon atoms; for example methoxy, ethoxy, propoxy and butoxy groups), aryl groups (having preferably 6 to 30 carbon atoms, more preferably 6 to 20 carbon atoms, and particularly preferably 6 to 12 carbon atoms; for example phenyloxy and 2-naphthyloxy groups), acyloxy groups (having preferably 2 to 20 carbon atoms, more preferably 2 to 16 carbon atoms, and particularly preferably 2 to 12 carbon atoms; for example acetoxy and benzoyloxy groups), amino groups (having preferably 0 to 20 carbon atoms, more preferably 1 to 16 carbon atoms, and particularly preferably 1 to 12 carbon atoms; for example dimethylamino, diethylamino, dibutylamino and anilino groups), acylamino groups (having preferably 2 to 20 carbon atoms, more preferably 2 to 16 carbon atoms, and particularly preferably 2 to 13 carbon atoms; for example acetylamino, tridecanoylamino and benzoylamino groups), sulfonylamino groups (having preferably 1 to 20 carbon atoms, more preferably 1 to 16 carbon atoms, and particularly preferably 1 to 12 carbon atoms; for example methanesulfonylamino, butanesulfonylamino and benzenesulfonylamino groups), ureido groups (having preferably 1 to 20 carbon atoms, more preferably 1 to 16 carbon atoms, and particularly preferably 1 to 12 carbon atoms; for example ureido, methylureido and phenylureido groups), carbamate groups (having preferably 2 to 20 carbon atoms, more preferably 2 to 16 carbon atoms, and particularly preferably 2 to 12 carbon atoms; for example methoxycarbonylamino and phenyloxycarbonylamino groups), carboxyl groups, carbamoyl groups (having preferably 1 to 20 carbon atoms, more preferably 1 to 16 carbon atoms, and particularly preferably 1 to 12 carbon atoms; for example carbamoyl, N,N-diethylcarbamoyl, N-dode cylcarbamoyl and N-phenylcarbamoyl groups), alkoxycarbonyl groups (having preferably 2 to 20 carbon atoms, more preferably 2 to 16 carbon atoms, and particularly preferably 2 to 12 carbon atoms; for example methoxycarbonyl, ethoxycarbonyl and butoxycarbonyl groups), acyl groups (having preferably 2 to 20 carbon atoms, more preferably 2 to 16 carbon atoms, and particularly preferably 2 to 12 carbon atoms; for example acetyl, benzoyl, formyl and pivaloyl groups), sulfo groups, sulfonyl groups (having preferably 1 to 20 carbon atoms, more preferably 1 to 16 carbon atoms, and particularly preferably 1 to 12 carbon atoms; for example mesyl and tosyl groups), sulfamoyl groups (having preferably 0 to 20 carbon atoms, more preferably 0 to 16 carbon atoms, and particularly preferably 0 to 12 carbon atoms; for example sulfamoyl, methylsulfamoyl, dimethylsulfamoyl and phenylsulfamoyl groups), cyano groups, nitro groups, hydroxyl groups, mercapto groups, alkylthio groups (having preferably 1 to 20 carbon atoms, more preferably 1 to 16 carbon atoms, and particularly preferably 1 to 12 carbon atoms; for example methylthio and butylthio groups), and heterocyclic groups (having preferably 2 to 20 carbon atoms, more preferably 2 to 16 carbon atoms, and particularly preferably 2 to 12 carbon atoms; for example pyridyl, imidazoyl and pyrrolidyl groups). These substituents may be further substituted with other substituents.

Preferable substituents represented by Y⁶¹ to Y⁶⁶ in formula (6) are halogen atoms, alkyl groups, aryl groups, alkoxy groups, aryloxy groups, acyloxy groups, anilino groups, acylamino groups, sulfonylamino groups, carboxyl groups, carbamoyl groups, acyl groups, sulfo groups, sulfonyl groups, sulfamoyl groups, cyano groups, hydroxyl groups, mercapto groups, alkylthio groups and heterocyclic groups.

In formula (6), preferable combinations comprise an alkyl group as R⁶¹, a carbamoyl group as X⁶¹, and hydrogen atoms as Y⁶¹ to Y⁶⁵.

While examples of the compound represented by formula (6) are listed below, the invention is not restricted to these examples.

TABLE 5

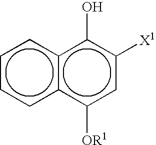

| Compound No. | X¹ | R¹ |
|---|---|---|
| 6-1 | —CONHC₆H₅ | —CH₃ |
| 6-2 | —CONHC₆H₅ | —C₂H₅ |
| 6-3 | —CONHC₆H₅ | —C₃H₇ |
| 6-4 | —CONHC₆H₅ | -i-C₃H₇ |
| 6-5 | —CONHC₆H₅ | —C₄H₉ |
| 6-6 | —CONHC₆H₅ | —C₅H₁₁ |
| 6-7 | —CONHC₆H₅ | —C₆H₁₃ |
| 6-8 | —CONHC₆H₅ | —C—C₆H₁₁ |
| 6-9 | —CONHC₆H₅ | —C₁₀H₂₁ |
| 6-10 | —CONHC₆H₅ | —C₁₂H₂₅ |
| 6-11 | —CONHC₆H₅ | —C₁₆H₃₃ |
| 6-12 | —CONHC₆H₅ | —CH₂C₆H₅ |
| 6-13 | —CONHC₆H₅ | —(CH₂)₂C₆H₅ |
| 6-14 | —CONHC₆H₅ | —(CH₂)₂NHSO₂CH₃ |
| 6-15 | —CONHC₆H₅ | —(CH₂)₂OCH₂CH₃ |
| 6-16 | —CONHC₆H₅ | —(CH₂)₂O(CH₂)₂OH |
| 6-17 | —CONHC₆H₅ | —(CH₂)₂OCH₂CO₂H |
| 6-18 | —CONHC₆H₅ | —C₈H₁₇ |
| 6-19 | —CONHC₆H₅ | —(CH₂)₂SO₂CH₃ |
| 6-20 | —CONHC₆H₅ | —(CH₂)₂SO₂CH₂CH₃ |
| 6-21 | —CONHC₆H₅ | —(CH₂)₂O(CH₂)₂OCH₂CH₃ |
| 6-22 | —CONHC₆H₅ | 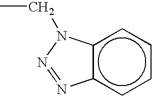 |

TABLE 6

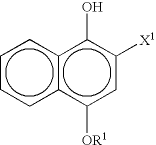

| Compound No. | X¹ | R¹ |
|---|---|---|
| 6-23 | —CONHC₆H₅ | 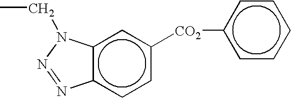 |
| 6-24 | —CONHC₆H₅ | —C₆H₅ |
| 6-25 | —CONHC₆H₅ | -p-CH₂—C₆H₄ |
| 6-26 | —CONHC₆H₅ | -p-Cl—C₆H₄ |
| 6-27 | —CONHC₆H₅ | 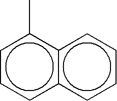 |
| 6-28 | —CONHC₆H₅ | 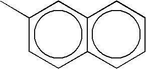 |
| 6-29 | —CONH-2-Cl—C₆H₄ | —CH₃ |
| 6-30 | —CONH-2-Cl—C₆H₄ | —C₄H₉ |
| 6-31 | —CONH-2-Cl—C₆H₄ | —C₆H₁₃ |
| 6-32 | —CONH-2-Cl—C₆H₄ | —(CH₂)₂C₆H₅ |
| 6-33 | —CONH-2-Cl—C₆H₄ | —C₁₂H₂₅ |
| 6-34 | —CONH-4-Cl—C₆H₄ | —C₄H₉ |
| 6-35 | —CONH-4-Cl—C₆H₄ | —C₆H₁₃ |
| 6-36 | —CONH-4-Cl—C₆H₄ | —C₈H₁₇ |
| 6-37 | —CONH-4-Cl—C₆H₄ | —(CH₂)₂C₆H₅ |
| 6-38 | —CONH-4-Cl—C₆H₄ | —C₁₀H₂₅ |
| 6-39 | 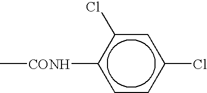 | —CH₃ |

TABLE 7

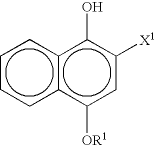

| Compound No. | X¹ | R¹ |
|---|---|---|
| 6-40 | 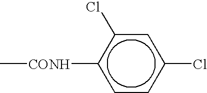 | —C₄H₉ |
| 6-41 | 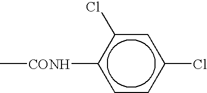 | —C₆H₁₃ |
| 6-42 | 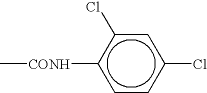 | —C₈H₁₇ |
| 6-43 | 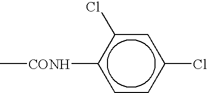 | —(CH₂)₂C₆H₅ |
| 6-44 | 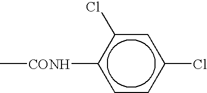 | —C₁₀H₂₁ |
| 6-45 | 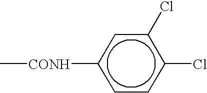 | —CH═CHCH₃ |
| 6-46 | 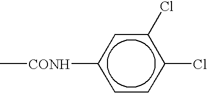 | —C₄H₉ |
| 6-47 | 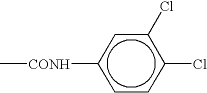 | —C₆H₁₃ |
| 6-48 | 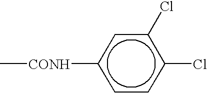 | —C≡CH |

TABLE 8

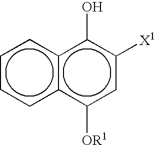

| Compound No. | X¹ | R¹ |
|---|---|---|
| 6-49 | 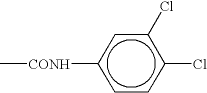 | —C₈H₁₇ |
| 6-50 | 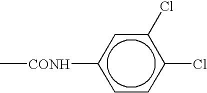 | —(CH₂)₂C₆H₅ |
| 6-51 | 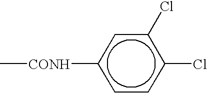 | —CH₂C₆H₅ |
| 6-52 | 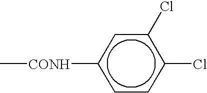 | —C₆H₅ |
| 6-53 | 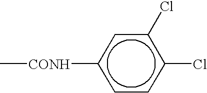 | —(CH₂)₂SO₂CH₃ |
| 6-54 | 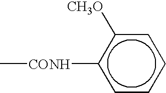 | —C₆H₁₃ |
| 6-55 | 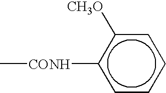 | —(CH₂)₂C₆H₅ |
| 6-56 | 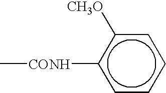 | —C₄H₉ |
| 6-57 | —CONHCH₃ | —C₆H₁₃ |
| 6-58 | —CONHC₄H₉ | —C₆H₁₃ |
| 6-59 | —CONHC₆H₁₃ | —C₆H₁₃ |
| 6-60 | —CONHC₁₀H₂₁ | —C₆H₁₃ |

TABLE 9

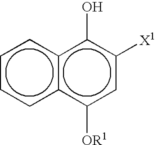

| Com- | | |
|---|---|---|
| pound | | |
| No. | X¹ | R¹ |
| 6-61 | —CONHC₁₂H₂₅ | —C₆H₁₃ |
| 6-62 | —CONHC₁₆H₃₃ | —C₆H₁₃ |
| 6-63 | 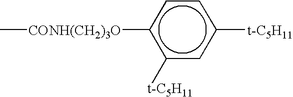 | —C₆H₁₃ |
| 6-64 | —CONH(CH₂)₃OC₁₂H₂₅ | —C₆H₁₃ |
| 6-65 | 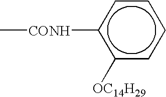 | —C₆H₁₃ |
| 6-66 | —CONHCH₂C₆H₅ | —C₆H₁₃ |
| 6-67 | 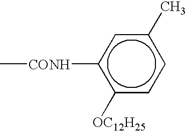 | —C₆H₁₃ |
| 6-68 | 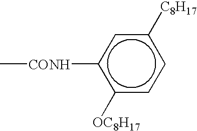 | —C₆H₁₃ |
| 6-69 | —CONH-t-C₄H₉ | —C₆H₁₃ |
| 6-70 | —CONH-t-C₈H₁₇ | —C₆H₁₃ |
| 6-71 | —CON(C₂H₅)₂ | —C₆H₁₃ |
| 6-72 | 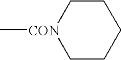 | —C₆H₁₃ |
| 6-73 | 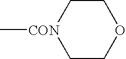 | —C₆H₁₃ |
| 6-74 | 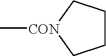 | —C₆H₁₃ |

TABLE 10

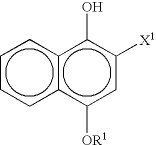

| Compound No. | X¹ | R¹ |
|---|---|---|
| 6-75 | —CONHC₄H₉ | —(CH₂)₂C₆H₅ |
| 6-76 | —CONHC₁₀H₂₁ | —(CH₂)₂C₆H₅ |
| 6-77 | —CONHC₁₂H₂₅ | —(CH₂)₂C₆H₅ |
| 6-78 | —CONH-t-C₄H₉ | —(CH₂)₂C₆H₅ |
| 6-79 | —CONH-t-C₈H₁₇ | —(CH₂)₂C₆H₅ |
| 6-80 | —CONHCH₃ | —(CH₂)₂C₆H₅ |
| 6-81 | 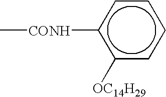 | —(CH₂)₂C₆H₅ |
| 6-82 | —CON(C₂H₅)₂ | —(CH₂)₂C₆H₅ |
| 6-83 | 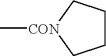 | —(CH₂)₂C₆H₅ |
| 6-84 | —CONHCH₂C₆H₅ | —(CH₂)₂C₆H₅ |

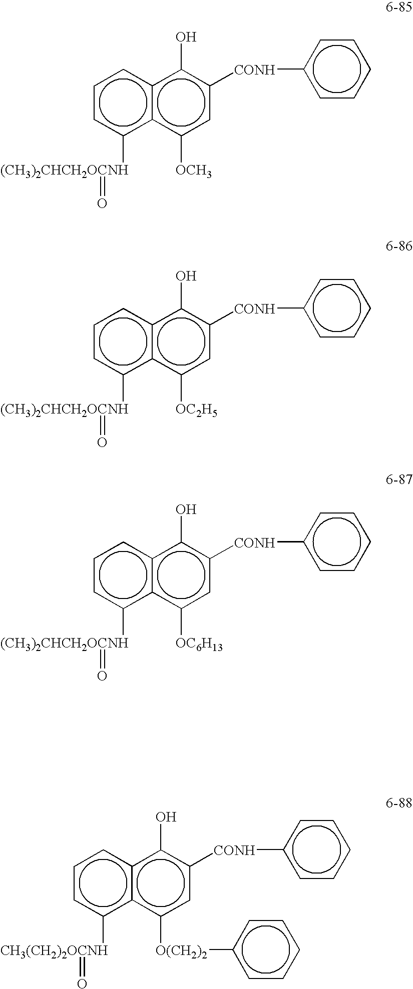 TABLE 11

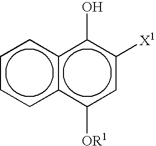

| Compound | | |
|---|---|---|
| No. | X¹ | R¹ |
| 6-89 | —COCH₃ | —C₆H₁₃ |
| 6-90 | —COC₂H₅ | —C₆H₁₃ |
| 6-91 | —COC₇H₁₅ | —C₆H₁₃ |
| 6-92 | —COC₁₁H₂₃ | —C₆H₁₃ |
| 6-93 | —COCH₃ | —(CH₂)₂C₆H₅ |
| 6-94 | —COC₂H₅ | —(CH₂)₂C₆H₅ |
| 6-95 | —COC₇H₁₅ | —(CH₂)₂C₆H₅ |
| 6-96 | —COC₁₁H₂₃ | —(CH₂)₂C₆H₅ |
| 6-97 | —COCH₃ | —CH₃ |
| 6-98 | —COCH₃ | —C₄H₉ |
| 6-99 | —COCH₃ | —C₆H₅ |
| 6-100 | —COCH₃ | —CH₂C₆H₅ |
| 6-101 | —COCH₃ | —C₁₀H₂₁ |
| 6-102 | —COCH₃ | —C₁₂H₂₅ |
| 6-103 | —COCH₃ | —C₁₆H₃₃ |
| 6-104 | —CO₂C₆H₅ | —C₆H₅ |
| 6-105 | —CO₂C₆H₅ | —CH₃ |
| 6-106 | —CO₂C₆H₅ | —C₂H₅ |
| 6-107 | —CO₂C₆H₅ | —C₄H₉ |
| 6-108 | —CO₂C₆H₅ | —C₆H₁₃ |
| 6-109 | —CO₂C₆H₅ | —C₁₀H₂₁ |
| 6-110 | —CO₂C₆H₅ | —CH₂C₆H₅ |
| 6-111 | —CO₂C₆H₅ | —(CH₂)₂C₆H₅ |
| 6-112 | —CO₂C₆H₅ | —C₁₂H₂₅ |

TABLE 12

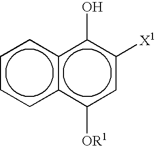

| Compound | | |
|---|---|---|
| No. | X¹ | R¹ |
| 6-113 | —CO₂C₆H₅ | —C₁₆H₃₃ |
| 6-114 | —CO₂C₆H₅ | —(CH₂)₂SO₂CH₃ |
| 6-115 | —CO₂C₆H₅ | —(CH₂)₂SO₂NHCH₃ |
| 6-116 | —CO₂C₆H₅ | —(CH₂)₂NHSO₂C₂H₅ |
| 6-117 | —CO₂CH₃ | —CH₃ |
| 6-118 | —CO₂CH₃ | —C₄H₉ |
| 6-119 | —CO₂C₂H₅ | —C₆H₁₃ |
| 6-120 | —CO₂C₂H₅ | —(CH₂)₂C₆H₅ |
| 6-121 | —CO₂C₂H₅ | —C₁₂H₂₅ |
| 6-122 | —CO₂C₁₂H₂₅ | —CH₃ |
| 6-123 | —CO₂C₁₂H₂₅ | —C₄H₉ |
| 6-124 | —CO₂C₁₂H₂₅ | —C₆H₁₃ |
| 6-125 | —CO₂C₁₂H₂₅ | —(CH₂)₂C₆H₅ |
| 6-126 | —CO₂C₁₂H₂₅ | —(CH₂)₂SO₂CH₃ |
| 6-127 | —CO₂C₁₂H₂₅ | —CH═CHCH₃ |
| 6-128 | —CO₂C₁₂H₂₅ | —CH₂CH═CH₂ |
| 6-129 | —CO₂C₁₂H₂₅ | —C≡CCH₃ |
| 6-130 | —CO₂C₁₂H₂₅ | —C—C₆H₁₁ |
| 6-131 | —CO₂C₁₂H₂₅ | —C₆H₅ |
| 6-132 | —SO₂CH₃ | —C₄H₉ |
| 6-133 | —SO₂CH₃ | —C₆H₁₃ |
| 6-134 | —SO₂CH₃ | —C₆H₅ |
| 6-135 | —SO₂CH₃ | —CH₃ |
| 6-136 | —SO₂CH₃ | —(CH₂)₂C₆H₅ |

TABLE 13

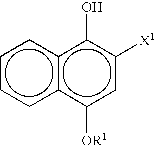

| Compound | | |
|---|---|---|
| No. | X¹ | R¹ |
| 6-137 | —SO₂CH₃ | —CH₂C₆H₅ |
| 6-138 | —SO₂C₆H₅ | —C₄H₉ |
| 6-139 | —SO₂C₆H₅ | —C₆H₁₃ |
| 6-140 | —SO₂C₆H₅ | —CH₃ |
| 6-141 | —SO₂C₆H₅ | —(CH₂)₂C₆H₅ |
| 6-142 | —SO₂C₆H₅ | —C₁₂H₂₅ |
| 6-143 | —SO₂NHC₆H₅ | —C₆H₅ |
| 6-144 | —SO₂NHCH₃ | —C₆H₅ |
| 6-145 | —SO₂NHC₂H₅ | —C₆H₅ |
| 6-146 | —SO₂NHC₆H₁₃ | —C₆H₅ |
| 6-147 | —SO₂NHC₄H₉ | —C₆H₅ |
| 6-148 | —SO₂NH-t-C₄H₉ | —C₆H₅ |
| 6-149 | —SO₂NH-t-C₈H₁₇ | —C₆H₅ |
| 6-150 | —SO₂NHC₆H₅ | —C₆H₁₃ |
| 6-151 | —SO₂NHCH₃ | —C₆H₁₃ |
| 6-152 | —SO₂NHC₂H₅ | —C₆H₁₃ |
| 6-153 | —SO₂NHC₄H₉ | —C₆H₁₃ |
| 6-154 | —SO₂NH-t-C₄H₉ | —C₆H₁₃ |
| 6-155 | —SO₂NH-t-C₈H₁₇ | —C₆H₁₃ |
| 6-156 | —SO₂NHC₆H₁₃ | —(CH₂)₂C₆H₅ |
| 6-157 | —SO₂NHC₆H₅ | —(CH₂)₂C₆H₅ |
| 6-158 | —SO₂NHCH₃ | —(CH₂)₂C₆H₅ |
| 6-159 | —SO₂NH-t-C₈H₁₇ | —(CH₂)₂C₆H₅ |

Particularly preferable development accelerators are the compounds shown below.

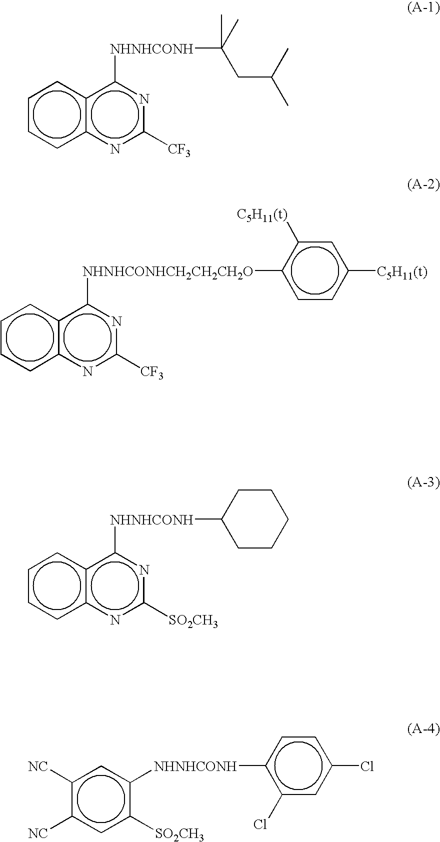

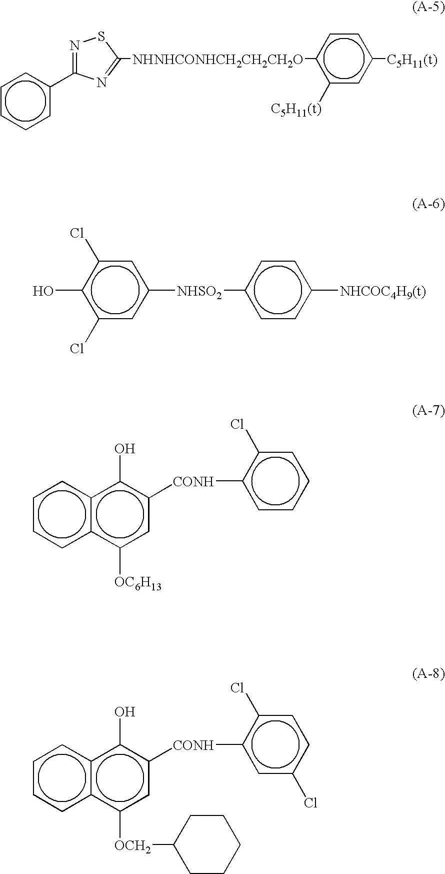

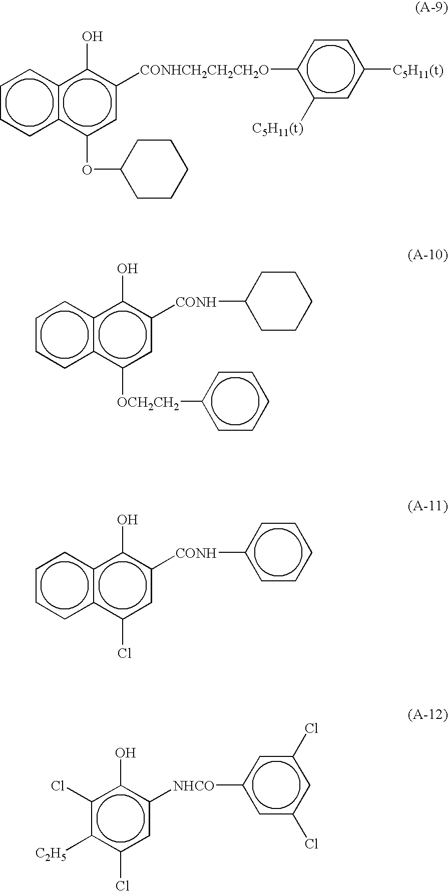

The development accelerator represented by formulae (1) to (6) may be added in the coating solution in any forms of a solution, powder, fine solid particle dispersion, emulsion and oil protect dispersion. The development accelerator is preferably added as fine solid particles particularly when it is used together with the latex of the invention. The fine solid particles may be dispersed by pulverization methods known in the art (for example using a ball mill, a vibrating ball mill, a sand mill, a colloid mill, a jet mill and a roller mill), and pulverizing with the sand mill is preferable among these methods. A dispersion aid may be used for dispersing the fine solid particles.

(Reducing Agent)

The reducing agent used in the invention will be described below.

The photothermographic material of the invention contains a reducing agent. The reducing agent may be any substance (preferably organic substance) capable of reducing silver ion into metallic silver. Such reducing agents are described in paragraph Nos. 0043 to 0045 in JP-A No. 11-65021, and in line 34 page 7 to line 12 page 18 in EP No. 0803764A1.

So-called hindered phenol reducing agents having substituents at the ortho-position from a phenolic hydroxyl group, or bisphenol type reducing agent is preferable as the reducing agent of the invention, and the compound represented by the formula (7) below is more preferable.

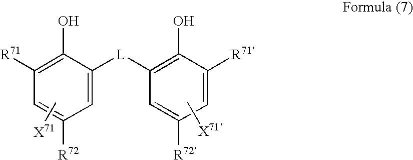

In formula (7), R⁷¹ and R^{71′} each independently represent an alkyl group having 1 to 20 carbon atoms. R⁷² and R^{72′} each independently represent a hydrogen atom or a substituents capable of substituting for a hydrogen atom on the benzene ring. L represents a —S— group or a —CHR⁷³-group. R⁷³ represents a hydrogen atom or an alkyl group having 1 to 20 carbon atoms. X⁷¹ and X^{71′} each independently represent a hydrogen atom or a substituent capable of substituting for a hydrogen atom on the benzene ring.

Hereinafter, formula (7) will be described in detail.

In formula (7), R⁷¹ and R^{71′} may have substituents. While the substituent is not particularly restricted, preferable substituents include an aryl group, a hydroxyl group, an alkoxy group, an aryloxy group, an alkylthio group, an aryl thio group, an acylamino group, a sulfonamide group, a sulfonyl group, a phosphoryl group, an acyl group, a carbamoyl group, an ester group, a ureido group, an urethane group and halogen atoms.

R⁷¹ and R^{71′} in formula (7) are preferably secondary or tertiary alkyl groups having 3 to 15 carbon atoms, more preferably tertiary alkyl groups having 4 to 12 carbon atoms. Examples thereof include an isopropyl group, an isobutyl group, a t-butyl group, a t-amyl group, a t-octyl group, a cyclohexyl group, a cyclopentyl group, a 1-methyl cyclohexyl group and a 1-methylcyclopropyl group, preferably the t-butyl group and t-amyl group, and more preferably the t-butyl group.

R⁷² and R^{72′} in formula (7) each independently represent a hydrogen atom or a group capable of substituting for a hydrogen atom on the benzene ring, and X⁷¹ and X^{71′} also each independently represent a hydrogen atom or a group capable of substituting for a hydrogen atom on the benzene ring. The group capable of substituting for a hydrogen atom on the benzene ring is preferably an alkyl group, an aryl group, halogen atoms, an alkoxy group and an acylamino group.

Preferably, R⁷² and R^{72′} in formula (7) each independently represents an alkyl group having 1 to 20 carbon atoms. Examples thereof are preferably methyl groups, ethyl groups, propyl groups, butyl groups, isopropyl groups, t-butyl groups, t-amyl groups, cyclohexyl groups, 1-methyl cyclohexyl groups, benzyl groups, methoxymethyl groups and ethoxymethyl groups, more preferably methyl groups, ethyl groups, propyl groups, isopropyl groups and t-butyl groups.

Preferably, X⁷¹ and X^{71′} in formula (7) are hydrogen atoms, halogen atoms and alkyl groups, more preferably hydrogen atoms.

In formula (7), L represents a —S— group or a —CHR⁷³— group, preferably a —CHR⁷³ group.

R⁷³ is preferably a hydrogen atom or an alkyl group having 1 to 15 carbon atoms. Preferable examples thereof include a hydrogen atom, a methyl group, an ethyl group, a propyl group, an isopropyl group and a 2,4,4-trimethylpemtyl group, more preferably a hydrogen atom, a methyl group, a propyl group and an isopropyl group.

When R⁷³ is a hydrogen atom, R⁷² and R^{72′} are preferably alkyl groups having 2 to 5 carbon atoms, more preferably ethyl groups and propyl groups, and most preferably ethyl groups.

When R⁷³ is a primary or secondary alkyl group having 1 to 8 carbon atoms, on the other hand, R⁷² and R^{72′} are preferably methyl groups. The alkyl group as R¹³ having 1 to 8 carbon atoms is preferably a methyl group, an ethyl group, a propyl groups and an isopropyl group, more preferably a methyl group, an ethyl group and a propyl group.

When all of R⁷¹, R^{71′}, R⁷² and R^{72′} are methyl groups, R⁷³ is preferably a secondary alkyl group. The secondary alkyl group as R⁷³ is preferably an isopropyl group, an isobutyl group and a 1-ethylpentyl group, and more preferably an isopropyl group.

The reducing agent has different thermal development property and color tone of developed silver depending on the combination of R⁷¹, R^{71′}, R⁷² and R^{72′} Since these properties can be controlled by combining at least two reducing agents, it is preferable to use as a combination of at least two reducing agents.

While examples of the compound as the reducing agent of the invention represented by formula (7) are listed below, the invention is not restricted to these compounds.

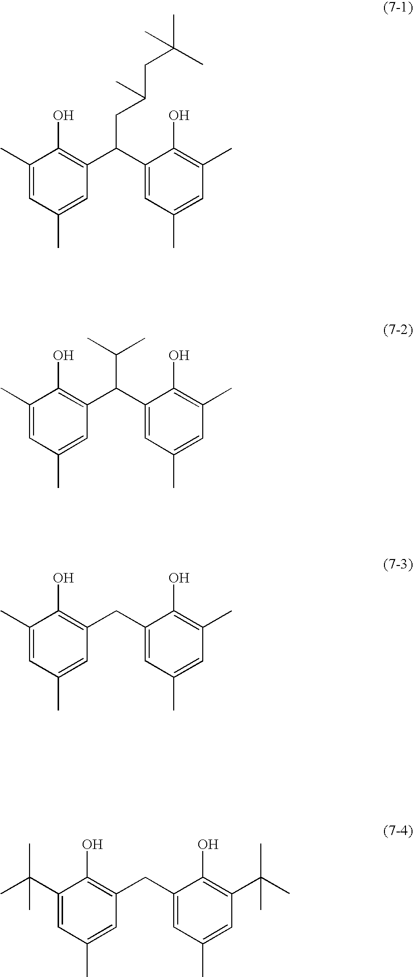

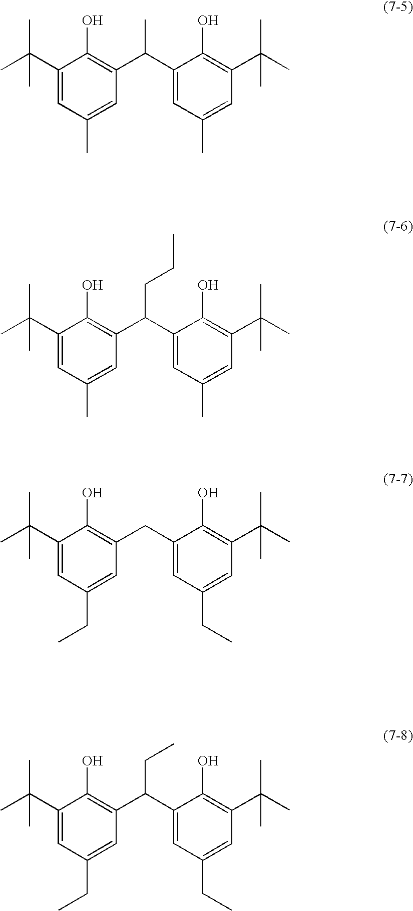

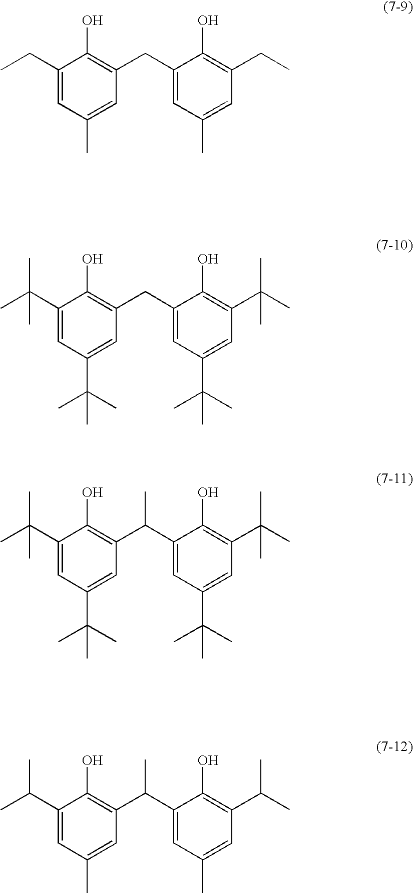

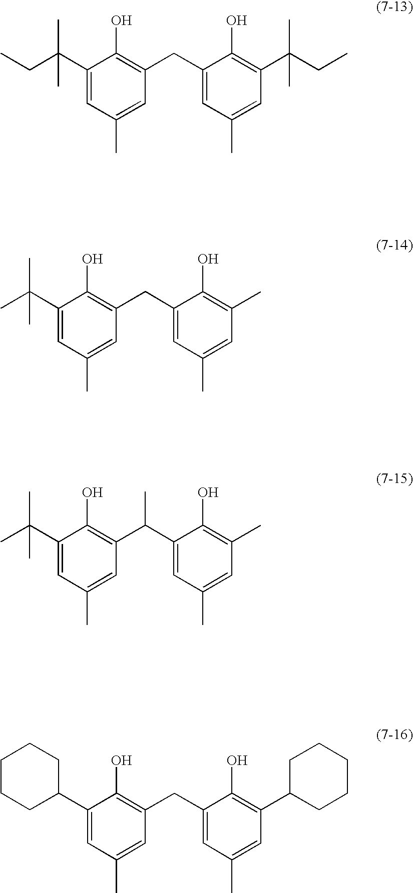

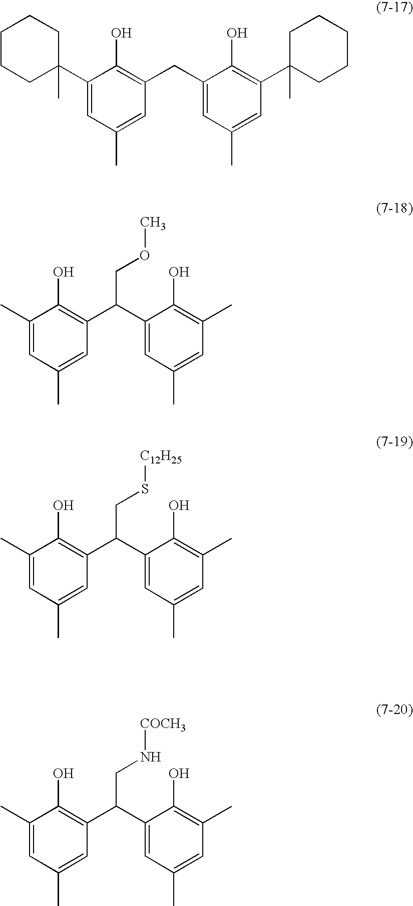

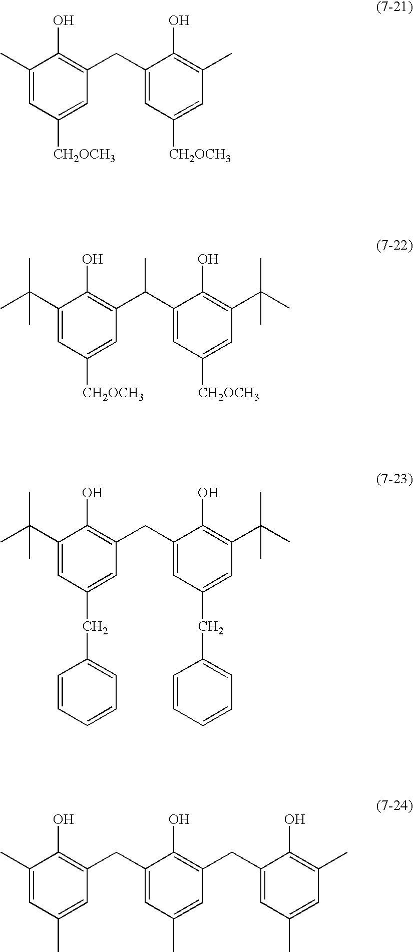

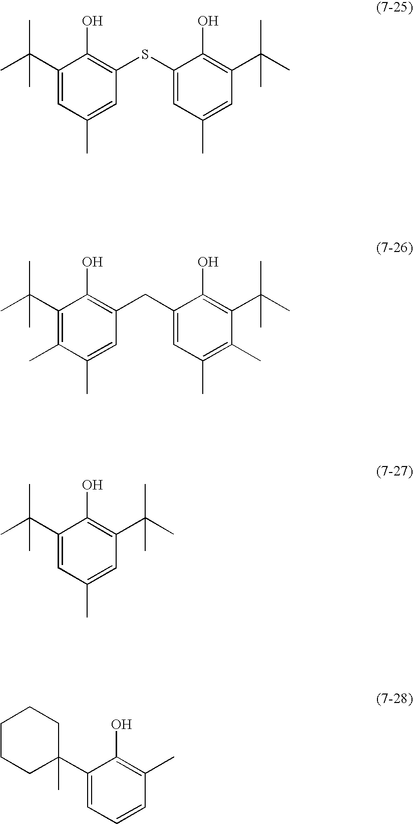

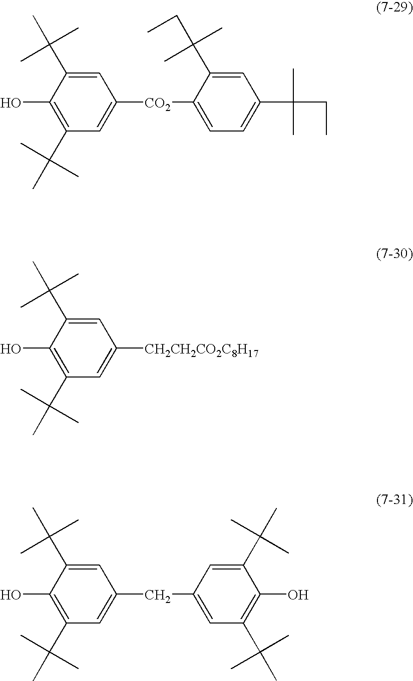

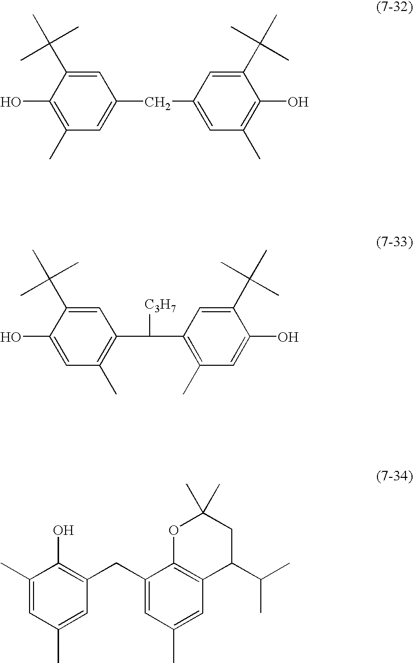

The addition amount of the reducing agent in the invention is preferably 0.1 g/m² to 3.0 g/m², more preferably 0.2 g/m² to 1.5 g/m², and further preferably 0.3 g/m² to 1.0 g/m². The reducing agent is contained in a proportion of preferably 5% by mole to 50% by mole, more preferably 8% by mole to 30% by mole, and further preferably 10% by mole to 20% by mole, per one mole of silver contained in the surface comprising the image forming layer.

The reducing agent is preferably contained in the image forming layer.

The reducing agents may be added in the photothermographic material by allowing it to be contained in the coating solution in any form such as a solution, dispersed emulsion and dispersion of fine solid particles.

In the emulsified dispersion method well known in the art, the reducing agent is dissolved using an oil such as dibutyl phthalate, trichlesyl phosphate, glyceryl triacetate or diethyl phthalate, or an auxiliary solvent such as ethyl acetate or cyclohexanone, followed by mechanically forming the emulsified dispersion.

In the fine solid particle dispersion method, the powder of the reducing agents is dispersed in water using a ball mill, a colloid mill, a vibrating ball mill, a sand mill, a jet mill, a roller mill or an ultrasonic wave to prepare a solid dispersion. A protective colloid (for example polyvinyl alcohol) and a detergent (for example an anionic surfactant such as a sodium triisopropylnaphthalene sulfonic acid (a mixture of compounds having three different substitution positions of isopropyl groups)) may be used for forming the dispersion.

Since beads such as zirconia beads are usually used as a dispersion medium in the mill, Zr dissolved from these beads may be mingled in the dispersion medium. The amount of mingling of Zr is in the range of 1 ppm to 1000 ppm, although it depends on the dispersion condition. Mingling of Zr causes no practical problem, provided that the amount is 0.05 mg or less per 1 g of silver.

An antiseptic (for example sodium benzoisothiazoline) is preferably added in the aqueous dispersion.

(Organic Silver Salt)

1) Composition

The organic silver salt particle according to the invention is relatively stable to light but serves as to supply silver ions and forms silver images when heated to 80° C. or higher under the presence of an exposed photosensitive silver halide and a reducing agent. The organic silver salt may be any organic material containing a source capable of reducing silver ions. Such non-photosensitive organic silver salt is disclosed, for example, in JP-A No. 10-62899 (paragraph Nos. 0048 to 0049), EP-A No. 0803764A1 (page 18, line 24 to page 19, line 37), EP-A No. 962812A1, JP-A Nos. 11-349591, 2000-7683, and 2000-72711, and the like. A silver salt of organic acid, particularly, a silver salt of long chained fatty acid carboxylic acid (having 10 to 30, preferably, 15 to 28 carbon atoms) is preferable. Preferred examples of the silver salt of the organic acid can include, for example, silver lignocerate, silver behenate, silver arachidinate, silver stearate, silver oleate, silver laurate, silver capronate, silver myristate, silver palmitate, silver erucate and mixtures thereof. Among the organic silver salts, it is preferred to use an organic silver salt with the silver behenate content of 50 mol % or more, more preferably, 85 mol % or more, further preferably, 95 mol % or more. And, it is preferred to use an organic silver salt with the silver erucate content of 2 mol % or less, more preferably, 1 mol % or less, further preferably, 0.1 mol % or less.

It is preferred that the content of the silver stearate is 1 mol % or less. When the content of the the silver stearate is 1 mol % or less, a silver salt of organic acid having low Dmin, high sensitivity and excellent image stability can be obtained. The content of the silver stearate above-mentioned, is preferably 0.5 mol % or less, more preferably, the silver stearate is not substantially contained.

Further, in the case the silver salt of organic acid includes silver arachidinic acid, it is preferred that the content of the silver arachidinic acid is 6 mol % or less in order to obtain a silver salt of organic acid having low Dmin and excellent image stability. The content of the silver arachidinate is more preferably 3 mol % or less.

2) Shape

There is no particular restriction on the shape of the organic silver salt usable in the invention and it may needle-like, bar-like, plate-like or flaky shape.

In the invention, a flaky shaped organic silver salt is preferred. Short needle-like, rectangular, cuboidal or potato-like indefinite shaped particle with the major axis to minor axis ratio being 5 or less is also used preferably. Such organic silver particle has a feature less suffering from fogging during thermal development compared with long needle-like particles with the major axis to minor axis length ratio of 5 or more. Particularly, a particle with the major axis to minor axis ratio of 3 or less is preferred since it can improve the mechanical stability of the coating film. In the present specification, the flaky shaped organic silver salt is defined as described below. When an organic acid silver salt is observed under an electron microscope, calculation is made while approximating the shape of an organic acid silver salt particle to a rectangular body and assuming each side of the rectangular body as a, b, c from the shorter side (c may be identical with b) and determining x based on numerical values a, b for the shorter side as below.
x=b/a

As described above, x is determined for the particles by the number of about 200 and those capable of satisfying the relation: x (average)≧1.5 as an average value x is defined as a flaky shape. The relation is preferably: 30≧x (average)≧1.5 and, more preferably, 15≧x (average)≧1.5. By the way, needle-like is expressed as 1≦x (average)<1.5.

In the flaky shaped particle, a can be regarded as a thickness of a plate particle having a main plate with b and c being as the sides. a in average is preferably 0.01 μm to 0.3 μm and, more preferably, 0.1 μm to 0.23 μm. c/b in average preferably 1 to 9, more preferably, 1 to 6 and, further preferably, 1 to 4 and, most preferably, 1 to 3.

By controlling the sphere equivalent diameter to 0.05 μm to 1 μm, it causes less agglomeration in the photosensitive material and image stability is improved. The spherical equivalent diameter is preferably 0.1 μm to 1 μm. In the invention, the sphere equivalent diameter can be measured by a method of photographing a sample directly by using an electron microscope and then image-processing negative images.

In the flaky shaped particle, the sphere equivalent diameter of the particle/a is defined as an aspect ratio. The aspect ratio of the flaky particle is, preferably, 1.1 to 30 and, more preferably, 1.1 to 15 with a viewpoint of causing less agglomeration in the photosensitive material and improving the image stability.

As the particle size distribution of the organic silver salt, mono-dispersion is preferred. In the mono-dispersion, the percentage for the value obtained by dividing the standard deviation for the length of minor axis and major axis by the minor axis and the major axis respectively is, preferably, 100% or less, more preferably, 80% or less and, further preferably, 50% or less. The shape of the organic silver salt can be measured by determining dispersion of an organic silver salt as transmission type electron microscopic images. Another method of measuring the mono-dispersion is a method of determining of the standard deviation of the volume weighted mean diameter of the organic silver salt in which the percentage for the value defined by the volume weight mean diameter (variation coefficient), is preferably, 100% or less, more preferably, 80% or less and, further preferably, 50% or less. For determination of such a value, a commercially available laser-beam scattering grain size analyzer can be used.

3) Preparing Method

Methods known in the art may be applied to the method for producing the organic silver salt used in the invention, and to the dispersion method thereof. For example, reference can be made to JP-A No. 10-62899, EP-A Nos. 0803763A1 and 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870 and 2002-107868.

The following reaction temperature and mixing method are preferable for preparing non-photosensitive organic silver salt having an average spherical diameter of 0.05 μm to 1.0 μm, and a variation coefficient of the volume average spherical diameter of 30% or less. A substantially transparent solution is preferably used for preparing non-photosensitive organic silver salt by dissolving an alkali metal salt of organic acid in an organic solvent.

(Reaction Temperature)

The organic silver salt particles of the invention is preferably prepared at a reaction temperature of 60° C. or less in order to obtain the particles having low Dmin. While the temperature of the solution of the reagent added, for example an aqueous solution of an organic acid alkali metal salt, may be higher than 60° C., the temperature of the reaction bath in which the reaction solution is added is preferably 50° C. or less, more preferably 40° C. or less.

(Mixing Method)

While the organic silver salt particles of the invention is prepared by allowing a solution containing silver ions such as silver nitride to react with a solution or suspension of an organic acid alkali metal salt, 50% or more of the total amount of silver is preferably added simultaneously with adding a solution or suspension of an alkali metal salt of organic acid. Any methods including adding on the liquid surface of the reaction bath, adding in the solution, or adding in sealed mixing means may be available.

(Aging)

The organic silver salt of the invention may be aged by increasing the reaction temperature after completing the addition of the silver ion containing solution (for example aqueous silver nitride solution) and/or organic acid alkali metal salt solution. The aging temperature in the invention may be considered to be different from the reaction temperature. Silver nitride and the solution or suspension of the alkali metal salt of organic acid is not added at all during the aging process. The aging temperature is preferably 1° C. to 20° C. as high as the reaction temperature, more preferably 1° C. to 10° C. as high as the reaction temperature. The aging time is preferably determined by trial and error.

(Divided Addition)

In preparation of the organic silver salt of the invention, the addition of the alkali metal salt of organic acid solution may be divided into 2 to 6 times. Such divided addition permits the particles to be endowed with various functions such as improvement photographic performance and changes of surface hydrophobicity. The number of divided additions is preferably 2 to 4 times. Since the organic acid salt is solidified at high temperatures, the divided addition method should be considered such that a plurality of divided addition lines are provided, or a circulation method is devised.

In preparation of the organic silver salt of the invention, preferably, 0.5% by mole to 30% by mole, more preferably 3% by mole to 20% by mole, of the total moles of addition of the alkali metal salt of organic acid solution is solely added after completing the addition of the silver ion containing solution. This addition preferably corresponds to one time of the divided additions. While the solution may be added in either the sealed mixing means or reaction vessel, it is preferable to add in the reaction vessel, since surface hydrophilicity of the particles can be enhanced while improving the film forming ability of the photosensitive material to enable peeling of the film to be prevented by the addition method as described above.

(Organic Acid Alkali Metal Salt Solution)

An organic solvent in an amount capable of forming a substantially transparent solution, not forming strings or a micelle, of the organic alkali metal salt is preferably contained in at least one solution of the silver ion containing solution, the solution or suspension of the organic acid alkali metal salt, and a solution previously prepared as a reaction field, in order to form organic acid particles in the practice of the invention. While the solution may comprise a single organic solvent, it is preferably a mixed solvent of the organic solvent and water.

While the kind of the organic solvent is not particularly restricted so long as it is soluble in water and has the properties as described above, a solvent that hinders photographic performance is not preferable. The solvent is preferably an alcohol or acetone, and tertiary alcohols having 4 to 6 carbon atoms are more preferable.

The alkali metals of the alkali metal salt of organic acid used in the invention is preferably Na or K. The alkali metal salt of organic acid is prepared by adding NaOH or KOH in the organic acid. Preferably, the alkali is added in an amount of less than the equivalent of the organic acid in order to permit an unreacted organic acid to be left behind. The proportion of the residual organic acid is 3% by mole to 50% by mole, preferably 3% by mole to 30% by mole, with respect to the total amount of the organic acid. Excess alkali may be neutralized by adding nitric acid or sulfuric acid after adding a predetermined amount of the alkali.

For example, the compounds as indicated by the formula (1) in JP-A No. 62-65035, the water soluble group containing N-heterocyclic compounds as described in JP-A No. 62-150240, inorganic peroxides as described in JP-A No. 50-101019, sulfur compounds as described in JP-A No. 51-78319, and disulfide compounds and hydrogen peroxide as described in JP-A No. 57-643 may be added to the silver ion containing solution and organic acid alkali metal salt solution, or to the sealed mixing vessel in which both solutions are added, as disclosed.

The proportion of the alkali metal salt of organic acid solution used in the invention is preferably 3% to 70%, more preferably 5% to 50%, with respect to the volume of the solvent. The optimum volume may be decided by trial and error, since the optimum volume changes by the reaction temperature.

The concentration of the alkali metal salt of organic acid used in the invention is 5% by weight to 50% by weight, preferably 7% by weight to 45% by weight, and more preferably 10% by weight to 40% by weight.

The temperature of the aqueous tertiary alcohol solution of the alkali metal salt of organic acid added in the sealed mixing means or reaction vessel is preferably 50° C. to 90° C., more preferably 60° C. to 85° C., and most preferably 65° C. to 85° C., in order to avoid the alkali metal salt of organic acid from being crystallized or solidified. The temperature is controlled within the temperature selected from the range described above in order to maintain the reaction temperature to be constant.

Controlling the temperature as described above permits the precipitation rate of fine crystals formed by quenching the aqueous tertiary alcohol solution of the alkali metal salt of organic acid at a high temperature in the sealed mixing means, and the organic silver salt forming rate by a reaction with the silver ion containing solution to be preferably controlled, and the crystal habit, crystal size and crystal size distribution of the organic silver salt is favorably controlled. Consequently, the performance of the thermal development material, particularly of photothermographic material, may be also improved.

(Solution in Reaction Vessel)

The solvent may be previously filled in the reaction vessel. While water is preferably used as the solvent previously filled, a mixed solvent with the tertiary alcohol may be also preferably used.

(Dispersion Aid)

A dispersion aid soluble in an aqueous medium may be added in the tertiary alcohol solution of the organic acid alkali metal salt, silver ion containing solution or reaction solution. Any dispersion aid may be used so long as it is possible to disperse the organic silver salt formed. Examples thereof are in accordance to the dispersion aid to be described hereinafter.

(Desalting and Dehydration)

In the method for preparing the organic silver salt, the organic silver salt is preferably desalted and dehydrated after forming the silver salt. The method is not particularly restricted, and any method known in the art and commonly used may be used. For example, methods known in the art such as centrifugal filtration, suction filtration, ultrafiltration, and forming flocks by an aggregation method followed by washing with water, or removal of supernatant by centrifugal precipitation may be preferably used. The desalting and dehydration process may be applied once, or may be repeated a plurality of times. Water may be continuously or intermittently added and removed. The conductivity of water after the final desalting and dehydration is preferably 300 μS/cm or less, more preferably 100 μS/cm or less, and most preferably 60 μS/cm or less. While the lower limit of conductivity is not particularly restricted, it is usually 5 μS/cm.

The method used for desalting and concentration of silver halide emulsion can be used for the ultrafiltration method, which may be referred to Research Disclosure No. 10, 208 (1972), No. 13, 122 (1975) and No. 16, 351 (1977). While the differential pressure and flow rate crucial as the operation conditions may be selected with reference to the characteristic curves described in “Technical Handbook of Application of Membrane Technologies” by Haruhiko OYA, p 275, published by Saiwai Shobo Co., (1978), an optimum condition should be selected for suppressing aggregation and fogging of the particles for treating the desired organic silver salt dispersion. While a constant volume method for continuously adding the solvent and a batchwise method for intermittently adding the solvent are available for replenishing the solvent lost by membrane permeation, the constant volume method is preferable since the desalting time is relatively short.

Pure water obtained by distillation or ion-exchange is used for the replenishing solvent, a pH control agent may be mixed in pure water for maintaining a desired pH, or may be directly added in the organic silver salt dispersion.

While ultrafiltration membranes of flat plate, spiral, cylindrical and hollow fiber types are commercially available from Asahi Chemical Industries Co., Daicel Chemical Industries C., Toray Co. and Nitto Denko Co., the spiral type or follow fiber type is preferable from the viewpoint of total membrane area and washability.

The fractionation molecular weight as an index of threshold of the components permeable to the membrane is preferably as small as ⅕ of the molecular weight of the high molecular weight dispersant.

The particles are preferably dispersed to about twice of the weighed volume average particle diameter with the solvent prior to ultrafiltration for desalting in the invention. Any methods such as those using a high pressure homogenizer or microfluidizer to be described hereinafter may be employed for the dispersion method.

The solution after forming the particles and before the end of desalting is preferably maintained at a low temperature. This is because nuclei of silver tend to be formed by a stress field and pressure field generated by pumping and permeation through the ultrafiltration membrane, when the organic solvent used for dissolving the organic acid alkali metal salt is permeated in the organic silver salt particles formed. Accordingly, the temperature of the silver salt of organic acid particles is subjected to ultrafiltration by keeping a temperature of 1° C. to 30° C., preferably 5° C. to 25° C.

(Re-Dispersion)

The organic silver salt after desalting and dehydration is preferably converted into a fine dispersion by adding the dispersant in the organic silver salt for improving the application surface of the photothermographic material, particularly the surface of photothermographic material material.

Methods known in the art may be applied to the method for producing the organic silver salt used in the invention, and the dispersion method thereof. For example, the following methods may be referenced: JP-A Nos. 8-234358, 10-62899, 11-349591, 2000-7683, 2000-72711, 2000-53682, 2000-75437, 2000-86669, 2000-143578, 2000-178278 and 2000-256254; EP 0803763A1 and 0962812A; and Japanese Patent Application (JP-B) Nos. 11-348228 to 30, 11-203413, 11-115457, 11-180369, 11-297964, 11-157838, 11-202081, 2000-90093, 2000-195621, 2000-191226, 2000-213813, 2000-214155 and 2000-191226.

The organic silver salt may be mechanically dispersed into a fine particle dispersion using, in the presence of a dispersion aid, a pulverization method known in the art (for example a high speed mixer, homogenizer, high speed impact mill, Burberry mixer, homomixer, kneader, ball mill, vibrating ball mill, planetary ball mill, attoriter, sand mill, beads mill, colloid mill, jet mill, roller mill, tron mill and high speed stone mill).

Preferably, a large force is uniformly applied in the range not breaking the organic silver salt particles as an imaging media, or in the range not increasing the temperature of the particles, in order to obtain a uniform fatty acid silver salt solid dispersion having a high S/N ratio, small particle size without coagulation. The solution comprising the organic silver salt and dispersant is preferably dispersed by a pressure drop after converting the solution into a high speed stream for attaining the object above. While any dispersion media is available so long as the dispersion aid functions in the solvent, it is preferably composed of water alone, or an organic solvent may be contained in a proportion of 20% by weight or less. Since fogging is increased to cause a remarkable decrease of sensitivity when the photosensitive silver salt is present during the dispersion process, the dispersed solution is substantially free from the photosensitive silver salt in the dispersion process. Since the content of the photosensitive silver salt in the dispersion solution is 0.1% by mole or less per one mole of the organic silver salt in the invention, it is preferable not to add the photosensitive silver salt.

The dispersion apparatus and the dispersion technology used for executing the re-dispersion method as described above is described in detail in “Rheology of Dispersion System and Dispersion Technology”, by Toshio KAJIUCHI and Yosuke USUI, p 357-403, 1991, Shinzan-sha Publishing Co.; “Advance in Chemical Engineering”, ed. by Chemical Engineering Association Tokay Branch, p 184-185, 1990; JP-A Nos. 59-49832, 8-137044, 8-238848, 2-261525 and 1-94933; and U.S. Pat. No. 4,533,254. The re-dispersion method of the invention comprises the steps of sending a dispersion solution containing at least the organic silver salt in the piping by pressurizing the solution with a high pressure pump, allowing the solution to pass through a fine slits provided in the piping, and rapidly decreasing the pressure of the dispersion solution to finely disperse the solution.

In the high pressure homogenizer, it is commonly considered that (a) the shear stress generated by allowing the dispersion medium to pass through narrow gaps (with an width of 75 μm to 350 μm) at a high pressure and high speed, and (b) the impact force generated by collision between the droplets of the liquid or by collision of the liquid with the wall surface at a narrow high pressure space are not changed, and the cavitation force generated by a pressure drop thereafter is further increased to effect uniform and efficient dispersion. While a Manton-Golin homogenizer has been used for long time as the dispersion apparatus of this sort, the dispersing solution sent under a high pressure is converted into a high speed stream in a narrow gap on the surface of a round column, collide with the surrounding wall surface by the power of the stream to emulsify and disperse by the collision force. Examples of the liquid-liquid collision method include those using a Y-chamber of the microfluidizer, and a spherical chamber taking advantage of a spherical check valve as disclosed in JP-A No. 8-103642 to be described below, while examples of the liquid-wall collision method include those using a Z-chamber of the microfluidizer. The pressure used is usually in the range of 100 kg/cm² to 600 kg/cm² (1 MPa to 6 MPa), while the flow speed is several meter/second to 30 m/second. The high speed stream part is devised to be a saw tooth shape for increasing the collision frequency in order to enhance the dispersion efficiency. Representative examples of such instrument include Manton-Golin homogenizer, microfluidizer manufactured by Microfuidex, Co., microfluidizer manufactured by Mizuho Industry Co., and nanomizer manufactured by Tokushu Kika Kogyo Co. These instruments are described in JP-A Nos. 8-238848 and 8-103642, and U.S. Pat. No. 4,533,254.

While the organic silver salt can be dispersed into a desired particle size by adjusting the flow speed, differential pressure of pressure drop and the treatment times, the flow rate is preferably in the range of 200 m/sec to 600 m/sec, more preferably 300 m/sec to 600 m/sec, and the differential pressure at the pressure drop is preferably in the range of 900 kg/cm² to 3,000 kg/cm² (9 MPa to 30 MPa), more preferably 1,500 kg/cm² to 3,000 kg/cm² (15 MPa to 30 MPa) considering photographic characteristics and particle size. The dispersion treatment times are selected depending on requirements, which is usually 1 to 10 times and preferably 1 to 3 times considering productivity. It is not preferable to heat the dispersion solution at a high temperature under such high pressure from the viewpoint of dispersability and photographic performance. The particle size tends to be increased while enhancing fogging t a high temperature exceeding 90° C. Accordingly, it is preferable to keep the dispersion temperature in the range of 5° C. to 90° C., more preferably in the range of 5° C. to 80° C., and particularly preferably in the range of 5° C. to 65° C., by providing a cooling device before the step for converting the liquid into the high pressure/high speed stream, after the step for decreasing the pressure, or in the step including these two steps. Providing the cooling device is effective particularly when the solution is dispersed under a high pressure in the range of 1,500 kg/cm² to 3,000 kg/cm² (15 MPa to 30 MPa). The cooling device may be appropriately selected from those using a double or triple pipe static mixer, a multi-stage pipe heat exchanger, and a coil heat exchanger depending on the required heat exchange capacity. Favorable diameter, thickness and materials may be selected for enhancing the heat exchange efficiency considering the pressure used. The refrigerants available for the cooler include well water at 20° C., cool water at 5° C. to 10° C. after treating with a refrigerator, and ethyleneglycol/water at −30° C., if necessary.

For forming the organic silver salt into solid fine particles using the dispersant, the dispersant may be appropriately selected from synthetic anion polymers such as polyacrylic acid, acrylic acid copolymers, maleic acid copolymers, maleic acid monoester copolymers and acryloylmethylpropane sulfonic acid copolymers; semi-synthetic anion polymers such as carboxymethyl starch and carboxymethyl cellulose; anionic polymers of alginic acid and pectic acid; anionic surfactants described in JP-A No. 52-92716 and WO No. 88/04794; compounds described in JP-B No. 7-350753; anionic, nonionic and cationic surfactants known in the art; other polymers known in the art such as polyvinyl alcohol, polyvinyl pyrrolidone, carboxymethyl cellulose, hydroxypropyl cellulose and hydroxypropylmethyl cellulose; and polymers of natural origin such as gelatin. When a solvent is used as the dispersant, polyvinyl butyral, butylethyl cellulose, methacrylate copolymers, maleic anhydride copolymers, polystyrene and butadiene-styrene copolymer may be preferably used.

While the dispersion aid is mixed with a powder or wet cake of the organic silver salt before dispersion to send into the dispersing machine as a slurry, the powder or wet cake of the organic silver salt may be prepared by a heat treatment or treatment with a solvent after mixing the dispersion aid with the organic silver salt. The pH may be controlled with an appropriate pH controlling agent before or after the dispersion or during dispersion.

The organic silver salt may be formed into fine particles by roughly dispersing it in the solvent by controlling the pH followed by changing the pH in the presence of the dispersion aid, other than the mechanical dispersion method. A fatty acid solution may be used as the solvent used for the rough dispersion.

Since fogging is increased to decrease sensitivity by allowing the photosensitive silver salt to exist in the dispersion step of the organic silver salt, it is preferable that the organic silver salt is substantially free from the photosensitive silver salt in the dispersion step. Since the proportion of the photosensitive silver salt in the aqueous dispersion solution is 0.1% by mole or less per one mole of the organic silver salt in the invention, the photosensitive silver salt is not purposely added.

4) Addition Amount

While an organic silver salt in the invention can be used in a desired amount, an amount of an organic silver salt is preferably in the range of from 0.1 g/m² to 5 g/m², more preferably from 0.3 g/m² to 3.0 g/m² and further preferably from 0.5 g/m² to 2.0 g/m² with respect to total coating amount of Ag including silver halide. It is preferable that an amount of total silver preferably is in the range from 0.5 g/m² to 1.8 g/m², and more preferably from 0.5 g/m² to 1.6 g/m², to improve the image stability.

(Photosensitive Silver Halide)

1) Halogen Composition

It is important that the photosensitive silver halide in the present invention preferably has a silver iodide content of at least 5 mol % or more. It is more preferable that the silver iodide content is 40 mol % or more, and it is further preferable that the silver iodide content is 90 mol % or more. Other components are not particularly limited and can be selected from silver chloride and silver bromide and organic silver salts such as silver thiocyanate, silver phosphate and the like, and particularly, silver bromide and silver chloride are preferable. By using such a silver halide having a high silver iodide content, a preferable photothermographic material having excellent image stability after development treatment, particularly showing remarkably small increase in fogging in irradiation with light can be designed.

The distribution of the halogen composition in a grain may be uniform or the halogen composition may be changed stepwise, or it may be changed continuously. Further, a silver halide grain having a core/shell structure can be preferably used. Preferred structure is a twofold to fivefold structure and, more preferably, core/shell grain having a twofold to fourfold structure can be used. A core-high-silver iodide-structure which has a high content of silver iodide in the core part, and a shell-high-silver iodide-structure which has a high content of silver iodide in the shell part can also be preferably used. Further, a technique of localizing silver bromide or silver iodide on the surface of a grain as form epitaxial parts can also be preferably used.

2) Grain Size

The grain size of silver halide of the high silver iodide used in the invention preferably is in the range from 5 nm to 90 nm. When the size of a silver halide is relatively large, the application amount of a silver halide necessary for attaining required maximum image density increases and consequently transparency of the film decreases. In general, therefore, large size of a silver halide is not preferable.

The present inventors have found that the silver halide having high silver iodide content of the invention has a specific action in that the greater the application amount, the larger the development is suppressed and sensitivity is lowered, and it may become unstable against the developing time to obtain uniform image density. It has been found, therefore, that at a certain grain size or more, maximum concentration is not obtained in a given development time, and on the other hand, when the application amount thereof is suppressed to a certain level or less, a sufficient image density is obtained in spite of silver iodide.

Thus, when the high silver iodide is used, it is necessary that the size of a silver halide grain is sufficiently smaller as compared with conventional silver bromide and silver iodobromide having low iodine content for attaining sufficient maximum optical density. The average grain size of silver halide of high iodide content is preferably 5 nm to 70 nm, more preferably 5 nm to 55 nm. It is particularly preferably 10 nm to 40 nm. The grain size referred to here is observed by an electron microscope, and means the average diameter of a converted circle having the same area as the projected area.

3) Grain Form

While examples of forms of silver halide grains in the invention are cube grains, octahedron grains, dodecahedron grains, tetrahedron grains, flat plate grains, sphere grains, rod grains, potato grains and the like, particularly preferable in the invention are dodecahedron grains and tetrahedron grains. The term “dodecahedron grain” means a grain having planes of {001}, {1(−1)0} and {101} and the term “tetrahedron grain” means a grain having planes of {110}, {101} and {100}. Dodecahedron grains and tetrahedron grains can assume any of a β phase or a γ phase contained, but it is preferred that they assume at least γ phase. It is more The avarage content of γ phase is preferably 5 mol % to 90 mol %, more preferably 10 mol % to 70 mol %, and further preferably 25 mol % to 50 mol %.

The term “β phase” described above means a high silver iodide structure having a wurtzite structure of a hexagonal system and the term “γ phase” means a high silver iodide structure having a zinc blend structure of a cubic crystal system.

An average content of γ phase in the present invention is determined by a method presented by C. R. Berry. In the method, an average content of γ phase is calculated from the peak ratio of the intensity owing to γ phase (111) to that owing to β phase (100), (101), (002) in powder X ray diffraction method. Detail description, for example, is described in Physical Review, Volume 161, No. 3, p. 848 to 851 (1967).

The silver halide having high silver iodide content of the invention can take a complicated form, and as the preferable form, there are listed, for example, connecting particles as shown in R. L. JENKINS et al., J. of Phot. Sci. Vol. 28 (1980), p 164, FIG. 1. Flat plate particles as shown in FIG. 1 of the same literature can also be preferably used. Particles obtained by rounding corners of silver halide particles can also be preferably used. The surface index (Mirror index) of the outer surface of a photosensitive silver halide particle is not particularly restricted, and it is preferable that the ratio occupied by the [100] surface is rich, because of showing high spectral sensitization efficiency when a spectral sensitizing dye is adsorbed. The ratio is preferably 50% or more, more preferably 65% or more, further preferably 80% or more. The ratio of the [100] surface, Mirror index, can be determined by a method described in T. Tani; J. Imaging Sci., 29, 165 (1985) utilizing adsorption dependency of the [111] surface and [100] surface in adsorption of a sensitizing dye.

4) Grain Formation Method

The method of forming a photosensitive silver halide is well known in the art, and for example, methods described in Research Disclosure No. 170929, June 1978 and U.S. Pat. No. 3,700,458 can be used, and specifically, a method is used in which a photosensitive silver halide is prepared by mixing a silver supplying compound and a halogen supplying compound into a solution of gelatin or other polymers, and then, mixing with an organic silver salt. Further, a method described in JP-A No. 11-119374, paragraph Nos. 0217 to 0224 and a method described in JP-A No. 11-352627 are also preferable.

For example, a so-called halidation method is preferably used, in which a part of silver in the organic silver sat is halogenated with an organic or inorganic halogen compound. While any organic halogen compounds may be used provided that they reacts with the organic silver salt to form silver halide, examples thereof include N-halogenoimide (such as N-bromosuccinimide), halogenated quaternary nitrogen compounds (such as tetrabutyl ammonium bromide), and an associated product of a halogenated quaternary nitrogen salt and halogen molecules (such as perbromobromopyridium). While any inorganic halogen compounds may be used so long as they react with the organic silver salt to form silver halides, examples thereof include halogenated alkali metals or ammonium (such as sodium chloride, lithium bromide, potassium iodide and ammonium bromide) halogenated alkali earth metals (such as calcium bromide and magnesium chloride), halogenated transition metals (such as ferric chloride and cupric bromide), metal complexes having halogen ligands (such as sodium iridium (III) bromide and ammonium rhodium (III) chloride), and halogen molecules (bromine, chlorine and iodine). Desired organic or inorganic halogen compounds may be used together. The addition amount of the halogen compound for halidation is preferably 1 mmol to 500 mmol, more preferably 10 mmol to 250 mmol, per one mole of the organic silver salt.

While photosensitive silver halide particles can be desalted by the water washing methods known in the art such as a noodle method and flocculation method, desalting is not always necessary in the invention.

The photosensitive silver halide grains are preferably formed in the absence of the organic silver salt in the invention. The photosensitive silver halide grains of the invention are preferably mixed with non-photosensitive organic silver salt after proper control of the particle shape after forming the particles, or after a treatment for sensitization and stabilization such as a chemical sensitization treatment.

5) Heavy Metal

The photosensitive silver halide grain of the invention can contain metals or complexes of metals belonging to groups 8 to 10 of the periodic table (showing groups 1 to 18). The metal or the center metal of the metal complex from groups 8 to 10 of the periodic table is preferably rhodium, ruthenium or iridium. The metal complex may be used alone, or two or more kinds of complexes comprising identical or different species of metals may be used together. A preferred content is within a range from 1×10⁻⁹ mol to 1×10⁻³ mol per one mol of silver. The heavy metals, metal complexes and the addition method thereof are described in JP-A No. 7-225449, in paragraph Nos. 0018 to 0024 of JP-A No. 11-65021 and in paragraph Nos. 0227 to 0240 of JP-A No. 11-119374.

In the present invention, a silver halide grain having a hexacyano metal complex is present on the outermost surface of the grain is preferred. The hexacyano metal complex includes, for example, [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the invention, hexacyano Fe complex is preferred.

Since the hexacyano complex exists in ionic form in an aqueous solution, paired cation is not important and alkali metal ion such as sodium ion, potassium ion, rubidium ion, cesium ion and lithium ion, ammonium ion, alkyl ammonium ion (for example, tetramethyl ammonium ion, tetraethyl ammonium ion, tetrapropyl ammonium ion, and tetra(n-butyl)ammonium ion), which are easily misible with water and suitable to precipitation operation of a silver halide emulsion are preferably used.

The hexacyano metal complex can be added while being mixed with water, as well as a mixed solvent of water and an appropriate organic solvent miscible with water (for example, alcohols, ethers, glycols, ketones, esters and amides) or gelatin.

The addition amount of the hexacyano metal complex is preferably from 1×10⁻⁵ mol to 1×10⁻² mol and, more preferably, from 1×10⁻⁴ mol to 1×10⁻³ per one mol of silver in each case.

In order to allow the hexacyano metal complex to be present on the outermost surface of a silver halide grain, the hexacyano metal complex is directly added in any stage of: after completion of addition of an aqueous solution of silver nitrate used for grain formation, before completion of emulsion forming step prior to a chemical sensitization step, of conducting chalcogen sensitization such as sulfur sensitization, selenium sensitization and tellurium sensitization or noble metal sensitization such as gold sensitization, during washing step, during dispersion step and before chemical sensitization step. In order not to grow the fine silver halide grain, the hexacyano metal complex is rapidly added preferably after the grain is formed, and it is preferably added before completion of the emulsion forming step.

Addition of the hexacyano complex may be started after addition of 96% by weight of an entire amount of silver nitrate to be added for grain formation, more preferably started after addition of 98% by weight and, particularly preferably, started after addition of 99% by weight.

When any of the hexacyano metal complex is added after addition of an aqueous silver nitrate just before completion of grain formation, it can be adsorbed to the outermost surface of the silver halide grain and most of them form an insoluble salt with silver ions on the surface of the grain. Since the hexacyano iron (II) silver salt is a less soluble salt than AgI, re-dissolution with fine grains can be prevented and fine silver halide grains with smaller grain size can be prepared.

Metal atoms that can be contained in the silver halide grain used in the invention (for example, [Fe(CN)₆]⁴⁻), desalting method of a silver halide emulsion and chemical sensitization method are described in paragraph Nos. 0046 to 0050 of JP-A No. 11-84574, in paragraph Nos. 0025 to 0031 of JP-A No. 11-65021, and paragraph Nos. 0242 to 0250 of JP-A No. 11-119374.

6) Gelatin

As the gelatin contained the photosensitive silver halide emulsion used in the invention, various kinds of gelatins can be used. It is necessary to maintain an excellent dispersion state of a photosensitive silver halide emulsion in an organic silver salt containing coating solution, and low molecular weight gelatin having a molecular weight of 500 to 60,000 is preferably used. These low molecular weight gelatins may be used at grain formation or at the time of dispersion after desalting treatment and it is preferably used at the time of dispersion after desalting treatment.

7) Chemical Sensitization

The photosensitive silver halide in this invention can be used without chemical sensitization, but is preferably chemically sensitized by at least one of chalcogen sensitization method, gold sensitization method and reduction sensitization method. The chalcogen sensitization method includes sulfur sensitization method, selenium sensitization method and tellurium sensitization method.

In sulfur sensitization, unstable sulfur compounds can be used. Such unstable sulfur compounds are described in P. Grafkides, Chemie et Pysique Photographique (Paul Momtel, 1987, 5th ed.,) and Research Disclosure (vol. 307, Item 307105), and the like.

As typical examples of sulfur sensitizer, known sulfur compounds such as thiosulfates(e.g., hypo), thioureas (e.g., diphenylthiourea, triethylthiourea, N-ethyl-N′-(4-methyl-2-thiazolyl)thiourea and carboxymethyltrimethylthiourea), thioamides(e.g., thioacetamide), rhodanines(e.g., diethylrhodanine, 5-benzylydene-N-ethylrhodanine), phosphinesulfides(e.g., trimethylphosphinesulfide), thiohydantoins, 4-oxo-oxazolidin-2-thione derivatives, disulfides or polysulfides(e.g., dimorphorinedisulfide, cystine, hexathiocan-thione), polythionates, sulfur element and active gelatin can be used. Specifically, thiosulfates, thioureas and rhodanines are preferred.

In selenium sensitization, unstable selenium compounds can be used. These unstable selenium compounds are described in JP-B Nos. 43-13489 and 44-15748, JP-A Nos. 4-25832, 4-109340, 4-271341, 5-40324, and 5-11385 and the like.

As typical examples of selenium sensitizer, colloidal metal selenide, selenoureas(eg., N,N-dimethylselenourea, trifluoromethylcarbonyl-trimethylselenourea and acetyltrimethylselemourea), selenamides(eg., selenamide and N,N-diethylphenylselenamide), phosphineselenides(eg., triphenylphosphineselenide and pentafluorophenyl-triphenylphosphineselenide), selenophosphates(e.g., tri-p-tolylselenophosphate and tri-n-butylselenophosphate), selenoketones(e.g., selenobenzophenone), isoselenocyanates, selenocarbonic acids, selenoesters, diacylselenides can be used. Furthermore, non-unstable selenium compounds such as selenius acid, selenocyanic acid, selenazoles and selenides described in JP-B Nos. 46-4553 and 52-34492 can also be used. Specifically, phosphineselenides, selenoureas and salts of selenocyanic acids are preferred.

In the tellurium sensitization, unstable tellurium compounds are used. Unstable tellurium compounds described in JP-A Nos. 4-224595, 4-271341, 4-333043, 5-303157, 6-27573, 6-175,258,6-180478, 6-208186, 6-208184, 6-317867, 7-140579, 7-301879, 7-301880 and the like, can be used as tellurium sensitizer.

As typical examples of tellurium sensitizer, phosphinetellurides(e.g., butyl-diisopropylphosphinetelluride, tributylphosphinetelluride, tributoxyphosphinetelluride and ethoxy-diphenylphosphinetellride), diacyl(di)tellurides(e.g.,bis(diphenylcarbamoyl)ditelluri de, bis(N-phenyl-N-methylcarbamoyl)ditelluride, bis(N-phenyl-N-methylcarbamoyl)ditelluride, bis(N-phenyl-N-benzylcarbamoyl)telluride and bis(ethoxycarmonyl)telluride),telluroureas(e.g., N,N′-dimethylethylenetellurourea and N,N′-diphenylethylenetellurourea), telluramides, telluroesters are used. Specifically, diacyl(di)tellurides and phosphinetellurides are preferred. Especially, the compounds described in paragraph No. 0030 of JP-A No. 11-65021 and compounds represented by the formula (II), (III) and (IV) in JP-A No. 5-313284 are more preferred.

Selenium sensitization and tellurium sensitization are preferred and specifically, tellurium sensitization is more preferred.

In gold sensitization, gold sensitizer described in P. Grafkides, Chemie et Pysique Photographique (Paul Momtel, 1987, 5th ed.,) and Research Disclosure (vol. 307, Item 307105) can be used. To speak concretely, chloroauric acid, potassium chloroaurate, potassium aurithiocyanate, gold sulfide, gold selenide and the like can be used. In addition to these, the gold compounds described in U.S. Pat. Nos. 2,642,361, 5,049,484, 5,049,485, 5,169,751, and 5,252,455, Belg. Patent No. 691857, and the like can also be used. And another novel metal salts except gold such as platinum, palladium, iridium and so on described in P. Grafkides, Chemie et Pysique Photographique (Paul Momtel, 1987, 5th ed.,) and Research Disclosure (vol. 307, Item 307,105) can be used.

The gold sensitization can be used independently, but it is preferably used in combination with the above chalcogen sensitization. Specifically, these sensitizations are gold-sulfur sensitization (gold-plus-sulfur sensitization), gold-selenium sensitization, gold-tellurium sensitization, gold-sulfur-selenium sensitization, gold-sulfur-tellurium sensitization, gold-selenium-tellurium sensitization and gold-sulfur-selenium-tellurium sensitization.

In the invention, chemical sensitization can be applied at any time so long as it is after grain formation and before coating, and it can be applied, after desalting, (1) before spectral sensitization, (2) simultaneously with spectral sensitization, (3) after spectral sensitization and (4) just before coating.

The amount of chalcogen sensitizer used in the invention may vary depending on the silver halide grain used, the chemical ripening condition and the like and it is used by about 10⁻⁸ mol to 10⁻¹ mol, preferably, 10⁻⁷ mol to 10⁻² mol per one mol of the silver halide.

Similarly, the addition amount of the gold sensitizer used in the invention may vary depending on various conditions and it is generally about 10⁻⁷ mol to 10⁻² mol and, more preferably, 10⁻⁶ mol to 5×10⁻³ mol per one mol of the silver halide. There is no particular restriction on the condition for the chemical sensitization in the invention and, appropriately, pAg is 8 or less, preferably, 7.0 or less, more preferably, 6.5 or less and, particularly preferably, 6.0 or less, and pAg is 1.5 or more, preferably, 2.0 or more and, particularly preferably, 2.5 or more; pH is 3 to 10, preferably, 4 to 9; and temperature is at 20° C. to 95° C., preferably, 25° C. to 80° C.

In the invention, reduction sensitization can also be used in combination with the chalcogen sensitization or the gold sensitization. It is specifically preferred to use in combination with the chalcogen sensitization.

As the specific compound for the reduction sensitization, ascorbic acid, thiourea dioxide or dimethylamine borane is preferred, as well as use of stannous chloride, aminoimino methane sulfonic acid, hydrazine derivatives, borane compounds, silane compounds and polyamine compounds are preferred. The reduction sensitizer may be added at any stage in the photosensitive emulsion production process from crystal growth to the preparation step just before coating. Further, it is preferred to apply reduction sensitization by ripening while keeping pH to 8 or higher and pAg to 4 or lower for the emulsion, and it is also preferred to apply reduction sensitization by introducing a single addition portion of silver ions during grain formation.

The addition amount of the reduction sensitizer may also vary depending on various conditions and it is generally about 10⁻⁷ mol to 10⁻¹ mol and, more preferably, 10⁻⁶ mol to 5×10⁻² mol per one mol of the silver halide.

In the silver halide emulsion used in the invention, a thiosulfonic acid compound may be added by the method shown in EP-A No. 293917.

The photosensitive silver halide grain in the invention can be chemically unsensitized, but is preferably chemically sensitized by at least one method of gold sensitization method and chalcogen sensitization method for the purpose of designing a high-photosensitive photothermographic material.

8) Sensitizing Dye

As the sensitizing dye applicable in the invention, those capable of spectrally sensitizing silver halide grains in a desired wavelength region upon adsorption to silver halide grains having spectral sensitivity suitable to spectral characteristic of an exposure light source can be selected advantageously. In the present invention, photothermographic materials are preferably spectrally sensitized by spectral sensitizers having maximum sensitivity in a wavelength from 300 nm to 500 nm. The sensitizing dyes and the addition method are disclosed, for example, JP-A No. 11-65021 (paragraph Nos. 0103 to 0109), as a compound represented by the formula (II) in JP-A No. 10-186572, dyes represented by the formula (I) in JP-A No. 11-119374 (paragraph No. 0106), dyes described in U.S. Pat. Nos. 5,510,236 and 3,871,887 (Example 5), dyes disclosed in JP-A Nos. 2-96131 and 59-48753, as well as in page 19, line 38 to page 20, line 35 of EP-A No. 0803764A1, and in JP-A Nos. 2001-272747, 2001-290238 and 2002-23306. The sensitizing dyes described above may be used alone or two or more of them may be used in combination. In the invention, sensitizing dye can be added preferably after desalting step and before coating step, and more preferably after desalting step and before the completion of chemical ripening.

In the invention, the sensitizing dye may be added at any amount according to the property of photosensitivity and fogging, but it is preferably added from 1×10⁻⁶ mol to 1 mol, and more preferably, from 1×10⁻⁴ mol to 1×10⁻¹ mol per one mol of silver in each case.

The photothermographic material of the invention may also contain super sensitizers in order to improve spectral sensitizing effect. The super sensitizers usable in the invention can include those compounds described in EP-A No. 587,338, U.S. Pat. Nos. 3,877,943 and 4,873,184 and JP-A Nos. 5-341432, 11-109547, and 10-111543.

9) Combined use of a Plurality of Silver Halides

The photosensitive silver halide emulsion in the photosensitive material used in the invention may be used alone, or two or more kinds of them (for example, those of different average particle sizes, different halogen compositions, different crystal habits and of different conditions for chemical sensitization) may be used together. Gradation can be controlled by using a plural kinds of photosensitive silver halides of different sensitivity. The relevant techniques can include those described, for example, in JP-A Nos. 57-119341, 53-106125, 47-3929, 48-55730, 46-5187, 50-73627, and 57-150841. It is preferred to provide a sensitivity difference of 0.2 or more in terms of log E between each of the emulsions.

10) Mixing Silver Halide and Organic Silver Salt

The photosensitive silver halide in the invention is particularly preferably formed under the absence of the non-photosensitive organic silver salt and then mixed in the process for preparing the organic silver salt. This is because a sufficient sensitivity can not sometimes be attained by the method of forming the silver halide by adding a halogenating agent to the organic silver salt.

The method of mixing the silver halide and the organic silver salt can include a method of mixing a separately prepared photosensitive silver halide and an organic silver salt by a high speed stirrer, ball mill, sand mill, colloid mill, vibration mill, or homogenizer, or a method of mixing a photosensitive silver halide completed for preparation at any timing in the preparation of an organic silver salt and preparing the organic silver salt. The effect of the invention can be obtained preferably by any of the methods described above.

11) Mixing Silver Halide into Coating Solution

In the invention, the time of adding silver halide to the coating solution for the image forming layer is preferably in the range from 180 minutes before to just prior to the coating, more preferably, 60 minutes before to 10 seconds before coating. But there is no restriction for mixing method and mixing condition as far as the effect of the invention appears sufficient. As an embodiment of a mixing method, there is a method of mixing in the tank controlling the average residence time to be desired. The average residence time herein is calculated from addition flux and the amount of solution transferred to the coater. And another embodiment of mixing method is a method using a static mixer, which is described in 8th edition of “Ekitai kongou gijutu” by N. Harnby and M. F. Edwards, translated by Kouji Takahashi (Nikkankougyou shinbunsya, 1989).

12) Application Amount

The application amount of silver halide grains is 0.5 mol % to 15 mol %, preferably 0.5 mol % to 12 mol %, per one mol of silver of a non-photosensitive organic silver salt described above. It is further preferably 0.5 mol % to 7 mol %, particularly preferably 0.5 mol % to 5 mol %.

13) Compound that can be One-Electron-Oxidized to Provide a One-Electron Oxidation Product which Releases One or more Electrons

The photothermographic material of the invention preferably contains a compound that can be one-electron-oxidized to provide a one-electron oxidation product which releases one or more electrons. The said compound can be used in combination with various chemical sensitizers described above to increase the sensitivity of silver halide.

As the compound that can be one-electron-oxidized to provide a one-electron oxidation product which releases one or more electrons is a compound selected from the following Types 1 to 5.
(Type 1) a compound that can be one-electron-oxidized to provide a one-electron oxidation product which further releases at least two electrons, due to being subjected to a subsequent bond cleavage reaction;
(Type 2) a compound that has at least two groups adsorbable to the silver halide and can be one-electron-oxidized to provide a one-electron oxidation product which further releases one electron, due to being subjected to a subsequent bond cleavage reaction;
(Type 3) a compound that can be one-electron-oxidized to provide a one-electron oxidation product, which further releases at least one electron after being subjected to a subsequent bond formation;
(Type 4) a compound that can be one-electron-oxidized to provide a one-electron oxidation product which further releases at least one electron after a subsequent intramolecular ring cleavage reaction; and
(Type 5) a compound represented by X—Y, in which X represents a reducing group and Y represents a leaving group, and convertable by one-electron-oxidizing the reducing group to a one-electron oxidation product which can be converted into an X radical by eliminating the leaving group in a subsequent X—Y bond cleavage reaction, one electron being released from the X radical.

Each compound of Type 1 and Types 3 to 5 preferably is a “compound having a sensitizing dye moiety” or a “compound having an adsorbable group to the silver halide”. More preferred is a “compound having an adsorbable group to the silver halide”. Each compound of Types 1 to 4 more preferably is a “compound having a heterocyclic group containing nitrogen atoms substituted by two or more mercapto groups”.

The compound of Type 1 to 5 will be described in detail below.

In the compound of Type 1, the term “the bond cleavage reaction” specifically means a cleavage reaction of a bond of carbon-carbon, carbon-silicon, carbon-hydrogen, carbon-boron, carbon-tin or carbon-germanium. Cleavage of a carbon-hydrogen bond may be followed after the cleavage reaction. The compound of Type 1 can be one-electron-oxidized to be converted into the one-electron oxidation product, and thereafter can release further two or more electrons, preferably three or more electrons with the bond cleavage reaction.

The compound of Type 1 is preferably represented by any one of formulae (A), (B), (11), (12) and (13).

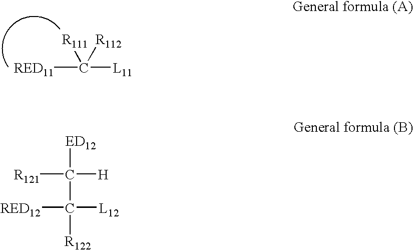

In formula (A), RED₁₁ represents a reducing group that can be one-electron-oxidized, and L₁₁ represents a leaving group. R₁₁₂ represents a hydrogen atom or a substituent. R₁₁₁ represents a nonmetallic atomic group forming a tetrahydro-, hexahydro- or octahydro-derivative of a 5- or 6-membered aromatic ring including aromatic heterocycles.

In formula (B), RED₁₂ represents a reducing group that can be one-electron-oxidized, and L₁₂ represents a leaving group. R₁₂₁ and R₁₂₂ each represent a hydrogen atom or a substituent. ED₁₂ represents an electron-donating group. In formula (B), R₁₂₁ and RED₁₂, R₁₂₁ and R₁₂₂, and ED₁₂ and RED₁₂ may bond together to form a ring structure, respectively.

In the compound represented by formula (A) or (B), the reducing group of RED₁₁ or RED₁₂ is one-electron-oxidized, and thereafter the leaving group of L₁₁, or L₁₂ is spontaneously eliminated in the bond cleavage reaction. Further two or more, preferably three or more electrons can be released with the bond cleavage reaction.

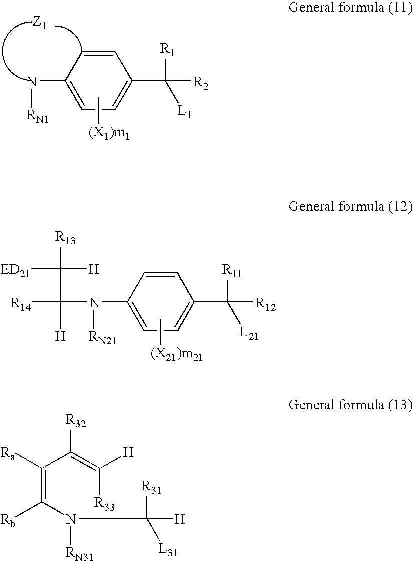

In formula (11), Z₁ represents an atomic group forming a 6-membered ring with a nitrogen atom and 2 carbon atoms in a benzene ring; R₁, R₂ and R_{N1} each represent a hydrogen atom or a substituent; X₁ represents a substituent capable of substituting for a hydrogen atom on a benzene ring; m₁ represents an integer from 0 to 3; and L₁ represents a leaving group. In formula (12), ED₂₁ represents an electron-donating group; R₁₁, R₁₂, R_{N21}, R₁₃ and R₁₄ each represent a hydrogen atom or a substituent; X₂₁ represents a substituent capable of substituting for a hydrogen atom on a benzene ring; m₂₁ represents an integer from 0 to 3; and L₂₁ represents a leaving group. R_{N21}, R₁₃, R₁₄, X₂₁ and ED₂₁ may bond to each other to form a ring structure. In formula (13), R₃₂, R₃₃, R₃₁, R_{N31}, Rₐ and R_{b} each represent a hydrogen atom or a substituent; and L₃₁ represents a leaving group. Incidentally, Rₐ and R_{b} bond together to form an aromatic ring when R_{N31} is not an aryl group.

After the compound is one-electron-oxidized, the leaving group of L₁, L₂₁ or L₃₁ is spontaneously eliminated in the bond cleavage reaction. Further two or more, preferably three or more electrons can be released with the bond cleavage reaction.

First, the compound represented by formula (A) will be described in detail below.

In formula (A), the reducing group of RED₁₁ can be one-electron-oxidized and can bond to after-mentioned R₁₁₁ to form the particular ring structure. Specifically, the reducing group may be a divalent group provided by removing one hydrogen atom from the following monovalent group at a position suitable for ring formation.

The monovalent group may be an alkylamino group; an arylamino group such as an anilino group and a naphthylamino group; a heterocyclic amino group such as a benzthiazolylamino group and a pyrrolylamino group; an alkylthio group; an arylthio group such as a phenylthio group; a heterocyclic thio group; an alkoxy group; an aryloxy group such as a phenoxy group; a heterocyclic oxy group; an aryl group such as a phenyl group, a naphthyl group and an anthranil group; or an aromatic or nonaromatic heterocyclic group, containing at least one heteroatom selected from the group consisting of a nitrogen atom, a sulfur atom, an oxygen atom and a selenium atom, which has a 5- to 7-membered, monocyclic or condensed ring structure such as a tetrahydroquinoline ring, a tetrahydroisoquinoline ring, a tetrahydroquinoxaline ring, a tetrahydroquinazoline ring, an indoline ring, an indole ring, an indazole ring, a carbazole ring, a phenoxazine ring, a phenothiazine ring, a benzothiazoline ring, a pyrrole ring, an imidazole ring, a thiazoline ring, a piperidine ring, a pyrrolidine ring, a morpholine ring, a benzimidazole ring, a benzimidazoline ring, a benzoxazoline ring and a methylenedioxyphenyl ring. RED₁₁ is hereinafter described as the monovalent group for convenience. The monovalent groups may have a substituent.

Examples of the substituent include halogen atoms; alkyl groups including aralkyl groups, cycloalkyl groups, active methine groups, etc.; alkenyl groups; alkynyl groups; aryl groups; heterocyclic groups, which may bond at any position; heterocyclic groups containing a quaternary nitrogen atom such as a pyridinio group, an imidazolio group, a quinolinio group and an isoquinolinio group; acyl groups; alkoxycarbonyl groups; aryloxycarbonyl groups; carbamoyl groups; a carboxy group and salts thereof; sulfonylcarbamoyl groups; acylcarbamoyl groups; sulfamoylcarbamoyl groups; carbazoyl groups; oxalyl groups; oxamoyl groups; a cyano group; carbonimidoyl groups; thiocarbamoyl groups; a hydroxy group; alkoxy groups, which may contain a plurality of ethyleneoxy groups or propyleneoxy groups as a repetition unit; aryloxy groups; heterocyclic oxy groups; acyloxy groups; alkoxy or aryloxy carbonyloxy groups; carbamoyloxy groups; sulfonyloxy groups; amino groups; alkyl, aryl or heterocyclic amino groups; acylamino groups; sulfoneamide groups; ureide groups; thioureide groups; imide groups; alkoxy or aryloxy carbonylamino groups; sulfamoylamino groups; semicarbazide groups; thiosemicarbazide groups; hydrazino groups; ammonio groups; oxamoylamino groups; alkyl or aryl sulfonylureide groups; acylureide groups; acylsulfamoylamino groups; a nitro group; a mercapto group; alkyl, aryl or heterocyclic thio groups; alkyl or aryl sulfonyl groups; alkyl or aryl sulfinyl groups; a sulfo group and salts thereof; sulfamoyl groups; acylsulfamoyl groups; sulfonylsulfamoyl groups and salts thereof; groups containing a phosphoric amide or phosphate ester structure; etc. These substituents may be further substituted by these substituents.

RED₁₁ is preferably an alkylamino group, an arylamino group, a heterocyclic amino group, an aryl group, an aromatic heterocyclic group, or nonaromatic heterocyclic group. RED₁₁ is more preferably an arylamino group (particularly an anilino group), or an aryl group (particularly a phenyl group). When RED₁₁ has a substituent, preferred as a substituent include halogen atoms, alkyl groups, alkoxy groups, carbamoyl groups, sulfamoyl groups, acylamino groups, sulfoneamide groups. When RED₁₁ is an aryl group, it is preferred that the aryl group has at least one “electron-donating group”. The “electron-donating group” is a hydroxy group; an alkoxy group; a mercapto group; a sulfoneamide group; an acylamino group; an alkylamino group; an arylamino group; a heterocyclic amino group; an active methine group; an electron-excess, aromatic, heterocyclic group with a 5-membered monocyclic ring or a condensed-ring including at least one nitrogen atom in the ring such as an indolyl group, a pyrrolyl group, an imidazolyl group, a benzimidazolyl group, a thiazolyl group, a benzthiazolyl group and an indazolyl group; a nitrogen-containing, nonaromatic heterocyclic group that substitutes at the nitrogen atom, such as so-called cyclic amino group like pyrrolidinyl group, an indolinyl group, a piperidinyl group, a piperazinyl group and a morpholino group; etc.

The active methine group is a methine group having two “electron-withdrawing groups”, and the “electron-withdrawing group” is an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group or a carbonimidoyl group. The two electron-withdrawing groups may bond together to form a ring structure.

In formula (A), specific examples of L₁₁ include a carboxy group and salts thereof, silyl groups, a hydrogen atom, triarylboron anions, trialkylstannyl groups, trialkylgermyl groups and a —CR_{C1}R_{C2}R_{C3} group. When L₁₁ represents a silyl group, the silyl group is specifically a trialkylsilyl group, an aryldialkylsilyl group, a triarylsilyl group, etc, and they may have a substituent.

When L₁₁ represents a salt of a carboxy group, specific examples of a counter ion to form the salt include alkaline metal ions, alkaline earth metal ions, heavy metal ions, ammonium ions, phosphonium ions, etc. Preferred as a counter ion are alkaline metal ions and ammonium ions, most preferred are alkaline metal ions such as Li⁺, Na⁺ and K⁺.

When L₁₁ represents a —CR_{C1}R_{C2}R_{C3} group, R_{C1}, R_{C2} and R_{C3} independently represent a hydrogen atom, an alkyl group, an aryl group, a heterocyclic group, an alkylthio group, an arylthio group, an alkylamino group, an arylamino group, a heterocyclic amino group, an alkoxy group, an aryloxy group or a hydroxy group. R_{C1}, R_{C2} and R_{C3} may bond to each other to form a ring structure, and may have a substituent. Incidentally, when one of R_{C1}, R_{C2} and R_{C3} is a hydrogen atom or an alkyl group, there is no case where the other two of them are a hydrogen atom or an alkyl group. R_{C1}, R_{C2} and R_{C3} are preferably an alkyl group, an aryl group (particularly a phenyl group), an alkylthio group, an arylthio group, an alkylamino group, an arylamino group, a heterocyclic group, an alkoxy group or a hydroxy group, respectively. Specific examples thereof include a phenyl group, a p-dimethylaminophenyl group, a p-methoxyphenyl group, a 2,4-dimethoxyphenyl group, a p-hydroxyphenyl group, a methylthio group, a phenylthio group, a phenoxy group, a methoxy group, an ethoxy group, a dimethylamino group, an N-methylanilino group, a diphenylamino group, a morpholino group, a thiomorpholino group, a hydroxy group, etc. Examples of the ring structure formed by R_{C1}, R_{C2} and R_{C3} include a 1,3-dithiolane-2-yl group, a 1,3-dithiane-2-yl group, an N-methyl-1,3-thiazolidine-2-yl group, an N-benzyl-benzothiazolidine-2-yl group, etc.

It is also preferred that the —CR_{C1}R_{C2}R_{C3} group is the same as a residue provided by removing L₁₁ from formula (A) as a result of selecting each of R_{C1}, R_{C2} and R_{C3} as above.

In formula (A), L₁₁ is preferably a carboxy group or a salt thereof, or a hydrogen atom, more preferably a carboxy group or a salt thereof.

When L₁₁ represents a hydrogen atom, the compound represented by formula (A) preferably has a base moiety. After the compound represented by formula (A) is oxidized, the base moiety acts to eliminate the hydrogen atom of L₁₁ and to release an electron.

The base is specifically a conjugate base of an acid with a pKa value of approximately 1 to 10. For example, the base moiety may contain a structure of a nitrogen-containing heterocycle such as pyridine, imidazole, benzoimidazole and thiazole; aniline; trialkylamine; an amino group; a carbon acid such as an active methylene anion; a thioacetic acid anion; carboxylate (—COO⁻); sulfate (—SO₃⁻); amineoxide (>N⁺(O⁻)—); and derivatives thereof. The base is preferably a conjugate base of an acid with a pKa value of approximately 1 to 8, more preferably carboxylate, sulfate or amineoxide, particularly preferably carboxylate. When these bases have an anion, the compound of formula (A) may have a counter cation. Examples of the counter cation include alkaline metal ions, alkaline earth metal ions, heavy metal ions, ammonium ions, phosphonium ions, etc. The base moiety may be at an optional position of the compound represented by formula (A). The base moiety may be connected to RED₁₁, R₁₁₁ or R₁₁₂ in formula (A), and to a substituent thereon.

In formula (A), R₁₁₂ represents a substituent capable of substituting a hydrogen atom or a carbon atom therewith, provided that R₁₁₂ and L₁₁ do not represent the same group.

R₁₁₂ preferably represents a hydrogen atom, an alkyl group, an aryl group (such as a phenyl group), an alkoxy group (such as a methoxy group, a ethoxy group, a benzyloxy group), a hydroxy group, an alkylthio group, (such as a methylthio group, a butylthio group), and amino group, an alkylamino group, an arylamino group, a heterocyclic amino group or the like; and more preferably represents a hydrogen atom, an alkyl group, an alkoxy group, a hydroxy group, a phenyl group and an alkylamino group.

Ring structures formed by R₁₁₁ in formula (A) are ring structures corresponding to a tetrahydro structure, a hexahydro structure, or an octahydro structure of a five-membered or six-membered aromatic ring (including an aromatic hetro ring), wherein a hydro structure means a ring structure in which partial hydrogenation is performed on a carbon-carbon double bond (or a carbon-nitrogen double bond) contained in an aromatic ring (an aromatic hetero ring) as a part thereof, wherein the tetrahydro structure is a structure in which 2 carbon-carbon double bonds (or carbon-nitrogen double bonds) are hydrogenated, the hexahydro structure is a structure in which 3 carbon-carbon double bonds (or carbon-nitrogen double bonds) are hydrogenated, and the octahydro structure is a structure in which 4 carbon-carbon double bonds (or carbon-nitrogen double bonds) are hydrogenated. Hydrogenation of an aromatic ring produces a partially hydrogenated non-aromatic ring structure.

Examples include a pyrrolidine ring, an imidazolidine ring, a thiazolidine ring, a pyrazolidine ring, an oxazolidine ring, a piperidine ring, a tetrahydropyridine ring, a tetrahydropyrimidine ring, a piperazine ring, a tetralin ring, a tetrahydroquinoline ring, a tetrahydroisoquinoline ring, a tetrahydroquinazoline ring and a tetrahydroquinoxaline ring, a tetrahydrocarbazole ring, an octahydrophenanthridine ring and the like. The ring structures may have any substituent therein.

More preferable examples of a ring structure forming R₁₁₁ include a pyrrolidine ring, an imidazolidine ring, a piperidine ring, a tetrahydropyridine ring, a tetrahydropyrimidine ring, a piperazine ring, a tetrahydroquinoline ring, a tetrahydroisoquinoline ring, a tetrahydroquinazoline ring, a tetrahydroquinoxaline ring and a tetracarbazole ring. Particularly preferable examples include a pyrrolidine ring, a piperidine ring, a piperazine ring, a tetrahydropyridine ring, a tetrahydroquinoline ring, a tetrahydroisoquinoline ring, a tetrahydroquinazoline ring and a tetrahydroquinoxaline ring; and most preferable examples include a pyrrolidine ring, a piperidine ring, a tetrahydropyridine ring, a tetrahydroquinoline ring and a tetrahydroisoquinoline ring.

In formula (B), RED₁₂ and L₁₂ represent groups having the respective same meanings as RED₁₁ and L₁₁ in formula (A), and have the respective same preferable ranges as RED₁₁ and L₁₁ in formula (A). RED₁₂ is a monovalent group except a case where RED₁₂ forms the following ring structure and to be concrete, there are exemplified groups each with a name of a monovalent group described as RED₁₁. RED₁₂₁ and L₁₂₂ represent groups having the same meaning as R₁₁₂ in formula (A), and have the same preferable range as R₁₁₂ in formula (A). ED₁₂ represents an electron-donating group. Each pair of R₁₂₁ and RED₁₂; R₁₂₁ and R₁₂₂; or ED₁₂ and RED₁₂ may form a ring structure by bonding with each other.

An electron-donating group represented by RED₁₂ in formula (B) is the same as an electron-donating group described as a substituent when RED₁₁ represents an aryl group. Preferable examples of RED₁₂ include a hydroxy group, an alkoxy group, a mercapto group, a sulfonamide group, an alkylamino group, an arylamino group, an active methine group, an electron-excessive aromatic heterocyclic group in a five-membered single ring or fused ring structure containing at least one nitrogen atom in a ring structure as part of the ring, a non-aromatic nitrogen containing hetrocyclic group having a nitrogen atom as a substitute, and a phenyl group substituted with an electron donating group described above, and more preferable examples thereof include a non-aromatic nitrogen containing heterocyclic group further substituted with a hydroxy group, a mercapto group, a sulfonamide group, an alkylamino group, an arylamino group, an active methine group, or a nitrogen atom; and a phenyl group substituted with an electron-donating group described above (for example, a p-hydroxyphenyl group, a p-dialkylaminophenyl group, an o- or p-dialkoxyphenyl group and the like).

In formula (B), R₁₂₁ and RED₁₂; R₁₂₂ and R₁₂₁; or ED₁₂ and RED₁₂ may bond to each other to form a ring structure. A ring structure formed here is a non-aromatic carbon ring or hetero ring in a 5- to 7-membered single ring or fused ring structure which is substituted or unsubstituted. Concrete examples of a ring structure formed from R₁₂₁ and RED₁₂ include, in addition to the examples of the ring structure formed by R₁₁₁ in formula (A), a pyrroline ring, an imidazoline ring, a thiazoline ring, a pyrazoline ring, an oxazoline ring, an indan ring, a morphorine ring, an indoline ring, a tetrahydro-1,4-oxazine ring, 2,3-dihydrobenzo-1,4-oxazine ring, a tetrahydro-1,4-thiazine ring, 2,3-dihydrobenzo-1,4-thiazine ring, 2,3-dihydrobenzofuran ring, 2,3-dihydrobenzothiophene ring and the like. In formation of a ring structure from ED₁₂ and RED₁₂, ED₁₂ is preferably an amino group, an alkylamino group or an arylamino group and concrete examples of the ring structure include a tetrahyropyrazine ring, a piperazine ring, a tetrahydroquinoxaline ring, a tetrahydroisoquinoline ring and the like. Concrete examples of a ring structure formed from R₁₂₂ and R₁₂₁ include a cyclohexane ring, a cyclopentane ring and the like.

Below, description will be given of formulae (11) to (13).

In formulae (11) to (13), R₁, R₂, R₁₁, R₁₂ and R₃₁ represent the same meaning as R₁₁₂ of formula (A) and have the same preferable range as R₁₁₂ of formula (A) L₁, L₂₁ and L₃₁ independently represents the same leaving groups as the groups shown as concrete examples in description of L₁₁ of formula (A) and also have the same preferable range as L₁₁, of formula (A). The substituents represented by X₁ and X₂₁ are the same as the examples of substituents of RED₁₁ of formula (A) and have the same preferable range as RED₁₁ of formula (A). m₁ and m₂ are preferably integers from 0 to 2 and more preferably integers of 0 or 1.

When R_{N1}, R_{N21} and R_{N31} each represent a substituent, preferred as a substituent include an alkyl group, an aryl group or a heterocyclic group, and may further have a substituent. Each of R_{N1}, R_{N21} and R_{N31} is preferably a hydrogen atom, an alkyl group or an aryl group, more preferably a hydrogen atom or an alkyl group.

When R₁₃, R₁₄, R₃₂, R₃₃, Rₐ and R_{b} independently represent a substituent, the substituent is preferably an alkyl group, an aryl group, an acyl group, an alkoxycarbonyl group, a carbamoyl group, a cyano group, an alkoxy group, an acylamino group, a sulfoneamide group, a ureide group, a thiouredide group, an alkylthio group, an arylthio group, an alkylsulfonyl group, an arylsulfonyl group, or a sulfamoyl group.

The 6-membered ring formed by Z₁ in formula (11) is a nonaromatic heterocycle condensed with the benzene ring in formula (11). The ring structure containing the nonaromatic heterocycle and the benzene ring to be condensed may be specifically a tetrahydroquinoline ring, a tetrahydroquinoxaline ring, or a tetrahydroquinazoline ring, which may have a substituent.

In formula (12), ED₂₁ is the same as ED₁₂ in formula (B) with respect to the meanings and preferred embodiments.

In formula (12), any two of R_{N21}, R₁₃, R₁₄, X₂₁ and ED₂₁ may bond together to form a ring structure. The ring structure formed by R_{N21} and X₂₁ is preferably a 5- to 7-membered, carbocyclic or heterocyclic, nonaromatic ring structure condensed with a benzene ring, and specific examples thereof include a tetrahydroquinoline ring, a tetrahydroquinoxaline ring, an indoline ring, a 2,3-dihydro-5,6-benzo-1,4-thiazine ring, etc. Preferred are a tetrahydroquinoline ring, a tetrahydroquinoxaline ring and an indoline ring.

When R_{N31} is a group other than an aryl group in formula (13), Rₐ and R_{b} bond together to form an aromatic ring. The aromatic ring is an aryl group such as a phenyl group and a naphthyl group, or an aromatic heterocyclic group such as a pyridine ring group, a pyrrole ring group, a quinoline ring group and an indole ring group, preferably an aryl group. The aromatic ring group may have a substituent.

In formula (13), Rₐ and R_{b} preferably bond together to form an aromatic ring, particularly a phenyl group.

In formula (13), R₃₂ is preferably a hydrogen atom, an alkyl group, an aryl group, a hydroxy group, an alkoxy group, a mercapto group or an amino group. When R₃₂ is a hydroxy group, R₃₃ is preferably an electron-withdrawing group. The electron-withdrawing group is the same as described above, preferably an acyl group, an alkoxycarbonyl group, a carbamoyl group or a cyano group.

The compound of Type 2 will be described below.

According to the compound of Type 2, the “bond cleavage reaction” is a cleavage reaction of a bond of carbon-carbon, carbon-silicon, carbon-hydrogen, carbon-boron, carbon-tin or carbon-germanium. Cleavage of a carbon-hydrogen bond may be caused with the cleavage reaction.

The compound of Type 2 has two or more, preferably 2 to 6, more preferably 2 to 4, adsorbent groups to the silver halide. The adsorbable group is further preferably a mercapto-substituted, nitrogen-containing, heterocyclic group. The adsorbable group will hereinafter be described.

The compound of Type 2 is preferably represented by the following formula (C).

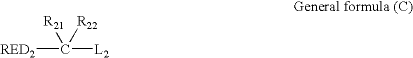

In the compound represented by formula (C), the reducing group of RED₂ is one-electron-oxidized, and thereafter the leaving group of L₂ is spontaneously eliminated, thus a C (carbon atom)-L₂ bond is cleaved, in the bond cleavage reaction. Further one electron can be released with the bond cleavage reaction.

In formula (C), RED₂ is the same as RED₁₂ in formula (B) with respect to the meanings and preferred embodiments. L₂ is the same as L₁₁ in formula (A) with respect to the meanings and preferred embodiments. Incidentally, when L₂ is a silyl group, the compound of formula (C) has two or more mercapto-substituted, nitrogen-containing, heterocyclic groups as the adsorbent groups. R₂₁ and R₂₂ each represent a hydrogen atom or a substituent, and are the same as R₁₁₂ in formula (A) with respect to the meanings and preferred embodiments. RED₂ and R₂₁ may bond together to form a ring structure.

The ring structure is a 5- to 7-membered, monocyclic or condensed, carbocyclic or heterocyclic, nonaromatic ring, and may have a substituent. Incidentally, there is no case where the ring structure corresponds to a tetrahydro-, hexahydro- or octahydro-derivative of an aromatic ring or an aromatic heterocycle. The ring structure is preferably such that corresponds to a dihydro-derivative of an aromatic ring or an aromatic heterocycle, and specific examples thereof include a 2-pyrroline ring, a 2-imidazoline ring, a 2-thiazoline ring, a 1,2-dihydropyridine ring, a 1,4-dihydropyridine ring, an indoline ring, a benzoimidazoline ring, a benzothiazoline ring, a benzoxazoline ring, a 2,3-dihydrobenzothiophene ring, a 2,3-dihydrobenzofuran ring, a benzo-α-pyran ring, a 1,2-dihydroquinoline ring, a 1,2-dihydroquinazoline ring, a 1,2-dihydroquinoxaline ring, etc. Preferred are a 2-imidazoline ring, a 2-thiazoline ring, an indoline ring, a benzoimidazoline ring, a benzothiazoline ring, a benzoxazoline ring, a 1,2-dihydro pyridine ring, a 1,2-dihydroquinoline ring, a 1,2-dihydroquinazoline ring and a 1,2-dihydroquinoxaline ring, more preferred are an indoline ring, a benzoimidazoline ring, a benzothiazoline ring and a 1,2-dihydroquinoline ring, particularly preferred is an indoline ring.

The compound of Type 3 will be described below.

According to the compound of Type 3, “bond formation” means that a bond of carbon-carbon, carbon-nitrogen, carbon-sulfur, carbon-oxygen, etc. is formed.

It is preferable that the one-electron oxidation product releases one or more electrons after an intramolecular bond-forming reaction between the one-electron-oxidized portion and a reactive site in the same molecular such as a carbon-carbon double bond, a carbon-carbon triple bond, an aromatic group and a benzo-condensed, nonaromatic heterocyclic group.

To be more detailed, a one-electron oxidized product (a cation radical species or a neutral radical species generated by elimination of a proton therefrom) formed by one electron oxidizing a compound of Type 3 reacts with a reactive group described above coexisting in the same molecule to form a bond and form a radical species having a new ring structure therein. The radical species have a feature to release a second electron directly or in company with elimination of a proton therefrom. One of compounds of Type 3 has a chance to further release one or more electrons, in a ordinary case two or more electrons, after formation of a two-electron oxidized product, after receiving a hydrolysis reaction in one case or after causing a tautomerization reaction accompanying direct migration of a proton in another case. Alternatively, compounds of Type 3 also include a compound having an ability to further release one or more electron, in an ordinary case two or more electrons directly from a two-electron oxidized product, not by way of a tautomerization reaction.

The compound of Type 3 is preferably represented by the following formula (D).

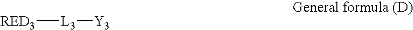

In formula (D), RED₃ represents a reducing group that can be one-electron-oxidized, and Y₃ represents a reactive group that reacts with the one-electron-oxidized RED₃, specifically an organic group containing a carbon-carbon double bond, a carbon-carbon triple bond, an aromatic group or a benzo-condensed, nonaromatic heterocyclic group. L₃ represents a linking group that connects RED₃ and Y₃.

In formula (D), RED₃ has the same meanings as RED₁₂ in formula (B). In formula (D), RED₃ is preferably an arylamino group, a heterocyclic amino group, an aryloxy group, an arylthio group, an aryl group, or an aromatic or nonaromatic heterocyclic group that is preferably a nitrogen-containing heterocyclic group. RED₃ is more preferably an arylamino group, a heterocyclic amino group, an aryl group, or an aromatic or nonaromatic heterocyclic group. Preferred as the heterocyclic group are a tetrahydroquinoline ring group, a tetrahydroquinoxaline ring group, a tetrahydroquinazoline ring group, an indoline ring group, an indole ring group, a carbazole ring group, a phenoxazine ring group, a phenothiazine ring group, a benzothiazoline ring group, a. pyrrole ring group, an imidazole ring group, a thiazole ring group, a benzoimidazole ring group, a benzoimidazoline ring group, a benzothiazoline ring group, a 3,4-methylenedioxyphenyl-1-yl group, etc.

Particularly preferred as RED₃ are an arylamino group (particularly an anilino group), an aryl group (particularly a phenyl group), and an aromatic or nonaromatic heterocyclic group.

The aryl group represented by RED₃ preferably has at least one electron-donating group. The term “electron-donating group” means the same as above-mentioned electron-donating group.

When RED₃ is an aryl group, more preferred as a substituent on the aryl group are an alkylamino group, a hydroxy group, an alkoxy group, a mercapto group, a sulfoneamide group, an active methine group, and a nitrogen-containing, nonaromatic heterocyclic group that substitutes at the nitrogen atom, furthermore preferred are an alkylamino group, a hydroxy group, an active methine group, and a nitrogen-containing, nonaromatic heterocyclic group that substitutes at the nitrogen atom, and the most preferred are an alkylamino group, and a nitrogen-containing, nonaromatic heterocyclic group that substitutes at the nitrogen atom.

When Y₃ is an organic group containing carbon-carbon double bond (for example a vinyl group) having a substituent, more preferred as the substituent are an alkyl group, a phenyl group, an acyl group, a cyano group, an alkoxycarbonyl group, a carbamoyl group and an electron-donating group. The electron-donating group is preferably an alkoxy group; a hydroxy group (that may be protected by a silyl group, and examples of the silyl-protected group include a trimethylsilyloxy group, a t-butyldimethylsilyloxy group, a triphenylsilyloxy group, a triethylsilyloxy group, a phenyldimethylsilyloxy group, etc); an amino group; an alkylamino group; an arylamino group; a sulfoneamide group; an active methine group; a mercapto group; an alkylthio group; or a phenyl group having the electron-donating group as a substituent.

Incidentally, when the organic group containing the carbon-carbon double bond has a hydroxy group as a substituent, Y₃ contains a moiety of >C₁═C₂(—OH)—, which may be tautomerized into a moiety of >C₁H—C₂(═O)—. In this case, it is preferred that a substituent on the C₁ carbon is an electron-withdrawing group, and as a result, Y₃ has a moiety of an active methylene group or an active methine group. The electron-withdrawing group, which can provide such a moiety of an “active methylene group” or an “active methine group”, may be the same as above-mentioned electron-withdrawing group on the methine group of the “active methine group”.

When Y₃ is an organic group containing a carbon-carbon triple bond (for example a ethynyl group) having a substituent, preferred as the substituent is an alkyl group, a phenyl group, an alkoxycarbonyl group, a carbamoyl group, an electron-donating group, etc.

When Y₃ is an organic group containing an aromatic group, preferred as the aromatic group is an aryl group, particularly a phenyl group, having an electron-donating group as a substituent, and an indole ring group. The electron-donating group is preferably a hydroxy group, which may be protected by a silyl group; an alkoxy group; an amino group; an alkylamino group; an active methine group; a sulfoneamide group; or a mercapto group.

When Y₃ is an organic group containing a benzo-condensed, nonaromatic heterocyclic group, preferred as the benzo-condensed, nonaromatic heterocyclic group are groups having an aniline moiety, such as an indoline ring group, a 1,2,3,4-tetrahydroquinoline ring group, a 1,2,3,4-tetrahydroquinoxaline ring group and a 4-quinolone ring group.

The reactive group of Y₃ is more preferably an organic group containing a carbon-carbon double bond, an aromatic group, or a benzo-condensed, nonaromatic heterocyclic group. Furthermore preferred are an organic group containing a carbon-carbon double bond; a phenyl group having an electron-donating group as a substituent; an indole ring group; and a benzo-condensed, nonaromatic heterocyclic group having an aniline moiety. The carbon-carbon double bond more preferably has at least one electron-donating group as a substituent.

It is also preferred that the reactive group represented by Y₃ contains a moiety the same as the reducing group represented by RED₃ as a result of selecting the reactive group as above.

L₃ represents a linking group that connects RED₃ and Y₃, specifically a single bond, an alkylene group, an arylene group, a heterocyclic group, —O—, —S—, —NR_{N}—, —C(═O)—, —SO₂—, —SO—, —P(═O)—, or a combination thereof. R_{N} represents a hydrogen atom, an alkyl group, an aryl group or a heterocyclic group. The linking group represented by L₃ may have a substituent. The linking group represented by L₃ may bond to each of RED₃ and Y₃ at an optional position such that the linking group substitutes optional one hydrogen atom of each RED₃ and Y₃. Preferred examples of L₃ include a single bond; alkylene groups, particularly a methylene group, an ethylene group or a propylene group; arylene groups, particularly a phenylene group; a —C(═O)— group; a —O— group; a —NH— group; —N(alkyl)- groups; and divalent linking groups of combinations thereof.

When a cation radical (X⁺.) provided by oxidizing RED₃ or a radical (X.) provided by eliminating a proton therefrom reacts with the reactive group represented by Y₃ to form a bond, it is preferable that they form a 3 to 7-membered ring structure containing the linking group represented by L₃. Thus, the radical (X⁺. or X.) and the reactive group of Y are preferably connected though 3 to 7 atoms.

Next, the compound of Type 4 will be described below.

The compound of Type 4 has a reducing group-substituted ring structure. After the reducing group is one-electron-oxidized, the compound can release further one or more electrons with a ring structure cleavage reaction. The ring cleavage reaction proceeds as follows.

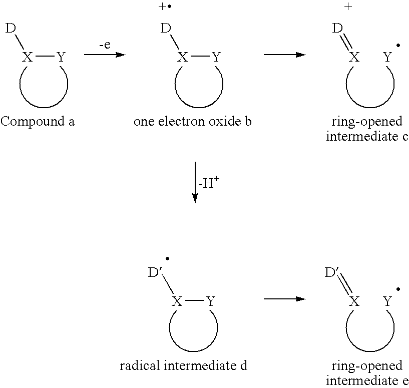

In the formula, compound a is the compound of Type 4. In compound a, D represents a reducing group, and X and Y each represent an atom forming a bond in the ring structure, which is cleaved after the one-electron oxidation. First, compound a is one-electron-oxidized to generate one-electron oxidation product b. Then, the X—Y bond is cleaved with conversion of the D-X single bond into a double bond, whereby ring-opened intermediate c is provided. Alternatively, there is a case where one-electron oxidation product b is converted into radical intermediate d with deprotonation, and ring-opened intermediate e is provided in the same manner. Subsequently, further one or more electrons are released form thus-provided ring-opened intermediate c or e.

The ring structure in the compound of Type 4 is a 3 to 7-membered, carbocyclic or heterocyclic, monocyclic or condensed, saturated or unsaturated, nonaromatic ring. The ring structure is preferably a saturated ring structure, more preferably 3- or 4-membered ring. Preferred examples of the ring structure include a cyclopropane ring, a cyclobutane ring, an oxirane ring, an oxetane ring, an aziridine ring, an azetidine ring, an episulphide ring and a thietane ring. More preferred are a cyclopropane ring, a cyclobutane ring, an oxirane ring, an oxetane ring and an azetidine ring, particularly preferred are a cyclopropane ring, a cyclobutane ring and an azetidine ring. The ring structure may have a substituent.

The compound of Type 4 is preferably represented by the following formula (E) or (F)

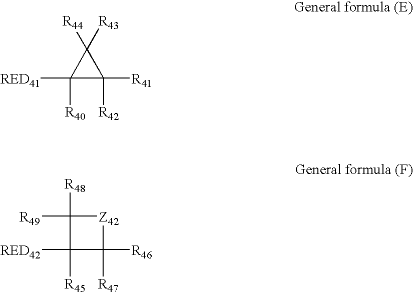

In formulae (E) and (F), RED₄₁ and RED₄₂ are the same as RED₁₂ in formula (B) with respect to the meanings and preferred embodiments, respectively. R₄₀ to R₄₄ and R₄₅ to R₄₉ each represent a hydrogen atom or a substituent. In formula (F), Z₄₂ represents —CR₄₂₀R₄₂₁—, —NR₄₂₃—, or —O—. R₄₂₀ and R₄₂₁ each represent a hydrogen atom or a substituent, and R₄₂₃ represents a hydrogen atom, an alkyl group, an aryl group or a heterocyclic group.

In formulae (E) and (F), each of R₄₀ and R₄₅ is preferably a hydrogen atom, an alkyl group or an aryl group, more preferably a hydrogen atom, an alkyl group or an aryl group. Each of R₄₁ to R₄₄ and R₄₆ to R₄₉ is preferably a hydrogen atom, an alkyl group, an alkenyl group, an aryl group, a heterocyclic group, an arylthio group, an alkylthio group, an acylamino group or a sulfoneamide group, more preferably a hydrogen atom, an alkyl group, an aryl group or a heterocyclic group,

It is preferred that at least one of R₄₁ to R₄₄ is a donor group, and it is also preferred that both of R₄₁ and R₄₂, or both of R₄₃ and R₄₄ are an electron-withdrawing group. It is more preferred that at least one of R₄₁ to R₄₄ is a donor group. It is furthermore preferred that at least one of R₄₁ to R₄₄ is a donor group and R₄₁ to R₄₄ other than the donor group are selected from a hydrogen atom and an alkyl group.

A donor group referred to here is an “electron-donating group” or an aryl group substituted with at least one “electron-donating group.” Preferable examples of donor groups include an alkylamino group, an arylamino group, a heterocyclicamino group, an electron-excessive aromatic heterocyclic group in a five-membered single ring or fused ring structure containing at least one nitrogen atom in a ring structure as part of the ring, a non-aromatic nitrogen containing hetrocyclic group having a nitrogen atom as a substitute and a phenyl group substituted with at least one electron-donating group. More preferable examples thereof include an alkylamino group, an aryamino group, an electron excessive aromatic heterocyclic group in a five-membered single ring or fused ring containing at least one nitrogen atom in a ring structure as a part (an indol ring, a pyrrole ring, a carbazole ring and the like), and a phenyl group substituted with an electron-donating group (a phenyl group substituted with three or more alkoxy groups, a phenyl group substituted with a hydroxy group, an alkylamino group, or an arylamino group and the like). Particularly preferable examples thereof include an aryamino group, an electron excessive aromatic heterocyclic group in a five-membered single ring or fused ring containing at least one nitrogen atom in a ring structure as a part (especially, a 3-indolyl group), and a phenyl group substituted with an electron-donating group (especially, a trialkoxyphenyl group and a phenyl group substituted with an alkylamino group or an arylamino group).

Z₄₂ is preferably —CR₄₂₀R₄₂₁- or —NR₄₂₃-, more preferably —NR₄₂₃—. Each of R₄₂₀ and R₄₂₁ is preferably a hydrogen atom, an alkyl group, an aryl group, a heterocyclic group, an acylamino group or a sulfoneamino group, more preferably a hydrogen atom, an alkyl group, an aryl group or a heterocyclic group. R₄₂₃ is preferably a hydrogen atom, an alkyl group, an aryl group or an aromatic heterocyclic group, more preferably a hydrogen atom, an alkyl group or an aryl group.

The substituent represented by each of R₄₀ to R₄₉, R₄₂₀, R₄₂₁ and R₄₂₃ preferably has 40 or less carbon atoms, more preferably has 30 or less carbon atoms, particularly preferably 15 or less carbon atoms. The substituents of R₄₀ to R₄₉, R₄₂₀, R₄₂₁ and R₄₂₃ may bond to each other or to the other portion such as RED₄₁, RED₄₂ and Z₄₂, to form a ring.

In the compounds of Types 1 to 4 used in the invention, the adsorbable group to the silver halide is such a group that is directly adsorbed on the silver halide or promotes adsorption of the compound onto the silver halide. Specifically, the adsorbable group is a mercapto group or a salt thereof; a thione group (—C(═S)—); a heterocyclic group containing at least one atom selected from the group consisting of a nitrogen atom, a sulfur atom, a selenium atom and a tellurium atom; a sulfide group; a cationic group; or an ethynyl group. Incidentally, the adsorbable group in the compound of Type 2 is not a sulfide group.

The mercapto group or a salt thereof used as the adsorbable group may be a mercapto group or a salt thereof itself, and is more preferably a heterocyclic group, an aryl group or an alkyl group having a mercapto group or a salt thereof as a substituent. The heterocyclic group is a 5- to 7-membered, monocyclic or condensed, aromatic or nonaromatic, heterocyclic group. EXAMPLEs thereof include an imidazole ring group, a thiazole ring group, an oxazole ring group, a benzimidazole ring group, a benzthiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group, etc. The heterocyclic group may contain a quaternary nitrogen atom, and in this case, the mercapto group bonding to the heterocyclic group may be dissociated into a mesoion. Such heterocyclic group may be an imidazolium ring group, a pyrazolium ring group, a thiazolium ring group, a triazolium ring group, a tetrazolium ring group, a thiadiazolium ring group, a pyridinium ring group, a pyrimidinium ring group, a triazinium ring group, etc. Preferred among them is a triazolium ring group such as a 1,2,4-triazolium-3-thiolate ring group. Examples of the aryl group include a phenyl group and a naphthyl group. Examples of the alkyl group include straight, branched or cyclic alkyl groups having 1 to 30 carbon atoms. When the mercapto group forms a salt, a counter ion of the salt may be a cation of an alkaline metal, an alkaline earth metal, a heavy metal, etc. such as Li⁺, Na⁺, K⁺, Mg²⁺, Ag⁺ and Zn²⁺; an ammonium ion; a heterocyclic group containing a quaternary nitrogen atom; a phosphonium ion; etc.

Further, the mercapto group used as the adsorbable group may be tautomerized into a thione group. Specific examples of the thione group include a thioamide group (herein a —C(═S)—NH— group); and groups containing a structure of the thioamide group, such as linear or cyclic thioamide groups, a thiouredide group, a thiourethane group and a dithiocarbamic acid ester group. Examples of the cyclic thioamide group include a thiazolidine-2-thione group, an oxazolidine-2-thione group, a 2-thiohydantoin group, a rhodanine group, an isorhodanine group, a thiobarbituric acid group, a 2-thioxo-oxazolidine-4-one group, etc.

The thione group used as the adsorbent group, as well as the thione group derived from the mercapto group by tautomerization, may be a linear or cyclic, thioamide, thiouredide, thiourethane or dithiocarbamic acid ester group that cannot be tautomerized into the mercapto group or has no hydrogen atom at α-position of the thione group.

The heterocyclic group containing at least one atom selected from the group consisting of a nitrogen atom, a sulfur atom, a selenium atom and tellurium atom, which is used as the adsorbent group, is a nitrogen-containing heterocyclic group having a —NH— group that can form a silver imide (>NAg) as a moiety of the heterocycle; or a heterocyclic group having a —S— group, a —Se— group, a —Te— group or a ═N— group that can form a coordinate bond with a silver ion as a moiety of the heterocycle. Examples of the former include a benzotriazole group, a triazole group, an indazole group, a pyrazole group, a tetrazole group, a benzimidazole group, an imidazole group, a purine group, etc. Examples of the latter include a thiophene group, a thiazole group, an oxazole group, a benzothiazole group, a benzoxazole group, a thiadiazole group, an oxadiazole group, a triazine group, a selenazole group, a benzselenazole group, a tellurazole group, a benztellurazole group, etc. The former is preferable.

The sulfide group used as the adsorbable group may be any group with a —S— moiety, and preferably has a moiety of: alkyl or alkylene-S-alkyl or alkylene; aryl or arylene-S-alkyl or alkylene; or aryl or arylene-S-aryl or arylene. The sulfide group may form a ring structure, and may be a —S—S— group. Specific examples of the ring structure include groups with a thiolane ring, a 1,3-dithiolane ring, a 1,2-dithiolane ring, a thiane ring, a dithiane ring, a tetrahydro-1,4-thiazine ring (a thiomorpholine ring), etc. Particularly preferred as the sulfide groups are groups having a moiety of alkyl or alkylene-S-alkyl or alkylene.

The cationic group used as the adsorbable group is a quaternary nitrogen-containing group, specifically a group with an ammonio group or a quaternary nitrogen-containing heterocyclic group. Incidentally, there is no case where the cationic group partly composes an atomic group forming a dye structure, such as a cyanine chromophoric group. The ammonio group may be a trialkylammonio group, a dialkylarylammonio group, an alkyldiarylammonio group, etc., and examples thereof include a benzyldimethylammonio group, a trihexylammonio group, a phenyldiethylammonio group, etc. Examples of the quaternary nitrogen-containing heterocyclic group include a pyridinio group, a quinolinio group, an isoquinolinio group, an imidazolio group, etc. Preferred are a pyridinio group and an imidazolio group, and particularly preferred is a pyridinio group. The quaternary nitrogen-containing heterocyclic group may have an optional substituent. Preferred as the substituent in the case of the pyridinio group and the imidazolio group are alkyl groups, aryl groups, acylamino groups, a chlorine atom, alkoxycarbonyl groups and carbamoyl groups. Particularly preferred as the substituent in the case of the pyridinio group is a phenyl group.

The ethynyl group used as the adsorbable group means a —C═CH group, in which the hydrogen atom may be substituted.

The adsorbable group may have an optional substituent.

Specific examples of the adsorbable group further include groups described in pages 4 to 7 of a specification of JP-A No. 11-95355.

Preferred as the adsorbable group used in the invention are mercapto-substituted, nitrogen-containing, heterocyclic groups such as a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzthiazole group and a 1,5-dimethyl-1,2,4-triazolium-3-thiolate group; and nitrogen-containing heterocyclic groups having a —NH— group that can form a silver imide (>NAg) as a moiety of the heterocycle, such as a benzotriazole group, a benzimidazole group and an indazole group. Particularly preferred are a 5-mercaptotetrazole group, a 3-mercapto-1,2,4-triazole group and a benzotriazole group, and the most preferred are a 3-mercapto-1,2,4-triazole group and a 5-mercaptotetrazole group.

Among these compounds, it is particularly preferred that the compound has two or more mercapto groups as a moiety. The mercapto group (—SH) may be converted into a thione group in the case where it can be tautomerized. The compound may have two or more adsorbent groups containing above-mentioned mercapto or thione group as a moiety, such as a cyclic thioamide group, an alkylmercapto group, an arylmercapto group and a heterocyclic mercapto group. Further, the compound may have one or more adsorbable group containing two or more mercapto or thione groups as a moiety, such as a dimercapto-substituted, nitrogen-containing, heterocyclic group.

Examples of the adsorbable group containing two or more mercapto group, such as a dimercapto-substituted, nitrogen-containing, heterocyclic group, include a 2,4-dimercaptopyrimidine group, a 2,4-dimercaptotriazine group, a 3,5-dimercapto-1,2,4-triazole group, a 2,5-dimercapto-1,3-thiazole group, a 2,5-dimercapto-1,3-oxazole group, a 2,7-dimercapto-5-methyl-s-triazolo(1,5-A)-pyrimidine group, a 2,6,8-trimercaptopurine group, a 6,8-dimercaptopurine group, a 3,5,7-trimercapto-s-triazolotriazine group, a 4,6-dimercaptopyrazolo pyrimidine group, a 2,5-dimercapto-imidazole group, etc. Particularly preferred are a 2,4-dimercaptopyrimidine group, a 2,4-dimercaptotriazine group, and a 3,5-dimercapto-1,2,4-triazole group.

The adsorbable group may be connected to any position of the compound represented by each of formulae (A) to (F) and (11) to (13). Preferred portions, which the adsorbable group bonds to, are RED₁₁, RED₁₂, RED₂ and RED₃ in formulae (A) to (D), RED₄₁, R₄₁, RED₄₂, and R₄₆ to R₄₈ in formulae (E) and (F), and optional portions other than R₁, R₂, R₁₁, R₁₂, R₃₁, L₁, L₂₁ and L₃₁ in formulae (11) to (13). Further, more preferred portions are RED₁₁ to RED₄₂ in formulae (A) to (F).

The spectral sensitizing dye moiety is a group containing a spectral sensitizing dye chromophore, a residual group provided by removing an optional hydrogen atom or substituent from a spectral sensitizing dye compound. The spectral sensitizing dye moiety may be connected to any position of the compound represented by each of formulae (A) to (F) and (11) to (13). Preferred portion, which the spectral sensitizing dye moiety bonds to, are RED₁₁, RED₁₂, RED₂ and RED₃ in formulae (A) to (D) RED₄₁, R₄₁, RED₄₂, and R₄₆ to R₄₈ in formulae (E) and (F) and optional portions other than R₁, R₂, R₁₁, R₁₂, R₃₁, L₁, L₂₁ and L₃₁ in formulae (11) to (13). Further, more preferred portions are RED₁₁ to RED₄₂ in formulae (A) to (F). The spectral sensitizing dye is preferably such that typically used in color sensitizing techniques. Examples thereof include cyanine dyes, composite cyanine dyes, merocyanine dyes, composite merocyanine dyes, homopolar cyanine dyes, styryl dyes, and hemicyanine dyes. Typical spectral sensitizing dyes are disclosed in Research Disclosure, Item 36544, September 1994. The dyes can be synthesized by one skilled in the art according to procedures described in the above Research Disclosure and F. M. Hamer, The Cyanine dyes and Related Compounds, Interscience Publishers, New York, 1964. Further, dyes described in pages 4 to 7 of a specification of JP-A No. 11-95355 (U.S. Pat. No. 6,054,260) may be used in the invention.

The compounds of Types 1 to 4 used in the invention has preferably 10 to 60 carbon atoms in total, more preferably 15 to 50 carbon atoms, furthermore preferably 18 to 40 carbon atoms, particularly preferably 18 to 30 carbon atoms.

When a silver halide photosensitive material using the compounds of Types 1 to 4 is exposed, the compound is one-electron-oxidized. After the subsequent reaction, the compound is further oxidized while releasing one electron, or two or more electrons depending on Type. An oxidation potential in the first one-electron oxidation is preferably 1.4 V or less, more preferably 1.0 V or less. This oxidation potential is preferably 0 V or more, more preferably 0.3 V or more. Thus, the oxidation potential is preferably approximately 0 V to 1.4 V, more preferably approximately 0.3 V to 1.0 V.

The oxidation potential may be measured by a cyclic voltammetry technique. Specifically, a sample is dissolved in a solution of acetonitrile/water containing 0.1 M lithium perchlorate=80/20 (volume %), nitrogen gas is passed through the resultant solution for 10 minutes, and then the oxidation potential is measured at 25° C. at a potential scanning rate of 0.1 V/second by using a glassy carbon disk as a working electrode, using a platinum wire as a counter electrode, and using a calomel electrode (SCE) as a reference electrode. The oxidation potential per SCE is obtained at peak potential of cyclic voltammetric curve.

In the case where the compound of Types 1 to 4 is one-electron-oxidized and release further one electron after the subsequent reaction, an oxidation potential in the subsequent oxidation is preferably −0.5 V to −2 V, more preferably −0.7 V to −2 V, furthermore preferably −0.9 V to −1.6 V.

In the case where the compound of Types 1 to 4 is one-electron-oxidized and release further two or more electrons after the subsequent reaction, oxidation potentials in the subsequent oxidation are not particularly limited. The oxidation potentials in the subsequent oxidation often cannot be measured precisely, because an oxidation potential in releasing the second electron cannot be clearly differentiated from an oxidation potential in releasing the third electron.

Next, the compound of Type 5 will be described.

The compound of Type 5 is represented by X—Y, in which X represents a reducing group and Y represents a leaving group. The reducing group represented by X can be one-electron-oxidized to provide a one-electron oxidation product, which can be converted into an X radical by eliminating the leaving group of Y with a subsequent X—Y bond cleavage reaction. The X radical can release further one electron. The oxidation reaction of the compound of Type 5 may be represented by the following formula.

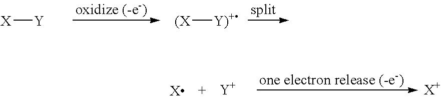

The compound of Type 5 exhibits an oxidation potential of preferably 0 V to 1.4 V, more preferably 0.3 V to 1.0 V. The radical X. generated in the formula exhibits an oxidation potential of preferably −0.7 V to −2.0 V, more preferably −0.9 V to −1.6 V.

The compound of Type 5 is preferably represented by the following formula (G).

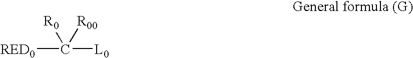

In formula (G), RED₀ represents a reducing group, L₀ represents a leaving group, and R₀ and R₀₀ each represent a hydrogen atom or a substituent. RED₀ and R₀, and R₀ and R₀₀ may be bond together to form a ring structure, respectively. RED₀ is the same as RED₂ in formula (C) with respect to the meanings and preferred embodiments. R₀ and R₀₀ are the same as R₂₁ and R₂₂ in formula (C) with respect to the meanings and preferred embodiments, respectively. Incidentally, R₀ and R₀₀ are not the same as the leaving group of L₀ respectively, except for a hydrogen atom. RED₀ and R₀ may bond together to form a ring structure with examples and preferred embodiments the same as those of the ring structure formed by bonding RED₂ and R₂₁ in formula (C). Examples of the ring structure formed by bonding R₀ and R₀₀ each other include a cyclopentane ring, a tetrahydrofuran ring, etc. In formula (G), L₀ is the same as L₂ in formula (C) with respect to the meanings and preferred embodiments.

The compound represented by formula (G) preferably has an adsorbable group to the silver halide or a spectrally sensitizing dye moiety. However, the compound does not have two or more adsorbable groups when L₀ is a group other than a silyl group. Incidentally, the compound may have two or more sulfide groups as the adsorbent groups, not depending on L₀.

The adsorbable group to the silver halide in the compound represented by formula (G) may be the same as those in the compounds of Types 1 to 4, and further may be the same as all of the compounds and preferred embodiments described as “an adsorbable group to the silver halide” in pages 4 to 7 of a specification of JP-A No. 11-95355.

The spectral sensitizing dye moiety in the compound represented by formula (G) is the same as in the compounds of Types 1 to 4, and may be the same as all of the compounds and preferred embodiments described as “photoabsorptive group” in pages 7 to 14 of a specification of JP-A No. 11-95355.

Specific examples of the compounds of Types 1 to 5 used in the invention are illustrated below without intention of restricting the scope of the invention.

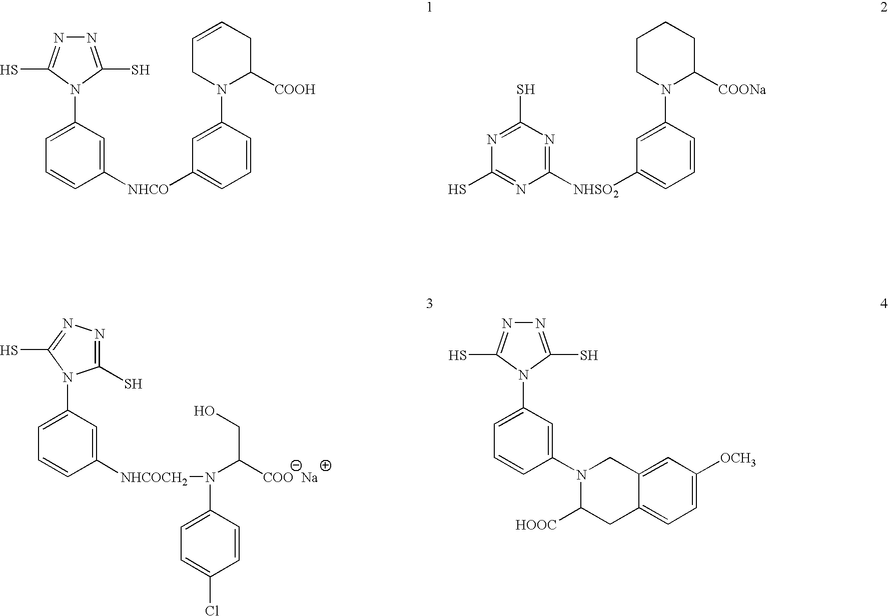

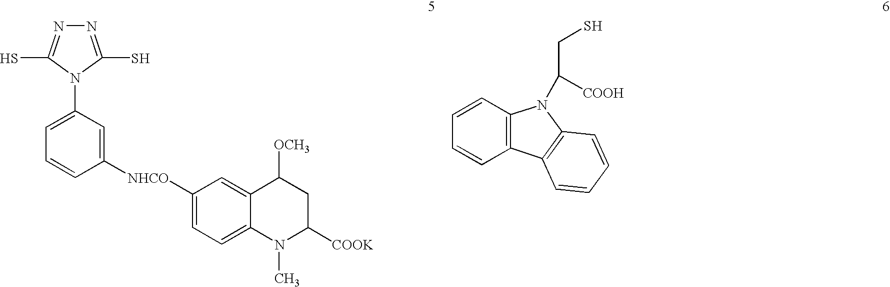

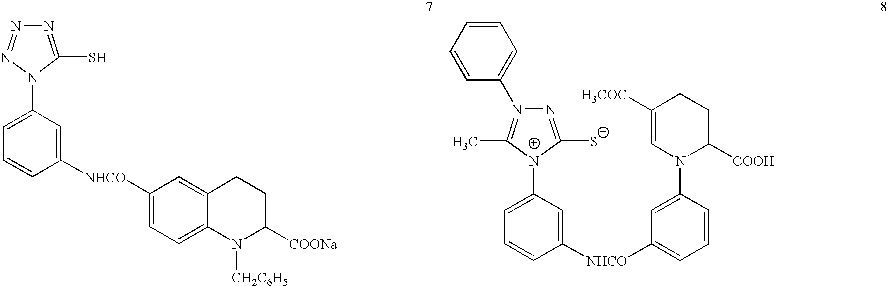

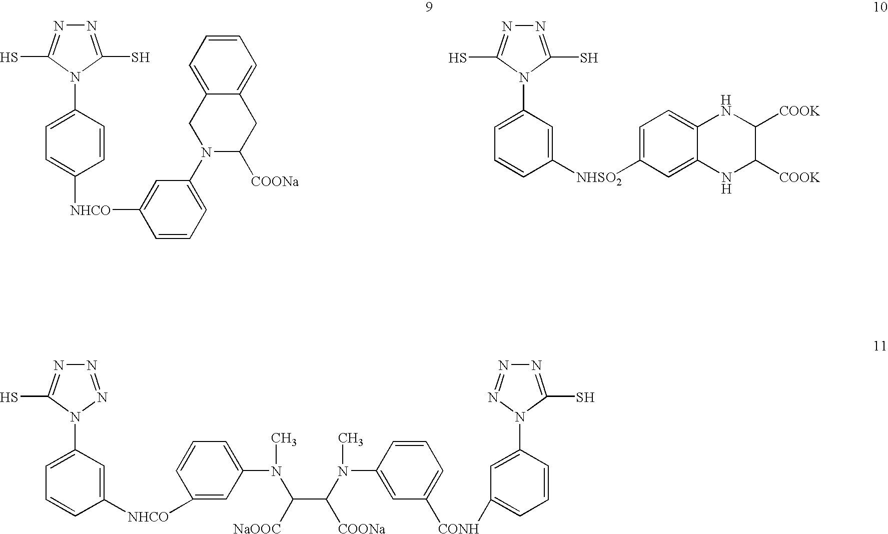

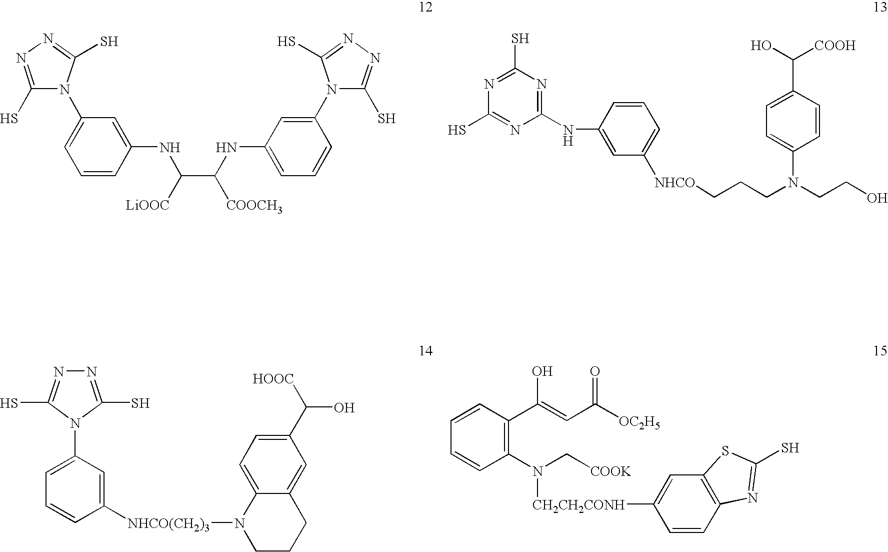

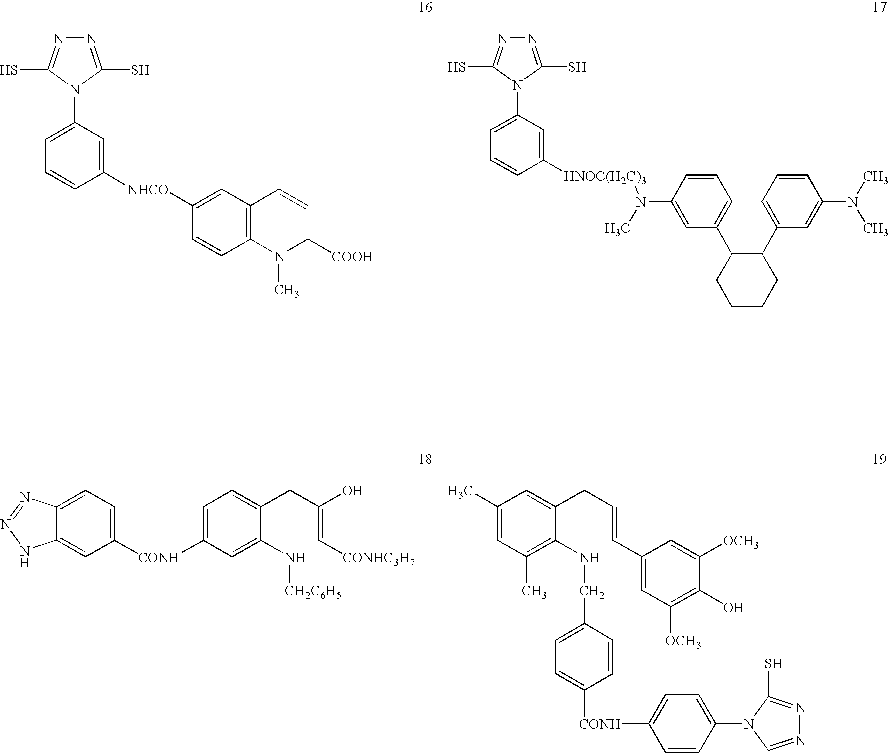

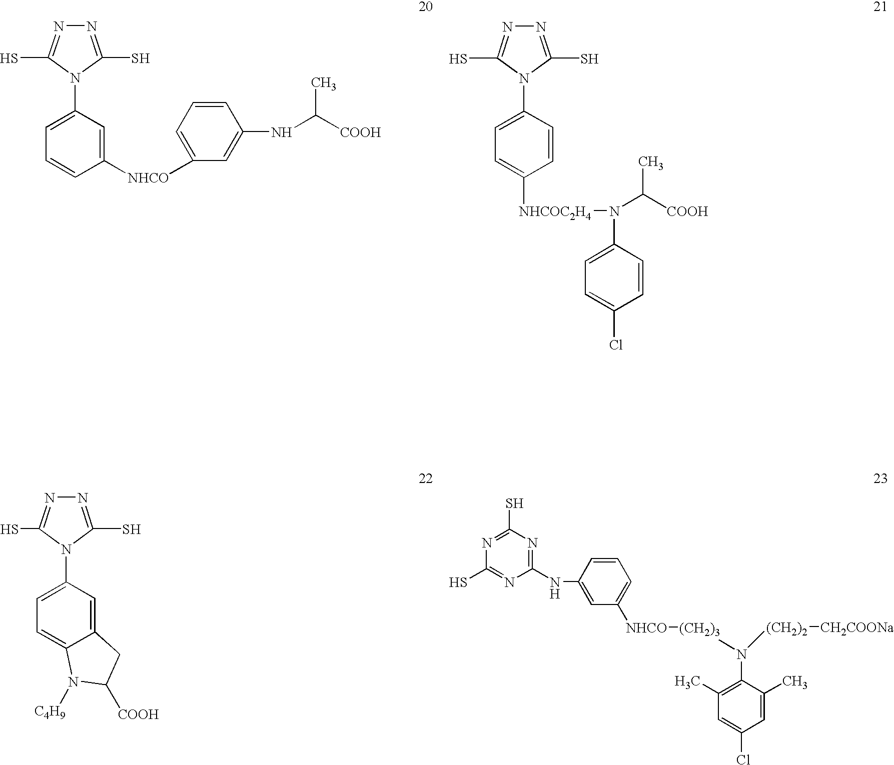

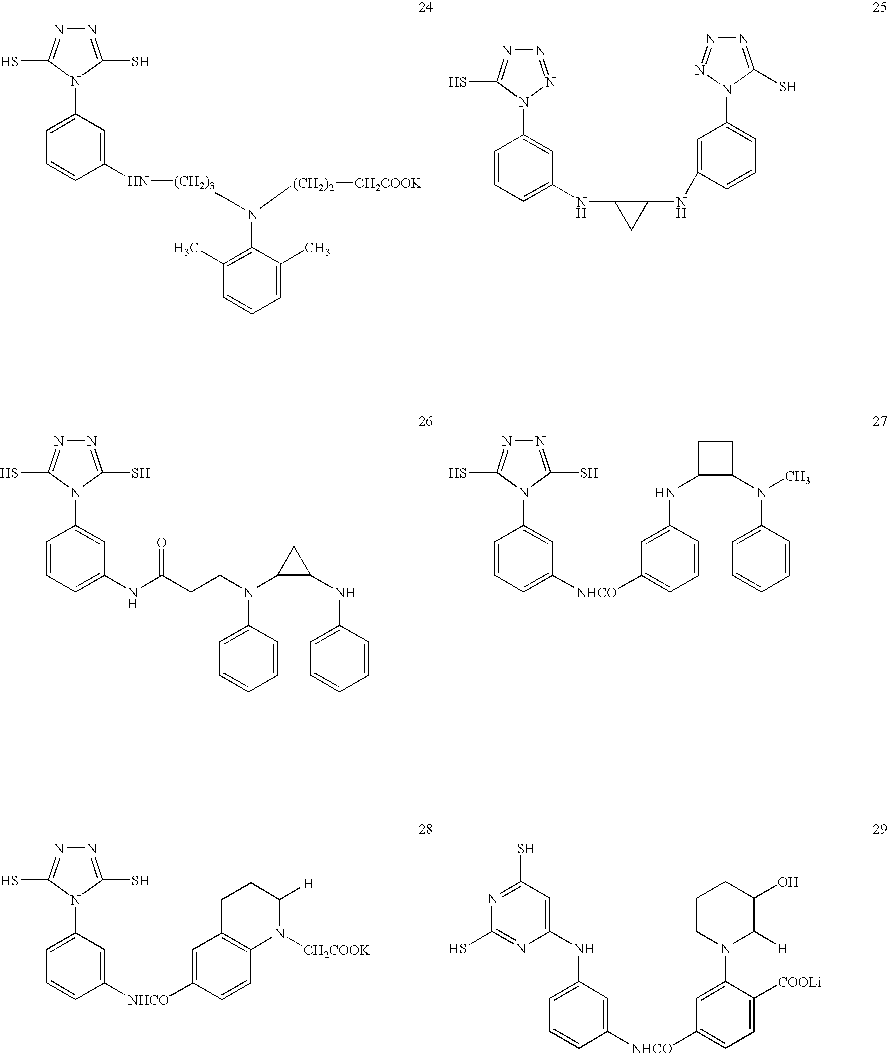

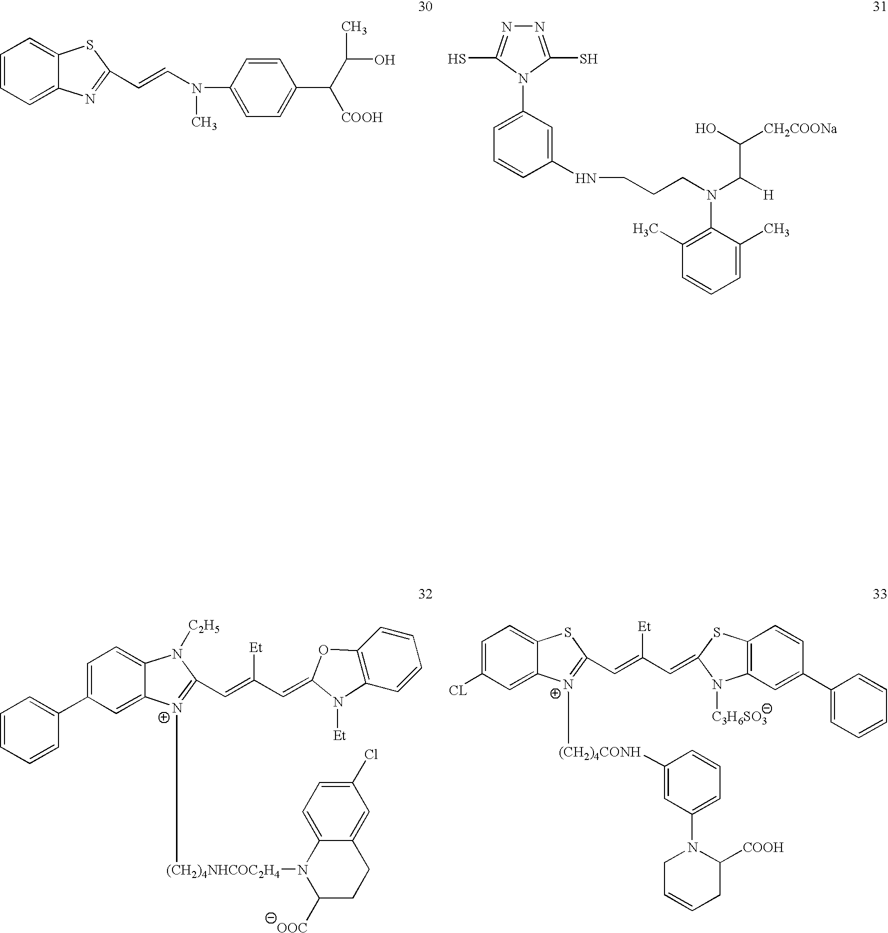

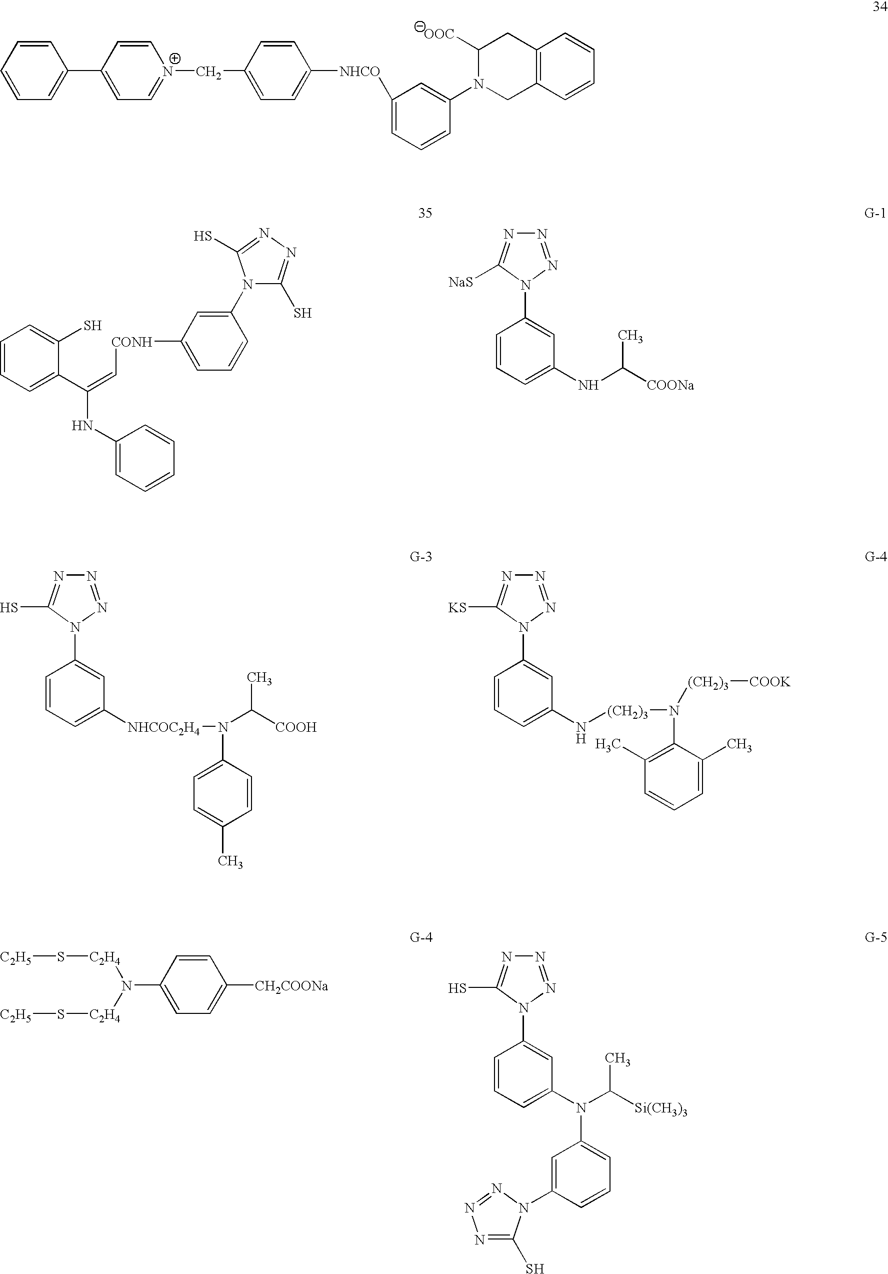

The compounds of Types 1 to 4 used in the invention are the same as compounds described in detail in Japanese Patent Application Nos. 2002-192373, 2002-188537, 2002-188536, 2001-272137 and 2002-192374, respectively. The specific examples of the compounds of Types 1 to 4 used in the invention further include compound examples disclosed in the specifications. Synthesis examples of the compounds of Types 1 to 4 used in the invention may be the same as described in the specifications.

Specific examples of the compound represented by formula (G) further include examples of compound referred to as “one photon two electrons sensitizer” or “deprotonating electron-donating sensitizer” described in JP-A No. 9-211769 (Compound PMT-1 to S-37 in Tables E and F, pages 28 to 32); JP-A No. 9-211774; JP-A No. 11-95355 (Compound INV 1 to 36); JP-W No. 2001-500996 (Compound 1 to 74, 80 to 87, and 92 to 122); U.S. Pat. Nos. 5,747,235 and 5,747,236; EP No. 786692 A1 (Compound INV 1 to 35); EP No. 893732 A1; U.S. Pat. Nos. 6,054,260 and 5,994,051; etc.

The compounds of Types 1 to 5 may be used at any time during preparation of the photosensitive silver halide emulsion and production of the photothermographic material. For example, the compound may be used, in a photosensitive silver halide grain formation step, in a desalting step, in a chemical sensitization step, before application, etc. The compound may be added in numbers, in these steps. The compound is preferably added, after the photosensitive silver halide grain formation step and before the desalting step; in the chemical sensitization step (just before the chemical sensitization to immediately after the chemical sensitization); or before the application. The compound is more preferably added, just before the chemical sensitization step to before mixing with the non-photosensitive organic silver salt.

It is preferred that the compound of Types 1 to 5 used in the invention is dissolved in water, a water-soluble solvent such as methanol and ethanol, or a mixed solvent thereof, to be added. In the case where the compound is dissolved in water and solubility of the compound is increased by increasing or decreasing a pH value of the solvent, the pH value may be increased or decreased to dissolve and add the compound.

The compound of Types 1 to 5 used in the invention is preferably added to the image forming layer comprising the photosensitive silver halide and the non-photosensitive organic silver salt. The compound may be added to a surface protective layer, an intermediate layer, as well as the image forming layer comprising the photosensitive silver halide and the non-photosensitive organic silver salt, to be diffused to the image forming layer in the application step. The compound may be added before or after addition of a sensitizing dye. A mol value of the compound per one mol of the silver halide is preferably 1×10⁻⁹ mol to 5×10⁻¹ mol, more preferably 1×10⁻⁸ mol to 5×10⁻² mol, in a layer comprising the photosensitive silver halide emulsion.

(Binder)

In one aspect of the photothermographic material of the invention, Tg (glass transition temperature) of the binder is 45° C. or less. The binder is preferably a polymer latex synthesized by using a polymerization initiator in an amount of 0.3% by weight to 2.0% by weight based on a total amount of monomers.

The polymer latex is used in a proportion of preferably 50% by weight or more, more preferably 60% by weight or more, and most preferably 70% by weight or more, of the amount of the binder in the image forming layer comprising non-photosensitive organic silver salt.

The photothermographic material shows excellent image stability as a result of using the latex comprising a specified range of a polymerization initiator, chelating agent or chain transfer agent as the binder.

The polymer latex used in the invention can be readily obtained by an emulsion polymerization method. For example, the polymer latex is obtained by emulsion polymerization at 30° C. to 100° C., preferably at 60° C. to 90° C., for 3 to 8 hours with stirring using water or a mixed solvent of water and a water-miscible organic solvent (for example methanol, ethanol, acetone and the like) as a dispersion medium, and using a monomer mixture in an amount of 5% by weight to 50% by weight with respect to the dispersion solvent, an emulsifying agent in an amount of 0.1% by weight to 20% by weight with respect to a total amount of monomers, and a polymerization initiator.

Conditions such as the dispersion medium, monomer concentration, the amount of the initiator, the amount of the emulsifying agent, the amount of the dispersing agent, the reaction temperature and the addition method of the monomer may be appropriately determined considering the kind of the monomer used.

The dispersing agent is preferably used, if necessary.

Emulsion polymerization is usually carried out according to the following documents: “Synthetic Resin Emulsion” ed. by Taira OKUDA and Hiroshi INAGAKI, Polymer Publishing Association (1978); “Application of Synthetic Latex” ed. by Taka-aki SUGIMURA, Yasuo KATAOKA, Sohichi SUZUKI and Keiji KASAHARA, Polymer Publishing Association (1993); and “Chemistry of Synthetic Latex” by Sohichi MUROI, Polymer Publishing Association (1970).

Preferable polymerization methods for synthesizing the polymer latex of the invention may be selected from an overall polymerization method, a monomer addition (continuous or divided) method, an emulsion addition method and a seed polymerization method. The overall polymerization method, monomer addition (continuous or divided) method and emulsion addition method are preferable in view of productivity of the latex.

The polymerization initiator used for the synthesis of the polymer latex of the invention may have a radical generation ability, and examples of them available include inorganic peroxide initiators such as persulfate salts and hydrogen peroxide, peroxide initiators described in the catalogue of organic peroxides by Nippon Oil and Fat Co., and azo compound initiators described in azo polymerization initiator catalogue by Wako Pure Chemical Industries, Ltd. The water soluble peroxide initiators such as persulfate, and water soluble azo compound initiators described in azo polymerization initiator catalogue by Wako Pure Chemical Industries, Ltd., are preferable. Ammonium persulfate, sodium persulfate, potassium persulfate, azobis(2-methylpropionamidine) hydrochloride, azobis(2-methyl-N-(2-hydroxyethyl)propionamide and azobiscyanovaleric acid are more preferable, and peroxide initiators such as ammonium persulfate, sodium persulfate and potassium persulfate are preferable in view of image preservability, solubility and cost.

The amount of the polymerization initiator used for the synthesis of the polymer latex used in the invention is preferably 0.3% by weight to 2.0% by weight, more preferably 0.4% by weight to 1.75% by weight, and particularly preferably 0.5% by weight to 1.5% by weight based on a total amount of monomers. Image stability decreases when the amount of the polymerization initiator is less than 0.3% by weight, while the latex tends to be aggregated to deteriorate coating ability when the amount of the polymerization initiator exceeds 2.0% by weight.

Chelating agents are preferably used for the synthesis of the polymer latex used in the invention. The chelating agent is a compound capable of coordinating multi-valent metal ions such as iron ions and alkali earth metal ions such as calcium ions, and examples thereof include the compounds described in JP-B No. 6-8956; U.S. Pat. No. 5,053,322; and JP-A Nos. 4-73645, 4-127145, 4-247073, 4-305572, 6-11805, 5-173312, 5-66527, 5-158195, 6-118580, 6-110168, 6-161054, 6-175299, 6-214352, 7-114161, 7-114154, 7-120894, 7-199433, 7-306504, 9-43792, 8-314090, 10-182571, 10-182570 and 11-190892.

The chelating agents used in the invention are preferably inorganic chelating agents (sodium tripolyphosphate, sodium hexametaphosphate and sodium tetrapolyphosphate), aminopolycarboxylic acid chelating agents (such as nitrilotriacetic acid and ethylenediamine tetraacetic acid), organic phosphonic acid chelating agents (compounds described in Research Disclosure No. 18170, JP-A Nos. 52-102726; 53-42730, 56-97347, 54-121127, 55-4024, 55-4025, 55-29883, 55-126241, 55-65955, 55-65956, 57-179843 and 54-61125; and WGP No. 1045373), polyphenol chelating agents and polyamine chelating agents. Aminopolycarboxylic acid derivatives are particularly preferable.

Preferable examples of the aminopolycarboxylic acid derivatives are described in the supplement table of “EDTA—Chemistry of Complexane”, Nankodo 1977. A part of the carboxyl group of these compounds may be substituted with alkali metal salts such as sodium and potassium, and ammonium salts. Particularly preferable aminocarboxylic acid derivatives include iminodiacetic acid, N-methyliminodiacetic acid, N(2-aminoethyl)iminodiacetic acid, N-(carbamoylethyl)iminodiacetic acid, nitrilotriacetic acid, ehylenediamine-N,N′-diacetic acid, ehylenediamine-N,N′-di-α-propionic acid, ethylenediamine-N,N′-di-β-propionic acid, N,N′-ethylene-bis(α-o-hydroxyphenyl)glycine, N,N′-di(2-hydroxybenzyl)ethylenediamine-N,N′-diacetic acid, ethylenediamine-N,N′-diacetic acid-N,N′-diacetohydroxamic acid, N-hydroxyethylethylenediamine-N,N′,N′-triacetic acid, ethylenediamine-N,N,N′,N′-tetraacetic acid, 1,2-propylenediamine-N,N,N′,N′-tetraacetic acid, di-2,3-diaminobutane-N,N,N′,N′-tetraacetic acid, meso-2,3-diaminobutane-N,N,N′,N′-tetraacetic acid, 1-phenylethylenediamine-N,N,N′,N′-tetraacetic acid, di-1,2-diphenylethylenediamine-N,N,N′,N′-tetraacetic acid, 1,4-diaminobutane-N,N,N′,N′-tetraacetic acid, trans-cyclobutane-1,2-diamine-N,N,N′,N′-tetraacetic acid, trans-cyclopentame-1,2-diamine-N,N,N′,N′-tetraacetic acid, trans-cyclohexane-1,2-diamine-N,N,N′,N′-tetraacetic acid, cic-cyclohexane-1,2-diamine-N,N,N′,N′-tetraacetic acid, cyclohexane-1,3-diamine-N,N,N′,N′-tetraacetic acid, cyclohexane-1,4-diamine-N,N,N′,N′-tetraacetic acid, o-phenylenediamine-N,N,N′,N′-tetraacetic acid, cis-1,4-diamine-N,N,N′,N′-tetraacetic acid, trans-1,4-diaminobutene-N,N,N′,N′-tetraacetic acid, α,α′-diamino-o-xylene-N,N,N′,N′-tetraacetic acid, 2-hydroxy-1,3-propanediamine-N,N,N′,N′-tetraacetic acid, 2,2-oxy-bis(ethyliminodiacetic acid), 2,2′-ethylenedioxy-bis(ethylimonodiacetic acid), ethylenediamine-N,N′-diacetic acid-N,N′-di-α-propionic acid, ethylenediamine-N,N′-diacetic acid-N,N′-di-β-propionic acid, ethylenediamine-N,N,N′,N′-tetrapropionic acid, diethylenetriamine-N,N,N″,N″-pentaacetic acid, triethylenetetamine-N,N,N′,N″,N″′,N″′-hexaacetic acid, and 1,2,3-triaminopropane-N,N,N′,N″,N″′,N″′-hexaacetic acid. A part of the carboxylic groups of these compounds may be substituted with alkali metal salts such as sodium and potassium and ammonium salt.

The amount of the chelating agent used for the synthesis of the polymer latex is preferable 0.01% by weight to 0.4% by weight, more preferably 0.02% by weight to 0.3% by weight, and particularly 0.03% by weight to 0.15% by weight based on a total amount of monomers. Metal ions mingling in the production process of the polymer latex are insufficiently trapped when the amount of the chelating agent is less than 0.01% by weight to decrease stability of the latex against aggregation to deteriorate coating ability. When the content exceeds 0.4%, on the other hand, the viscosity of the latex increases to deteriorate coating ability.

The chain transfer agent is preferably used in the synthesis of the polymer latex used in the invention. The compounds describe din Polymer Handbook Third Edition (Wiley-Interscience, 1989) are preferable as the chain transfer agents. Sulfur compounds are preferable since they have high chain transfer ability to make the amount of use of the reagent small. Particularly preferable chain reaction agents are hydrophobic mercaptan chain transfer agents such as tert-dodecylmercaptan, n-dodecylmercaptan and α-methylstyrene dimer.

The amount of the chain transfer agent used for the synthesis of the polymer latex of the invention is preferable 0.2% by weight to 2.0% by weight, more preferably 0.3% by weight to 1.8% by weight, and particularly preferably 0.4% by weight to 1.6% by weight based on a total amount of monomers. Work brittleness is decreased when the amount of the chain transfer agent is less than 0.2% by weight, while image stability is deteriorated when the amount exceeds 2.0% by weight.

The glass transition temperature (Tg) can be calculated by the following equation in the invention:
1/Tg=Σ(Xi/Tgi)

The polymer is defined herein to comprise polymerized n monomer components (i=1 to n). Xi denotes the weight fraction of the i-th monomer (ΣXi=1), and Tgi is a glass transition temperature (in absolute temperature) of the homopolymer of the i-Th monomer. Σ means a sum of i=1 to n. Polymer Handbook third edition (J. Brandrup and E. H. Immergut, Wiley-Interscience, 1989) was cited for the glass transition temperature (Tgi) of the homopolymer of each monomer.

The binder of the invention preferably has a grass transition temperature (Tg) in the range of −20° C. to 45° C., more preferably 0° C. to 35° C., and further preferably 10° C. to 30° C., considering work brittleness and image stability. At least two polymers may be blended for the binder, and Tg of the blended polymer as a composition weighed average preferably falls within the range above. When the polymers exhibit phase separation or has a core-shell structure, Tg of each phase preferably falls within the range above.

The polymer latex used in the invention has a particle diameter of preferably 10 nm to 500 nm, more preferably 20 nm to 300 nm, and further preferably 50 nm to 200 nm. The kind of the polymer is not particularly restricted, and hydrophobic resins such as an acrylic resin, a polyester resin, rubber based resin (for example a conjugated diene copolymer), polyurethane resin, vinyl chloride resin, vinyl acetate resin and polyolefin resin, and copolymers thereof may be used.

The acrylic resin, polyester resin and rubber based resin (for example a conjugated diene copolymer) are more preferable among them.

It is preferable to independently and freely select the polymer used in the invention from the polymer groups (a) to (j) below, and polymers obtained by copolymerization of at least conjugated dienes are more preferable in view of photographic performance and film quality. The monomer units available are not particularly restricted, and any monomers may be favorably used provided that they are polymerizable by usual radical polymerization or ion polymerization.

-Monomer Group (a) to (j)-

(a) conjugated diene: 1,3-butadiene, isoprene, 1,3-pentadiene, 2-ethyl-1,3-butadiene, 2-n-propyl-1,3-butadiene, 2,3-dimthyl-1,3-butadiene, 2-methyl-1,3-butadiene, 1-phenyl-1,3-butadiene, 1-α-naphthyl-1,3-butadiene, 1-β-naphthyl-1,3-butadiene, 2-chloro-1,3-butadiene, 1-bromo-1,3-butadiene, 1-chloro-1,3-butadiene, 2-fluoro-1,3-butadiene, 2,3-dichloro-1,3-butadiene, 1,1,2-trichloro-1,3-butadiene, 2-cyano-1,3-butadiene, and cyclobutadiene;
(b) olefin: ethylene, propylene, vinyl chloride, vinylidene chloride, 6-hydroxy-1-hexene, 4-pnetenoic acid, methyl 8-nonenate, vinylsulfonic acid, trimethylvinylsilane, trimethoxyvinylsilane, 1,4-divinylcyclohexane, 1,2,5-trivinylcyclohexane;
(c) α, β-unsaturated carboxylic acid and salts thereof: acrylic acid, methacrylic acid, itaconic acid, maleic acid, sodium acrylate, sodium methacrylate, ammonium methacrylate, potassium itaconate;
(d) α,β-unsaturated carboxylic acid ester: alkyl acrylate (for example methyl acrylate, ethyl acrylate, butyl acrylate, cyclohexyl acrylate, 2-ethylhexyl acrylate and dodecyl acrylate), substituted alkyl acrylate (for example 1-chloroethyl acrylate, benzyl acrylate and 2-cyanoethyl acrylate), alkyl methacrylate (for example methyl methacrylate, butyl methacrylate, 2-ethylhexyl methacrylate and dodecyl methacrylate), substituted alkyl methacrylate (for example 2-hydroxyethyl methacrylate, glycidyl methacrylate, glycerin methacrylate, 2-acrtoxyethyl methacrylate, tetrahydrofurfuly methacrylate, 2-methoxyethyl methacrylate, polypropyleneglycol monomethacrylate (addition mole number of polyoxypropylene=2 to 100), 3-N,N-dimethylaminopropyl methacrylate, chloro-3-N,N-trimethylammoniopropyl methacrylate, 2-carboxyethyl methacrylate, 3-sulfopropyl methacrylate, 4-oxysulfobutyl methacrylate, 3-trimethoxysilylpropyl methacrylate, allyl methacrylate and 2-isocyanatoethyl methacrylate), derivatives of unsaturated dicarboxylic acid (for example monobutyl maleate, dimethyl maleate, monomethyl itaconate and dibutyl itaconate), and polyfunctional esters (for example ethyleneglycol diacrylate, ethyleneglycol dimethacrylate, 1,4-cyclohehane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylaye and 1,2,4-cyclohexane tetramethacrylate);
(e) amides of β-unsaturated carboxylic acid: for example acrylamide, methacrylamide, N-methylacrylamide, N,N-dimethylacrylamide, N-methyl-N-hydroxyethyl methacrylamide, N-tert-butyl acrylamide, N-tert-octyl methacrylamide, N-cyclohexyl acrylamide, N-phenyl acrylamide, N-(2-acetoxyethyl) acrylamide, N-acryloyl morpholine, diacetone acrylamide, itaconic acid diamide, N-methyl maleimide, 2-acrylamide-methylpropanesulfonic acid, methylenebis acrylamide and dimethacryloyl piperazine;
(f) unsaturated nitrile: acrylonitrile and methacrylonitrile;
(g) styrene and derivatives thereof: styrene, vinyltoluene, p-tert-butylstyrene, vinylbenzoic acid, methyl vinylbenzoate, α-methylstyrene, p-chloromethylstyrene, vinylnaphthalene, p-hydroxymethylstyrene, sodium p-styrenesulfonate, potassium p-styrenesulfinate, p-aminomethylstyrene and 1,4-divinylbenzene;
(h) vinylethers: methylvinyl ether, butylvinyl ether, and methoxyethylvinyl ether;
(i) vinyl esters: vinyl acetate, vinyl propionate, vinyl benzoate, vinyl salicylate and vinyl chloroacetate; and
(j) other polymerizable monomers: N-vinylimidazole, 4-vinylpyridine, N-vinylpyrrolidone, 2-vinyloxazoline, 2-isopropenylozazoline and divinylsulfone.

Preferable examples of the polymer prepared by copolymerization of at least conjugated dienes include styrene-butadiene copolymers (for example butadiene-styrene block copolymer and styrene-butadiene-styrene block copolymer), styrene-isoprene copolymers (for example random copolymers and block copolymers), ethylene-propylene-diene copolymers (examples of diene monomers are 1,4-hexadiene, dicyclopentadiene and ethylydene norbonene), acrylonitrile-butadiene copolymers, isobutylene-isoprene copolymers, butadiene-acrylic ester copolymers (examples of acrylic esters are ethyl acrylate and butyl acrylate), and butadiene-acrylic ester-acrylonitrile copolymers (the acrylic esters available include those described above). The styrene-butadiene copolymers are most preferable among them.

Examples of the polymer used in the invention are listed below (compound P-1 to P-23). The initiators, chelating gents and chain transfer agents used for the polymerization are shown in Table 14. The molecular weights of the exemplified compounds below denote mass average molecular weights, and the molecular weights of polyfunctional monomers are omitted since the concept of the molecular weight is not applicable to these monomers.

x, y, z and z′ in the polymer main chain in the chemical formula show the mass ratios in the polymer composition, and the sum of x, y, z and z′ is equal to 100%. The numeral at the bottom right of in the parenthesis showing the polymer side chain in the chemical formula denotes the degree of polymerization.

Tg represents the glass transition temperature of a dry film obtained from the polymer. The invention is not restricted to the examples as set forth above.

TABLE 14
(P-1)

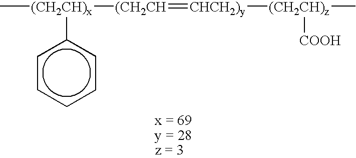

molecular weight - Tg = 20° C.

(P-2)

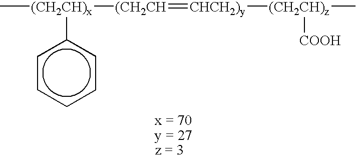

molecular weight - Tg = 22° C.

(P-3)

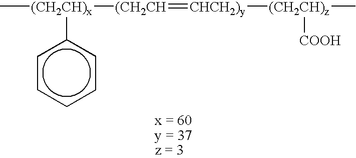

molecular weight - Tg = 0° C.

(P-4)

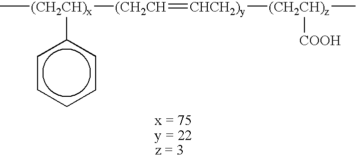

molecular weight - Tg = 34° C.

(P-5)

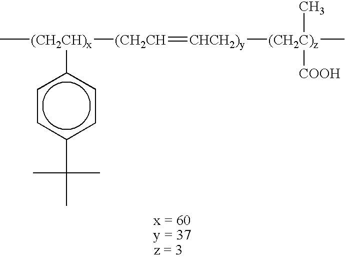

molecular weight - Tg = 9° C.

(P-6)

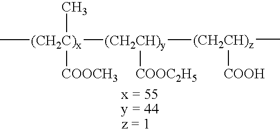

molecular weight 72,000 Tg = 33° C.

(P-7)

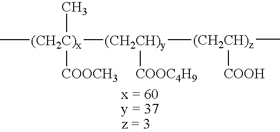

molecular weight 130,000 Tg = 0° C.

(P-8)

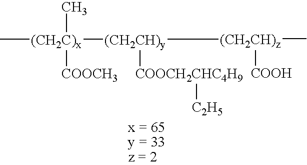

molecular weight 150,000 Tg = 32° C.

(P-9)

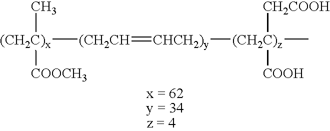

molecular weight - Tg = 8° C.

(P-10)

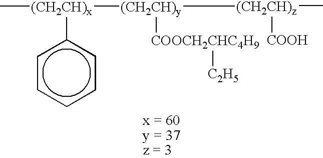

molecular weight 180,000 Tg = 26° C.

(P-11)

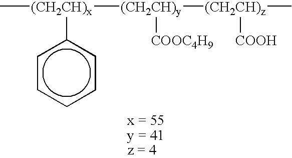

molecular weight 98,000 Tg = 17° C.

(P-12)

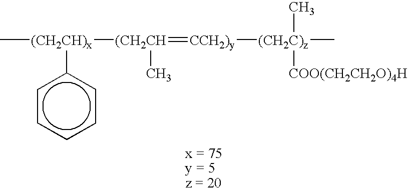

molecular weight - Tg = 38° C.

(P-13)

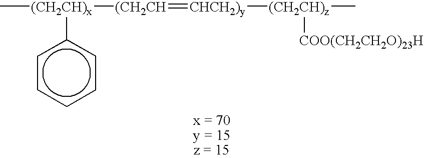

molecular weight - Tg = 22° C.

(P-14)

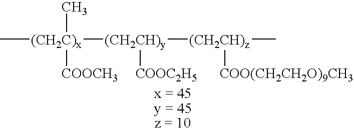

molecular weight 120,000 Tg = 14° C.

(P-15)

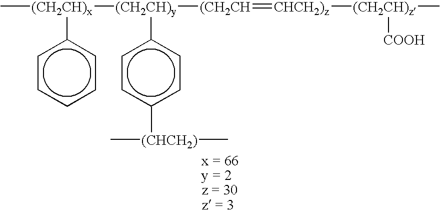

molecular weight - Tg = 15° C.

(P-16)

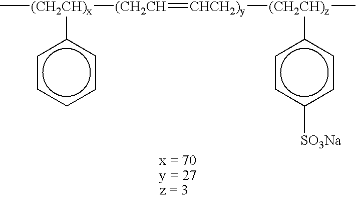

molecular weight - Tg = 19° C.

(P-17)

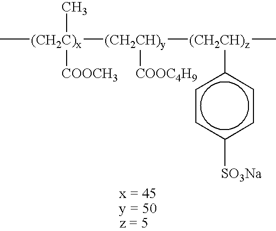

molecular weight 100,000 Tg = 5° C.

(P-18)

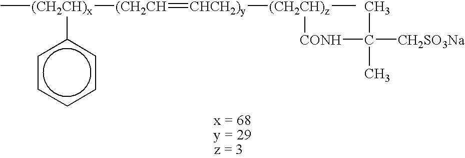

molecular weight - Tg = 21° C.

(P-19)

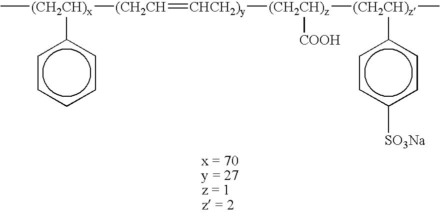

molecular weight - Tg = 24° C.

(P-20)

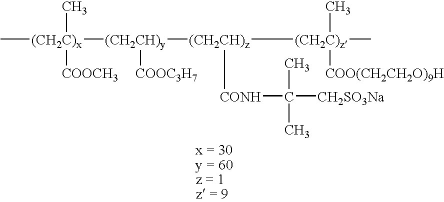

molecular weight 89,000 Tg = 7° C.

| Compound | Initiator | | Chelating agent | | Chain transfer agent | | | Chloride ion |
|---|---|---|---|---|---|---|---|---|
| No. | Kind | Amount | Kind | Amount | Kind | Amount | Tg | concentration |
| P-1 | APS | 0.50% | EDTA-4Na | 0.04% | TDM | 0.80% | 20° C. | 3 ppm |
| P-2 | APS | 0.50% | EDTA-4Na | 0.04% | TDM | 0.80% | 22° C. | 4 ppm |
| P-3 | KPS | 0.50% | EDTA-4Na | 0.04% | TDM | 0.80% | 0° C. | 15 ppm |
| P-4 | APS | 0.75% | DETAPA | 0.01% | TDM | 0.80% | 34° C. | 190 ppm |
| P-5 | NaPS | 0.60% | NTA | 0.08% | TDM | 0.20% | 9° C. | 160 ppm |
| P-6 | V-50 | 0.40% | EDTA-4Na | 0.40% | TOM | 0.60% | 33° C. | 35 ppm |
| P-7 | VA-086 | 0.40% | NTP-3Na | 0.10% | TDM | 0.60% | 0° C. | 88 ppm |
| P-8 | APS | 0.30% | EDTA-4Na | 0.15% | NDM | 0.40% | 32° C. | 7 ppm |
| P-9 | APS | 1.00% | EDTA-2NH | 0.06% | TDM | 2.00% | 8° C. | 4 ppm |
| P-10 | KPS | 1.50% | DETAPA | 0.12% | NOM | 1.00% | 26° C. | 86 ppm |
| P-11 | NaPS | 1.20% | NTP-3Na | 0.30% | NDM | 1.50% | 17° C. | 56 ppm |
| P-12 | APS | 0.40% | EDTA-4Na | 0.18% | TDM | 0.40% | 38° C. | 146 ppm |
| P-13 | NaPS | 0.50% | EDTA-4Na | 0.01% | TDM | 1.80% | 22° C. | 220 ppm |
| P-14 | V-501 | 0.30% | EDTA-2NH | 0.02% | TDM | 0.80% | 14° C. | 33 ppm |
| P-15 | APS | 1.30% | NTA | 0.14% | TOM | 0.80% | 15° C. | 35 ppm |
| P-16 | APS | 0.50% | EDTA-2NH | 0.20% | TDM | 1.20% | 19° C. | 5 ppm |
| P-17 | NaPS | 1.75% | EDTA-4Na | 0.04% | NDM | 1.60% | 5° C. | 280 ppm |
| P-18 | APS | 2.00% | EDTA-4Na | 0.02% | NOM | 0.80% | 21° C. | 8 ppm |
| P-19 | NaPS | 0.80% | EDTA-4Na | 0.05% | TDM | 0.50% | 24° C. | 42 ppm |
| P-20 | APS | 0.60% | EDTA-4Na | 0.08% | NDM | 0.90% | 7° C. | 4 ppm |

The abbreviations in the table denote the following compound, and the quantity used is represented by % by weight based on a total amount of monomers used for polymerization.
APS: ammonium persulfate
NaPS: sodium persulfate
KPS: potassium persulfate
V-50: azobis(2-methylpropionamizide)hydrochloride
VA-086: azobis(2-methyl-N-(2-hydroxyethyl)propionamide)
V-501: azobiscyanovaleric acid
EDTA-4NA: tetrasodium ethylenediamine tetraacetate
EDTA2NH3: diammonium ethylenediamine tetraacetate
NTA: nitrilotriaetic acid
NTP-3NA: trisodium nitrilotrismethylene phosphonate
DETAPA: diethylenetriamine pentaacetic acid
TDM: tert-dodecylmercaptan
NDM: n-dodecylmercaptan
TOM: tert-octylmercaptan
NOM: n-octylmercaptan
αMSD: α-methylstyrene dimer

While the dispersant available for emulsion polymerization is any one of an anionic surfactant, a nonionic surfactant, a cationic surfactant and an amphoteric surfactant, the anionic surfactant is preferable in view of dispersability. Long chain alkyldiphenylether disulfonate is more preferable, and low electrolyte type surfactant such as Paionine A-43-S (produced by Takemoto Oil and Fat Co.) is particularly preferable.

Additives such as an electrolyte, a stabilizer, a thickening agent, a defoaming agent, an antioxidant, a curing agent, an antifreeze agent, a gelling agent and a hardening accelerator describes in Synthetic Rubber Handbook may be used in addition to the compounds above.

While examples of synthesis of the polymers used in the invention are shown below, the invention is not restricted to these examples. The same synthetic method may be used for other compounds in the examples.

(Synthesis Example 1: Synthesis of Compound P-1)

Passivation films were formed on the stainless steel surface of a polymerization vessel and on stainless steel stirring members by adding 1500 g of distilled water in the polymerization vessel of a gaseous monomer reaction apparatus (type TAS-2J manufactured by Taiatsu Techno Co.) followed by heating at 90° C. for 3 hours. Added in this polymerization vessel after this treatment were 584.8 g of distilled water, 9.70 g of a surfactant (Pionine A-43-S produced by Takemoto Oil and Fats Cp.), 20.25 g of NaOH with a concentration of 1 mol/L, 0.216 g of tetrasodium ethylenediamine tetraacetic acid, 327.6 g of styrene, 16.2 g of acrylic acid and 4.32 g of tert-dodecylmercaptan, and the mixture was stirred at 225 rpm while the reaction vessel is hermetically sealed. After purging nitrogen gas several times by evacuating with a vacuum pump, 151.2 g of 1,3-butadiene was introduced with pressurizing followed by increasing the inner temperature to 60° C. Further added was 2.7 g of an aqueous ammonium persulfate solution dissolved in 50 mL of water, followed by stirring for 5 hours. Stirring was continued for additional 3 hours at 90° C. to complete the reaction. After cooling the reaction vessel to room temperature, the pH of the solution was adjusted to 8.4 by adding 1 mol/L of NaOH and NH₄OH so that the ratio of the Na⁺ ions to the NH₄ ions is 1:5.3 (molar ratio).

The reaction solution was filtered through a polypropylene filter with a pore size of 1.0 μm to remove foreign substances such as dusts to obtained 1150 g of the example compound P-1 (solid fraction 44% by weight, particle diameter 91 nm, Tg=20° C.). The chloride ion concentration was 3 ppm from the measurement of halogen ions by ion chromatography.

(Synthetic Example 2: synthesis of compound P-2)

The passivation films were formed in the gaseous monomer reaction apparatus (type TAS-2J manufactured by Taiatsu Techno Co.) by the same method as in Synthesis Example 1. Added in this polymerization vessel of this polymerization apparatus were 350.92 g of distilled water, 3.85 g of the surfactant (Pionine A-43-S produced by Takemoto Oil and Fats Cp.), 20.25 g of NaOH with a concentration of 1 mol/L, 0.216 g of tetrasodium ethylenediamine tetraacetic acid, 18.9 g of styrene, 0.81 g of acrylic acid and 2.16 g of tert-dodecylmercaptan, and the mixture was stirred at 225 rpm while the reaction vessel is hermetically sealed. After purging nitrogen gas several times by evacuating with a vacuum pump, 7.29 g of 1,3-butadiene was introduced with pressurizing followed by increasing the inner temperature to 65° C. Further added was 1.35 g of an aqueous ammonium persulfate solution dissolved in 50 mL of water, followed by stirring for 1 hours.

An emulsion was separately prepared by adding, with stirring, 233.94 g of distilled water, 5.75 g of the surfactant (Pionine A-43-S produced by Takemoto Oil and Fats Cp.), 351.9 g of styrene, 15.39 g of acrylic acid, 138.51 g of butadiene 2.16 g of tert-dodecylmercaptan and 1.35 g of ammonium persulfate. The emulsion was added in the reaction vessel described above in 3 hours. The reaction solution was further stirred for 2 hours after completing the addition. The mixture was further stirred for 3 hours by increasing the temperature at 90° C. to complete the reaction. After decreasing the temperature to room temperature. After cooling the reaction vessel to room temperature, the pH of the solution was adjusted to 8.4 by adding 1 mol/L of NaOH and NH₄OH so that the ratio of the Na⁺ ions to the NH₄ ions is 1:5.3 (molar ratio).

The reaction solution was filtered through a polypropylene filter with a pore size of 1.0 μm to remove foreign substances such as dusts to obtained 1155 g of the example compound P-2 (solid fraction 44% by weight, particle diameter 105 nm, Tg=22° C.). The chloride ion concentration was 4 ppm from the measurement of halogen ions by ion chromatography.

(Synthetic Example 3: Synthesis of Compound P-17)

Added in a three necked glass flask equipped with a stirrer and cooling tower were 584.86 g of distilled water, 9.45 g of the surfactant (Pionine A-43-S produced by Takemoto Oil and Fats Cp.), 20.25 g of NaOH with a concentration of 1 mol/L, 0.216 g of tetrasodium ethylenediamine tetraacetic acid, 243 g of methyl methacrylate, 270 g of butyl acrylate, 27.0 g of sodium styrenesulfonate and 4.32 g of tert-dodecylmercaptan. The mixture was stirred in a nitrogen stream at 225 rpm followed by increasing the temperature to 60° C. Ammonium persulfate (2.7 g) dissolved in 50 mL of water was added in this solution with additional stirring for 5 hours. The temperature of the solution was increased to 90° C. with additional stirring for 3 hours to complete the reaction. After cooling the reaction vessel to room temperature, the pH of the solution was adjusted to 7.9 by adding 1 mol/L of NaOH and NH₄OH so that the ratio of the Na⁺ ions to the NH₄ ions is 1:5.3 (molar ratio).

The reaction solution was filtered through a polypropylene filter with a pore size of 1.0 μm to remove foreign substances such as dusts to obtained 1140 g of the example compound P-17 (solid fraction 45% by weight, particle diameter 98 nm, mass average molecular weight 100,000, Tg=5° C.)

In the invention, for the solvent of a coating solution for the polymer latex, water solvent can be used and any of water-miscible organic solvents may be used in combination.

Examples of water-miscible organic solvents include alcohols such as methyl alcohol, ethyl alcohol and isopropyl alcohol, cellosolves such as methyl cellosolve, ethyl cellosolve and butyl cellosolve, ethyl acetate and dimethylformamide. The addition amount of the organic solvent is 50% by weight or less and more preferably 30% by weight or less with respect to the solvent.

According to the amount of the binder for the layer containing organic silver salt, the weight ratio for total binder to organic silver salt (total binder/organic silver salt) is preferably in a range of 1/10 to 10/1, more preferably 1/5 to 4/1.

The layer containing organic silver salt is, in general, a photosensitive layer (image forming layer) containing a photosensitive silver halide, i.e., the photosensitive silver salt; in such a case, the weight ratio for total binder to silver halide (total binder/silver halide) is in a range of from 400 to 5, more preferably, from 200 to 10.

The total binder content in the image forming layer is preferably in a range of from 0.2 g/m² to 30 g/m², more preferably from 1 g/m² to 15 g/m². In the image forming layer of the invention, there may be added a crosslinking agent for crosslinking, or a surfactant and the like to improve work brittleness.

Any type of polymer may be used in combination with the polymer latex of the invention as a binder for the layer containing organic silver salt in the photothermographic material of the invention. Suitable as the binder are those that are transparent or translucent, and that are generally colorless, such as natural resin or polymer and their copolymers; synthetic resin or polymer and their copolymer; or media forming a film; for example, included are gelatin, rubber, poly(vinyl alcohol), hydroxyethyl cellulose, cellulose acetate, cellulose acetate butyrate, poly(vinyl pyrrolidone), casein, starch, poly(acrylic acid), poly(methylmethacrylic acid), poly(vinyl chloride), poly(methacrylic acid), styrene-maleic anhydride copolymers, styrene-acrylonitrile copolymers, styrene-butadiene copolymers, poly(vinyl acetal)(e.g., poly(vinyl formal) and poly(vinyl butyral)), poly(ester), poly(urethane), phenoxy resin, poly(vinylidene chloride), poly(epoxide), poly(carbonate), poly(vinyl acetate), poly(olefin), cellulose esters, and poly(amide). A binder may be used with water, an organic solvent or emulsion to form a coating solution.

In the invention, the Tg of the binder used for the layer including organic silver salts in combination with the polymer latex of the invention, is preferably from −20° C. to 45° C., more preferably, from 0° C. to 35° C., further preferably, from 10° C. to 30° C.

The binder used in combination with the polymer latex of the invention may be of two or more kinds. And the polymer having Tg more than 20° C. and the polymer having Tg less than 20° C. can be used in combination. In a case that two types or more of polymers differing in Tg may be blended for use, it is preferred that the weight-average Tg is in the range mentioned above.

In the invention, it is preferred that the layer containing organic silver salt is formed by first applying a coating solution containing 30% by weight or more of water in the solvent and by then drying.

In the case the layer containing organic silver salt is formed by first applying a coating solution containing 30% by weight or more of water in the solvent and by then drying, and furthermore, in the case the binder of the layer containing organic silver salt is soluble or dispersible in an aqueous solvent (water solvent), the performance can be ameliorated particularly in the case a polymer latex having an equilibrium water content of 2% by weight or lower under 25° C. and 60% RH is used. Most preferred embodiment is such prepared to yield an ion conductivity of 2.5 mS/cm or lower, and as such a preparation method, there can be mentioned a refining treatment using a separation function membrane after synthesizing the polymer.

The aqueous solvent in which the polymer is soluble or dispersible, as referred herein, signifies water or water containing mixed therein 70% by weight or less of a water-admixing organic solvent. As water-miscible organic solvents, there can be mentioned, for example, alcohols such as methyl alcohol, ethyl alcohol, propyl alcohol, and the like; cellosolves such as methyl cellosolve, ethyl cellosolve, butyl cellosolve, and the like; ethyl acetate, dimethylformamide, and the like.

The term aqueous solvent is also used in the case the polymer is not thermodynamically dissolved, but is present in a so-called dispersed state.

The term “equilibrium water content under 25° C. and 60% RH” as referred herein can be expressed as follows:

Equilibrium water content under 25° C. and 60% RH=[(W1−W0)/W0]×100 (% by weight)

where, W1 is the weight of the polymer in moisture-controlled equilibrium under the atmosphere of 25° C. and 60% RH, and W0 is the absolutely dried weight at 25° C. of the polymer.

For the definition and the method of measurement for water content, reference can be made to Polymer Engineering Series 14, “Testing methods for polymeric materials” (The Society of Polymer Science, Japan, published by Chijin Shokan).

The equilibrium water content under 25° C. and 60% RH is preferably 2% by weight or lower, but is more preferably, 0.01% by weight to 1.5% by weight, and is further preferably, 0.02% by weight to 1% by weight.

The polymers used in the invention are particularly preferably polymers capable of being dispersed in aqueous solvent. Examples of dispersed states may include a latex, in which water-insoluble fine particles of hydrophobic polymer are dispersed, or such in which polymer molecules are dispersed in molecular states or by forming micelles, but preferred are latex-dispersed particles. The average particle size of the dispersed particles is in a range of from 1 to 50,000 nm, preferably 5 nm to 1,000 nm, more preferably, 10 nm to 500 nm, and further preferably, 50 nm to 200 nm. There is no particular limitation concerning particle size distribution of the dispersed particles, and may be widely distributed or may exhibit a monodisperse particle size distribution. From the viewpoint of controlling the physical properties of the coating solution, preferred mode of usage includes mixing two or more types of particles each having monodisperse particle distribution.

In the invention, preferred embodiment of the polymers capable of being dispersed in aqueous solvent includes hydrophobic polymers such as acrylic polymers, poly(ester), rubber (e.g., SBR resin), poly(urethane), poly(vinyl chloride), poly(vinyl acetate), poly(vinylidene chloride), poly(olefin), and the like. As the polymers above, usable are straight chain polymers, branched polymers, or crosslinked polymers; also usable are the so-called homopolymers in which single monomer is polymerized, or copolymers in which two or more types of monomers are polymerized. In the case of a copolymer, it may be a random copolymer or a block copolymer. The molecular weight of these polymers is, in number average molecular weight, in a range of from 5,000 to 1,000,000, preferably from 10,000 to 200,000. Those having too small molecular weight exhibit insufficient mechanical strength on forming the image forming layer, and those having too large molecular weight are also not preferred because the filming properties result poor. Further, crosslinking polymer latexes are particularly preferred for use.

(Hydrogen Bonding Compound)

In the invention, in the case that the reducing agent has an aromatic hydroxyl group (—OH) or an amino group (—NHR, R represents each one of hydrogen atom and alkyl group), particularly in the case that the reducing agent is a bisphenol described above, it is preferred to use in combination, a non-reducing compound having a group capable of reacting with these groups of the reducing agent, and that is also capable of forming a hydrogen bond therewith. As a group forming a hydrogen bond with a hydroxyl group or an amino group, there can be mentioned a phosphoryl group, a sulfoxido group, a sulfonyl group, a carbonyl group, an amido group, an ester group, an urethane group, an ureido group, a tertiary amino group, a nitrogen-containing aromatic group, and the like. Particularly preferred among them is phosphoryl group, sulfoxido group, amido group (not having >N—H moiety but being blocked in the form of >N—Ra (where, Ra represents a substituent other than H)), urethane group (not having >N—H moiety but being blocked in the form of >N—Ra (where, Ra represents a substituent other than H)), and ureido group (not having >N—H moiety but being blocked in the form of >N—Ra (where, Ra represents a substituent other than H)).

In the invention, particularly preferable as the hydrogen-bonding compound is the compound expressed by formula (D) shown below.

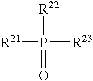

In formula (D), R²¹ to R²³ each independently represent an alkyl group, an aryl group, an alkoxy group, an aryloxy group, an amino group, or a heterocyclic group, which may be substituted or not substituted. In the case R²¹ to R²³ contain a substituent, examples of the substituents include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, a phosphoryl group, and the like, in which preferred as the substituents are an alkyl group or an aryl group, e.g., methyl group, ethyl group, isopropyl group, t-butyl group, t-octyl group, phenyl group, a 4-alkoxyphenyl group, a 4-acyloxyphenyl group, and the like.

Specific examples of an alkyl group expressed by R²¹ to R²³ include methyl group, ethyl group, butyl group, octyl group, dodecyl group, isopropyl group, t-butyl group, t-amyl group, t-octyl group, cyclohexyl group, 1-methylcyclohexyl group, benzyl group, phenetyl group, 2-phenoxypropyl group, and the like. As aryl groups, there can be mentioned phenyl group, cresyl group, xylyl group, naphthyl group, 4-t-butylphenyl group, 4-t-octylphenyl group, 4-anisidyl group, 3,5-dichlorophenyl group, and the like. As alkoxyl groups, there can be mentioned methoxy group, ethoxy group, butoxy group, octyloxy group, 2-ethylhexyloxy group, 3,5,5-trimethylhexyloxy group, dodecyloxy group, cyclohexyloxy group, 4-methylcyclohexyloxy group, benzyloxy group, and the like. As aryloxy groups, there can be mentioned phenoxy group, cresyloxy group, isopropylphenoxy group, 4-t-butylphenoxy group, naphthoxy group, biphenyloxy group, and the like. As amino groups, there can be mentioned are dimethylamino group, diethylamino group, dibutylamino group, dioctylamino group, N— methyl-N-hexylamino group, dicyclohexylamino group, diphenylamino group, N-methyl-N-phenylamino, and the like.

Preferred as R²¹ to R²³ are an alkyl group, an aryl group, an alkoxy group, and an aryloxy group. Concerning the effect of the invention, it is preferred that at least one or more of R²¹ to R²³ are an alkyl group or an aryl group, and more preferably, two or more of them are an alkyl group or an aryl group. From the viewpoint of low cost availability, it is preferred that R²¹ to R²³ are of the same group.

Specific examples of hydrogen bonding compounds represented by formula (D) of the invention and others are shown below, but it should be understood that the invention is not limited thereto.

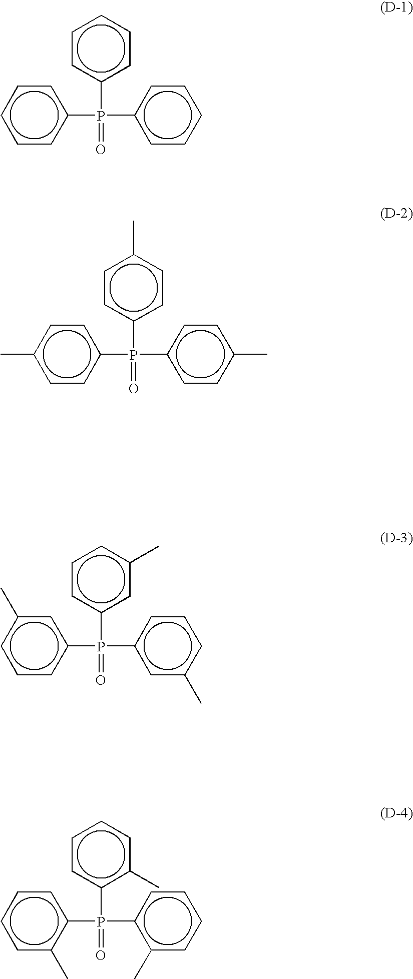

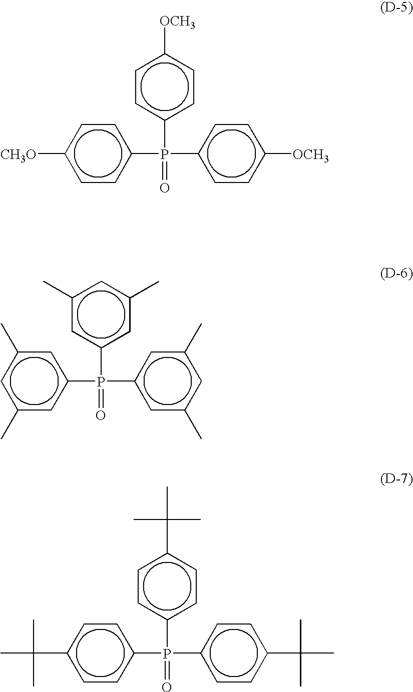

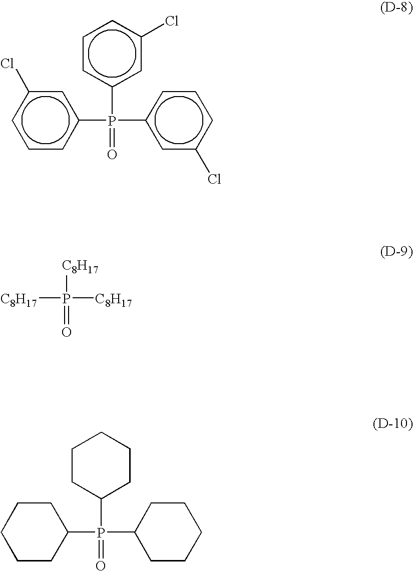

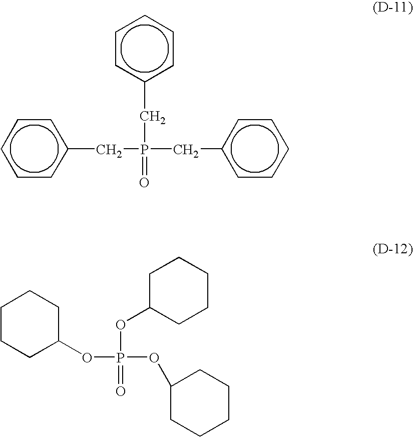

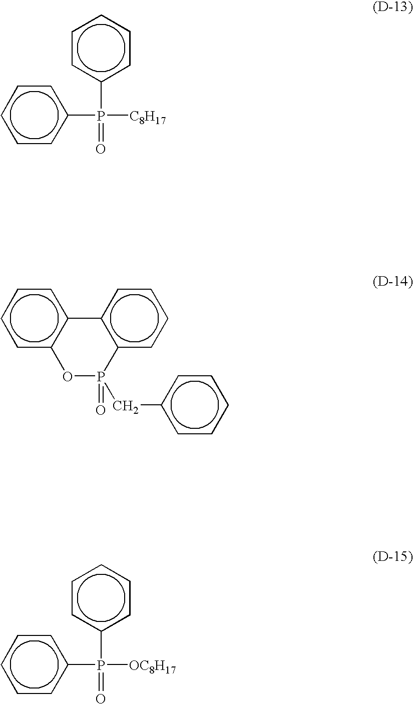

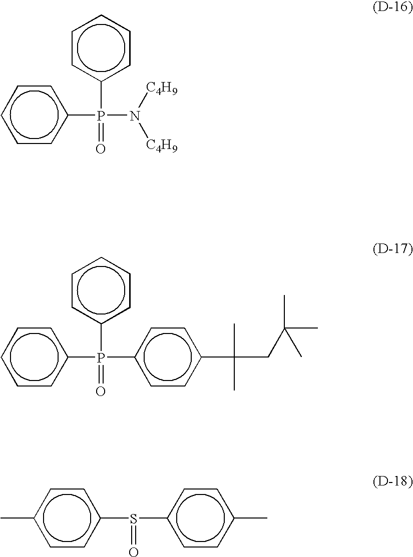

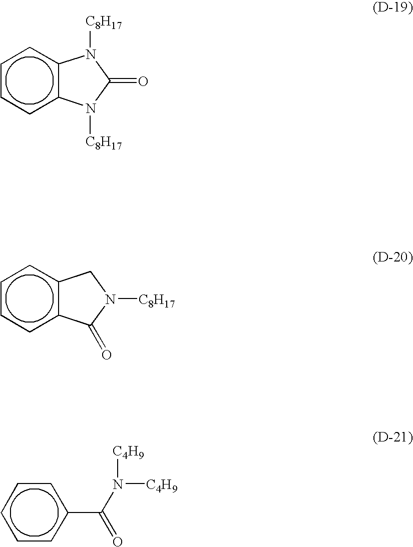

Specific examples of hydrogen bonding compounds other than those enumerated above can be found in those described in EP-A No. 1096310 and in Japanese Patent Application Nos. 2000-270498 and 2001-124796.

The compound expressed by formula (D) used in the invention can be used in the photosensitive material by being incorporated into the coating solution in the form of solution, emulsion dispersion, or solid-dispersed fine particle dispersion similar to the case of reducing agent, however, it is preferred to be used after it is prepared in the form of solid-dispersed fine particle dispersion. In the solution, the compound expressed by formula (D) forms a hydrogen-bonded complex with a compound having a phenolic hydroxyl group or an amino group, and can be isolated as a complex in crystalline state depending on the combination of the reducing agent and the compound expressed by formula (D). It is particularly preferred to use the crystal powder thus isolated in the form of a solution by dissolving it into a coating solvent, because it provides stable performance. Further, it is also preferred to use a method of leading to form complex during dispersion by mixing the reducing agent and the compound expressed by formula (D) in the form of powders and dispersing them with a proper dispersion solvent using sand grinder mill and the like.

The compound expressed by formula (D) is preferably used in a range of from 1 mol % to 200 mol %, more preferably from 10 mol % to 150 mol %, and further preferably, from 20 mol % to 100 mol %, with respect to the reducing agent.

(Antifoggant)

As an antifoggant, stabilizer and stabilizer precursor usable in the invention, there can be mentioned those disclosed as patents in paragraph number 0070 of JP-A No. 10-62899 and in line 57 of page 20 to line 7 of page 21 of EP-A No. 0803764A1, the compounds described in JP-A Nos. 9-281637 and 9-329864, in U.S. Pat. No. 6,083,681, and in EP-A No. 1048975. Furthermore, the antifoggant preferably used in the invention is an organic halogen compound, and those disclosed in paragraph Nos. 0111 to 0112 of JP-A No. 11-65021 can be enumerated as examples thereof. In particular, the organic halogen compound expressed by formula (P) in JP-A No. 2000-284399, the organic polyhalogen compound expressed by formula (II) in JP-A No. 10-339934, and organic polyhalogen compounds described in JP-A Nos. 2001-31644 and 2001-33911 are preferred.

1) Polyhalogen Compound

Organic polyhalogen compounds preferably used in the invention are specifically described below. In the invention, preferred polyhalogen compounds are the compounds expressed by formula (H) below:

Formula (H)
Q-(Y)ₙ—C(Z₁)(Z₂)X

In formula (H), Q represents an alkyl group, an aryl group, or a heterocyclic group; Y represents a divalent connecting group; n represents 0 or 1; Z₁ and Z₂ represent a halogen atom; and X represents a hydrogen atom or an electron attracting group.

In formula (H), Q is preferably an aryl group, or a heterocyclic group.

In formula (H), in the case that Q is a heterocyclic group, Q is preferably a nitrogen containing heterocyclic group having 1 to 2 nitrogen atoms and particularly preferably 2-pyridyl group and 2-quinolyl group.

In formula (H), in the case that Q is an aryl group, Q preferably is a phenyl group substituted by an electron-attracting group whose Hammett substitution coefficient σp yields a positive value. For the details of Hammett substitution coefficient, reference can be made to Journal of Medicinal Chemistry, Vol. 16, No. 11 (1973), pp. 1207 to 1216, and the like. As such electron-attracting groups, examples include, halogen atoms (fluorine atom (σp value: 0.06), chlorine atom (σp value: 0.23), bromine atom (σp value: 0.23), iodine atom (σp value: 0.18)), trihalomethyl groups (tribromomethyl (σp value: 0.29), trichloromethyl (σp value: 0.33), trifluoromethyl (σp value: 0.54)), a cyano group (σp value: 0.66), a nitro group (σp value: 0.78), an aliphatic aryl or heterocyclic sulfonyl group (for example, methanesulfonyl (σp value: 0.72)), an aliphatic aryl or heterocyclic acyl group (for example, acetyl (σp value: 0.50) and benzoyl (σp value: 0.43)), an alkinyl (e.g., C≡CH (σp value: 0.23)), an aliphatic aryl or heterocyclic oxycarbonyl group (e.g., methoxycarbonyl (σp value: 0.45) and phenoxycarbonyl (σp value: 0.44)), a carbamoyl group (σp value: 0.36), sulfamoyl group (σp value: 0.57), sulfoxido group, heterocyclic group, and phosphoryl group. Preferred range of the σp value is from 0.2 to 2.0, and more preferably, from 0.4 to 1.0. Preferred as the electron-attracting groups are carbamoyl group, an alkoxycarbonyl group, an alkylsulfonyl group, and an alkylphosphoryl group, and particularly preferred among them is carbamoyl group.

X preferably is an electron-attracting group, more preferably, a halogen atom, an aliphatic aryl or heterocyclic sulfonyl group, an aliphatic aryl or heterocyclic acyl group, an aliphatic aryl or heterocyclic oxycarbonyl group, carbamoyl group, or sulfamoyl group; particularly preferred among them is a halogen atom. Among halogen atoms, preferred are chlorine atom, bromine atom, and iodine atom; more preferred are chlorine atom and bromine atom; and particularly preferred is bromine atom.

Y preferably represents —C(═O)—, —SO—, or —SO₂—; more preferably, —C(═O)— or —SO₂—; and particularly preferred is —SO₂—. N represents 0 or 1, and preferred is 1.

Specific examples of the compounds expressed by formula (H) of the invention are shown below.

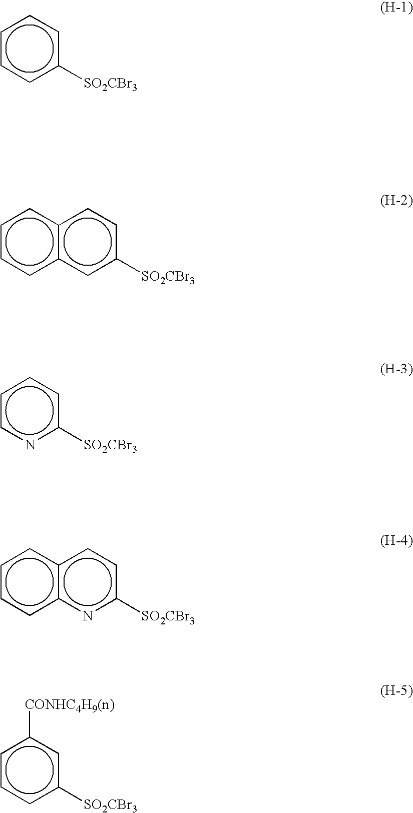

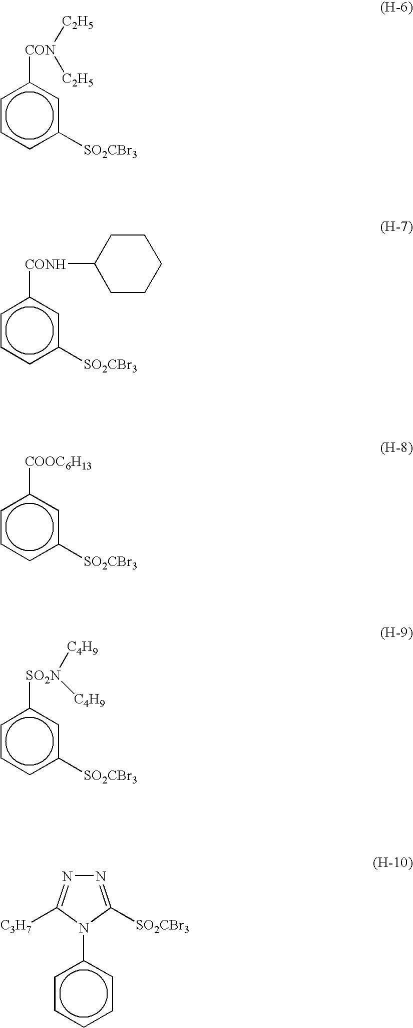

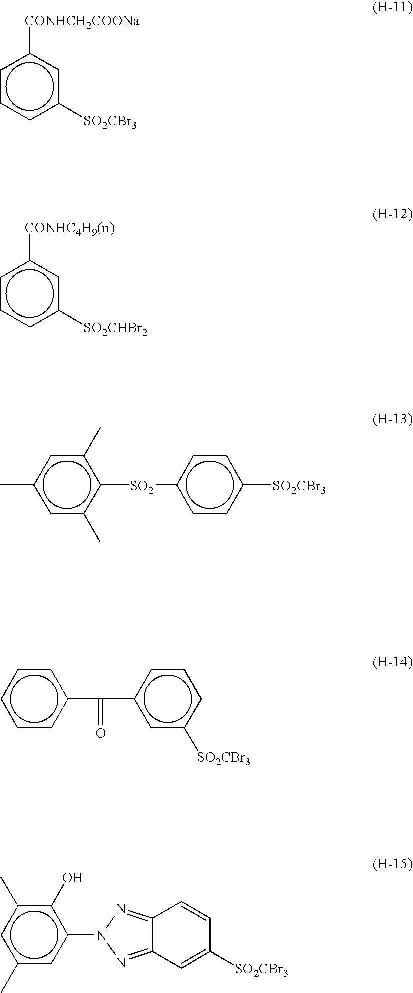

As preferred polyhalogen compounds of the invention other than those above, there can be mentioned compounds disclosed in JP-A Nos. 2001-31644, 2001-56526, and 2001-209145.

The compounds expressed by formula (H) of the invention are preferably used in an amount of from 10⁻⁴ mol to 0.8 mol, more preferably, 10⁻² mol to 5×10⁻² mol, and further preferably, 10⁻² mol to 3×10⁻² mol, per one mol of non-photosensitive silver salt incorporated in the image forming layer.

In the invention, usable methods for incorporating the compound expressed by formula (H) into the photosensitive material are those described above in the method for incorporating the reducing agent.

Melting point of the compound expressed by formula (H) is preferably 170° C. or lower, more preferably 160° C. or lower, and further preferably 150° C. or lower.

2) Other Antifoggants

As other antifoggants, there can be mentioned a mercury (II) salt described in paragraph number 0113 of JP-A No. 11-65021, benzoic acids described in paragraph number 0114 of the same literature, a salicylic acid derivative described in JP-A No. 2000-206642, a formaline scavenger compound expressed by formula (S) in JP-A No. 2000-221634, a triazine compound related to claim 9 of JP-A No. 11-352624, a compound expressed by formula (III), 4-hydroxy-6-methyl-1,3,3a, 7-tetrazaindene and the like, as described in JP-A No. 6-11791.

The photothermographic material of the invention may further contain an azolium salt in order to prevent fogging. As azolium salts, there can be mentioned a compound expressed by formula (XI) as described in JP-A No. 59-193447, a compound described in JP-B No. 55-12581, and a compound expressed by formula (II) in JP-A No. 60-153039. The azolium salt may be added to any part of the photosensitive material, but as the addition layer, preferred is to select a layer on the side having thereon the photosensitive layer, and more preferred is to select a layer containing organic silver salt. The azolium salt may be added at any time of the process of preparing the coating solution; in the case the azolium salt is added into the layer containing the organic silver salt, any time of the process may be selected, from the preparation of the organic silver salt to the preparation of the coating solution, but preferred is to add the salt after preparing the organic silver salt and just before the coating. As the method for adding the azolium salt, any method using a powder, a solution, a fine-particle dispersion, and the like, may be used. Furthermore, it may be added as a solution having mixed therein other additives such as sensitizing agents, reducing agents, tone adjusting agents, and the like. In the invention, the azolium salt may be added at any amount, but preferably, it is added in a range of from 1×10⁻⁶ mol to 2 mol, and more preferably, from 1×10⁻³ mol to 0.5 mol per one mol of silver.

(Other Additives)

1) Mercapto Compounds, Disulfides and Thiones

In the invention, mercapto compounds, disulfide compounds, and thione compounds may be added in order to control the development by suppressing or enhancing development, to improve spectral sensitization efficiency, and to improve storage properties before and after development. Descriptions can be found in paragraph Nos. 0067 to 0069 of JP-A No. 10-62899, a compound expressed by formula (I) of JP-A No. 10-186572 and specific examples thereof shown in paragraph Nos. 0033 to 0052, and in lines 36 to 56 in page 20 of EP No. 0803764A1. Among them, mercapto-substituted heterocyclic aromatic compounds described in JP-A Nos. 9-297367, 9-304875, and 2001-100358, and in Japanese Patent Application Nos. 2001-104213 and 2001-104214, and the like, are particularly preferred.

2) Toner

In the photothermographic material of the present invention, the addition of a toner is preferred. The description of the toner can be found in JP-A No. 10-62899 (paragraph Nos. 0054 to 0055), EP-A No. 0803764A1 (page 21, lines 23 to 48), JP-A Nos. 2000-356317 and 2000-187298. Particularly preferred are phthalazinones (phthalazinone, phthalazinone derivatives and metal salts thereof, e.g.,4-(1-naphthyl)phthalazinone,6-chlorophthalazinone, 5,7-dimethoxyphthalazinone and 2,3-dihydro-1,4-phthalazinedione); combinations of phthalazinones and phthalic acids(e.g., phthalic acid, 4-methylphthalic acid, 4-nitrophthalic acid, diammonium phthalate, sodium phthalate, potassium phthalate and tetrachlorophthalic anhydride); phthalazines(phthalazine, phthalazine derivatives and metal salts thereof, e.g., 4-(1-naphthyl)phthalazine,6-isopropylphthalazine, 6-ter-butylphthalazine, 6-chlorophthalazine, 5,7-dimethoxyphthalazine and 2,3-dihydrophthalazine). In the case used together with the silver halide having a high silver iodide content, particularly preferred is a combination of phthalazines and phthalic acids.

Preferred addition amount of the phthalazines is in the range from 0.01 mol to 0.3 mol, more preferably in the range from 0.02 mol to 0.2 mol, and particularly preferably in the range from 0.02 mol to 0.1 mol, per one mol of organic silver salt. This addition amount is an important factor for the problem of development acceleration when using a silver halide emulsion having a high silver iodide content. By selecting appropriate addition amount, both of sufficient development performance and low fogging will be possible.

3) Plasticizer and Lubricant

Plasticizers and lubricants usable in the photothermographic material of the invention are described in paragraph No. 0117 of JP-A No. 11-65021. Lubricants are described in paragraph Nos. 0061 to 0064 of JP-A No. 11-84573.

4) Ultra-High Contrast Promoting Agent

In order to form ultra-high contrast image suitable for use in graphic arts, it is preferred to add an ultra-high contrast promoting agent into the image forming layer. Details on the ultra-high contrast promoting agents, method of their addition and addition amount can be found in paragraph No. 0118, paragraph Nos. 0136 to 0193 of JP-A No. 11-223898, as compounds expressed by formulae (H), (1) to (3), (A), and (B) in Japanese Patent Application No. 11-87297, as compounds expressed by formulae (III) to (V) (specific compound: chemical No. 21 to chemical No. 24) in Japanese Patent Application No. 11-91652; as an ultra-high contrast accelerator, description can be found in paragraph No. 0102 of JP-A No. 11-65021, and in paragraph Nos. 0194 to 0195 of JP-A No. 11-223898.

In the case of using formic acid or formates as a strong fogging agent, it is preferably incorporated into the side having thereon the image forming layer containing photosensitive silver halide, at an amount of mmol or less, preferably, 1 mmol or less per one mol of silver.

In the case of using an ultra-high contrast promoting agent in the photothermographic material of the invention, it is preferred to use an acid resulting from hydration of diphosphorus pentaoxide, or its salt in combination. Acids resulting from the hydration of diphosphorus pentaoxide or salts thereof include metaphosphoric acid (salt), pyrophosphoric acid (salt), orthophosphoric acid (salt), triphosphoric acid (salt), tetraphosphoric acid (salt), hexametaphosphoric acid (salt), and the like. Particularly preferred acids obtainable by the hydration of diphosphorus pentaoxide or salts thereof include orthophosphoric acid (salt) and hexametaphosphoric acid (salt). Specifically mentioned as the salts are sodium orthophosphate, sodium dihydrogen orthophosphate, sodium hexametaphosphate, ammonium hexametaphosphate, and the like.

The amount of usage of the acid obtained by hydration of diphoshorus pentaoxide or the salt thereof (i.e., the coverage per 1 m² of the photosensitive material) may be set as desired depending on the sensitivity and fogging, but preferred is an amount of 0.1 mg/m² to 500 mg/m², and more preferably, of 0.5 mg/m² to 100 mg/m².

The reducing agent, hydrogen bonding compound, development accelerating agent, and polyhalogen compounds according to the invention are preferably used as solid dispersions, and the method of preparing the solid dispersion is described in JP-A No. 2002-55405.

(Preparation of Coating Solution and Coating)

The temperature for preparing the coating solution for use in the image forming layer of the invention is preferably from 30° C. to 65° C., more preferably, from 35° C. or more to less than 60° C., and most preferably, from 35° C. to 55° C. Furthermore, the temperature of the coating solution for the image forming layer immediately after adding the polymer latex is preferably maintained in the temperature range from 30° C. to 65° C.

(Layer Constitution and Other Constituting Components)

The image forming layer of the invention is constructed on a support by one or more layers. In the case of constituting the layer by a single layer, it comprises an organic silver salt, photosensitive silver halide, a reducing agent, and a binder, which may further comprise additional materials as desired if necessary, such as a toner, a coating aid, and other auxiliary agents. In the case of constituting the image forming layer from two layers or more, the first image forming layer (in general, a layer placed adjacent to the support) contains an organic silver salt and a photosensitive silver halide, and some of the other components must be incorporated in the second image forming layer or in both of the layers. The constitution of a multicolor photothermographic material may include combinations of two layers for those for each of the colors, or may contain all the components in a single layer as described in U.S. Pat. No. 4,708,928. In the case of multicolor photothermographic material, each of the image forming layers is maintained distinguished from each other by incorporating functional or non-functional barrier layer between each of the photosensitive layers as described in U.S. Pat. No. 4,460,681.

The photothermographic material according to he invention may have a non-photosensitive layer in addition to the image forming layer. The non-photosensitive layers can be classified depending on the layer arrangement into (a) a surface protective layer provided on the image forming layer (on the side farther from the support), (b) an intermediate layer provided among plural image forming layers or between the image forming layer and the protective layer, (c) an undercoat layer provided between the image forming layer and the support, and (d) a back layer provided to the side opposite to the image forming layer.

Furthermore, a layer that functions as an optical filter may be provided as (a) or (b) above. An antihalation layer may be provided as (c) or (d) to the photosensitive material.

1) Surface Protective Layer and Intermediate Layer

The photothermographic material of the invention may further comprise a surface protective layer with an object to prevent adhesion of the image forming layer. The surface protective layer may be a single layer, or plural layers. Description on the surface protective layer may be found in paragraph Nos. 0119 to 0120 of JP-A No. 11-65021, and in Japanese Patent Application No. 2000-171936.

Preferred as the binder of the surface protective layer of the invention is gelatin, but polyvinyl alcohol (PVA) may be used preferably instead, or in combination. As gelatin, there can be used an inert gelatin (e.g., Nitta gelatin 750), a phthalated gelatin (e.g., Nitta gelatin 801), and the like. Usable as PVA are those described in paragraph Nos. 0009 to 0020 of JP-A No. 2000-171936, and preferred are the completely saponified product PVA-105 and the partially saponified PVA-205 and PVA-335, as well as modified polyvinyl alcohol MP-203 (trade name of products from Kuraray Ltd.). The coating amount of polyvinyl alcohol (per 1 m² of support) in the protective layer (per one layer) is preferably in a range of from 0.3 g/m² to 4.0 g/m², and more preferably, from 0.3 g/m² to 2.0 g/m².

The coating amount of the total binder (including water-soluble polymer and latex polymer) in the surface protective layer (per one layer) is preferably 0.3 g/m² to 5.0 g/m², more preferably, 0.3 g/m² to 2.0 g/m² per one m of a support.

2) Antihalation Layer

It is preferred that the photothermographic material of the present invention contains a dye having absorption at the exposure wavelength region in at least one layer of an image forming layer and a light insensitive layer to prevent a halation at the exposure. The said light insensitive layer is located in nearer side to a support than an image forming layer (may be an antihalation layer or a subbing layer) or in opposite side to an image forming layer toward a binder.

In the case, wherine the exposure wavelength is in the infrared region, an infrared dye may be used and in the case, wherein the exposure wavelength is in the ultraviolet region, an ultraviolet absorber may be used, whereby both dyes preferably have no absorption in the visible region or have a little visible absorption.

In the case where the exposure wavelength is present in the visible region, it is preferred to allow substantially no color of the dye to remain after the image formation and to use the color bleaching method by heating at the thermal development. In particular, the light insensitive layer is preferably rendered to function as a thermal bleaching antihalation layer by adding thereto a thermal bleaching dye and a base precursor. These techniques are described in JP-A No. 11-231457 and the like.

The amount of antihalation dye to be added is determined depending on the usage of the dye. In general, the decolorizable dye is preferably used in the amount where the optical density (absorbance) measured at the objective wavelength shows more than 0.1. Particularly, the optical density is preferably 0.15 to 2. For attaining such optical density, the amount of the dye to be coated is generally on the order of 0.001 g/m² to 1 g/m².

In the case where the exposure source is a laser beam, it is enough that the antihalation layer has the absorption in the narrow wavelength region correspondent to the peak of the radiation wavelength, therefore it is possible to be a lower coating amount of the dye and to produce photosensitive material with lower cost.

Shorter the radiation peak wavelength of laser beam is, more fine definition image recording is possible. Therefore, the radiation peak wavelength of laser beam is preferably 350 nm to 430 nm, more preferably 380 nm to 420 nm from the practical point of view.

In the case where the laser beam as the exposure light source has the radiation peak wavelength at 350 nm to 430 nm, it is preferred that the antihalation dye has the absorption maximum at the wavelength between 350 nm to 430 nm. Further, in the case where the radiation peak wavelength of laser beam is present between 380 nm to 420 nm, it is preferred that the dye described above has the absorption maximum at the wavelength between 380 nm to 420 nm.

The layer comprising the dye having an absorption maximum at the wavelength between 350 nm to 430 nm preferably may be an image forming layer, a light insensitive layer (may be an antihalation layer) in the nearer side to the support than an image forming layer, or a light insensitive layer on the back side in opposite to the image forming layer toward the support.

The kind of dye described above is not particularly limited as far as it has an absorption maximum between 350 nm to 430 nm. The absorption maximum measured between 350 nm to 430 nm may be either of a main absorption or a sub absorption. Specific examples of the dye having an absorption maximum between 350 nm to 430 nm are an azo dye, an azomethine dye, a quinone dye (e.g., an anthraquinone dye, a naphthoquinone dye and the like), a quinoline dye (e.g., a quinophthalone dye and the like), a methine dye (e.g., a cyanine dye, a merocyanine dye, an oxonol dye, a styryl dye, an arylidene dye, an aminobutadiene dye and the like and a polymethine dye is also contained), a carbonium dye (e.g., a cationic dye such as diphenylmethane dye, a triphenylmethane dye a xanthene dye, an acridine dye and the like), an azine dye (e.g., a cationic dye such as a thiazine dye, an oxazine dye, a phenazine dye and the like), an aza [18] π electron dye (e.g., a porphin dye, a tetrazaporphin dye, a phthalocyanine dye and the like), an indigoid dye (e.g., indigo, a thioindigo dye and the like), a squalenium dye, a croconium dye, a pyrromethene dye, a nitro-nitroso dye, a benzotriazole dye, a triazine dye and the like can be described. An azo dye, an azomethine dye, a quinone dye, a quinoline dye, a methine dye, an aza [18] π electron dye, an indigoid dye and a pyrromethene dye are preferable and an azo dye, an azomethine dye and a methine dye are more preferable and a methine dye are most preferable.

These dyes may be present in a solid fine particle dispersion or in an aggregation state (a liquid crystal state also contained) and may be used with two kinds of dyes or more in combination.

A dye having larger absorption at the exposure wavelength is preferably used as the antihalation dye because the coating amount of the dye can be reduced. Therefore, an antihalation dye preferably has a narrow half value width and a sharp absorption peak on an absorption spectrum. In another way, it is also preferred to use a dye under the condition wherein the dye shows such absorption. In order to the dye to have larger absorption and sharper absorption spectrum, it is preffered to be used under the dispersion state of solid fine particle or the aggregation state. A dye having an ionic hydrophilic group prefferably is used for formation of an aggregation state. The half value width of the dye preferably is 100 nm or less, more preferably 75 nm or less and most preferably 50 nm or less.

The antihalation dye either may be bleached after the image forming or may not be bleached. In the case where the dye is not bleached (from now on, this is called non-bleaching dye), the dye preferably is not remarkable in visual and the ratio of the absorption at the exposure wavelength to the absorption at 425 nm, preferably is larger. For example, in the case, where the photographic material is exposed by a laser diode having a radiation at 405 nm, the ratio of an absorption at 405 nm to the absorption at 425 nm is preferably 5 or more, more preferably 10 or more and particularly preferably 15 or more.

As examples of these dyes, an aminobutadiene dye, the merocyanine dye in which an acidic nucleus and an alkaline nucleus directory connect with each other or a polymethine dye may be described. And in the case of non-bleaching dye, it can be added as aqueous solution if it might be water-soluble.

In another case, an antihalation dye preferably is bleached in thermal development process. As the color bleaching method, following methods are known and any method thereof can be used.

(1) The color bleaching method by the reaction of a coloring matter (dye) composed of an electron donating color forming organic compound and an acidic developer and a specifcal dye bleaching agent at the thermal development described in such as JP-A Nos. 9-34077 and 2001-51371.

(2) The color bleaching method by a combination of the said bleaching dye and the radical generating compound by the light irradiation or the heating and the bleaching dye, described in such as JP-A Nos. 9-133984,2000-29168, 2000-284403 and 2000-347341.

(3) The color bleaching method by a combination of the said bleaching dye and a compound which can release an alkali or a nucleophile by heating and bleach the dye, described in U.S. Pat. Nos. 5,135,842, 5,258,724, 5,314,795, 5,324,627, 5,384,237, JP-A Nos. 3-26765, 6-222504, 6-222505 and 7-36145.

(4) The color bleaching method of dye througth an intra-molecular ring closure reaction by the thermal self decomposition of the dye described in U.S. Pat. No. 4,894,358, JP-A Nos. 2-289856 and 59-182436.

(5) The color bleaching method of the dye by the combination of the intra-molecular ring closure bleaching dye having an exellent bleaching property and a base or a base precursor described in JP-A Nos. 6-82948, 11-231457 and 2000-112058, 2000-281923, 2000-169248.

Among them, the combination of the color bleaching agent (a radical generator, a base precursor, a nucleophile generator) and the bleaching dye is preferably, because it is easy to be consistent with the bleaching property at the thermal development and the stock stability at the non-development. Particularly, the combination of the intra-molecular ring closure bleaching dye and a base precursor is more preferably, because it can be consistent with the bleaching property and the stability.

The intra-molecular ring closure bleaching dye preferred to have a polymethine chromophore and more preferably a polymethine dye having a group which can generate a nucleophilic at the position where a 5 to 7 ring can be formed by the reaction at the polymethine part part by the reaction of the base.

The polymethine dye having the group which can become the nucleophilic group by dissociation at the position capable of a 5 to 7 ring formation is most preferable, such as represented by following formulae (21) and (22).

Particularly, the dye represented by following formulae (21) and (22) is preferably used.

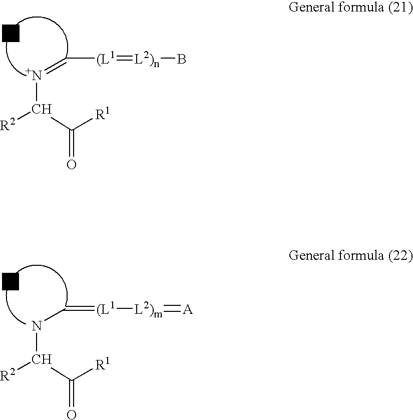

In formulae (21) and (22), R¹ represents a hydrogen atom, an aliphatic group, an aromatic group, —NR²¹R²⁶, —OR²¹ and —SR²¹. R²¹ and R²⁶ each independently represent a hydrogen atom, an aliphatic group, an aromatic group, or R²¹ and R²⁶ may bind each other to form a nitrogen containing heterocyclic ring. R² represents a hydrogen atom, an aliphatic group, an aromatic group, or R¹ and R² may bind each other to form a 5 or 6 membered ring. L¹ and L² each independently represent a substituted or unsubstituted methine group, wherein the substituents of methine group may bind each other to form an unsaturated alicyclic ring, or an unsaturated hetero cyclic ring. Z¹ represents the atomic group necessary to form a 5 or 6 membered nitrogen containing hetero cyclic ring and the nitrogen containing hetero cyclic ring may condense with an aromatic ring and the nitrogen containing hetero cyclic ring and the condensed ring may have substituents. A represents an acidic nucleus and B represents an aromatic group, an unsubstituted heterocyclic group or a group represented by following formula (23). n and m each represent an integral number of 1 to 3. When n and m each represents 2 or more, L¹ and L² which represent 2 or more may be the same or different.

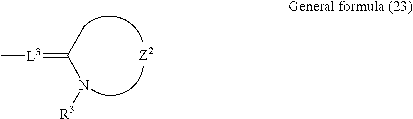

In formula (23), L³ represents a substituted or unsubstituted methine group and may bind with L² to form an unsaturated alicyclic ring or an unsaturated heterocyclic ring. R³ represents an aliphatic group or an aromatic group. Z² represents an atomic group necessary to form a 5 or 6 membered nitrogen containing heterocyclic ring, wherein the nitrogen containing heterocyclic ring may condense with an aromatic ring, and the nitrogen containing heterocyclic ring and the condensed ring may have substituents.

In the formula above described, R¹ represents a hydrogen atom, an aliphatic group, an aromatic group, —NR²¹R²⁶, —OR²¹ and —SR²¹. R²¹ and R²⁶ each independently represents a hydrogen atom, an aliphatic group, an aromatic group or R²¹ and R²⁶ may bind each other to form a nitrogen containing hetero cyclic ring.

R¹ preferably represents —NR²¹R²⁶, —OR²¹ and —SR²¹. R²¹ preferably represents an aliphatic group or an aromatic group and more preferably an unsubstituted alkyl group, a substituted alkyl group, an unsubstituted aralkyl group, a substituted aralkyl group, an unsubstituted aryl group and a substituted aryl group.

R²⁶ preferably represents a hydrogen atom or an aliphatic group and more preferably a hydrogen atom, an unsubstituted alkyl group or a substituted alkyl group. The nitrogen containing heterocyclic ring formed by binding with R²¹ and R²⁶ preferably is a 5 or 6 membered ring. The nitrogen containing heterocyclic ring may have a hetero atom except for nitrogen atom (e.g., a oxygen atom, a sulfur atom).

In the specification of the present invention, “an aliphatic group” means an unsubstituted alkyl group, a substituted alkyl group, an unsubstituted alkenyl group, a substituted alkenyl group, an unsubstituted alkynyl group, a substituted alkynyl group, an unsubstituted aralkyl group, and a substituted aralkyl group. In the present invention, an unsubstituted alkyl group, a substituted alkyl group, an unsubstituted alkenyl group, a substituted alkenyl group, an unsubstituted aralkyl group and a substituted aralkyl group are preferable and an unsubstituted alkyl group, a substituted alkyl group, an unsubstituted aralkyl group and a substituted aralkyl group are more preferable. Further, a chain aliphatic group is more preferable than an alicyclic group. A chain aliphatic group may be branched. An unsubstituted alkyl group has preferably 1 to 30 carbon atoms, more preferably 1 to 15 carbon atoms, still more preferably 1 to 10 carbon atoms and most preferably 1 to 8 carbon atoms. An alkyl part of a substituted alkyl group is similar to that in the preferred range of an unsubstituted alkyl group.

An unsubstituted and a substituted alkenyl group have preferably 2 to 30 carbon atoms, more preferably 2 to 15 carbon atoms, still more preferably 2 to 12 carbon atoms, and most preferably 2 to 8 carbon atoms. An alkenyl part of a substituted alkenyl group and an alkynyl part of a substituted alkynyl group are similar to that in the each preferred range of an unsubstituted alkenyl group and an unsubstituted alkynyl group respectively. An unsubstituted aralkyl group has preferably 7 to 35 carbon atoms, more preferably 7 to 20 carbon atoms, still more preferably 7 to 15 carbon atoms and most preferably 7 to 10 carbon atoms. The aralkyl part of a substituted aralkyl group is similar to that in the preferred range of an unsubstituted aralkyl group.

Examples of a substituent of an aliphatic group (a substituted alkyl group, a substituted alkenyl group, a substituted alkynyl group and a substituted aralkyl group) include a halogen atom (fluorine atom, chlorine atom and bromine atom), a hydroxy group, an alkoxy group, an aryloxy group, a silyloxy group, an oxy group substituted at a hetero ring, an acyloxy group, a carbamoyloxy group, an alkoxycarbonyloxy group, an aryloxycarbonyloxy group, a nitro group, a sulfo group, a carboxyl group, an acyl group, an alkoxycarbonyl group, an aryloxycarbonyl group, a carbamoyl group, an alkylthiocarbonyl group, a hetero ring group, a cyano group, an amino group (an anilino group is included), an acylamino group, an aminocarbonylamino group, an alkoxycarbonylamino group, an aryloxycarbonylamino group, a sulfamoylamino group, an alkyl and arylsulfonylamino group, a mercapto group, an alkylthio group, an arylthio group, a mercapto group attached to a hetero ring, a sulfamoyl group, an alkyl and arylsulfinyl group, an alkyl and arylsulfonyl group an alkoxycarbonyl group, an imido group, a phosphino group, a phosphinyl group, a phosphinyloxy group a phosphinylamino group, a phosphono group and a silyl group. A carboxyl group, a sulfo group and a phosphono group may be the corresponding salt states. The cation, which forms a salt with a carboxyl group, a phosphono group and a sulfo group, preferably is an ammonium ion and an alkali metal ion (e.g., lithium ion, sodium ion and potassium ion).

In the specification of the present invention, “an aromatic group” means an unsubstituted aryl group or a substituted aryl group. An unsubstituted aryl group preferably has 6 to 30 carbon atoms, more preferably 6 to 20 carbon atoms, still more preferably 6 to 15 carbon atoms and most preferably 6 to 12 carbon atoms. The aryl part of a substituted aryl group is the same as that in the preferred range of an unsubstituted aryl group. As examples of a substituent of an aromatic group (a substituted aryl group), the examples in an aliphatic group and the examples in the substituent of an aliphatic group can be described.

In formulae (21) and (22) described above, R² represents a hydrogen atom, an aliphatic group, or an aromatic group, wherein R¹ and R² may bind each other to form a 5 or 6 membered ring. The definition of an aliphatic group and an aromatic group is the same as that described above. R² preferably represents a hydrogen atom, or an aliphatic group and more preferably a hydrogen atom, or an alkyl group and still more preferably a hydrogen atom, or an alkyl group having 1 to 15 carbon atoms and most preferably a hydrogen atom.

In formulae (21), (22) and (23) described above, L¹, L² and L³ each independently represent a methine group which may be substituted. The substituents of methine group may bind each other to form an unsubstituted aliphatic ring or an unsubstituted heterocyclic ring. Examples of a methine group include a halogen atom, an aliphatic group and an aromatic group. The definition of an aliphatic group and an aromatic group is the same as that described above. The substituents of methine group may bind each other to form an unsaturated aliphatic ring or an unsaturated heterocyclic ring. The unsaturated aliphatic ring is more preferable than the unsaturated heterocyclic ring. The formed ring is preferably a 5 or 6 membered ring, more preferably a cyclopentene ring or a cyclohexene ring. It is particularly preferred that the methine group is unsubstituted or substituted by an alkyl group or an aryl group at the meso position.

In formula (21) described above, n represents the integer from 1 to 3 and preferably 1 or 2. When n is 2 or more, the repeated methine group may be the same or different. In formula (22) described above, m represents the integer from 1 to 3 and preferably 1 or 2. When m is 2 or more, the repeated methine group may be the same or different.

In formulae (21) and (22) described above, Z¹ represents the atomic group necessary to form a 5 or 6 membered nitrogen containing heterocyclic ring and may condense with an aromatic ring, wherein the nitrogen containing heterocyclic ring and the condensed ring may have substituents. As the examples of the nitrogen containing heterocyclic ring, an oxazole ring, a thiazole ring, a selenazole ring, a pyrrole ring, a pyrroline ring, an imidazole ring and a pyridine ring are included. A 5 membered ring is more preferable than a 6 membered ring. The nitrogen containing heterocyclic ring may condense with an aromatic ring (benzene ring and naphthalene ring). The nitrogen containing heterocyclic ring and the condensed ring may have substituents. As the examples of substituent, the substituent of the aromatic group described above can be described and a halogen atom (fluorine atom, chlorine atom and bromine atom), a hydroxy group, a nitro group, a carboxyl group, a sulfo group, an alkoxy group, an aryl group and an alkyl group are preferable. A carboxyl group and a sulfo group may be a salt state. As the cation which forms a salt with a carboxyl group and a sulfo group, an ammonium ion and an alkali metal ion (e.g., sodium ion and potassium ion) are preferable.

In formula (21), B represents an aromatic group, an unsaturated heterocyclic ring group or formula (23) described above. The definition of an aromatic group is the same as that described above. As the aromatic group represented by B, a substituted or an unsubstituted phenyl group is preferable. As the substituent, a halogen atom, an amino group, an acylamino group, an alkoxy group, an aryloxy group, an alkyl group, an alkylthio group and an aryl group are preferably and an amino group, an acylamino group, an alkoxy group and an alkyl group at the 4 position are particularly preferable. As the unsaturated heterocyclic ring group represented by B, a 5 or 6 membered heterocyclic ring group composed of a carbon atom, an oxygen atom and a sulfer atom is preferable. Among them, a 5 membered ring is particularly preferable. As the preferred examples, a substituted or unsabstituted pyrrole, indole, thiophene and furan can be described.

In formula (23) described above, Z² represents the atomic group necessary to form a 5 or 6 membered nitrogen containing heterocyclic ring and may be the same as Z¹ or different. The examples of nitrogen containing heterocyclic ring described above can be demonstrated the same examples described in the case of Z¹. In formula (23) described above, R3 represents an aliphatic group or an aromatic group and an aliphatic group is preferable, and —CHR²(COR¹) that is similar to the substituent on a nitrogen atom of formula (21) described above is most preferable.

In formula (22) described above, A represents an acidic nucleus. The acidic nucleus preferably is a group in which one or more (usually two) hydrogen atoms are removed from a cyclic ketomethylene compound or a compound having a methylene group put between two electron withdrawing groups. As the examples of cyclic ketomethylene compound, a 2-pyrazoline-5-one, a rhodanine, a hydantoin, a thiohydantoin, an 2,4-oxazolidinedione, an isoxazolone, a barbituric acid, a thiobarbituric acid, an indanedione, a dioxopyrazolopyridine, a Meldrum's acid, a hydroxypyridine, a pyrazolidinedione, a 2,6-dihydrofuran-2-one and a pyrroline-2-one can be described. These may have a substituent.

The compounds having a methylene group put between the electron withdrawing groups described above can be represented as Z^{a}CH₂Z^{b}. Z^{a} and Z^{b} each independently represents —CN, —SO₂R^{a1}, —COR^{a1}, —COOR^{a2}, —CONHR^{a2}, SO₂NHR^{a2}, —C[═C(CN)₂]R^{a1} and —C[═C(CN)₂]NHR^{a1}. R^{a1} represents an alkyl group, an aryl group or a heterocyclic ring group and R^{a2} represents a hydrogen atom, an alkyl group, an aryl group or a heterocyclic ring group and R^{a1} and R^{a2} each may have a substituent. Among these acidic nuclei, a 2-pyrazoline-5-one, an isoxazolone, a barbituric acid, an indanedione, a hydroxypyridine, a pyrazolidinedione and a dioxopyrazolopyridine are more preferable.

The dye represented by formula (21) preferably forms a salt with an anion. In the case, wherein the dye represented by formula (21) described above has an anionic group such as a carboxyl group and a sulfo group as a substituent, the dye can form an intra-moleculer salt. In the other case besides this, the dye preferably forms a salt with an anion outside of a molecule. An anion is preferably mono or divalent and more preferably monovalent. As the examples of anion, a halogen ion (Cl⁻, Br⁻, I⁻), a p-toluene sulfonate ion, an ethyl sulfonate ion, a 1,5-disulfonaphthalene dianion, PF₆⁻, BF₄⁻, and ClO₄⁻ can be included.

The dye represented by formulae (21) and (22) described above may be used under a molecular dispersion state, but preferably under a solid fine particle dispersion state or an aggregation state. In order to form the aggregation state of the dye described above, the dye preferably has an ionic hydrophilic group. The ionic hydrophilic group contains a sulfo group, a carboxyl group, a phosphono group a quaternary ammonium group and the like, and preferably a carboxyl group, a phosphono group and a sulfo group and more preferably a carboxyl group and a sulfo group. A carboxyl group, a phosphono group and a sulfo group may be a salt state and as the examples of counter ion to form a salt, an ammonium ion, an alkali metal ion (e.g., lithium ion, sodium ion and potassium ion) and an organic cation (e.g., tetramethylammonium ion, tetramethylguanidium ion and tetramethylphosphonium ion) are included.

General formula of an amino butadiene dye and a merocyanine dye as a non-bleaching dye for an antihalation can be shown below.

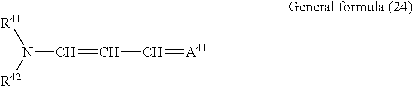

In the formula, R⁴¹ and R⁴² each independently represent a hydrogen atom, an aliphatic group, an aromatic group or the non metal atomic group necessary to form a 5 or 6 membered ring. And either one of R⁴¹ and R⁴² may bind with a methine group adjacent to a nitrogen atom to form a 5 or 6 membered ring. A⁴¹ represents an acidic nucleus.

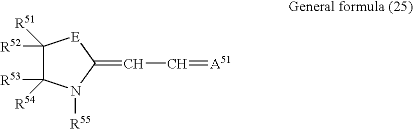

In the formula, R⁵¹ to R⁵⁵ each independently represent a hydrogen atom, an aliphatic group or an aromatic group and R⁵¹ and R⁵⁴ may join together to form a double bond. When R⁵¹ and R⁵⁴ joins together to form a double bond, R⁵² and R⁵³ may join together to form a benzene ring or a naphthalene ring. R⁵⁵ represents an aliphatic group or an aromatic group and E represents an oxygen atom, a sulfur atom, an ethylene group, >N—R⁵⁶ or >C(R⁵⁷) (R⁵⁸) and R⁵⁶ represents an aliphatic group or an aromatic group and R⁵⁷ and R⁵⁸ each independently represent a hydrogen atom or an aliphatic group. A⁵¹ represents an acidic nucleus.

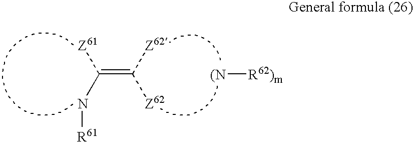

In the formula, R⁶¹ represents a hydrogen atom, an aliphatic group or an aromatic group. R⁶² represents a hydrogen atom, an aliphatic group or an aromatic group. Z⁶¹ represents an atomic group necessary to form a nitrogen containing heterocyclic ring. Z⁶² and Z^{62′} represent an atomic group necessary to form a heterocyclic ring or a noncyclic terminal acidic group by joining with (N—R⁶²)m. However, Z⁶¹, Z⁶² and Z^{62′} each may condense to form a ring. m represents 0 or 1.

Following, a dye represented by formulae (24), (25), and (26) is described in detail.

For an aliphatic group and an aromatic group of R⁴¹, R⁴², R⁵¹ to R⁵⁸, R⁶¹ and R⁶² in formulae (24), (25) and (26) the similar aliphatic group and aromatic group as those described in R¹ can be applied. The examples of subsutituent also are similar to those ones.

For an acidic nucleus represented by A⁴¹ and A⁵¹, similar one as those described in A of formula (22) can be applied, and preferably applied a group in which one ore more (usually two) hydrogen atoms are removed from a ketomethylene compound or a compound having a methylene group put between two electron withdrawing groups. As more preferable examples of methylene compound, Z^{a}CH₂Z^{b} (the same definition described in A of formula (22)), a 2-pyrazoline-5-one, an isoxazolone, a barbituric acid, an indanedione, a Meldrum's acid, a hydroxypyridine, a pyrazolidinedione, a dioxopyrazolopyridine and the like can be described. These may have a substituent.

As a 5 or 6 membered ring formed by binding with R⁴¹ and R⁴², a pyrrolidine ring, a pyperidine ring a morphorine ring and the like can be described as preferred examples.

In formula (26) described above, Z⁶¹ is an atomic group necessary to form a 5 or 6 membered nitrogen containing heterocyclic ring and the nitrogen containing heterocyclic ring may condense with an aromatic ring. The nitrogen containing heterocyclic ring and the condensed ring may have a substituent. As the examples of nitrogen containing heterocyclic ring described above, a thiazoline nucleus, a thiazole nucleus, a benzothiazole nucleus, an oxazoline nucleus, an oxazolole nucleus, a benzoxazole nucleus, a selenazoline nucleus, a selenazole nucleus, a benzoselenazole nucleus, a tellurazoline nucleus, a tellurazole nucleus, a benzotellurazole nucleus, a 3,3-dialkylindolenine nucleus (e.g., 3,3-dimethylindolenine), an imidazoline nucleus, an imidazole nucleus, a benzimidazole nucleus, a 2-pyridine nucleus, a 4-pyridine nucleus, a 2-quinoline nucleus, a 4-quinoline nucleus, a 1-isoquinoline nucleus, a 3-isoquinoline nucleus, an imidazo[4,5-b]quinoxaline nucleus, an oxadiazole nucleus, a thiadiazole nucleus, a tetrazole nucleus, a pyrimidine nucleus and the like can be described. A thiazoline nucleus, a thiazole nucleus, a benzothiazole nucleus, an oxazoline nucleus, an oxazole nucleus, a benzoxazole nucleus, 3,3-dialkylindolenine nucleus (e.g., 3,3-dimethylindolenine), an imidazoline nucleus, an imidazole nucleus, a benzimidazole nucleus, a 2-pyridine nucleus, a 4-pyridine nucleus, a 2-quinoline nucleus, a 4-quinoline nucleus, a 1-isoquinoline nucleus and a 3-isoquinoline nucleus are preferably. And a thiazoline nucleus, a thiazole nucleus, a benzothiazole nucleus, an oxazoline nucleus, an oxazole nucleus, a benzoxazole nucleus, 3,3-dialkylindolenine nucleus (e.g., 3,3-dimethylindolenine), an imidazoline nucleus, an imidazole nucleus and a benzimidazole nucleus are more preferably. And a thiazoline nucleus, a thiazole nucleus, a benzothiazole nucleus, an oxazoline nucleus, an oxazole nucleus and a benzoxazole nucleus are particularly preferably. And a thiazoline nucleus, an oxazoline nucleus and a benzoxazole nucleus are most preferably. The nitrogen containing heterocyclic ring may condense with an aromatic ring (benzene ring and naphthalene ring). The nitrogen containing heterocyclic ring and the condensed ring may have a substituent. As the examples of substituent, a substituent of the aromatic group described above can be described, and preferably described a halogen atom (fluorine atom, chlorine atom and bromine atom), a hydroxy group, a nitro group, a carboxyl group, a sulfo group, an alkoxy group, an aryl group and an alkyl group. A carboxyl group and a sulfo group may be a salt state. As the cation which forms a salt with a carboxyl group and a sulfo group, an ammonium ion and an alkali metal ion (e.g., sodium ion and potassium ion) are preferable.

Z⁶² and Z^{62′} and (N—R⁶²)ₘ represent an atomic group necessary to form a heterocyclic ring and a noncyclic acidic terminal group by joining each other. As a heterocyclic ring (preferably a 5 or 6 membered heterocyclic ring), any heterocyclic ring can be applied, and an acidic nucleus preferably can be applied.

Next, an acidic nucleus and a noncylic acidic terminal group are explained. As an acidic nucleus and a noncylic acidic terminal group, any acidic nucleus in merocyanine dye and any noncyclic acidic terminal group can be applied. z⁶² preferably represents a thiocarbonyl group, a carbonyl group, an ester group, an acyl group, a carbamoyl group, a cyano group, a sulfonyl group and more preferably a thiocarbonyl group and a carbonyl group. Z^{62′} represents a residual atomic group necessary to form an acidic nucleus and a noncyclic acidic terminal group. In the case where a noncyclic acidic terminal group is formed, a thiocarbonyl group, a carbonyl group, an ester group, an acyl group, a carbamoyl group, a cyano group, a sulfonyl group and the like are preferable.

m represents 0 or 1 and preferably 1.

The acidic nucleus and the noncyclic acidic terminal group herein are described in, for example, James, “The theory of the Photographic Process”, MaCmillan publishing Co., Inc., the 4^{th} ed., pages 197 to 200, (1977). Herein, the noncyclic acidic terminal group means a group not to form a ring among an acidic terminal group that is to say an electron accepting terminal group.

Typical examples of an acidic nucleus and a noncyclic acidic terminal group are described in U.S. Pat. Nos. 3,567,719, 3,575,869, 3804634, 3837862, 4002480, 4925777, JP-A No. 3-167546, U.S. Pat. Nos. 5,994,051, 5,747,236 and the like.

The acidic nucleus preferably is a heterocyclic ring (preferably, a 5 or 6 membered nitrogen containing heterocyclic ring) composed of a carbon atom, a nitrogen atom and/or chalcogen atom (typically, an oxygen atom, a sulfur atom, a selenium atom and a tellurium atom) and more preferably a 5 or 6 membered nitrogen containing heterocyclic ring composed of a carbon atom, a nitrogen atom and/or chalcogen atom (typically, an oxygen atom, a sulfur atom, a selenium atom and a tellurium atom). As typical examples, the nucleus of 2-pyrazoline-5-one, pyrazolidine-3,5-dione, imidazoline-5-one, hydantoin, 2- or 4-thiohydantoin, 2-iminoxazolidine-4-one, 2-oxazoline-5-one, 2-thioxazolidine-2,5-dione, 2-thioxazoline-2,4-dione, isoxazolidine-5-one, 2-thiazoline-4-one, thiazolidine-4-one, thiazolidine-2,4,-dione, rhodanine, thiazolidine-2,4-dithione, isorhodanine, indane-1,3-dione, thiophene-3-one, thiophene-3-one-1,1-dioxide, indoline-2-one, indoline-3-one, 2-oxoindazolinium, 3-oxoindazolinium, 5,7-dioxo-6,7-dihydrothiazolo[3,2-a]pyrimidine, cyclohexane-1,3-dione, 3,4-dihydroisoquinoline-4-one, 1,3-dioxane-4,6-dione, barbituric acid, 2-thiobarbituric acid, chromane-2,4-dione, indazoline-2-one, pyrido[1,2-a]pyrimidine-1,3-dione, pyrazolo[1,5-b]quinazolone, pyrazolo[1,5-a]benzimidazole, pyrazolopyrydone, 1,2,3,4-tetrahydroquinoline-2,4-dione, 3-oxo-2,3-dihydrobenzo[d]thiophene-1,1-dioxide, 3-dicyanomethine-2,3-dihydrobenzo[d]thiophene-1,1-dioxide, a nucleus having an exo-methylene structure formed by substitution of the carbonyl group or a thiocarbonyl group in the nuclei above described at an active methylene position of acidic nucleus, a nucleus having an exo-methylene structure formed by substitution at an active methylene position of active methylene compound having a ketomethylene or a cyanomethylene structure which can be a starting material of noncyclic acidic terminal group and a nucleus having a repeating structure of these nuclei are described.

An acidic nucleus and a noncyclic acidic terminal group described above may be substituted by a substutuent described above as an example of the substituent in an aromatic group and and the ring may be condensed.

As Z⁶², Z^{62′} and (N—R⁶²)ₘ, hydantoin, 2- or 4-thiohydantoin, 2-oxazoline-5-one, 2-thioxazoline-2,4-dione, thiazolidine-2,4,-dione, rhodanine, thiazolidine-2,4-dithione, barbituric acid and 2-thiobarbituric acid are preferable and hydantoin, 2- or 4-thiohydantoin, 2-oxazoline-5-one, rhodanine, barbituric acid and 2-thiobarbituric acid are more preferable and 2- or 4-thiohydantoin, 2-oxazoline-5-one and rhodanine are especially preferable.

In the case where a dye represented formulae (24) to (26) described above is water-soluble, it is preferred that the dye has an ionic hydrophilic group. The examples and the preferred examples of ionic hydrophilic group are similar to those described in formulae (21) and (22).

Typical examples of antihalation dye for preferred use are shown below, but the antihalation dyes are not limited to following typical examples.

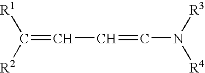

| No | —R¹ | —R² | —R³ | —R⁴ |
|---|---|---|---|---|
| 1 | —CN | —CO₂CH₃ | -nC₄H₉ | -nC₄H₉ |
| 2 | —CN | —CN | -nC₆H₁₃ | -nC₆H₁₃ |
| 3 | —CN | 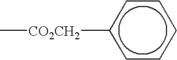 | 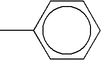 | -nC₄H₉ |
| 4 | —CN | —CN | 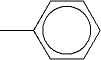 | -nC₆H₁₃ |
| 5 | —CN | —CN | 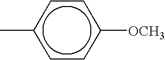 | —C₂H₅ |
| 6 | —COCH₃ | —COCH₃ | —C₂H₅ | —C₂H₅ |
| 7 | —COCH₃ | —CO₂C₂H₅ | —C₂H₅ | —C₂H₅ |
| 8 | —COCH₃ | —CO₂C₂H₅ | —CH₂CH₂—O—CH₂CH₂— | |
| 9 | 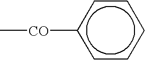 | —CO₂C₂H₅ | -nC₆H₁₃ | -nC₆H₁₃ |
| 10 | —COCH₃ | 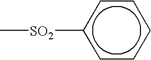 | —C₂H₅ | —C₂H₅ |
| 11 | —COCH₃ | 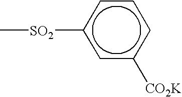 | —CH₂CH₂SO₃K | —CH₂CH₂SO₃K |
| 12 | —COCH₃ | 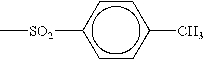 | H | -tC₄H₉ |
| 13 | —COCH₃ | —CONHCH₂CH₂SO₃Na | —C₂H₅ | —C₂H₅ |
| 14 | —COCH₃ | 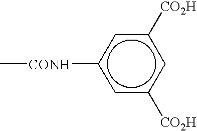 | 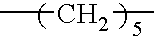 | |
| 15 | 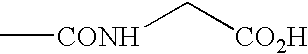 | 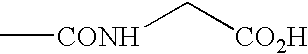 | 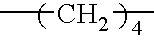 | |
| 16 | —CONHCH₂CH₂SO₃Na | —CONHCH₂CH₂SO₃Na | nC₃H₇ | nC₃H₇ |
| 17 | —COCH₃ | —CO₂C₂H₅ | —CH₂CH₂SO₃Na | —CH₂CH₂SO₃Na |
| 18 | —CO₂C₂H₅ | —CO₂C₂H₅ | 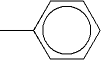 | —CH₂SO₃Na |

| | |
|---|---|
| 19 | 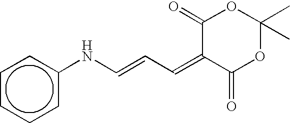 |
| 20 | 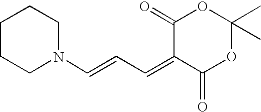 |
| 21 | 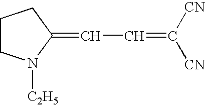 |
| 22 | 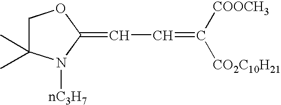 |
| 23 | 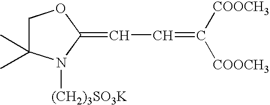 |
| 24 | 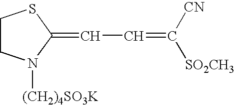 |
| 25 | 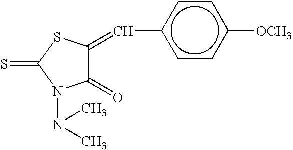 |
| 26 | 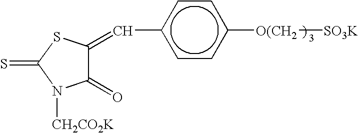 |
| 27 | 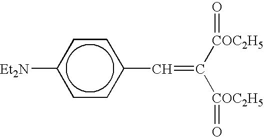 |
| 28 | 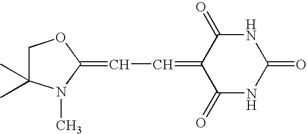 |
| 29 | 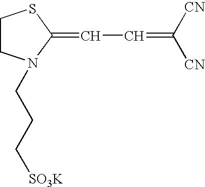 |
| 30 | 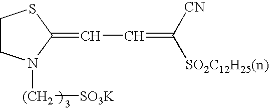 |
| 31 | 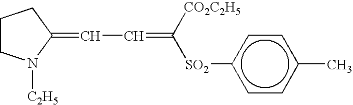 |
| 32 | 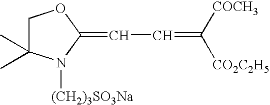 |

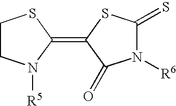

| No | R⁵ | R⁶ |
|---|---|---|
| 33 | —C₂H₅ | —CH₂CO₂H |
| 34 | -nC₆H₁₃ | 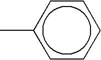 |
| 35 | 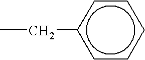 | -nC₁₂H₂₅ |
| 36 | 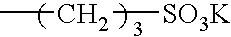 | —H |
| 37 | 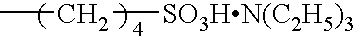 | —CH₂CO₂H |
| 38 | 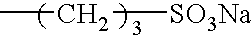 | 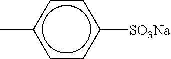 |
| 39 | -nC₃H₇ | 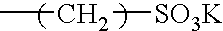 |

| | |
|---|---|
| 40 | 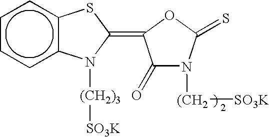 |
| 41 | 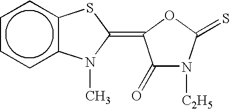 |
| 42 | 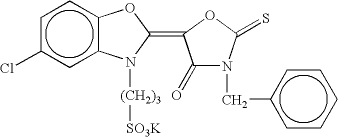 |
| 43 | 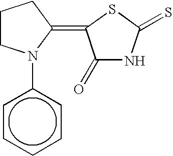 |
| 44 | 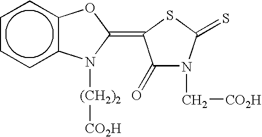 |
| 45 | 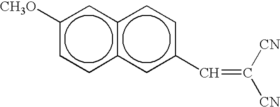 |
| 46 | 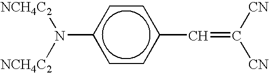 |
| 47 | 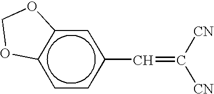 |
| 48 | 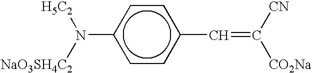 |
| 49 | 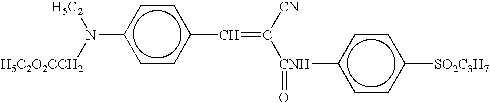 |
| 50 | 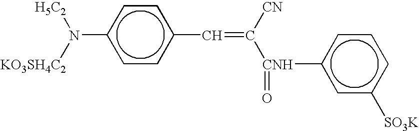 |
| 51 | 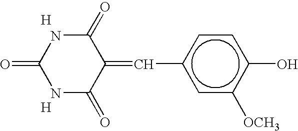 |
| 52 | 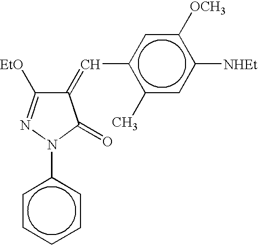 |
| 53 | 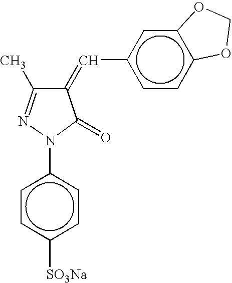 |
| 54 | 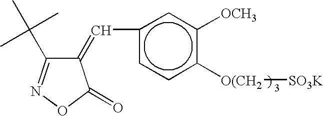 |
| 55 | 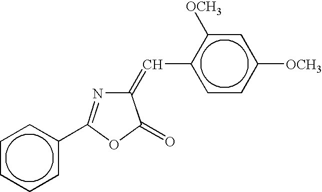 |
| 56 | 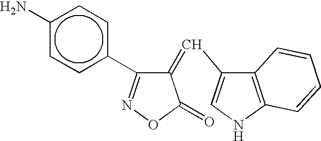 |
| 57 | 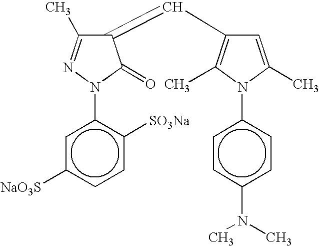 |
| 58 | 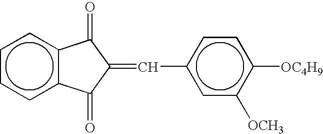 |
| 59 | 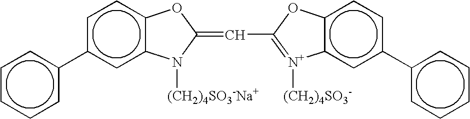 |
| 60 | 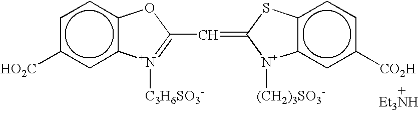 |
| 61 | 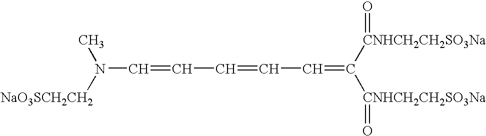 |
| 62 | 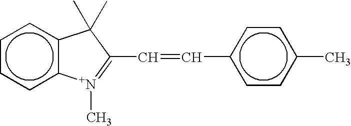 |
| 63 | 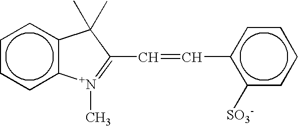 |
| 64 | 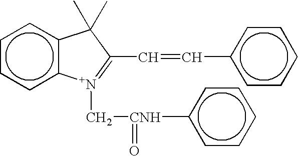 |
| | 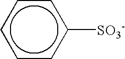 |
| 65 | 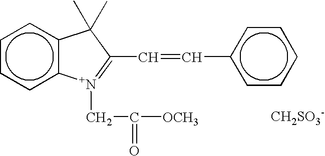 |
| 66 | 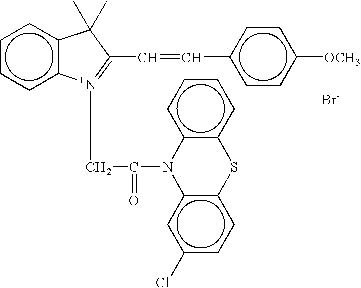 |
| 67 | 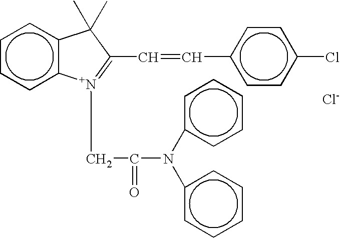 |
| 68 | 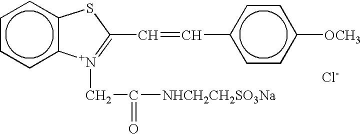 |
| 69 | 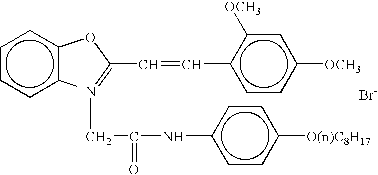 |
| 70 | 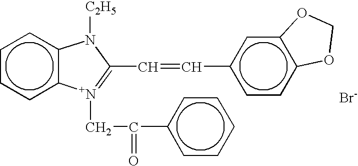 |
| 71 | 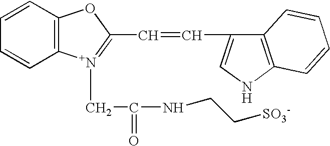 |
| 72 | 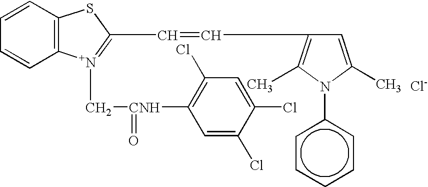 |
| 73 | 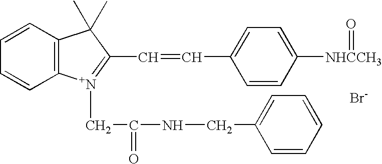 |
| 74 | 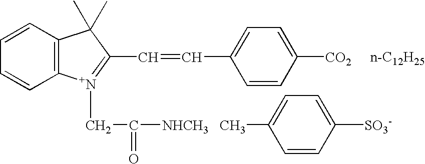 |
| 75 | 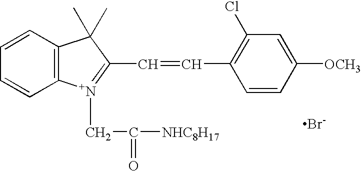 |
| 76 | 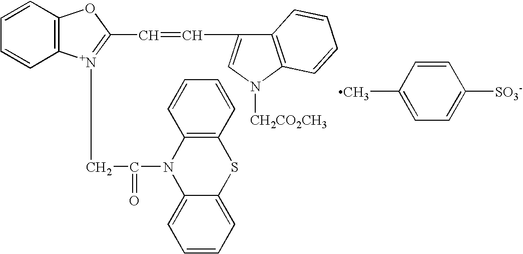 |
| 77 | 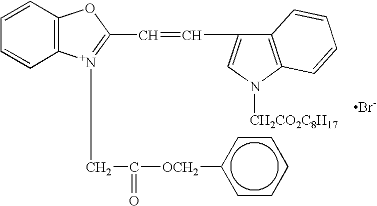 |
| 78 | 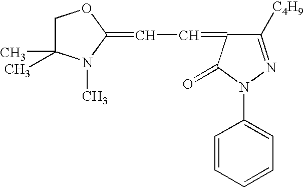 |
| 79 | 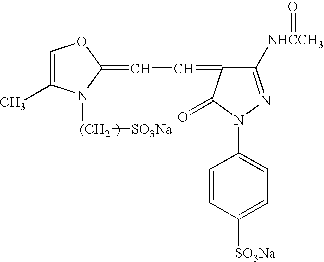 |
| 80 | 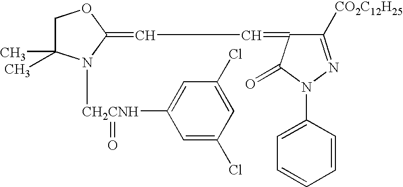 |
| 81 | 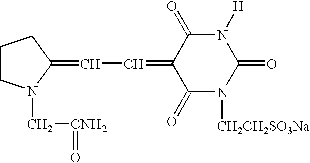 |
| 82 | 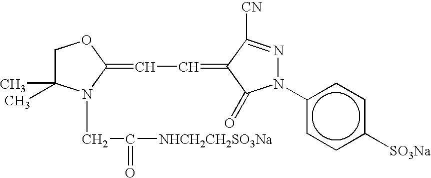 |
| 83 | 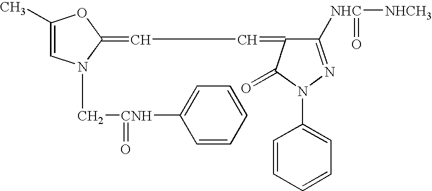 |
| 84 | 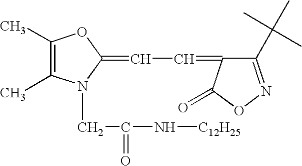 |
| 85 | 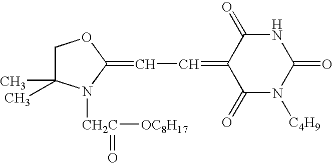 |
| 86 | 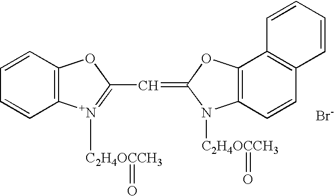 |
| 87 | 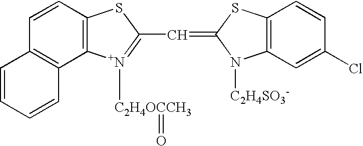 |
| 88 | 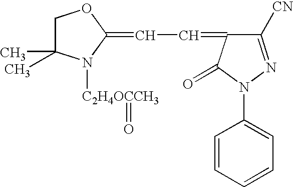 |
| 89 | 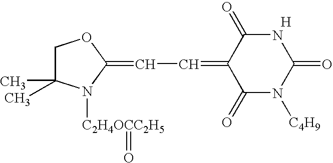 |
| 90 | 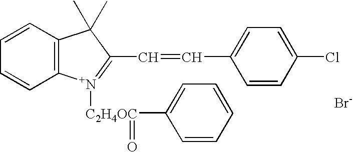 |
| 91 | 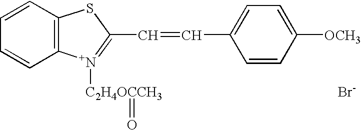 |
| 92 | 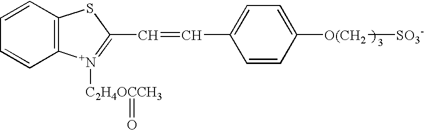 |
| 93 | 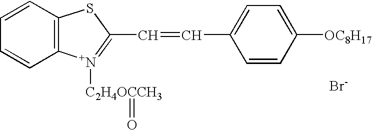 |

As the synthesis of antihalation dye, the general synthesis is described in Frances Harmer, The Cyanine Dyes and Related Compounds, Interscience Publishers, 1964. Specifically, the synthesis can be performed by the method based on the method described in JP-A Nos. 11-231457, 2000-112058, 2000-86927 and 2000-86928.

In the case to decolorize an antihalation dye at the thermal developing process, the color bleaching can be made by an action of a color bleaching agent under the thermal condition. Particularly, the dye represented by formulae (21) and (22) described above is bleached by an action of a base, wherein the base causes a deprotonation from an active methylene group and the resulting nucleophile attacks to the methylene chain in a molecule and then the intra-molecular ring closure is occurred and finally the dye is decolorized. Therefore, as the base usable for this reaction, any base can be used as far as it can cause the deprotonation of active methylene group in the dye. Though the ring number newly formed by an intra-molecular ring closure reaction is not especially limited, a 5 to 7 membered ring is preferable and a 5 or 7 membered ring is more preferable. The actually colorless compound formed in this way is stable compound and does not return to the original dye. And there is no coloring problem caused by returning of the bleached dye back to the original dye.

A heating temperature in the bleaching reaction of above described dye is preferably 40° C. to 200° C. and more preferably 80° C. to 200° C. and still more preferably 100° C. to 130° C. and most preferably 115° C. to 125° C. The heating time is preferably 5 seconds to 120 seconds and more preferably 10 seconds to 60 seconds and still more preferably is 12 seconds to 30 seconds and most preferably is 14 seconds to 25 seconds. In the photothermographic material, the heating for thermal development can be used for decolorizing of dye.

A heat response type base precursor, which generates a base by heating (described after in detail), is preferably used. In this case, the actual temperature and heating time are determined under the consideration of the temperature or the time necessary for thermal development and the temperature and the time necessary for the thermal decomposition.

The color bleaching agent necessary for bleaching reaction is preferably a radical, a nucleophile, a base or a precursor thereof. In the case where a dye represented by formulae (21) or (22) described above is used, it is preferred to bleach by using a base or a base precursor. A base necessary for bleaching reaction means a base in a wide sense and contains a nucleophile (Lewis base) in addition to a base in a narrow sense. When a base and a dye coexist, there is a fear of the bleaching reaction progressing a little, even if under the room temperature. Therefore, a base is preferably isolated from a dye physically or chemically, and the isolation is released at the time to be decoloried, for example by heating, resulting a contact (reaction) of the dye and the base. There are three physical isolation method of both compounds: namely to make at least one of the base and the dye described above enclose in a microcapsule; to make at least one of the base and the dye described above enclose in a fine particle of a heat melting compound; or to make the dye described and the base described above contain in a different layer each other. One type of the microcapule described above is exploded by pressure and the other is exploded by heating. It is convenient to use the thermal explosion type (heat response type) of microcapsule, as the bleaching reaction described above progresses easily under the thermal condition. At least one of a base and a dye is enclosed in a microcapsule to isolate each other. It is also preffered to enclose both of them in different capsules each other. In the case wherein an outer shell of a microcapsule is opaque, it is preferred that a dye is contained in the outside of microcapsule and a base is contained in the microcapsule. As the heat response microcapsule, it is described in Hiroyuki Moriga, NYUMON TOKUSYUSI NO KAGAKU, 1975 and JP-A No. 1-150575.

As the heat melting compound described above to isolate a dye and a base described above, a wax and the like can be used. The isolation can be done by the addition of at least one of a dye and a base (preferably a base) in a fine particle of a heat melting compound. A melting point of a heat melting compound described above is preferably between a room temperature and a heating temperature at which a bleaching reaction occurs. In the case, wherein a dye and a base are isolated by incorporating to different layers each other, it is preferred that a barrier layer containing a heat melting compound is arranged between those layers.

A chemical isolation of a dye and a base is practically convenient and preffered. As the chemical isolation method of both, it is preferred to use a base precursor capable to generate (releasing of base is also contained) a base by heating. As the base precursor described above, a thermal decomposition type base precursor is typically and a thermal decomposition type base precursor composed of a carboxylic acid and a base (decarbonation type) is particularly typically. When the decarbonation type base precursor is heated, the carboxyl group of carboxylic acid is decarbonated and an organic base is released. As the carboxylic acid composing of the thermal decomposition type base precursor, sulfonyldiacetic acid and propiolic acid which can decarbonate easily can be used. A sulfonyldiacetic acid and propiolic acid having a substituent group having an aromaticity to promote a decarbonation (an aryl group and an unsaturated heterocyclic ring group) is preffered. A base precursor with a sulfonyldiacetic acid is described in JP-A No. 59-168441 and a base precursor with a propiolic acid salt is described in JP-A No. 59-180537. As a base component of a decarbonation type base precursor, an organic base is preferable and amidines, guanidines and these derivatives are more preferable. The organic base is preferably a diacidic base, a triacidic base or a tetraacidic base and more preferably diacidic base and most preferably an amidine derivative or a guanidine derivative.

As the precursor of a diacidic base, a triacidic base and a tetreaacidic base of amidine derivative, it is described in JP-B No. 7-59545. As the precursor of a diacidic base, a triacidic base and a tetreaacidic base of guanidine derivative, it is described in JP-B No. 8-10321. The diacidic base of amidine derivative or guanine derivative is composed of (A) two amidine parts or guanine parts, (B) the substituent of amidine part or guanine part and (C) divalent connecting group to bind two amidine parts or guanine parts. As the examples of substituent of (B), an alkyl group (a cycloalkyl group is contained), an alkenyl group, an alkynyl group, an aralkyl group and a heterocyclic residual group are included. Two or more substituents may bind together to form a nitrogen containing heterocyclic ring. The connecting group of (C) is preferably an alkylene group or a phenylene group. As the example of diacidic base precursor of amidine derivative or guanidine derivative, the base precursor described in compound 55 to compound 95 in JP-A No. 11-231457 can be preferably used in the present invention.

When the dye described above is bleached, the optical density after thermal development can be decreased to 0.1 or less. Two or more bleaching dyes may be used together in a photothermographic material. Similarly, two or more base precursors may be used in combination. In a thermal bleaching process, wherein a base and a dye described above are used, it is preferable to use a compound which can decrease a melting point of a base precursor at 3° C. or more by mixing with a base precursor. Such melting point decreasing compound is described in JP-A No. 11-352626 and the examples are diphenylsulfone, 4-chlorophenyl(phenyl)sulfone, 2-naphthylbenzoate and the like.

A layer containing an antihalation dye preferably contains a binder with the dye. As a binder, a hydrophilic polymer (e.g., a polyvinyl alcohol, a gelatin) is preferable. In general, an addition amount of an antihalation dye in a photothermographic material is preferably in a range wherein an optical density (absorbance) shows 0.1 or more and more preferably 0.2 to 2.0. The amount of dye needed for obtaining those optical densities can be smaller by using an aggregation dye and generally is 0.001 g/m² to 0.2 g/m² and preferably 0.001 g/m² to 0.1 g/m² and more preferably 0.001 g/m² to 0.05 g/m². In an embodiment wherein an antihalation dye is bleached, it is possible to make the optical density decrease to 0.1 or less by the dye bleaching. Two or more dyes may be used in combination. Similarly, two or more base precursors may be used in combination. An amount of a base precursor (mol) for usage preferably is 1 to 100 times toward an amount of dye (mol) and more preferably 3 to 30 times. A base precursor is preferably dispersed and contained in either layer of photothermographic material as a solid fine particle state.

As an addition method for an antihalation dye to a light insensitive layer, an addtion of a solid fine particle dispersion or an aggregation dispersion of dye to the coating solution for the light insensitive layer can be adopted. The addition method generally is similar to the addition method of dye generally used in the photothermographic material.

3) Back Layer

Back layers usable in the invention are described in paragraph Nos. 0128 to 0130 of JP-A No. 11-65021.

In the invent-ion, coloring matters having maximum absorption in the wavelength range of from 300 nm to 450 nm may be added in order to improve a color tone of developed images and a deterioration of the images during aging. Such coloring matters are described in, for example, JP-A Nos. 62-210458, 63-104046, 63-103235, 63-208846, 63-306436, 63-314535, 01-61745, 2001-100363, and the like.

Such coloring matters are generally added in the range of from 0.1 mg/m² to 1 g/m², preferably to the back layer provided to the side opposite to the photosensitive layer.

In order to control the basic color tone, it is preferred to use a dye having an absorption peak in the wavelength range of from 580 nm to 680 nm. As a dye satisfying this purpose, preferred are oil-soluble azomethine dyes described in JP-A Nos. 4-359967 and 4-359968, or water-soluble phthalocyanine dyes described in Japanese Patent Application No. 2002-96797, which have low absorption intensity on the short wavelength side. The dyes for this purpose may be added to any of the layers, but more preferred is to add them in the non-photosensitive layer on the image forming layer side, or in the back layer side.

According to the invention, it is preferred that the photothermographic material is a one-side photographic material, that is, the photothermographic material has, on one side of the support, at least one image forming layer comprising silver halide emulsion and on the other side of the support a back layer.

4) Matting Agent

A matting agent may be preferably added to the photothermographic material of the invention in order to improve transportability. Description on the matting agent can be found in paragraphs Nos. 0126 to 0127 of JP-A No. 11-65021. The amount of adding the matting agents is preferably in the range from 1 mg/m² to 400 mg/m², more preferably, from 5 mg/m² to 300 mg/m², with respect to the coating amount per one m² of the photosensitive material.

There is no particular restriction on the shape of the matting agent usable in the invention and it may fixed form or non-fixed form. Preferred is to use those having fixed form and globular shape. Average particle size is preferably in the range of from 0.5 μm to 10 μm, more preferably, from 1.0 μm to 8.0 μm, and most preferably, from 2.0 μm to 6.0 μm. Furthermore, the particle distribution of the matting agent is preferably set as such that the variation coefficient may become 50% or lower, more preferably, 40% or lower, and most preferably, 30% or lower. The variation coefficient, herein, is defined by (the standard deviation of particle diameter)/(mean diameter of the particle)×100. Furthermore, it is preferred to use by blending two types of matting agents having low variation coefficient and the ratio of their mean diameters is more than 3.

The matness on the image forming layer surface is not restricted as far as star-dust trouble occurs, but the matness of 30 seconds to 2000 seconds is preferred, particularly preferred, 40 seconds to 1500 seconds as Beck's smoothness. Beck's smoothness can be calculated easily, by seeing Japan Industrial Standared (JIS) P8119 “The method of testing Beck's smoothness for papers and sheets using Beck's test apparatus”, or TAPPI standard method T479.

The matt degree of the back layer in the invention is preferably in a range of 1200 seconds or less and 10 seconds or more; more preferably, 800 seconds or less and 20 seconds or more, as expressed by Beck smoothness.

In the invention, the matting agent is incorporated preferably in the outermost surface layer on the photosensitive layer plane or a layer functioning as the outermost surface layer, or a layer near to the outer surface, and a layer that functions as the so-called protective layer.

5) Polymer Latex

In the case of the photothermographic material of the invention for graphic arts in which changing of dimension is critical, it is preferred to incorporate polymer latex in the surface protective layer and the back layer. As such polymer latexes, descriptions can be found in “Gosei Jushi Emulsion (Synthetic resin emulsion)” (Taira Okuda and Hiroshi Inagaki, Eds., published by Kobunshi Kankokai (1978)), “Gosei Latex no Ouyou (Application of synthetic latex)” (Takaaki Sugimura, Yasuo Kataoka, Soichi Suzuki, and Keiji Kasahara, Eds., published by Kobunshi Kankokai (1993)), and “Gosei Latex no Kagaku (Chemistry of synthetic latex)” (Soichi Muroi, published by Kobunshi Kankokai (1970)). More specifically, there can be mentioned a latex of methyl methacrylate (33.5% by weight)/ethyl acrylate (50% by weight)/methacrylic acid (16.5% by weight) copolymer, a latex of methyl methacrylate (47.5% by weight)/butadiene (47.5% by weight)/itaconic acid (5% by weight) copolymer, a latex of ethyl acrylate/methacrylic acid copolymer, a latex of methyl methacrylate (58.9% by weight)/2-ethylhexyl methacrylate (25.4% by weight)/styrene (8.6% by weight)/2-hydroethyl methacrylate (5.1% by weight)/acrylic acid copolymer, a latex of methyl methacrylate (64.0% by weight)/styrene (9.0% by weight)/butyl acrylate (20.0% by weight)/2-hydroxyethyl methacrylate(5.0% by weight)/acrylic acid copolymer, and the like. Furthermore, as the binder for the surface protective layer, there can be applied a combination of polymer latex described in the specification of Japanese Patent Application No. 11-6872, the technology described in paragraph Nos. 0021 to 0025 of the specification of JP-A No. 2000-267226, the technology described in paragraph Nos. 0027 and 0028 of the specification of Japanese Patent Application No. 11-6872, and the technology described in paragraph Nos. 0023 to 0041 of the specification of JP-A No. 2000-19678. The polymer latex in the surface protective layer preferably is contained in an amount of 10% by weight to 90% by weight, particularly preferably, of 20% by weight to 80% by weight of the total weight of binder.

6) Surface pH

The surface pH of the photothermographic material according to the invention preferably yields a pH of 7.0 or lower, more preferably, 6.6 or lower, before thermal development treatment. Although there is no particular restriction concerning the lower limit, the pH value is about 3, and the most preferred surface pH range is from 4 to 6.2. From the viewpoint of reducing the surface pH, it is preferred to use an organic acid such as phthalic acid derivative or a non-volatile acid such as sulfuric acid, or a volatile base such as ammonia for the adjustment of the surface pH. In particular, ammonia can be used favorably for the achievement of low surface pH, because it can easily vaporize to remove it before the coating step or before applying thermal development.

It is also preferred to use a non-volatile base such as sodium hydroxide, potassium hydroxide, lithium hydroxide, and the like, in combination with ammonia. The method of measuring surface pH value is described in paragraph No. 0123 of the specification of JP-A No. 2000-284399.

7) Hardener

A hardener can be used in each of image forming layer, protective layer, back layer, and the like. As examples of the hardener, descriptions of various methods can be found in pages 77 to 87 of T. H. James, “THE THEORY OF THE PHOTOGRAPHIC PROCESS, FOURTH EDITION” (Macmillan Publishing Co., Inc., 1977). Preferably used are, in addition to chromium alum, sodium salt of 2,4-dichloro-6-hydroxy-s-triazine, N,N-ethylene bis(vinylsulfonacetamide), and N,N-propylene bis(vinylsulfonacetamide), polyvalent metal ions described in page 78 of the above literature and the like, polyisocyanates described in U.S. Pat. No. 4,281,060, JP-A No. 6-208193 and the like, epoxy compounds of U.S. Pat. No. 4,791,042 and the like, and vinyl sulfone based compounds of JP-A No. 62-89048.

The hardener is added as a solution, and the solution is added to the coating solution for forming the protective layer 180 minutes before coating to just before coating, preferably 60 minutes before to 10 seconds before coating. However, so long as the effect of the invention is sufficiently exhibited, there is no particular restriction concerning the mixing method and the conditions of mixing. As specific mixing methods, there can be mentioned a method of mixing in the tank, in which the average stay time calculated from the flow rate of addition and the feed rate to the coater is controlled to yield a desired time, or a method using static mixer as described in Chapter 8 of N. Harnby, M. F. Edwards, A. W. Nienow (translated by Koji Takahashi) “Liquid Mixing Technology” (Nikkan Kogyo Shinbun, 1989), and the like.

8) Surfactant

As the surfactant, the solvent, the support, antistatic agent or the electrically conductive layer, and the method for obtaining color images applicable in the invention, there can be mentioned those disclosed in paragraph Nos. 0132, 0133, 0134, 0135, and 0136, respectively, of JP-A No. 11-65021. The lubricant is described in paragraph Nos. 0061 to 0064 of JP-A No. 11-84573 and in paragraph Nos. 0049 to 0062 of Japanese Patent Application No. 11-106881.

In the invention, preferably used are fluorocarbon surfactants. Specific examples of fluorocarbon surfactants can be found in those described in JP-A Nos. 10-197985, 2000-19680, and 2000-214554. Polymer fluorocarbon surfactants described in JP-A 9-281636 can be also used preferably. For the photothermographic material in the invention, the fluorocarbon surfactants described in JP-A Nos. 2002-82411, 2001-242357, and 2001-264110 are preferably used. Especially, the usage of the fluorocarbon surfactants described in JP-A Nos. 2001-242357 and 2001-264110 in an aqueous coating solution is preferred viewed from the standpoint of capacity in static control, stability of the coating side state and sliding facility. The fluorocarbon surfactant described in JP-A No. 2001-264110 is mostly preferred because of high capacity in static control and that it needs small amount to use.

According to the invention, the fluorocarbon surfactant can be used on either side of image forming layer side or back layer side, but is preferred to use on the both sides. Further, it is particularly preferred to use in combination with electrically conductive layer including aforementioned metal oxides. In this case the amount of the fluorocarbon surfactant on the side of the electrically conductive layer can be reduced or removed.

The amount of the fluorocarbon surfactant used is preferably in the range of 0.1 mg/m² to 100 mg/m² on each side of image forming layer and back layer, more preferably 0.3 mg/m² to 30 mg/m², further preferably 1 mg/m² to 10 mg/m². Especially, the fluorocarbon surfactant described in Japanese Patent Application No. 2001-264110 is effective, and used preferably in the range of 0.01 mg/m² to 10 mg/m², more preferably 0.1 mg/m² to 5 mg/m².

9) Antistatic Agent

The photothermographic material of the invention preferably contains an electrically conductive layer including metal oxides or electrically conductive polymers. The antistatic layer may serve as an undercoat layer, or a back surface protective layer, and the like, but can also be placed specially. As an electrically conductive material of the antistatic layer, metal oxides having enhanced electric conductivity by the method of introducing oxygen defects or different types of metallic atoms into the metal oxides are preferably for use. Examples of metal oxides are preferably selected from ZnO, TiO₂ and SnO₂. As the combination of different types of atoms, preferred are ZnO combined with A1, In; SnO₂ with Sb, Nb, P, halogen atoms, and the like; TiO₂ with Nb, Ta, and the like; Particularly preferred for use is SnO₂ combined with Sb. The addition amount of different types of atoms is preferably in a range of from 0.01 mol % to 30 mol %, and particularly preferably, in a range of from 0.1 mol % to 10 mol %. The shape of the metal oxides can include, for example, spherical, needle-like, or plate-like shape. The needle-like particles, with the rate of (the major axis)/(the minor axis) is more than 2.0, or more preferably, 3.0 to 50, is preferred viewed from the standpoint of the electric conductivity effect. The metal oxides is used preferably in the range of from 1 mg/m² to 1000 mg/m², more preferably from 10 mg/m² to 500 mg/m², and further preferably from 20 mg/m² to 200 mg/m². The antistatic layer can be laid on either side of the image forming layer side or the back layer side, it is preferred to set between the support and the back layer. Examples of the antistatic layer in the invention include described in JP-A Nos. 11-65021, 56-143430, 56-143431, 58-62646, and 56-120519, and in paragraph Nos. 0040 to 0051 of JP-A No. 11-84573, U.S. Pat. No. 5,575,957, and in paragraph Nos. 0078 to 0084 of JP-A No. 11-223898.

10) Support

As the transparent support, favorably used is polyester, particularly, polyethylene terephthalate, which is subjected to heat treatment in the temperature range of from 130° C. to 185° C. in order to relax the internal strain caused by biaxial stretching and remaining inside the film, and to remove strain ascribed to heat shrinkage generated during thermal development. In the case of a photothermographic material for medical use, the transparent support may be colored with a blue dye (for instance, dye-1 described in the example of JP-A No. 8-240877), or may be uncolored. Example of the support is described in paragraph No. 0134 of JP-A No. 11-65021.

As to the support, it is preferred to apply undercoating technology, such as water-soluble polyester described in JP-A No. 11-84574, a styrene-butadiene copolymer described in JP-A No. 10-186565, a vinylidene chloride copolymer described in JP-A No. 2000-39684 and in paragraph Nos. 0063 to 0080 of Japanese Patent Application No. 11-106881, and the like. The moisture content of the support is preferably 0.5% by weight or less when coating for image forming layer and back layer is conducted on the support.

11) Other Additives

Furthermore, antioxidant, stabilizing agent, plasticizer, UV absorbent, or a coating aid may be added to the photothermographic material. Each of the additives is added to either of the photosensitive layer or the non-photosensitive layer. Reference can be made to WO No. 98/36322, EP-A No. 803764A1, JP-A Nos. 10-186567 and 10-18568, and the like.

12) Coating Method

The photothermographic material of the invention may be coated by any method. More specifically, various types of coating operations inclusive of extrusion coating, slide coating, curtain coating, immersion coating, knife coating, flow coating, or an extrusion coating using the type of hopper described in U.S. Pat. No. 2,681,294 are used. Preferably used is extrusion coating or slide coating described in pages 399 to 536 of Stephen F. Kistler and Petert M. Shweizer, “LIQUID FILM COATING” (Chapman & Hall, 1997), and most preferably used is slide coating. Example of the shape of the slide coater for use in slide coating is shown in FIG. 11b.1, page 427, of the same literature. If desired, two or more layers can be coated simultaneously by the method described in pages 399 to 536 of the same literature, or by the method described in U.S. Pat. No. 2,761,791 and British Patent No. 837,095. Particularly preferred in the invention is the method described in JP-A Nos. 2001-194748, 2002-153808, 2002-153803, and 2002-182333.

The coating solution for the layer containing organic silver salt in the invention is preferably a so-called thixotropic fluid. For the details of this technology, reference can be made to JP-A No. 11-52509. Viscosity of the coating solution for the layer containing organic silver salt in the invention at a shear velocity of 0.1S⁻¹ is preferably from 400 mPa·s to 100,000 mPa·s, and more preferably, from 500 mPa·s to 20,000 mPa·s. At a shear velocity of 1000S⁻¹, the viscosity is preferably from 1 mPa·s to 200 mPa·s, and more preferably, from 5 mPa·s to 80 mPa·s.

In the case of mixing two types of liquids on preparing the coating solution of the invention, known in-line mixer and in-plant mixer can be used favorably. Preferred in-line mixer of the invention is described in JP-A No. 2002-85948, and the in-plant mixer is described in JP-A No. 2002-90940.

The coating solution of the invention is preferably subjected to defoaming treatment to maintain the coated surface in a fine state. Preferred defoaming treatment method in the invention is described in JP-A No. 2002-66431.

In the case of applying the coating solution of the invention to the support, it is preferred to perform diselectrification in order to prevent the adhesion of dust, particulates, and the like due to charge up. Preferred example of the method of diselectrification for use in the invention is described in JP-A No. 2002-143747.

Since a non-setting coating solution is used for the image forming layer in the invention, it is important to precisely control the drying wind and the drying temperature. Preferred drying method for use in the invention is described in detail in JP-A Nos. 2001-194749 and 2002-139814.

In order to improve the film-forming properties in the photothermographic material of the invention, it is preferred to apply a heat treatment immediately after coating and drying. The temperature of the heat treatment is preferably in a range of from 60° C. to 100° C. at the film surface, and heating time is preferably in a range of from 1 second to 60 seconds. More preferably, heating is performed in a temperature range of from 70° C. to 90° C. at the film surface for a duration of from 2 seconds to 10 seconds. A preferred method of heat treatment for the invention is described in JP-A No. 2002-107872.

Furthermore, the production methods described in JP-A Nos. 2002-156728 and 2002-182333 are favorably used in the invention in order to stably and continuously produce the photothermographic material of the invention.

The photothermographic material is preferably of mono-sheet type (i.e., a type which can form image on the photothermographic material without using other sheets such as an image-receiving material).

13) Wrapping Material

In order to suppress fluctuation from occurring on the photographic property during a preservation of the photosensitive material of the invention before thermal development, or in order to improve curling or winding tendencies, it is preferred that a wrapping material having low oxygen transmittance and/or vapor transmittance is used. Preferably, oxygen transmittance is 50 mL/atm·m²·day or lower at 25° C., more preferably, 10 mL/atm·m²·day or lower, and most preferably, 1.0 mL/atm·m²·day or lower. Preferably, vapor transmittance is 10 g/atm·m²·day or lower, more preferably, 5 g/atm·m²·day or lower, and most preferably, 1 g/atm·m²·day or lower.

As specific examples of a wrapping material having low oxygen transmittance and/or vapor transmittance, reference can be made to, for instance, the wrapping material described in JP-A Nos. 8-254793 and 2000-206653.

14) Other Applicable Techniques

Techniques which can be used for the photothermographic material of the invention also include those in EP803764A1, EP883022A1, WO98/36322, JP-A Nos. 56-62648, 58-62644, JP-A Nos. 09-43766, 09-281637, 09-297367, 09-304869, 09-311405, 09-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10 -207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, JP-A Nos. 2000-187298, 2000-10229, 2000-47345, 2000-206642, 2000-98530, 2000-98531, 2000-112059, 2000-112060, 2000-112104, 2000-112064 and 2000-171936.

In instances of multi-color photothermographic materials, each photosensitive layer is in general, held distinctively each other by using a functional or nonfunctional barrier layer between each photosensitive layer as described in U.S. Pat. No. 4,460,681.

Constitution of the multi-color photothermographic material may include a combination of these two layers for each color. Alternatively, all ingredients may be included into a single layer as described in U.S. Pat. No. 4,708,928.

(Image Forming Method)

1) Exposure

Although the photosensitive material of the invention may be subjected to exposure by any methods, laser beam is preferred as an exposure light source. As laser beam according to the invention, He—Ne laser of red through infrared emission, red laser diode, or Ar⁺, He—Ne, He—Cd laser of blue through green emission, blue laser diode are used. Preferred laser is red to infrared laser diode and the peak wavelength of laser beam is 600 nm to 900 nm, preferably 620 nm to 850 nm. In recent years, development has been made particularly on a light source module with an SHG (a second harmonic generator) and a laser diode integrated into a single piece whereby a laser output apparatus in a short wavelength region has come into the limelight. A blue laser diode enables high definition image recording and makes it possible to obtain an increase in recording density and a stable output over a long lifetime, which results in expectation of an expanded demand in the future.

The peak wavelength of laser beam is 300 nm to 500 nm, preferably 350 nm to 450 nm and more preferably 390 nm to 430 nm; red to infrared 600 nm to 900 nm, preferably 620 nm to 870 nm, and more preferably 640 nm to 830 nm.

Laser beam which oscillates in a longitudinal multiple modulation by a method such as high frequency superposition is also preferably employed.

2) Thermal Development

Although the development of the photothermographic material of the invention is usually performed by elevating the temperature of the photothermographic material exposed imagewise, any method may be used for this thermal development process. The temperature for the development is preferably 80° C. to 250° C., preferably 100° C. to 140° C., and more preferably 110° C. to 130° C. Time period for the development is preferably 1 second to 60 seconds, more preferably 3 seconds to 30 seconds, particularly preferably 5 seconds to 25 seconds, and most preferably 7 seconds to 15 seconds.

In the process for the thermal development, either drum type heaters or plate type heaters may be used. However, plate type heater processes are more preferred. Preferable process for the thermal development by a plate type heater may be a process described in JP-A NO. 11-133572, which discloses a thermal developing device in which a visible image is obtained by bringing a photothermographic material with a formed latent image into contact with a heating means at a thermal development region, wherein the heating means comprises a plate heater, and plurality of retainer rollers are oppositely provided along one surface of the plate heater, the thermal developing device is characterized in that thermal development is performed by passing the photothermographic material between the retainer rollers and the plate heater. It is preferred that the plate heater is divided into 2 to 6 portions, with the leading end having the lower temperature by 1° C. to 10° C. For example, 4 sets of plate heaters which can be independently subjected to the temperature control are used, and are controlled so that they respectively become 112° C., 119° C., 121° C., and 120° C.

Such a process is also described in JP-A NO. 54-30032, which allows for excluding moisture and organic solvents included in the photothermographic material out of the system, and also allows for suppressing the change of shapes of the support of the photothermographic material upon rapid heating of the photothermographic material.

As another heating method, a backside resistive heating layer described in U.S. Pat. Nos. 4,460,681 and 4,374,921 may be provided and allowed to generate heat by passing an electricity and thereby perform the heating.

3) System

Examples of a medical laser imager equipped with a light exposing part and a thermal developing part include Fuji Medical Dry Laser Imager FM-DP L. In connection with FM-DPL, description is found in Fuji Medical Review No. 8, pages 39 to 55. It goes without mentioning that those techniques may be applied as the laser imager for the photothermographic material of the invention. In addition, the present photothermographic material can be also applied as a photothermographic material for the laser imager used in “AD network” which was proposed by Fuji Film Medical Co., Ltd. as a network system accommodated to DICOM standard.

(Application of the Invention)

The image forming method in which the photothermographic material of the invention is used is preferably employed as image forming methods for photothermographic materials for use in medical imaging, photothermographic materials for use in industrial photographs, photothermographic materials for use in graphic arts, as well as for COM, through forming black and white images by silver imaging.

### EXAMPLES

The present invention is specifically explained by way of Examples below, which should not be construed as limiting the invention thereto.

### Example 1

1. Preparation of PET Support and Undercoating

1-1. Film Manufacturing

PET having IV (intrinsic viscosity) of 0.66 (measured in phenol/tetrachloroethane=6/4 (weight ratio) at 25° C.) was obtained according to a conventional manner using terephthalic acid and ethylene glycol. The product was pelletized, dried at 130° C. for 4 hours. Thereafter, the mixture was extruded from a T-die and rapidly cooled to form a non-tentered film having such a thickness that the thickness should become 175 μm after tentered and thermal fixation.

The film was stretched along the longitudinal direction by 3.3 times using rollers of different peripheral speeds, and then stretched along the transverse direction by 4.5 times using a tenter machine. The temperatures used for these operations were 110° C. and 130° C., respectively. Then, the film was subjected to thermal fixation at 240° C. for 20 seconds, and relaxed by 4% along the transverse direction at the same temperature. Thereafter, the chucking part was slit off, and both edges of the film were knurled. Then the film was rolled up at the tension of 4 kg/cm² to obtain a roll having the thickness of 175 μm.

1-2. Surface Corona Discharge Treatment

Both surfaces of the support were treated at room temperature at 20 m/minute using Solid State Corona Discharge Treatment Machine Model 6 KVA manufactured by Piller GmbH. It was proven that treatment of 0.375 kV A minute/m² was executed, judging from the readings of current and voltage on that occasion. The frequency upon this treatment was 9.6 kHz, and the gap clearance between the electrode and dielectric roll was 1.6 mm.

1-3. Undercoating

1) Preparation of Coating Solution for Undercoat Layer

Formula (1) (for undercoat layer on
the image forming layer side)

| | |
|---|---|
| Pesresin A-520 manufactured by Takamatsu Oil & Fat | 59 g |
| Co., Ltd. (30% by weight solution) | |
| polyethyleneglycol monononylphenylether (average | 5.4 g |
| ethylene oxide number = 8.5) 10% by weight solution | |
| MP-1000 manufactured by Soken Chemical & | 0.91 g |
| Engineering Co., Ltd. (polymer fine particle, mean | |
| particle diameter of 0.4 μm) | |
| distilled water | 935 mL |
| Formula (2) (for first layer on the back surface) | |
| Styrene-butadiene copolymer latex (solid content of | 158 g |
| 40% by weight, styrene/butadiene weight ratio = 68/32) | |
| 8% by weight aqueous solution of 2,4-dichloro-6- | 20 g |
| hydroxy-S-triazine sodium salt | |
| 1% by weight aqueous solution of sodium | 10 mL |
| laurylbenzenesulfonate | |
| distilled water | 854 mL |
| Formula (3) (for second layer on the back surface) | |
| SnO₂/SbO (9/1 weight ratio, mean particle diameter | 84 g |
| of 0.038 μm, 17% by weight dispersion) | |
| gelatin (10% by weight aqueous solution) | 89.2 g |
| METOLOSE TC-5 manufactured by Shin-Etsu Chemical | 8.6 g |
| Co., Ltd. (2% by weight aqueous solution) | |
| MP-1000 manufactured by Soken Chemical & | 0.01 g |
| Engineering Co., Ltd. | |
| 1% by weight aqueous solution of sodium | 10 mL |
| dodecylbenzenesulfonate | |
| NaOH (1% by weight) | 6 mL |
| Proxel (manufactured by Imperial Chemical | 1 mL |
| Industries PLC) | |
| distilled water | 805 mL |

2) Undercoating

Both surfaces of the biaxially tentered polyethylene terephthalate support having the thickness of 175 μm were subjected to the corona discharge treatment as described above. Thereafter, the aforementioned formula (1) of the coating solution for the undercoat was coated on one surface (image forming layer side) with a wire bar so that the amount of wet coating became 6.6 mL/m² (per one side), and dried at 180° C. for 5 minutes. Then, the aforementioned formula (2) of the coating solution for the undercoat was coated on the reverse face (back surface) with a wire bar so that the amount of wet coating became 5.7 mL/m², and dried at 180° C. for 5 minutes. Furthermore, the aforementioned formula (3) of the coating solution for the undercoat was coated on the reverse face (back surface) with a wire bar so that the amount of wet coating became 7.7 mL/m², and dried at 180° C. for 6 minutes. Thus, an undercoated support was produced.

2. Back Layer

1) Prepration of Coating Solution of Back Layer

(Preparation of Coating Solution for Antihalation Layer)

60 g of gelatin, 24.5 g of polyacrylamide, 2.2 g of a 1 mol/L aqueous sodium hydroxide solution, 2.4 g of monodispersed polymethyl methacrylate fine particles (mean particle size of 8 μm, standard deviation of particle diameter of 0.4), 0.08 g of benzoisothiazolinone, 0.3 g of sodium polystyrenesulfonate, 0.21 g of blue dye-1, 0.15 g of yellow dye-1, and 8.3 g of acrylic acid/ethyl acrylate copolymer latex (copolymerization rate 5/95) were mixed. Then, water was added to give the total volume of 818 mL to prepare a coating solution for the antihalation layer.

(Preparation of Coating Solution for Back Surface Protective Layer)

A vessel was kept at 40° C., and thereto were added 40 g of gelatin, liquid paraffin emulsion at 1.5 g equivalent to liquid paraffin, 35 mg of benzoisothiazolinone, 6.8 g of a 1 mol/L aqueous sodium hydroxide solution, 0.5 g of sodium t-octylphenoxyethoxyethanesufonate, 0.27 g of sodium polystyrenesulfonate, 5.4 mL of a 2% by weight solution of a fluorocarbon surface active agent (FF-1), 6.0 g of acrylic acid/ethyl acrylate copolymer latex (copolymer weight ratio of 5/95), and 2.0 g of N,N′-ethylene-bis(vinylsufoneacetamide) were admixed. Then water was added to give the volume of 1000 mL to prepare a coating solution for the back surface protective layer.

2) Coating of Back Layer

The back surface side of the undercoated support as described above was subjected to simultaneous double coating so that the coating solution for the antihalation layer gives the coating amount of gelatin of 1.70 g/m², and so that the coating solution for the back surface protective layer gives the coating amount of gelatin of 0.79 g/m², followed by drying to produce a back layer.

3. Image Forming Layer and Surface Protective Layer

3-1. Preparation of Coating Materials

(Silver Halide Emulsion)

1) Preparation of Silver Halide Emulsion-1

To 1420 mL of distilled water was added 4.3 mL of a 1% by weight potassium iodide solution. Further, a liquid added with 3.5 mL of a 0.5 mol/L sulfuric acid and 88.3 g of phthalated gelatin was kept at 42° C. while stirring in a stainless steel reaction pot, and thereto were added total amount of: solution A prepared through diluting 22.22 g of silver nitrate by adding distilled water to give the volume of 195.6 mL; and solution B prepared through diluting 21.8 g of potassium iodide with distilled water to give the volume of 218 mL, over 9 minutes at a constant flow rate. Thereafter, 10 mL of a 3.5% by weight aqueous solution of hydrogen peroxide was added thereto, and 10.8 mL of a 10% by weight aqueous solution of benzimidazole was further added.

Moreover, a solution C prepared through diluting 51.86 g of silver nitrate by adding distilled water to give the volume of 317.5 mL and a solution D prepared through diluting 60 g of potassium iodide with distilled water to give the volume of 600 mL were added. A controlled double jet method was executed through adding total amount of the solution C at a constant flow rate over 120 minutes, accompanied by adding the solution D while maintaining the pAg at 8.1. Hexachloroiridium (III) potassium salt was added to give 1×10⁻⁴ mol per one mol of silver at 10 minutes post initiation of the addition of the solution C and the solution D in its entirety. Moreover, at 5 seconds after completing the addition of the solution C, a potassium iron (II) hexacyanide aqueous solution was added at a total amount of 3×10⁻⁴ mol per one mol of silver. The mixture was adjusted to the pH of 3.8 with 0.5 mol/L sulfuric acid. After stopping stirring, the mixture was subjected to precipitation/desalting/water washing steps. The mixture was adjusted to the pH of 5.9 with 1 mol/L sodium hydroxide to produce a silver halide dispersion having the pAg of 8.0.

The above-mentioned silver halide dispersion was kept at 38° C. with stirring, and thereto was added 5 mL of a 0.34% by weight methanol solution of 1,2-benzoisothiazoline-3-one, followed by elevating the temperature to 47° C. At 20 minutes after elevating the temperature, sodium benzene thiosulfonate in a methanol solution was added at 7.6×10⁻⁵ mol per one mol of silver. At additional 5 minutes later, a tellurium sensitizer C in a methanol solution was added at 2.9×10⁻⁴ mol per one mol of silver and subjected to aging for 91 minutes. Thereto was added 1.3 mL of a 0.8% by weight N,N′-dihydroxy-N″,N″-diethylmelamine in methanol, and at additional 4 minutes thereafter, 5-methyl-2-mercaptobenzimidazole in a methanol solution at 4.8×10⁻³ mol per one mol of silver, 1-phenyl-2-heptyl-5-mercapto-1,3,4-triazole in a methanol solution at 5.4×10⁻³ mol per one mol of silver were added to produce a silver halide emulsion-1.

Grains in the prepared silver halide emulsion-1 were pure silver iodide grains having a mean sphere equivalent diameter of 0.040 μm, a variation coefficient of 18%, and tetrahedron shaped grains having planes of (001), {100} and {101}. The ratio of γ phase was 30%, determined by powder X ray diffraction analysis. Grain size and the like were determined from the average of 1000 grains using an electron microscope.

2) Preparation of Silver Halide Emulsion-2

Preparation of silver halide emulsion-2 was conducted in a similar manner to the process in the preparation of the silver halide emulsion-1 except that: the temperature of the reaction solution was altered to 65° C., and 5 mL of a 5% by weight 2,2′-(ethylenedithio) diethanol in methanol was added after adding the solutions A and B, solution D was addded by controlled double jet method keeping pAg at 10.5, bromoauric acid at 5.0×10⁻⁴ mol per one mol of silver and potassium thiocyanate at 2.0×10⁻³ mol per one mol of silver were added after the addition of the tellurium sensitizer in chemical sensitizing step.

Grains in thus prepared silver halide emulsion were pure silver iodide tabular grains having a mean circle equivalent diameter of 0.164 μm, a mean thichness of 0.032 μm, a mean aspect ratio of 5, a mean sphere equivalent diameter of 0.11 μm, and a variation coefficient thereof of 23%. The ratio of γ phase determined by powder X ray diffraction analysis was 80%.

3) Preparation of Silver Halide Emulsion-3

Preparation of silver halide emulsion-3 was conducted in a similar manner to the process in the preparation of the silver halide emulsion-1 except that the temperature of the reaction solution was altered to 27° C., and a solution D was added by controlled double jet method keeping pAg at 10.2.

Grains in thus prepared silver halide emulsion were pure silver iodide grains having a mean sphere equivalent diameter of 0.022 μm, a variation coefficient of 17%. These were dodecahedron grains shaped having planes of (001), {1(−1)0} and {101}. Almost of the grains were β phase, determined by powder X ray diffraction analysis.

4) Preparation of Silver Halide Emulsion-4

Preparation of silver halide emulsion-4 was conducted in a similar manner to the process in the preparation of the silver halide emulsion-1 except that using mixed solution of potassium iodide and potassium bromide instead of using potassium iodide. Grains in thus prepared silver halide emulsion-4 were silver iodobromide grains which uniformly include 70 mol % of silver iodide and 30 mol % of silver bromide.

Grain size of the obtained grains was the same as the silver halide emulsion-1, by controlling the temperature of grain formation.

5) Preparation of Silver Halide Emulsion-5

Preparation of silver halide emulsion-5 was conducted in a similar manner to the process in the preparation of the silver halide emulsion-2 except that using mixed solution of potassium iodide and potassium bromide instead of using potassium iodide. Grains in thus prepared silver halide emulsion-5 were silver iodobromide grains which uniformly include 70 mol % of silver iodide and 30 mol % of silver bromide.

Grain size of the obtained grains was the same as the silver halide emulsion-2, by controlling the temperature of grain formation.

6) Preparation of Silver Halide Emulsion-6

Preparation of silver halide emulsion-6 was conducted in a similar manner to the process in the preparation of the silver halide emulsion-3 except that using mixed solution of potassium iodide and potassium bromide instead of using potassium iodide. Grains in thus prepared silver halide emulsion-6 were silver iodobromide grains which uniformly include 70 mol % of silver iodide and 30 mol % of silver bromide.

Grain size of the obtained grains was the same as the silver halide emulsion-3, by controlling the temperature of grain formation.

7) Preparation of Silver Halide Emulsion-7

Preparation of silver halide emulsion-7 was conducted in a similar manner to the process in the preparation of the silver halide emulsion-1 except that using mixed solution of potassium iodide and potassium bromide instead of using potassium iodide. Grains in thus prepared silver halide emulsion-7 were silver iodobromide grains which uniformly include 3.5 mol % of silver iodide and 96.5 mol % of silver bromide.

Grain size of the obtained grains was the same as the silver halide emulsion-1, by controlling the temperature of grain formation.

8) Preparation of Silver Halide Emulsion-8

Preparation of silver halide emulsion-8 was conducted in a similar manner to the process in the preparation of the silver halide emulsion-2 except that using mixed solution of potassium iodide and potassium bromide instead of using potassium iodide. Grains in thus prepared silver halide emulsion-8 were silver iodobromide grains which uniformly include 3.5 mol % of silver iodide and 96.5 mol % of silver bromide.

Grain size of the obtained grains was the same as the silver halide emulsion-2, by controlling the temperature of grain formation.

9) Preparation of Silver Halide Emulsion-9

Preparation of silver halide emulsion-9 was conducted in a similar manner to the process in the preparation of the silver halide emulsion-3 except that using mixed solution of potassium iodide and potassium bromide instead of using potassium iodide. Grains in thus prepared silver halide emulsion-9 were silver iodobromide grains which uniformly include 3.5 mol % of silver iodide and 96.5 mol % of silver bromide.

Grain size of the obtained grains was the same as the silver halide emulsion-3, by controlling the temperature of grain formation.

(Preparations of Mixed Emulsion A1 to A3 for Coating Solution)

The silver halide emulsion-1, the silver halide emulsion-2 and the silver halide emulsion-3 at the rate of (silver halide emulsion-1:silver halide emulsion-2: silver halide emulsion-3=) 5:2:3 by mol of silver were dissolved, and thereto was added benzothiazolium iodide at 7×10⁻³ mol per one mol of silver with a 1% by weight aqueous solution. Further, water was added thereto to give the content of silver of 38.2 g per one kg of the mixed emulsion for a coating solution, and 1-(3-methylureidophenyl)-5-mercaptotetrazole was added to give 0.34 g per 1 kg of the mixed emulsion for a coating solution.

Further, as “a compound that can be one-electron-oxidized to provide a one-electron oxidation product, which release one or more electrons”, the compounds Nos. 2, 20 and 26 were added in the amount of 2×10⁻³ mol per one mol of silver halide respectively.

Further, the compound having an adsorption group and a reducing group of the invention were added as shown in Table 14.

Mixed emulsion A1: the emulsion wherein none of the compound having an adsorption group and a reducing group was added.

Mixed emulsion A2: the emulsion wherein, as “a compound having an adsorption group and a reducing group”, the compounds Nos. 19, 49 and 71 were added in the amount of 8×10⁻³ mol per one mol of silver halide respectively.

Mixed emulsion A3: the emulsion wherein, as “a compound having an adsorption group and a reducing group”, the compounds Nos. 19 and 71 were added in the amount of 8×10⁻³ mol per one mol of silver halide respectively.
(Preparations of Mixed Emulsion B1 to B3 for Coating Solution)
Preparations of of the mixed emulsion B1 to B3 for coating solution were conducted in a similar manner to the process in the preparations of the mixed emulsion A1 to A3 for coating solution except that using the silver halide emulsion-4, the silver halide emulsion-5 and the silver halide emulsion-6 at the rate of (silver halide emulsion-4:silver halide emulsion-5:silver halide emulsion-6=) 5:2:3 by mol of silver instead of using the silver halide emulsion-1, the silver halide emulsion-2 and the silver halide emulsion-3.

(Preparations of Mixed Emulsion C1 to C3 for Coating Solution)

Preparations of the mixed emulsion C1 to C3 for coating solution were conducted in a similar manner to the process in the preparations of the mixed emulsion A1 to A3 for coating solution except that using the silver halide emulsion-7, the silver halide emulsion-8 and the silver halide emulsion-9 at the rate of (silver halide emulsion-7:silver halide emulsion-8:silver halide emulsion-9=) 5:2:3 by mol of silver instead of using the silver halide emulsion-1, the silver halide emulsion-2 and the silver halide emulsion-3.

(Preparation of Dispersion of Organic Silver Salt A)

1) Preparation of Recrystallized Behenic Acid

Behenic acid manufactured by Henkel Co. (trade name: Edenor C22-85R) in an amount of 100 kg was admixed with 1200 kg of isopropyl alcohol, and dissolved at 50° C. The mixture was filtrated through a 10 μm filter, and cooled to 30° C. to allow recrystallization. Cooling speed for the recrystallization was controlled to be 2° C./hour.

Thus resulting crystal was subjected to centrifugal filtration, and washing was performed with 200 kg of isopropyl alcohol, followed by repeating the aforementioned recrystallization procedure twice additionally. Thereafter, the crystal was dried. Thus resulting crystal was esterified, and subjected to GC-FID analysis to give the results of the content of behenic acid being 98 mol %, lignoceric acid 1.9 mol %, and arachidic acid 0.1 mol %. In addition, erucic acid was included at 0.001 mol % or less.

2) Preparation of Dispersion of Organic Silver Salt A

88 kg of recrystallizes behenic acid, 422 L of distilled water, 49.2 L of an aqueous sodium hydroxide solution at the concentration of 5 mol/L, 120 L of t-butyl alcohol were admixed, and subjected to a reaction with stirring at 75° C. for one hour to give a solution of a sodium behenate. Separately, 206.2 L of an aqueous solution of 39.1 kg of silver nitrate (pH 4.0) was provided, and kept at a temperature of 10° C. A reaction vessel charged with 635 L of distilled water and 30 L of t-butyl alcohol was kept at 30° C., and thereto were added the total amount of the solution of a sodium behenate and the total amount of the aqueous silver nitrate solution with sufficient stirring at a constant flow rate over 93 minutes and 15 seconds, and 87 minutes and 6 seconds, respectively.

Upon this operation, during first 11 minutes following the initiation of adding the aqueous silver nitrate solution, the added material was restricted to the aqueous silver nitrate solution alone. The addition of the solution of a sodium behenate was thereafter started, and during 17 minutes and 9 seconds following the completion of adding the aqueous silver nitrate solution, the added material was restricted to the solution of a sodium behenate alone. The temperature inside of the reaction vessel was then set to be 30° C., and the temperature outside was controlled so that the liquid temperature could be kept constant. In addition, the temperature of a pipeline for the addition system of the solution of a sodium behenate was kept constant by circulation of warm water outside of a double wall pipe, so that the temperature of the liquid at an outlet in the leading edge of the nozzle for addition was adjusted to be 75° C. Further, the temperature of a pipeline for the addition system of the aqueous silver nitrate solution was kept constant by circulation of cool water outside of a double wall pipe. Position at which the solution of a sodium behenate was added and the position at which the aqueous silver nitrate solution was added were arranged symmetrically with a shaft for stirring located at a center. Moreover, both of the positions were adjusted to avoid contact with the reaction liquid.

After completing the addition of the solution of a sodium behenate, the mixture was left to stand at the temperature as it is for 20 minutes. The temperature of the mixture was then elevated to 35° C. over 30 minutes followed by aging for 210 minutes. Immediately after completing the aging, solid matters were filtered out with centrifugal filtration. The solid matters were washed with water until the electric conductivity of the filtrated water became 80 μS/cm. A silver salt of fatty acid was thus obtained. The resulting solid matters were stored as a wet cake without drying.

When the shape of the resulting particles of the silver behenate was evaluated by an electron micrography, a flake crystal was revealed having a mean sphere equivalent diameter of 0.40 μm and a variation coefficient of 11%.

To the wet cake corresponding to 269 kg of a dry solid matter content, were added 19.7 kg of polyvinyl alcohol (trade name: PVA-217) and water to give the total amount of 1000 kg. Then, slurry was obtained from the mixture using a dissolver blade. Additionally, the slurry was subjected to preliminary dispersion with a pipeline mixer (manufactured by MIZUHO Industrial Co., Ltd.: PM-10 type).

Next, a stock liquid after the preliminary dispersion was treated three times using a dispersing machine (trade name: Microfluidizer M-610, manufactured by Microfluidex International Corporation, using Z type Interaction Chamber) with the pressure controlled to be 900 kg/cm² to give a dispersion of the silver behenate. For the cooling manipulation, coiled heat exchangers were equipped fore and aft of the interaction chamber respectively, and accordingly, the temperature for the dispersion was set to be 10° C. by regulating the temperature of the cooling medium.

(Preparations of Reducing Agent Dispersion)

1) Preparation of Reducing Agent-1 Dispersion

To 10 kg of a reducing agent-1 (2,2′-methylenebis-(4-ethyl-6-tert-butylphenol)) and 16 kg of a 10% by weight aqueous solution of modified polyvinyl alcohol (manufactured by Kuraray Co., Ltd., Poval MP203) was added 10 kg of water, and thoroughly mixed to give slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 3 hours. Thereafter, 0.2 g of a benzoisothiazolinone sodium salt and water were added thereto, thereby adjusting the concentration of the reducing agent to be 25% by weight. This dispersion was subjected to thermal treatment at 60° C. for 5 hours to obtain a reducing agent-1 dispersion. Particles of the reducing agent included in thus resulting reducing agent dispersion had a median diameter of 0.40 μm, and a maximum particle diameter of 1.4 μm or less. The resultant reducing agent dispersion was subjected to filtration with a polypropylene filter having a pore size of 3.0 μm to remove foreign substances such as dust, and stored.

2) Preparation of Reducing Agent-2 Dispersion

To 10 kg of a reducing agent-2 (6,6′-di-t-butyl-4,4′-dimethyl-2,2′-butylidenediphenol)) and 16 kg of a 10% by weight aqueous solution of modified polyvinyl alcohol (manufactured by Kuraray Co., Ltd., Poval MP203) was added 10 kg of water, and thoroughly mixed to give slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 3 hours and 30 minutes. Thereafter, 0.2 g of a benzoisothiazolinone sodium salt and water were added thereto, thereby adjusting the concentration of the reducing agent to be 25% by weight. This dispersion was warmed at 40° C. for one hour, followed by a subsequent thermal treatment at 80° C. for one hour to obtain a reducing agent-2 dispersion. Particles of the reducing agent included in the resulting reducing agent-2 dispersion had a median diameter of 0.50 μm, and a maximum particle diameter of 1.6 μm or less. The resultant reducing agent-2 dispersion was subjected to filtration with a polypropylene filter having a pore size of 3.0 μm to remove foreign substances such as dust, and stored.

(Preparation of Hydrogen Bonding Compound-1 Dispersion)

To 10 kg of a hydrogen bonding compound-1 (tri(4-t-butylphenyl)phosphineoxide) and 16 kg of a 10% by weight aqueous solution of modified polyvinyl alcohol (manufactured by Kuraray Co., Ltd., Poval MP203) was added 10 kg of water, and thoroughly mixed to give slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 4 hours. Thereafter, 0.2 g of a benzoisothiazolinone sodium salt and water were added thereto, thereby adjusting the concentration of the hydrogen bonding compound to be 25% by weight. This dispersion was warmed at 40° C. for one hour, followed by a subsequent thermal treatment at 80° C. for one hour to obtain a hydrogen bonding compound dispersion. Particles of the hydrogen bonding compound included in the resulting hydrogen bonding compound-1 dispersion had a median diameter of 0.45 μm, and a maximum particle diameter of 1.3 μm or less. The resultant hydrogen bonding compound-1 dispersion was subjected to filtration with a polypropylene filter having a pore size of 3.0 μm to remove foreign substances such as dust, and stored.

(Preparations of Development Accelerator Dispersions)

1) Preparation of Development Accelerator No. 1-68 Dispersion

To 10 kg of a development accelerator No. 1-68 and 20 kg of a 10% by weight aqueous solution of modified polyvinyl alcohol (manufactured by Kuraray Co., Ltd., Poval MP203) was added 10 kg of water, and thoroughly mixed to give slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 3 hours and 30 minuets. Thereafter, 0.2 g of a benzoisothiazolinone sodium salt and water were added thereto, thereby adjusting the concentration of the development accelerator to be 20% by weight. Accordingly, a development accelerator No. 1-68 dispersion was obtained. Particles of the development accelerator included in thus resulting development accelerator dispersion had a median diameter of 0.48 μm, and a maximum particle diameter of 1.4 μm or less. The resultant development accelerator dispersion was subjected to filtration with a polypropylene filter having a pore size of 3.0 μm to remove foreign substances such as dust, and stored.

2) Preparation of Development Accelerator No. 6-41 Dispersion

As for solid dispersion of development accelerator No. 6-41, dispersion was conducted in a similar manner to the process in the preparation of the development accelerator No. 1-68 dispersion, to obtain 20% by weight dispersion solution.

(Preparation of Solid Dispersion of Color-tone-adjusting Agent-1)

As for solid dispersion of color-tone-adjusting agent-1, dispersion was conducted in a similar manner to the process in the preparation of the development accelerator No. 1-68 dispersion, to obtain 15% by weight dispersion solution.

(Preparation of Polyhalogen Compound Dispersion)

1) Preparation of Organic Polyhalogen Compound-1 Dispersion

An organic polyhalogen compound-1 in an amount of 10 kg, 10 kg of a 20% by weight aqueous solution of modified polyvinyl alcohol (manufactured by Kuraray Co., Ltd., Poval MP203), 0.4 kg of a 20% by weight aqueous solution of sodium triisopropylnaphthalenesulfonate and 14 kg of water were added, and thoroughly admixed to give slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 5 hours. Thereafter, 0.2 g of a benzoisothiazolinone sodium salt and water were added thereto, thereby adjusting the concentration of the organic polyhalogen compound to be 26% by weight. Accordingly, an organic polyhalogen compound-1 dispersion was obtained. Particles of the organic polyhalogen compound included in thus resulting polyhalogen compound dispersion had a median diameter of 0.41 μm, and a maximum particle diameter of 2.0 μm or less. The resultant organic polyhalogen compound dispersion was subjected to filtration with a polypropylene filter having a pore size of 10.0 μm to remove foreign substances such as dust, and stored.

2) Preparation of Organic Polyhalogen Compound-2 Dispersion

An organic polyhalogen compound-2 in an amount of 10 kg, 20 kg of a 10% by weight aqueous solution of modified polyvinyl alcohol (manufactured by Kuraray Co., Ltd., Poval MP203), 0.4 kg of a 20% by weight aqueous solution of sodium triisopropylnaphthalenesulfonate and 8 kg of water were added, and thoroughly admixed to give slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 5 hours. Thereafter, 0.2 g of a benzoisothiazolinone sodium salt and water were added thereto, thereby adjusting the concentration of the organic polyhalogen compound to be 25% by weight. This fluid dispersion was heated at 40° C. for 5 hours to obtain an organic polyhalogen compound-2 dispersion. Particles of the organic polyhalogen compound included in thus resulting polyhalogen compound dispersion had a median diameter of 0.36 μm, and a maximum particle diameter of 1.5 μm or less. The resultant organic polyhalogen compound dispersion was subjected to filtration with a polypropylene filter having a pore size of 3.0 μm to remove foreign substances such as dust, and stored.

(Preparation of Phthalazine Compound-1 Solution)

Modified polyvinyl alcohol MP203 in an amount of 8 kg was dissolved in 174.57 kg of water, and then thereto were added 3.15 kg of a 20% by weight aqueous solution of sodium triisopropylnaphthalenesulfonate and 14.28 kg of a 70% by weight aqueous solution of 6-isopropyl phthalazine to prepare a 5% by weight phthalazine compound-1 solution.

(Preparations of Mercapto Compound)

1) Preparation of an Aqueous Solution of Mercapto Compound-1

A mercapto compound-1 (1-(3-sulfophenyl)-5-mercaptotetrazole sodium salt) in an amount of 7 g was dissolved in 993 g of water to give a 0.7% by weight aqueous solution.

2) Preparation of an Aqueous Solution of Mercapto Compound-2

A mercapto compound-2 (1-(3-methylureidophenyl)-5 -mercaptotetrazole) in an amount of 20 g was dissolved in 980 g of water to give a 2.0% by weight aqueous solution.

(Preparation of Pigment-1 Dispersion)

C.I. Pigment Blue 60 in an amount of 64 g and 6.4 g of DEMOL N manufactured by Kao Corporation were added to 250 g water and thoroughly mixed to give slurry. Zirconia beads having the mean particle diameter of 0.5 mm were provided in an amount of 800 g, and charged in a vessel with the slurry. Dispersion was performed with a dispersing machine (1/4G sand grinder mill: manufactured by IMEX Co., Ltd.) for 25 hours. Thereto was added water to adjust so that the concentration of the pigment became 5% by weight to obtain a pigment-1 dispersion. Particles of the pigment included in thus resulting pigment dispersion had a mean particle diameter of 0.21 μm.

(Preparation of SBR Latex Solution)

To a polymerization tank of a gas monomer reaction apparatus (manufactured by Taiatsu Techno Corporation, TAS-2J type), were charged 287 g of distilled water, 7.73 g of a surface active agent (Pionin A-43-S (manufactured by TAKEMOTO OIL & FAT CO., LTD.): solid matter content of 48.5% by weight), 14.06 mL of 1 mol/L sodium hydroxide, 0.15 g of ethylenediamine tetraacetate tetrasodium salt, 255 g of styrene, 11.25 g of acrylic acid, and 3.0 g of tert-dodecyl mercaptan, followed by sealing of the reaction vessel and stirring at a stirring rate of 200 rpm. Degassing was conducted with a vacuum pump, followed by repeating nitrogen gas replacement several times. Tereto was injected 108.75 g of 1,3-butadiene, and the inner temperature was elevated to 60° C. Thereto was added a solution of 1.875 g of ammonium persulfate dissolved in 50 mL of water, and the mixture was stirred for 5 hours as it stands. The temperature was further elevated to 90° C., followed by stirring for 3 hours. After completing the reaction, the inner temperature was lowered to reach to the room temperature, and thereafter the mixture was treated by adding 1 mol/L sodium hydroxide and ammonium hydroxide to give the molar ration of Na⁺ ion:NH₄⁺ ion=1:5.3, and thus, the pH of the mixture was adjusted to 8.4. Thereafter, filtration with a polypropylene filter having the pore size of 1.0 μm was conducted to remove foreign substances such as dust followed by storage. Accordingly, SBR latex was obtained in an amount of 774.7 g. Upon the measurement of halogen ion by ion chromatography, concentration of chloride ion was revealed to be 3 ppm. As a result of the measurement of the concentration of the chelating agent by high performance liquid chromatography, it was revealed to be 145 ppm.

The aforementioned latex had the mean particle diameter of 90 nm, Tg of 17° C., solid matter concentration of 44% by weight, the equilibrium moisture content at 25° C., 60% RH of 0.6% by weight, ionic conductance of 4.80 mS/cm (measurement of the ionic conductance performed using a conductivity meter CM-30S manufactured by Toa Electronics Ltd. for the latex stock solution (44% by weight) at 25° C.) and pH of 8.4.

3-2. Preparation of Coating Solutions

1) Preparation of Coating Solution for Image Forming Layer

(Preparations of Coating Solution for Image Forming Layer-1 to -9)

To the dispersion of organic silver salt obtained as described above in an amount of 1000 g and 276 mL of water were serially added the organic polyhalogen compound-1 dispersion, the organic polyhalogen compound-2 dispersion, the phthalazine compound solution, the SBR latex (Tg: 17° C.) solution, the reducing agent-1 dispersion, the reducing agent-2 dispersion, the hydrogen bonding compound-i dispersion, and as shown in Table 15, the development accelerator No. 1-68 dispersion and the development accelerator No. 6-41 dispersion, and further the color-tone-adjusting agent-1 dispersion, the mercapto compound-1 aqueous solution and the mercapto compound-2 aqueous solution. The coating solutions for the image forming layer were prepared by adding the silver halide mixed emulsion A1 to A3 for coating solution thereto followed by thorough mixing just prior to the coating was fed directly to a coating die, and was coated.

(Preparations of Coating Solution for Image Forming Layer-10 to -18)

Preparations of coating solution for image forming layer-10 to -18 were conducted in a similar manner to those of coating solution for image forming layer-1 to -9 except that using the silver halide mixed emulsion B1 to B3 instead of using the silver halide mixed emulsion A1 to A3.

(Preparations of Coating Solution for Image Forming Layer-19 to -27)

Preparations of coating solution for image forming layer-19 to -27 were conducted in a similar manner to those of coating solution for image forming layer-1 to -9 except that using the silver halide mixed emulsion C1 to C3 instead of using the silver halide mixed emulsion A1 to A3.

2) Preparation of Coating Solution for Intermediate Layer

To 1000 g of polyvinyl alcohol PVA-205 (manufactured by Kuraray Co., Ltd.), 272 g of the pigment-1 dispersion and 4200 mL of a 19% by weight solution of methyl methacrylate/styrene/butyl acrylate/hydroxyethyl methacrylate/acrylic acid copolymer (weight ratio of the copolymerization of 64/9/20/5/2) latex, were added 27 mL of a 5% by weight aqueous solution of aerosol OT (manufactured by American Cyanamid Co.), 135 mL of a 20% by weight aqueous solution of ammonium secondary phthalate and water to give total amount of 10000 g. The mixture was adjusted with NaOH to give the pH of 7.5. Accordingly, the coating solution for the intermediate layer was prepared, and was fed to a coating die to provide 9.1 mL/m².

Viscosity of the coating solution was 58 [mPa·s] which was measured with a B type viscometer at 40° C. (No. 1 rotor, 60 rpm).

3) Preparation of Coating Solution for First Layer of Surface Protective Layers

In water was dissolved 64 g of inert gelatin, and thereto were added 112 g of a 19% by weight solution of methyl methacrylate/styrene/butyl acrylate/hydroxyethyl methacrylate/acrylic acid copolymer (weight ratio of the copolymerization of 64/9/20/5/2) latex, 30 mL of a 15% by weight methanol solution of phthalic acid, 23 mL of a 10% by weight aqueous solution of 4-metyl phthalic acid, 28 mL of 0.5 mol/L sulfuric acid, 5 mL of a 5% by weight aqueous solution of aerosol OT (manufactured by American Cyanamid Co.), 0.5 g of phenoxyethyl alcohol, and 0.1 g of benzoisothiazolinone. Water was added to give total amount of 750 g. Immediately before coating, 26 mL of a 4% by weight chrome alum which had been mixed with a static mixer was fed to a coating die so that the amount of the coating solution became 18.6 mL/m².

Viscosity of the coating solution was 20 [mPa·s] which was measured with a B type viscometer at 40° C. (No. 1 rotor, 60 rpm).

2) Preparation of Coating Solution for Second Layer of Surface Protective Layers

In water were dissolved 80 g of inert gelatin and thereto were added 102 g of a 27.5% by weight solution of methyl methacrylate/styrene/butyl acrylate/hydroxyethyl methacrylate/acrylic acid copolymer (weight ratio of the copolymerization of 64/9/20/5/2) latex, 3.2 mL of a 5% by weight solution of a fluorocarbon surface active agent (F-1), 32 mL of a 2% by weight aqueous solution of a fluorocarbon surface active agent (F-2), 23 mL of a 5% by weight aqueous solution of aerosol OT (manufactured by American Cyanamid Co.), 4 g of polymethyl methacrylate fine particles (mean particle diameter of 0.7 μm) and 21 g of polymethyl methacrylate fine particles (mean particle diameter of 4.5 μm), 1.6 g of 4-methyl phthalic acid, 44 mL of 0.5 mol/L sulfuric acid, and 10 mg of benzoisothiazolinone. Water was added to give total amount of 650 g. Immediately before coating, 445 mL of a aqueous solution containing 4% by weight chrome alum and 0.67% by weight phthalic acid was mixed to give a coating solution for the second surface protective layer, which was fed to a coating die so that 8.3 mL/m² could be provided.

Viscosity of the coating solution was 19 [mPa·s] which was measured with a B type viscometer at 40° C. (No. 1 rotor, 60 rpm).

3-3. Coating

Reverse surface of the back surface was subjected to simultaneous overlaying coating by a slide bead coating method in order of the image forming layer, intermediate layer, first layer of the surface protective layers and second layer of the surface protective layers starting from the undercoated face, and thus samples of the photothermographic material-1 to -36 were produced. In this method, the temperature of the coating solution was adjusted to 31° C. for the image forming layer and intermediate layer, to 36° C. for the first layer of the surface protective layers, and to 37° C. for the second layer of the surface protective layers.

The kind of organic silver salt and silver halide for each sample is shown in Table 15.

The coating amount of each compound for the image forming layer (g/m²) is as follows.

| | |
|---|---|
| Organic silver salt (on the basis of the coating | 5.27 |
| amount of silver behenate) | |
| Pigment (C. I. Pigment Blue 60) | 0.036 |
| Polyhalogen compound-1 | 0.09 |
| Polyhalogen compound-2 | 0.14 |
| Phthalazine compound-1 | 0.18 |
| SBR latex | 9.43 |
| Reducing agent-1 | 0.55 |
| Reducing agent-2 | 0.22 |
| Hydrogen bonding compound-1 | 0.28 |
| Development accelerator No. 1-68 | (see Table 15) |
| Development accelerator No. 6-41 | (see Table 15) |
| Color-tone-adjusting agent-1 | 0.008 |
| Mercapto compound-1 | 0.002 |
| Mercapto compound-2 | 0.006 |
| Silver halide (on the basis of Ag content) | 0.046 |

Conditions for coating and drying are as follows.

Coating was performed at the speed of 160 m/min. The clearance between the leading end of the coating die and the support being 0.10 mm to 0.30 mm, and with the pressure in the vacuum chamber set to be lower than atmospheric pressure by 196 Pa to 882 Pa. The support was decharged by ionic wind.

In the subsequent cooling zone, the coating solution was cooled by wind having the dry-bulb temperature of 10° C. to 20° C. Thereafter, transportation with no contact was carried out, and the coated support was dried with an air of the dry-bulb of 23° C. to 45° C. and the wet-bulb of 15° C. to 21° C. in a helical type contactless drying apparatus.

After drying, moisture conditioning was performed at 25° C. in the humidity of 40% RH to 60% RH. Then, the film surface was heated to be 70° C. to 90° C. After heating, the film surface was cooled to 25° C.

Thus prepared photothermographic material had the matness of 550 seconds on the image forming layer side surface, and 130 seconds on the back surface as Beck's smoothness. In addition, measurement of the pH of the film surface on the image forming layer side surface gave the result of 6.0.

Chemical structures of the compounds used in Examples of the invention are shown below.

TABLE 15

| | | | Compound having adsorption group | | | |
|---|---|---|---|---|---|---|
| | | | and reducing group | | Development accelerator | |
| | Silver halide emulsion | | Compound represented | | Compound represented by general formula | |
| Photothermographic | | Silver iodide | by general formula (I) | | (1) to (6) | |
| material No. | | content (mol %) | Compound | Addition amount(mol/mol Ag)* | Compound | Addition amount(mol/mol Ag)* |
| 1 | A1 | 100 | — | — | — | — |
| 2 | A1 | 100 | — | — | 1-68 | 2 × 10⁻³ |
| 3 | A1 | 100 | — | — | 6-41 | 2 × 10⁻³ |
| 4 | A2 | 100 | (19)(49)(71) | 8 × 10^{-'} | — | — |
| 5 | A2 | 100 | (19)(49)(71) | 8 × 10⁻³ | 1-68 | 2 × 10⁻³ |
| 6 | A2 | 100 | (19)(49)(71) | 8 × 10⁻³ | 6-41 | 2 × 10⁻³ |
| 7 | A3 | 100 | (19)(71) | 8 × 10⁻³ | — | — |
| 8 | A3 | 100 | (19)(71) | 8 × 10⁻³ | 1-68 | 2 × 10⁻³ |
| 9 | A3 | 100 | (19)(71) | 8 × 10⁻³ | 6-41 | 2 × 10⁻³ |
| 10 | B1 | 70 | — | — | — | — |
| 11 | B1 | 70 | — | — | 1-68 | 2 × 10⁻³ |
| 12 | B1 | 70 | — | — | 6-41 | 2 × 10⁻³ |
| 13 | B2 | 70 | (19)(49)(71) | 8 × 10⁻³ | — | — |
| 14 | B2 | 70 | (19)(49)(71) | 8 × 10⁻³ | 1-68 | 2 × 10⁻³ |
| 15 | B2 | 70 | (19)(49)(71) | 8 × 10⁻³ | 6-41 | 2 × 10⁻³ |
| 16 | B3 | 70 | (19)(71) | 8 × 10⁻³ | — | — |
| 17 | B3 | 70 | (19)(71) | 8 × 10⁻³ | 1-68 | 2 × 10⁻³ |
| 18 | B3 | 70 | (19)(71) | 8 × 10⁻³ | 6-41 | 2 × 10⁻³ |
| 19 | C1 | 3.5 | — | — | — | — |
| 20 | C1 | 3.5 | — | — | 1-68 | 2 × 10⁻³ |
| 21 | C1 | 3.5 | — | — | 6-41 | 2 × 10⁻³ |
| 22 | C2 | 3.5 | (19)(49)(71) | 8 × 10⁻³ | — | — |
| 23 | C2 | 3.5 | (19)(49)(71) | 8 × 10⁻³ | 1-68 | 2 × 10⁻³ |
| 24 | C2 | 3.5 | (19)(49)(71) | 8 × 10⁻³ | 6-41 | 2 × 10⁻³ |
| 25 | C3 | 3.5 | (19)(71) | 8 × 10⁻³ | — | — |
| 26 | C3 | 3.5 | (19)(71) | 8 × 10⁻³ | 1-68 | 2 × 10⁻³ |
| 27 | C3 | 3.5 | (19)(71) | 8 × 10⁻³ | 6-41 | 2 × 10⁻³ |

(Note:
in Table 15, addition amount (mol/molAg)* means the amount of each compound, respectively, when added plural kinds of the compound.)

Tellurium Sensitive C 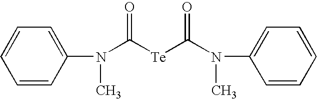
Blue Dye-1 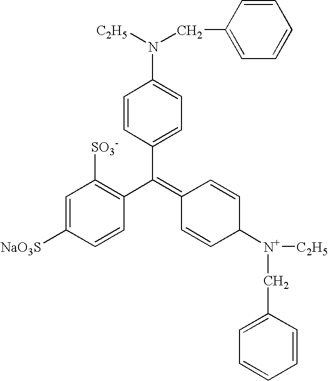
Ultraviolet absorber-1 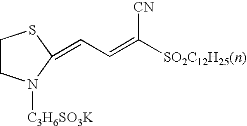
Reducing agent-1 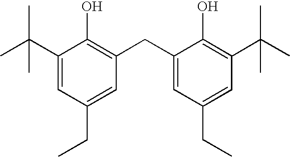
Reducing agent-2 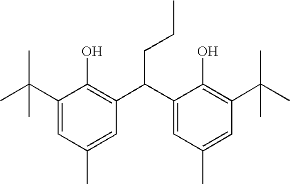
Hydrogen Bonding Compound-1 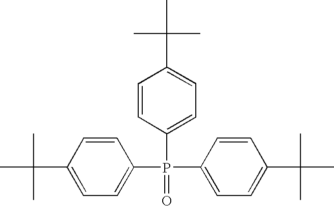
Polyhalogen Compound-1 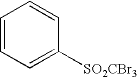
Polyhalogen Compound-2 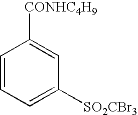
Mercapto Compound-1 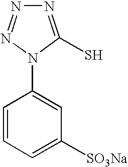
Mercapto Compound-2 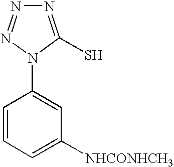
Phthalazine Compound-1 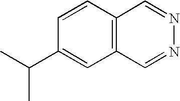
Color-Tone-Adjusting Agent-1 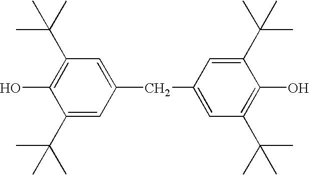
(F-1) 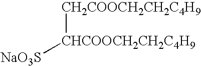
(F-2)

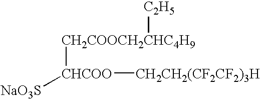

4. Evaluation of Photographic Performances

1) Preparation

The resulting sample was cut into a half-cut size (43 cm in length×35 cm in width), and was wrapped with the following packaging material under an environment of 25° C. and 50% RH, and stored for 2 weeks at an ambient temperature.

(Packaging Material)

PET 10 μm/PE 12 μm/aluminum foil 9 μm/Ny 15 μm/polyethylene 50 μm containing carbon at 3% by weight, oxygen permeability: 0.02 mL/atm·m²·25° C.·day, vapor permeability: 0.10 g/atm·m²·25° C.·day.

2) Exposure and Thermal Development

Exposure was performed on specimens using a Fuji medical dry laser imager FM-DP L in which a NLHV 3000E laser diode fabricated by Nichia Corporation as a laser diode beam source was mounted in an exposure portion thereof. Exposure of a photothermographic material was performed while setting or altering a photothermographic material surface illumination intensity at 0 mW/mm² and at various values from 1 mW/mm² to 1000 mW/mm². A light-emission wavelength of laser beam was 405 nm. Thermal development was performed in conditions that 4 panel heaters were set to be 112° C.-118° C.-120° C.-120° C., and a total thermal development time was set to 14 sec at an increased transport speed. Evaluation on an image obtained was performed with a densitometer.

3) Evaluation

(Sensitivity)

A sensitivity is defined as a reciprocal of an exposure value at which an optical density of fog+1.0 is obtained, and a sensitivity of the photothermographic material-1 is set to 100 and relative sensitivities were shown. A larger relative sensitivity value means a higher sensitivity.

(Fog)

Fog is indicated by the dentisy of the unexposed part.

(Raw Stok Storability)

Each sample hermetically sealed with the packaging material described above was exposed and thermal developed after purposely preserving it at 45° C. for 7 days. The sensitivity change was measured by comparing the sample with a sample preserved by freezing.

Raw stok storability (sensitivity change)=(sensitivity of freeze preservation sample)−(sensitivity after purposely preserving at 45° C. for 7 days)

(Print-Out Resistance)

Each sample after thermal development was left under a fluorescent lamp with an intensity of 200 lux in a room at 25° C. and 70% RH. The increment of fog relative to the fog before leaving was measured.

(Result)

The results obtained are shown in Table 16. The photothermographic material -5, -6, -8, -9, -14, -15, -17, -18, -23, -24, -26 and -27 of the invention have a high sensitivity with a low degree of fogging while exhibiting excellent performance with good raw stock storability and print-out resistance. It was an unexpected result that quite low fogging and high sensitivity are obtained by a concomitant use of a compound having an adsorption group and reducing group and a development accelerator, as compared with the result using respective compounds alone. This result was more evident as the content of silver iodide in silver halide is higher.

TABLE 16

| | | | Raw | |
|---|---|---|---|---|
| | | | stock storability | |
| Photothermographic | | | (Sensitivity | Print-out |
| material No. | Sensitivity | Fog | variation) | resistance |
| 1 | 100 | 0.16 | 20 | 0.03 |
| 2 | 120 | 0.17 | 15 | 0.03 |
| 3 | 120 | 0.17 | 15 | 0.03 |
| 4 | 120 | 0.16 | 15 | 0.03 |
| 5 | 200 | 0.17 | 7 | 0.03 |
| 6 | 195 | 0.17 | 7 | 0.03 |
| 7 | 110 | 0.16 | 18 | 0.03 |
| 8 | 195 | 0.17 | 7 | 0.03 |
| 9 | 193 | 0.17 | 7 | 0.03 |
| 10 | 90 | 0.16 | 25 | 0.04 |
| 11 | 110 | 0.17 | 20 | 0.04 |
| 12 | 110 | 0.17 | 20 | 0.04 |
| 13 | 110 | 0.16 | 20 | 0.04 |
| 14 | 170 | 0.17 | 8 | 0.04 |
| 15 | 165 | 0.17 | 8 | 0.04 |
| 16 | 100 | 0.16 | 22 | 0.04 |
| 17 | 165 | 0.17 | 8 | 0.04 |
| 18 | 163 | 0.17 | 8 | 0.04 |
| 19 | 70 | 0.16 | 35 | 0.07 |
| 20 | 80 | 0.17 | 28 | 0.07 |
| 21 | 80 | 0.17 | 28 | 0.07 |
| 22 | 80 | 0.16 | 28 | 0.07 |
| 23 | 130 | 0.17 | 9 | 0.07 |
| 24 | 125 | 0.17 | 9 | 0.07 |
| 25 | 70 | 0.16 | 30 | 0.07 |
| 26 | 128 | 0.17 | 9 | 0.07 |
| 27 | 123 | 0.17 | 9 | 0.07 |

### Example 2

1. Back layer

Blue dye-2 was used instead of blue dye-1, as an antihalation dye.

2. Preparation of Coating Sample

1) Preparations of Silver Halide Emulsions

Preparations were conducted in a similar manner to those in Example 1, instead of using mixed emulsion for coating solution described below.

(Preparations of Mixed Emulsion A11 to A13 for Coating Solution)

The silver halide emulsion-1, the silver halide emulsion-2 and the silver halide emulsion-3 at the rate of (silver halide emulsion-1:silver halide emulsion-2: silver halide emulsion-3=) 5:2:3 by mol of silver were dissolved, and thereto was added benzothiazolium iodide at 7×10⁻³ mol per one mol of silver with a 1% by weight aqueous solution. Further, water was added thereto to give the content of silver of 38.2 g per one kg of the mixed emulsion for a coating solution, and 1-(3-methylureidophenyl)-5-mercaptotetrazole was added to give 0.34 g per 1 kg of the mixed emulsion for a coating solution.

Further, as “a compound that can be one-electron-oxidized to provide a one-electron oxidation product, which release one or more electrons”, the compounds Nos. 2, 20 and 26 were added in the amount of 2×10⁻³ mol per one mol of silver halide respectively.

Further, the compound having an adsorption group and a reducing group of the invention were added as described below.

Mixed emulsion A11: the emulsion wherein none of the compound having an adsorption group and a reducing group was added.

Mixed emulsion A12: the emulsion wherein, as “a compound having an adsorption group and a reducing group”, the compounds Nos. 19 and 71 were added in the amount of 8×10⁻³ mol per one mol of silver halide respectively.

Mixed emulsion A13: the emulsion wherein, as “a compound having an adsorption group and a reducing group”, the compounds Nos. 19, 49 and 71 were added in the amount of 8×10⁻³ mol per one mol of silver halide respectively.

(Preparations of Mixed Emulsion B11 to B13 for Coating Solution)

Preparations of the mixed emulsion B11 to B13 were conducted in a similar manner to the process in the preparations of the mixed emulsion All to A13 for coating solution except that using the silver halide emulsion-4, the silver halide emulsion-5 and the silver halide emulsion-6 at the rate of (silver halide emulsion-4: silver halide emulsion-5:silver halide emulsion-6=) 5:2:3 by mol of silver instead of using the silver halide emulsion-1, the silver halide emulsion-2 and the silver halide emulsion-3.

(Preparations of Mixed Emulsion C11 to C13 for Coating Solution)

Preparations of he mixed emulsion C11 to C13 for coating solution were conducted in a similar manner to the process in the preparations of the mixed emulsion A11 to A13 for coating solution except that using the silver halide emulsion-7, the silver halide emulsion-8 and the silver halide emulsion-9 at the rate of (silver halide emulsion-7:silver halide emulsion-8:silver halide emulsion-9=) 5:2:3 by mol of silver instead of using the silver halide emulsion-1, the silver halide emulsion-2 and the silver halide emulsion-3.

2) Preparations of Dispersion of Organic Silver Salt B to D

To the recrystallized behenic acid used in Example 1 were mixed lignoceric acid, arachidinic acid, erucic acid and stearic acid (all produced by Tokyo Kasei Shiyaku) and fatty acids at the rate (mol ratio) shown in the next Table were prepared. Preparations of dispersion of organic silver salt B, C and D were conducted in a similar manner to the process in the preparation of the dispersion of organic silver salt A by using these fatty acids.

TABLE 17

| | Behenic | Lignoceric | Arachidinic | | |
|---|---|---|---|---|---|
| | acid | acid | acid | Erucic | Stearic acid |
| Fatty acid | (%) | (%) | (%) | acid (%) | (%) |
| B | 83 | 3 | 12 | 0.001 | 2 |
| C | 49 | 9 | 36 | 0.001 | 7 |
| D | 97 | 1.9 | 0.1 | 1.0 | 0 |

3) Preparations of Development Accelerator Dispersions

(Preparation of Development Accelerator-1 Dispersion)

To 10 kg of a development accelerator-1 and 20 kg of a 10% by weight aqueous solution of modified polyvinyl alcohol (manufactured by Kuraray Co., Ltd., Poval MP203) was added 10 kg of water, and thoroughly mixed to give slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 3 hours and 30 minuets. Thereafter, 0.2 g of a benzoisothiazolinone sodium salt and water were added thereto, thereby adjusting the concentration of the development accelerator to be 20% by weight. Accordingly, a development accelerator-1 dispersion was obtained. Particles of the development accelerator included in thus resulting development accelerator dispersion had a median diameter of 0.48 μm, and a maximum particle diameter of 1.4 μm or less. The resultant development accelerator dispersion was subjected to filtration with a polypropylene filter having a pore size of 3.0 μm to remove foreign substances such as dust, and stored.

(Preparation of Development Accelerator-2 Dispersion)

As for solid dispersion of development accelerator-2, dispersion was conducted in a similar manner to the process in the preparation of the development accelerator-1 dispersion, to obtain 20% by weight dispersion solution.

4) Preparation of Polymer Latex Solution

Polymer latex P-21 was prepared by a similar method as preparing polymer latex P-1, except those prepared using the compound in Synthesis Example 1 (synthesis of compound P-1) and using the compound in Synthesis Example 2 (synthesis of compound P-2), and except that the addition amount of ammonium persulfurate (abbreviated as APS) as the polymerization initiator is adjusted to 2% by weight with respect to the total amount of the monomer of polymer latex P-1.

Polymer latex P-22 was prepared as follows for the purpose of comparison.

Ammonium persulfate was used as the polymerization initiator, and an anionic surfactant was used as the emulsifying agent. After emulsion polymerization of 63.0% by weight of methyl methacrylate, 35.0% by weight of ethyl acrylate and 2.0% by weight of acrylic acid, the product was aged for 3 hours at 80° C. The solution was cooled to 40° C. thereafter, and the pH was adjusted to 7.0 with aqueous ammonia, followed by adding Subdet BL (produced by Sanyo Chemical Industries, Ltd.) to a concentration of 0.22% by weight. Then, the solution was adjusted to pH 8.3 by adding 5% by weight of aqueous sodium hydroxide solution and to pH 8.4 by adding aqueous ammonia. The molar ratio of Na⁺ ions to NH⁴⁺ ions used was 1:2.3. Subsequently, 0.15 ml of an aqueous sodium benzoisothiazolinone solution (7% by mass) was added per 1 kg of this solution to obtain P-22.

Composition: MMA (63% by weight), EA (355 by weight), AA (2% by weight); Tg 47° C.

5) Preparation of Coating Solution for Image Forming Layer-101 to 170

To the dispersion of organic silver salt obtained as described above in an amount of 1000 g and 276 mL of water were serially added the pigment-1 dispersion, the organic polyhalogen compound-1 dispersion, the organic polyhalogen compound-2 dispersion, the phthalazine compound-1 solution, the polymer latex described above, the reducing agent-1 dispersion, the reducing agent-2 dispersion, the hydrogen bonding compound-1 dispersion, and the development accelerator-i dispersion and the development accelerator-2 dispersion, the color-tone-adjusting agent-1 dispersion, the mercapto compound-1 aqueous solution and the mercapto compound-2 aqueous solution. The coating solutions for the image forming layer were prepared by adding the silver halide mixed emulsion for coating solution thereto followed by thorough mixing just prior to the coating was fed directly to a coating die, and was coated.

The dispersion of organic silver salt, the polymer latex and the mixed silver halide emulsion used respectively for the preparation are shown in Tables 18 to 21, and thus coating solutions for image forming layer-101 to -170 were prepared.

The amount of zirconium in the coating solution was 0.52 mg per one g of silver.

6) Preparations of Coating Sample-101 to -170

Preparations of samples of the photothermographic material-101 to -170 were conducted in a similar manner in Example 1 except using the coating solution for image forming layer-101 to -170. Reverse surface of the back surface was subjected to simultaneous overlaying coating by a slide bead coating method in order of the image forming layer, intermediate layer, first layer of the surface protective layers and second layer of the surface protective layers starting from the undercoated face, and thus samples of the photothermographic material-101 to -170 were produced.

The coating amount of each compound for the image forming layer (g/m²) is as follows.

| | |
|---|---|
| Organic silver salt (shown in | 5.27 |
| Tables 18 to 21) | |
| Pigment (C. I. Pigment Blue 60) | 0.036 |
| Polyhalogen compound-1 | 0.09 |
| Polyhalogen compound-2 | 0.14 |
| Phthalazine compound-1 | 0.18 |
| Polymer latex | 9.43 |
| Reducing agent-1 | 0.55 |
| Reducing agent-2 | 0.22 |
| Hydrogen bonding compound-1 | 0.28 |
| Development accelerator-1 | 0.025 |
| Development accelerator-2 | 0.020 |
| Color-tone-adjusting agent-1 | 0.008 |
| Mercapto compound-1 | 0.002 |
| Mercapto compound-2 | 0.006 |
| Silver halide (shown in Table 18 to 21) | 0.046 |
| (on the basis of Ag content) | |

Conditions for coating and drying are similar to those in Example 1.
Blue Dye-2 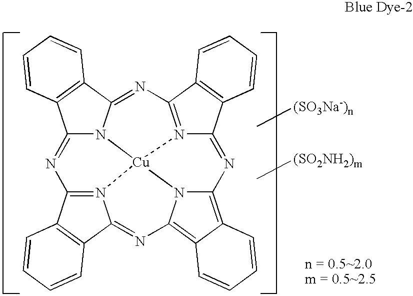 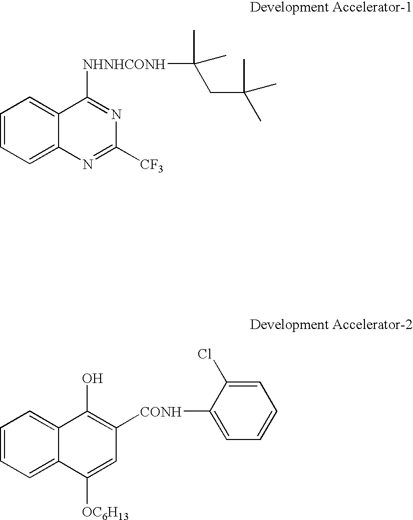
3. Evaluation of Photographic Performances

1) Exposure and Termal Development

Exposure and Thermal Development were performed on each sample similar to Example 1.

2) Evaluation

Sensitivity: Evaluation of sensitivity was done similar to Example 1. A sensitivity of the sample-101 is set to be 100 and relative sensitivities were shown.

Image stability: Each sample after thermal development was stored for 30 days under illumination of a fluorescent lamp with an intensity of 100 lux in a room at 25° C. and 70% RH. The fog density of just after the thermal development was measured, and the difference of fog density after leaving for 30 days in a condition described above relative to the fog before leaving (Δ Dmin) was defined as image stability. It is preferred that the increment in a fog density after such leaving is small.

The results obtained are shown in Tables 18 to 21.

TABLE 18

| | Mixed emulsion for coating solution | | | Dispersion of | | | | | | |
|---|---|---|---|---|---|---|---|---|---|---|
| | | Silver iodide | Compound having | silver salt of fatty acid | | | | | | Image |
| Photothermographic | | content | adsorption group and | | Silver | | Polymer latex | | Sensi- | stability |
| material No. | No | (mol %) | reducing group | No | behenate | Silver erucate | No | Tg | tivity | (Δ Dmin) |
| 101 | A11 | 100 | — | A | 98% | 0.001% | P-1 | 20° C. | 100 | 0.01 |
| 102 | A11 | 100 | — | A | 98% | 0.001% | P-2 | 22° C. | 95 | 0.01 |
| 103 | A11 | 100 | — | A | 98% | 0.001% | P-21 | 20° C. | 100 | 0.02 |
| 104 | A11 | 100 | — | A | 98% | 0.001% | P-22 | 47° C. | 60 | 0.03 |
| 105 | A11 | 100 | — | B | 83% | 0.001% | P-1 | 20° C. | 105 | 0.02 |
| 106 | A11 | 100 | — | B | 83% | 0.001% | P-2 | 22° C. | 100 | 0.02 |
| 107 | A11 | 100 | — | B | 83% | 0.001% | P-21 | 20° C. | 105 | 0.03 |
| 108 | A11 | 100 | — | B | 83% | 0.001% | P-22 | 47° C. | 65 | 0.04 |
| 109 | A11 | 100 | — | C | 49% | 0.001% | P-1 | 20° C. | 110 | 0.12 |
| 110 | A11 | 100 | — | C | 49% | 0.001% | P-2 | 22° C. | 105 | 0.12 |
| 111 | A11 | 100 | — | C | 49% | 0.001% | P-21 | 20° C. | 110 | 0.12 |
| 112 | A11 | 100 | — | C | 49% | 0.001% | P-22 | 47° C. | 70 | 0.12 |
| 113 | A11 | 100 | — | D | 97% | 1.0% | P-1 | 20° C. | 100 | 0.03 |
| 114 | A11 | 100 | — | D | 97% | 1.0% | P-2 | 22° C. | 95 | 0.03 |
| 115 | A11 | 100 | — | D | 97% | 1.0% | P-21 | 20° C. | 100 | 0.04 |
| 116 | A11 | 100 | — | D | 97% | 1.0% | P-22 | 47° C. | 60 | 0.05 |
| 117 | A12 | 100 | (19) (71) | A | 98% | 0.001% | P-1 | 20° C. | 145 | 0.01 |
| 118 | A12 | 100 | (19) (71) | A | 98% | 0.001% | P-2 | 22° C. | 140 | 0.01 |

TABLE 19

| | Mixed emulsion for coating solution | | | Dispersion of | | | | | | |
|---|---|---|---|---|---|---|---|---|---|---|
| | | Silver iodide | Compound having | silver salt of fatty acid | | | | | | Image |
| Photothermographic | | content | adsorption group and | | Silver | | Polymer latex | | Sensi- | stability |
| material No. | No | (mol %) | reducing group | No | behenate | Silver erucate | No | Tg | tivity | (Δ Dmin) |
| 119 | A12 | 100 | (19) (71) | A | 98% | 0.001% | P-21 | 20° C. | 145 | 0.02 |
| 120 | A12 | 100 | (19) (71) | A | 98% | 0.001% | P-22 | 47° C. | 70 | 0.03 |
| 121 | A12 | 100 | (19) (71) | B | 83% | 0.001% | P-1 | 20° C. | 150 | 0.02 |
| 122 | A12 | 100 | (19) (71) | B | 83% | 0.001% | P-2 | 22° C. | 145 | 0.02 |
| 123 | A12 | 100 | (19) (71) | B | 83% | 0.001% | P-21 | 20° C. | 150 | 0.03 |
| 124 | A12 | 100 | (19) (71) | B | 83% | 0.001% | P-22 | 47° C. | 75 | 0.04 |
| 125 | A12 | 100 | (19) (71) | C | 49% | 0.001% | P-1 | 20° C. | 155 | 0.12 |
| 126 | A12 | 100 | (19) (71) | C | 49% | 0.001% | P-2 | 22° C. | 150 | 0.12 |
| 127 | A12 | 100 | (19) (71) | C | 49% | 0.001% | P-21 | 20° C. | 155 | 0.12 |
| 128 | A12 | 100 | (19) (71) | C | 49% | 0.001% | P-22 | 47° C. | 75 | 0.12 |
| 129 | A12 | 100 | (19) (71) | D | 97% | 1.0% | P-1 | 20° C. | 140 | 0.03 |
| 130 | A12 | 100 | (19) (71) | D | 97% | 1.0% | P-2 | 22° C. | 135 | 0.03 |
| 131 | A12 | 100 | (19) (71) | D | 97% | 1.0% | P-21 | 20° C. | 140 | 0.04 |
| 132 | A12 | 100 | (19) (71) | D | 97% | 1.0% | P-22 | 47° C. | 65 | 0.05 |
| 133 | A13 | 100 | (19) (49) (71) | A | 98% | 0.001% | P-1 | 20° C. | 160 | 0.01 |
| 134 | A13 | 100 | (19) (49) (71) | A | 98% | 0.001% | P-2 | 22° C. | 155 | 0.01 |
| 135 | A13 | 100 | (19) (49) (71) | A | 98% | 0.001% | P-21 | 20° C. | 160 | 0.02 |
| 136 | A13 | 100 | (19) (49) (71) | A | 98% | 0.001% | P-22 | 47° C. | 70 | 0.03 |

TABLE 20

| | Mixed emulsion for coating solution | | | Dispersion of | | | | | | |
|---|---|---|---|---|---|---|---|---|---|---|
| | | Silver iodide | Compound having | silver salt of fatty acid | | | | | | Image |
| Photothermographic | | content | adsorption group and | | Silver | | Polymer latex | | Sensi- | stability |
| material No. | No | (mol %) | reducing group | No | behenate | Silver erucate | No | Tg | tivity | (Δ Dmin) |
| 137 | A13 | 100 | (19) (49) (71) | A | 98% | 0.001% | P-21 | 20° C. | 145 | 0.02 |
| 138 | A13 | 100 | (19) (49) (71) | B | 83% | 0.001% | P-2 | 22° C. | 165 | 0.02 |
| 139 | A13 | 100 | (19) (49) (71) | B | 83% | 0.001% | P-21 | 20° C. | 170 | 0.03 |
| 140 | A13 | 100 | (19) (49) (71) | B | 83% | 0.001% | P-22 | 47° C. | 75 | 0.04 |
| 141 | A13 | 100 | (19) (49) (71) | C | 49% | 0.001% | P-1 | 20° C. | 180 | 0.12 |
| 142 | A13 | 100 | (19) (49) (71) | C | 49% | 0.001% | P-2 | 22° C. | 175 | 0.12 |
| 143 | A13 | 100 | (19) (49) (71) | C | 49% | 0.001% | P-21 | 20° C. | 180 | 0.12 |
| 144 | A13 | 100 | (19) (49) (71) | C | 49% | 0.001% | P-22 | 47° C. | 75 | 0.12 |
| 145 | A13 | 100 | (19) (49) (71) | D | 97% | 1.0% | P-1 | 20° C. | 160 | 0.03 |
| 146 | A13 | 100 | (19) (49) (71) | D | 97% | 1.0% | P-2 | 22° C. | 155 | 0.03 |
| 147 | A13 | 100 | (19) (49) (71) | D | 97% | 1.0% | P-21 | 20° C. | 160 | 0.04 |
| 148 | A13 | 100 | (19) (49) (71) | D | 97% | 1.0% | P-22 | 47° C. | 65 | 0.05 |
| 149 | B11 | 70 | — | A | 98% | 0.001% | P-1 | 20° C. | 90 | 0.02 |
| 150 | B11 | 70 | — | A | 98% | 0.001% | P-22 | 47° C. | 50 | 0.04 |
| 151 | B11 | 70 | — | C | 49% | 0.001% | P-1 | 20° C. | 100 | 0.14 |
| 152 | B11 | 70 | — | C | 49% | 0.001% | P-22 | 47° C. | 60 | 0.14 |
| 153 | B12 | 70 | (19) (71) | A | 98% | 0.001% | P-1 | 20° C. | 135 | 0.02 |
| 154 | B12 | 70 | (19) (71) | A | 98% | 0.001% | P-22 | 47° C. | 55 | 0.04 |

TABLE 21

| | Mixed emulsion for coating solution | | | Dispersion of | | | | | | |
|---|---|---|---|---|---|---|---|---|---|---|
| | | Silver iodide | Compound having | silver salt of fatty acid | | | | | | Image |
| Photothermographic | | content | adsorption group and | | Silver | | Polymer latex | | Sensi- | stability |
| material No. | No | (mol %) | reducing group | No | behenate | Silver erucate | No | Tg | tivity | (Δ Dmin) |
| 155 | B12 | 70 | (19) (71) | C | 49% | 0.001% | P-21 | 20° C. | 145 | 0.14 |
| 156 | B12 | 70 | (19) (71) | C | 49% | 0.001% | P-22 | 47° C. | 65 | 0.14 |
| 157 | B13 | 70 | (19) (49) (71) | A | 98% | 0.001% | P-1 | 20° C. | 150 | 0.02 |
| 158 | B13 | 70 | (19) (49) (71) | A | 98% | 0.001% | P-22 | 47° C. | 55 | 0.03 |
| 159 | B13 | 70 | (19) (49) (71) | C | 49% | 0.001% | P-1 | 20° C. | 170 | 0.14 |
| 160 | B13 | 70 | (19) (49) (71) | C | 49% | 0.001% | P-22 | 47° C. | 65 | 0.14 |
| 161 | C11 | 3.5 | — | A | 98% | 0.001% | P-1 | 20° C. | 70 | 0.04 |
| 162 | C11 | 3.5 | — | A | 98% | 0.001% | P-22 | 47° C. | 35 | 0.06 |
| 163 | C11 | 3.5 | — | C | 49% | 0.001% | P-1 | 20° C. | 80 | 0.16 |
| 164 | C11 | 3.5 | — | C | 49% | 0.001% | P-22 | 47° C. | 45 | 0.16 |
| 165 | C12 | 3.5 | (19) (71) | A | 98% | 0.001% | P-1 | 20° C. | 120 | 0.04 |
| 166 | C12 | 3.5 | (19) (71) | A | 98% | 0.001% | P-22 | 47° C. | 40 | 0.06 |
| 167 | C12 | 3.5 | (19) (71) | C | 49% | 0.001% | P-1 | 20° C. | 130 | 0.16 |
| 168 | C12 | 3.5 | (19) (71) | C | 49% | 0.001% | P-22 | 47° C. | 45 | 0.16 |
| 169 | C13 | 3.5 | (19) (49) (71) | A | 98% | 0.001% | P-1 | 20° C. | 130 | 0.04 |
| 170 | C13 | 3.5 | (19) (49) (71) | A | 98% | 0.001% | P-22 | 47° C. | 40 | 0.05 |

As shown in Tables 18 to Table 21, each of the sample-117, -118, -119, -121, -122, -123, -129, -130, -131, -133, -134, -135, -137, -138, -139, -145, -146, -147, -153, -157, -165 and -169 of the invention show high sensitivity and excellent image stability. Particularly, according to the compound having an adsorption group to a silver halide and a reducing group, in the case the polymer latex P-22 having a Tg of 45° C. or more was used the increment in sensitivity was small, but in the cases the polymer latex P-1, P-2 and P-21 of the invention having Tg of 45° C. or less were used the increments in sensitivity were very large, and unexpected results were able to be obtained.

Further, when a dispersion of organic silver salt having lower content of silver behenate was used, the worse was the image stability not according to the polymer latex, and on the other hand, the higher content of silver behenate was used the better was the image stability. Particularly, it was an unexpected result that quite excellent image stability was obtained by a concomitant use of an organic silver salt having high content of silver behenate and a polymer latex having Tg of 45° C. or less.

### Example 3

1. Back Layer

A back layer similar to that used in Example 2 was used.

2. Preparations of Coating Samples

1) Preparations of Silver Halide Emulsions

Preparations were conducted similar to Example 1 except that using mixed emulsions for coating solution described below.

(Preparations of Mixed Emulsion A21 and A22 for Coating Solution)

The silver halide emulsion-1, the silver halide emulsion-2 and the silver halide emulsion-3 at the rate of (silver halide emulsion-1:silver halide emulsion-2: silver halide emulsion-3=) 5:2:3 by mol of silver were dissolved, and thereto was added benzothiazolium iodide at 7×10⁻³ mol per one mol of silver with a 1% by weight aqueous solution. Further, water was added thereto to give the content of silver of 38.2 g per one kg of the mixed emulsion for a coating solution, and 1-(3-methylureidophenyl)-5-mercaptotetrazole was added to give 0.34 g per 1 kg of the mixed emulsion for a coating solution. Further, as “a compound that can be one-electron-oxidized to provide a one-electron oxidation product, which release one or more electrons”, the compounds Nos. 2, 20 and 26 were added in the amount of 2×10⁻³ mol per one mol of silver halide respectively, and thus mixed emulsion A21 for coating solution was obtained.

Mixed emulsion A22 was prepared by adding, as “a compound having an adsorption group and a reducing group”, the compounds Nos. 19, 49 and 71 in the amount of 8×10⁻³ mol per one mol of silver halide respectively to the mixed emulsion A21.

(Preparations of Mixed Emulsion B21 and B22 for Coating Solution)

Preparations of the mixed emulsion B21 and B22 were conducted similar to the process in the preparations of the mixed emulsion A21 and A22 for coating solution except that using the silver halide emulsion-4, the silver halide emulsion-5 and the silver halide emulsion-6 at the rate of (silver halide emulsion-4:silver halide emulsion-5:silver halide emulsion-6=) 5:2:3 by mol of silver instead of using the silver halide emulsion-1, the silver halide emulsion-2 and the silver halide emulsion-3.

(Preparations of Mixed Emulsion C21 and C22 for Coating Solution)

Preparations of he mixed emulsion C21 and C22 for coating solution were conducted similar to the process in the preparations of the mixed emulsion A21 and. A22 for coating solution except that using the silver halide emulsion-7, the silver halide emulsion-8 and the silver halide emulsion-9 at the rate of (silver halide emulsion-7:silver halide emulsion-8:silver halide emulsion-9=) 5:2:3 by mol of silver instead of using the silver halide emulsion-1, the silver halide emulsion-2 and the silver halide emulsion-3.

2) Preparations of Coating Solution for Image Forming Layer-201 to -227

To the dispersion of organic silver salt obtained as described above in an amount of 1000 g and 276 mL of water were serially added the pigment-1 dispersion, the organic polyhalogen compound dispersion shown in Table 22 and Table 23, the phthalazine compound-1 solution, the SBR latex (Tg: 17° C.) solution, the reducing agent-1 dispersion, the reducing agent-2 dispersion, the hydrogen bonding compound-1 dispersion, and the development accelerator-1 dispersion and the development accelerator-2 dispersion, the color-tone-adjusting agent-1 dispersion, the mercapto compound-1 aqueous solution and the mercapto compound-2 aqueous solution. The coating solutions for the image forming layer (shown in Tables 22 and 23) were prepared by adding the silver halide mixed emulsion for coating solution thereto followed by thorough mixing just prior to the coating was fed directly to a coating die, and was coated.

The amount of zirconium in the coating solution was 0.52 mg per one g of silver.

3) Preparations of Coating Samples

Preparations of samples of the photothermographic material-201 to -227 were conducted similar to Example 1 except using the coating solution for image forming layer-201 to -227. Reverse surface of the back surface was subjected to simultaneous overlaying coating by a slide bead coating method in order of the image forming layer, intermediate layer, first layer of the surface protective layers and second layer of the surface protective layers starting from the undercoated face, and thus samples of the photothermographic material-201 to -227 were produced.

The coating amount of each compound for the image forming layer (g/m²) is as follows.

| | |
|---|---|
| Silver behenate | 5.27 |
| Pigment (C. I. Pigment Blue 60) | 0.036 |
| Polyhalogen compound | (see Tables 22 and 23) |
| Phthalazine compound-1 | 0.18 |
| SBR latex | 9.43 |
| Reducing agent-1 | 0.55 |
| Reducing agent-2 | 0.22 |
| Hydrogen bonding compound-1 | 0.28 |
| Development accelerator-1 | 0.025 |
| Development accelerator-2 | 0.020 |
| Color-tone-adjusting agent-1 | 0.008 |
| Mercapto compound-1 | 0.002 |
| Mercapto compound-2 | 0.006 |
| Silver halide (see Tables 22 and 23) | 0.046 |

(on the basis of Ag content)

3. Evaluation of Photographic Performances

Exposure and thermal development were performed on each sample similar to Example 1.

<Sensitivity>

Sensitivity was shown by the relative value by taking an inverse of the exposure required for giving a density of fog+1.0 in photothermographic material-206 as 100. The larger value shows a higher sensitivity.

(Raw Stock Storability)

Each sample packaged under the same condition as in Example 1 was exposed and thermal developed after purposely preserving it at 50° C. for 72 hours. The increase of fogging after the preservation at 50° C. for 72 hours was measured relative to that before preservation. The increment of fog (ΔDmin) shows raw stock stability. The smaller Dmin shows better raw stock stability.

The results obtained are shown in Tables 22 and 23.

TABLE 22

| | Silver halide emulsion | | | Organic polyhalogen compound | | | | | |
|---|---|---|---|---|---|---|---|---|---|
| | | Silver iodide | Compound having | | Melting | Addition amount | | | Raw stock |
| Photothermographic | | content | adsorption group and | | point | (mol/mol organic | | | storability |
| material No. | | (mol %) | reducing group | | (° C.) | silver salt) | Sensitivity | Fog | (Δ Dmin) |
| 201 | A21 | 100 | — | — | — | — | 40 | 1.20 | 0.50 |
| 202 | A21 | 100 | — | 1 (H-1) | 196 | 2 × 10⁻² | 40 | 0.18 | 0.04 |
| 203 | A21 | 100 | — | 2 (H-3) | 159 | 2 × 10⁻² | 40 | 0.18 | 0.01 |
| 204 | A21 | 100 | — | 3 (H-4) | 145 | 2 × 10⁻² | 40 | 0.18 | 0.01 |
| 205 | A22 | 100 | (19) (40) (71) | — | — | — | 60 | 1.40 | 0.55 |
| 206 | A22 | 100 | (19) (40) (71) | 1 (H-1) | 196 | 2 × 10⁻² | 100 | 0.18 | 0.04 |
| 207 | A22 | 100 | (19) (40) (71) | 2 (H-3) | 159 | 2 × 10⁻² | 100 | 0.18 | 0.01 |
| 208 | A22 | 100 | (19) (40) (71) | 3 (H-4) | 145 | 2 × 10⁻² | 100 | 0.18 | 0.01 |
| 209 | B21 | 70 | — | — | — | — | 35 | 1.30 | 0.55 |
| 210 | B21 | 70 | — | 1 (H-1) | 196 | 2 × 10⁻² | 35 | 0.18 | 0.06 |
| 211 | B21 | 70 | — | 2 (H-3) | 159 | 2 × 10⁻² | 35 | 0.18 | 0.03 |
| 212 | B21 | 70 | — | 3 (H-4) | 145 | 2 × 10⁻² | 35 | 0.18 | 0.03 |
| 213 | B22 | 70 | (19) (40) (71) | — | — | — | 95 | 1.50 | 0.60 |
| 214 | B22 | 70 | (19) (40) (71) | 1 (H-1) | 196 | 2 × 10⁻² | 95 | 0.18 | 0.06 |
| 215 | B22 | 70 | (19) (40) (71) | 2 (H-3) | 159 | 2 × 10⁻² | 95 | 0.18 | 0.03 |
| 216 | B22 | 70 | (19) (40) (71) | 3 (H-4) | 145 | 2 × 10⁻² | 95 | 0.18 | 0.03 |

TABLE 23

| | Silver halide emulsion | | | Organic polyhalogen compound | | | | | |
|---|---|---|---|---|---|---|---|---|---|
| | | Silver iodide | Compound having | | Melting | Addition amount | | | Raw stock |
| Photothermographic | | content | adsorption group and | | point | (mol/mol organic | | | storability |
| material No. | | (mol %) | reducing group | | (° C.) | silver salt) | Sensitivity | Fog | (Δ Dmin) |
| 217 | C21 | 3.5 | — | — | — | — | 30 | 1.70 | 0.80 |
| 218 | C21 | 3.5 | — | 1 (H-1) | 196 | 2 × 10⁻² | 30 | 0.19 | 0.09 |
| 219 | C21 | 3.5 | — | 2 (H-3) | 159 | 2 × 10⁻² | 30 | 0.19 | 0.05 |
| 220 | C21 | 3.5 | — | 3 (H-4) | 145 | 2 × 10⁻² | 30 | 0.19 | 0.05 |
| 221 | C22 | 3.5 | (19) (40) (71) | — | — | — | 85 | 1.90 | 1.00 |
| 222 | C22 | 3.5 | (19) (40) (71) | 1 (H-1) | 196 | 2 × 10⁻² | 85 | 0.19 | 0.09 |
| 223 | C22 | 3.5 | (19) (40) (71) | 2 (H-3) | 159 | 2 × 10⁻² | 85 | 0.19 | 0.05 |
| 224 | C22 | 3.5 | (19) (40) (71) | 3 (H-4) | 145 | 2 × 10⁻² | 85 | 0.19 | 0.05 |
| 225 | A22 | 100 | (19) (40) (71) | 3 (H-4) | 145 | 0.5 × 10⁻² | 110 | 0.20 | 0.05 |
| 226 | A22 | 100 | (19) (40) (71) | 3 (H-4) | 145 | 1.0 × 10⁻¹ | 80 | 0.18 | 0.01 |
| 227 | A22 | 100 | (19) (40) (71) | 3 (H-4) | 145 | 2.0 × 10⁻¹ | 60 | 0.17 | 0.01 |

The results in Tables 22 and 23 show that the photothermographic material-206, -207, -208, -214, -215, -216, -222, -223, -224, -225, -226 and -227 of the invention have high sensitivity, small degree of fogging and excellent raw stock storability. It was an unexpected result that the degree of increment of sensitivity is large by adding an organic polyhalogen compound by using a compound having an adsorptive group and reducing group, although a slight increase of sensitivity is observed in the absence of the organic polyhalogen compound. In addition, raw sock storability was excellent in using the organic polyhalogen compound H-3 or H-4 with melting point of 170° C. or less. This result clearly shows that the invention is effective when the content of silver iodide in photosensitive silver halide is large.

What is claimed is:

1. A photothermographic material comprising an image forming layer containing at least a photosensitive silver halide, a non-photosensitive organic silver salt, a reducing agent and a binder on the same surface of a support, wherein the photothermographic material contains:
a compound having an adsorption group to silver halide and a reducing group, or a precursor of the compound; and
a development accelerator.

2. The photothermographic material according to claim 1, wherein the compound having an adsorption group to silver halide and a reducing group is represented by the following formula (I):
A-(W)n-B formula (I)
wherein, in the formula, A represents an atomic group containing a group capable of adsorbing to silver halide, W represents a divalent linking group, n represents 0 or 1, and B represents a reducing group.

3. The photothermographic material according to claim 1, wherein the development accelerator is at least one selected from compound groups represented by the following formulae (1), (2) and (3): 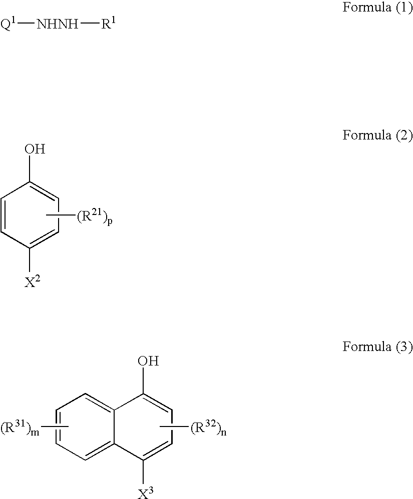
wherein:
in formula (1), Q¹ represents a 5 to 7 membered unsaturated ring capable of bonding to NHNH—R¹ through a carbon atom; R¹ represents a carbamoyl group, an acyl group, an alkoxycarbonyl group, an aryloxycarbonyl group, a sulfonyl group or a sulfamoyl group; and
in formulae (2) and (3), X² and X³ each independently represent a hydrogen atom or a substituent; R²¹, R³¹ and R³² each independently represent a hydrogen atom or a substituent capable of substitution; m and p each independently represent an integer from 0 to 4; and n represents an integer from 0 to 2.

4. The photothermographic material according to claim 1, wherein the reducing agent is represented by the following formula (7): 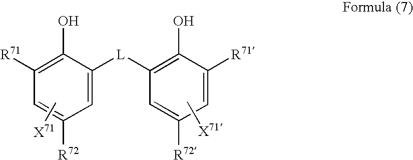
wherein, in formula (7), R⁷¹ and R^{71′} each independently represent an alkyl group having 1 to 20 carbon atoms; R⁷² and R^{72′} each independently represent a hydrogen atom or a group capable of substituting for a hydrogen atom on a benzene ring; X⁷¹ and X^{71′} each independently represent a hydrogen atom or a group capable of substituting for a hydrogen atom on a benzene ring; L represents a —S— group or —CHR⁷³— group; and R⁷³ represents a hydrogen atom or an alkyl group.

5. The photothermographic material according to claim 1, wherein a silver iodide content of the photosensitive silver halide is 5% by mole or more.

6. The photothermographic material according to claim 5, wherein the silver iodide content of the photosensitive silver halide is 40% by mole or more.

7. The photothermographic material according to claim 1, wherein the photothermographic material is exposed to a laser beam.

8. The photothermographic material according to claim 7, wherein the laser beam has a wavelength of 350 nm to 450 nm.

9. The photothermographic material according to claim 7, wherein a light source of the laser beam is a blue laser diode.

10. A photothermographic material comprising, on a support, at least a photosensitive silver halide, a non-photosensitive organic silver salt, a reducing agent and a binder, wherein:
1) the photothermographic material contains a compound having an adsorption group to silver halide and a reducing group, or a precursor of the compound;
2) the non-photosensitive organic silver salt contains silver behenate in an amount of not less than 80% by mole; and
3) the binder has a glass transition temperature (Tg) of 45° C. or less.

11. The photothermographic material according to claim 10, wherein the non-photosensitive organic silver salt contains silver erucate in an amount of from 1.0×10⁻⁶% by mole to 0.4% by mole.

12. The photothermographic material according to claim 10, wherein the binder is a polymer latex synthesized by using a polymerization initiator in an amount of 0.3% by weight to 2.0% by weight based on a total amount of monomers.

13. The photothermographic material according to claim 10, wherein a silver iodide content of the photosensitive silver halide is 5% by mole or more.

14. The photothermographic material according to claim 13, wherein the silver iodide content of the photosensitive silver halide is 40% by mole or more.

15. A photothermographic material comprising, on a surface of a support, at least a photosensitive silver halide, a non-photosensitive organic silver salt, a reducing agent and a binder, wherein the photothermographic material contains: a compound having an adsorption group to silver halide and a reducing group, or a precursor of the compound; and at least one compound represented by the following formula (H):
Q-(Y)ₙ—C(Z₁)(Z₂)X
wherein, in formula (H), Q represents an alkyl group, an aryl group or a heterocyclic group; Y represents a divalent linking group; n represents 0 or 1; Z₁ and Z₂ each independently represent a halogen atom; and X represents a hydrogen atom or an electron attracting group.

16. The photothermographic material according to claim 15, wherein the compound represented by formula (H) has a melting point of 170° C. or less.

17. The photothermographic material according to claim 15, wherein Q represents a heterocyclic group in formula (H).

18. The photothermographic material according to claim 15, wherein the compound represented by formula (H) is contained in an amount of 1×10⁻² mole to 5×10⁻² mole per one mole of the non-photosensitive organic silver salt.

19. The photothermographic material according to claim 18, wherein the compound represented by formula (H) is contained in an amount of 1×10⁻² mole to 3×10⁻² mole per one mole of the non-photosensitive organic silver salt.

20. The photothermographic material according to claim 15, wherein a silver iodide content of the photosensitive silver halide is 5% by mole or more.

21. The photothermographic material according to claim 20, wherein the silver iodide content of the photosensitive silver halide is 40% by mole or more.
